SEQUENCE LISTING (31 sequences)

SEQ ID NO: 1 - DNA, 99599 bp, Homo sapiens
gtgggcccctgtgcttcaaaacgtccccgcatgggaaccacaaaaacgttgcctccccagttatcaccccaagggcccaagagccgaggactctgcccggcgtccttcagctggcaccagctgtcagaaaagcggaactggggacgaggactttgcccctaaccaacatggccgccctgaggcttcgggcttcgggcggcagaaggaaggtcacgtgaagagaattccgttcctttattggccccgtctcctggaagggcggggtacaataacccaaccggcgccggccttaaaggggccaccgttggatctgccggtggccggccctaggggctgggggggcggtcgccgcgccgggcttctgcccctcccgcgcggaacggtgacgggcggggctggcgctgggaggccgtgtcgctgggagactgctgacagcccgccgcctgccgccgcgcgattccgagggggttaacggcggagccgccggccgggcgcggaccggagcgcgtgaggctccggcgcgcaagcccggagcagcccgctggggcgcacagggtcgcgcgggcgcggggatggaggacggcgtggccggtccccagctcggggccgcggcggaggcggcggaggcggccgaggcgcgagcgcggcccggggtgacgctgcggcccttcgcgcccctctcgggggcggccgaggcggacgagggcggcggcgactggagcttcattgactgcgagatggaggaggtggacctgcaggacctgcccagcgccaccatcgcctgtcacctggacccgcgcgtgttcgtggacggcctgtgccgggtgaggaccgcgccgggcgggccgtcggggcggagggcggacacttgttgcccgaggaggcggcgcgggtcgcagcgcccagtcccggccgcgcgcggggcggggaggcagcgacgtcccccgggctgctcggccgcggacccgtcagggctggggcgtggggacggcgccccgagggtcccggtcccctagcacccccggggcgcgcggagctcactgcagagtcccacaggctcgccccggcccccgtgtgcgcccaggctggtgcgactaggggggtgaattcgctccccaaggtggggcagcgccgccgccccctgcgctctcgccatcgccccgcatttactcgctggaggagggggtcacctcattcctagggaggaggaaacagacattgagcggcgacgtgactcagtgttcataaataggacgacgtccctgcattcccaatctgcactattggaagaaaagccaatgtttgggtgaggatccgtggttgctcattagccagcggctggccagttttggtggaattgtgttggggggaaggggaccatctttcagacctttaggatatttagtcaagaaccttgcccccttgtgtgaaggtgtggcttgccgccatcggggacacccagtacatggggagtcgactccttcccccgcctccccccacccccgcaaaatccacacaatttagacactttggagggtgaggggcaggtatgagtaatcaataatggtggtggggaggaagaatttatttcaaatctgcagttattgtgcagaataaaatgtggacaacgtgggcgtcacagaatgaaaccggtctttgagagatgccccattaggagagcagctgtcaaaaaaagcagtgctttcagcgcttggctgtgggtccacaaatgctgtcaatgaactatagttgaaggctgctgccaatacaacaccactgtgaaacagaatggtgtatgtaagtgtcatttatttataatttatatgttcacttactttctgaaaggaattacaatggccgtgtgcttaggtaagcttccaggcatgctttctagagcagcaattgtcaggaactcagggtcttactgattgatcttactctaaaaccttttcctctccatataaactaagcgctagccagcatttcagaccttttccttaggagttctaggctgtctttctgctagaacaaggtcaagtcacgtaagacggcacttacttgtagtgttggagacaattttttccagtgttggatacaatcctgaaattgtgttgtatgaaagtttgcccacttcgctagctattcattttaacaaatatttattgagacttcgctacgggataggtactgtcctaggctctgaggctgcatcagtaaataaaatagcatttctgcctccagggttgacattttttggaagggaaacaagcaataaagaaatatcaaatgtatcagaaagtaatgatgctataggaaaaaataagacttggagggcaggaggagggagtggagatctgggagtggaggggagattgctattttccataagatgatcagggaaggtcttactgatatggtgatattttgagcagagacaatgtagcattggttcattcaggctttgctgtctattgagtgcttactgtgttccagccactggtttaggcccagaggataaagcagggaacatttcaagctccttgctttcatggagcttaggatccagtggttgagggggagatagacaataggaaaaaggcaagtgaacaagatcatttcggatagtgataaatgcgatgaagagactgaaacagggatagagagcaaggggagggggcttggtcagagtggtcaggtcctaacactgtgggggttttgttgaagagctggtgaattggggcagtcctgagggaactaacaagggatgtccaggcctgcagccatgagcaacagctggaagctggagctgggggaggaagtcacgtggctggaaacctaggggaggagctgcctgccaggagctgtagacttgaaggtgtggagttgagatgctaaggcagggtacaggcagggaagaaattctcaggcttctgatttcattggcagaactcaaaggacagctaggaggcaagggagcccctgcagtggagtccataggttgggtcatcctttcagggcccacagaagggtagataatggctctggggacagtgtggataaaggggacttacacagaggagttagtagggagccactttagatggagtggcccagggaggcctctgcacagcctggaccaggttgacaggaagaagctccctggggaggtgtttgtgtggccggcatcccggcagagggactagcaggtgcagaagctccagtgcagggtgaactccatttttaaaggacttgaagggttgcatgagagacagagaggcgattggtagctgaggttggataagcaaccagaaaacatccccctggggccatggtaaggattcaggtgtgattctaattgcacatcttggtggagaatggctttcaggagggaaactgggtaggctagagaggaagcaaggagacctggtaggaggctgttgccatcatccaggggagataggaagggagtgggactaggatggtggtattggagatggagaaaggggcagagcctccatctgagcctcttctctccatttggagaatctggagcttcagaatggggatgagggagggttgtgcactgatgtccaattctagggtcctgtgagatatacagcaatcagtgaaaacccaaaaaccaggtgggctaagggagtcccagtctctgagggcaaatagctctatgcagtgggcaacctgagagctaaagtcacagcgggtccttggtaagccttgcagcaagtggaccatttctcatttagctgaaaccatccttctaggtgggaatatgtagtttctgcggtttcaatgtggcagtcttactgttaagactggggtgtcacctttggatgatgtaatgtaaatgtaaatctactttaggttggtggtatctccccttgtgtaaacagatcattaactgcaatgctgacaaaagtccctgggggtctggccgtcccctccttagccagtctgttggatctggagagtgatggtgtgaggaaaaaagactggatcaaacttctttatatatagtcacatgattctgtaagcttagtcttcaaggaaagaaaaaaaattaacctgaactagaattcttttgaaaatttacatcagaagctgttttgtaactataattgcttggccagatatgtaagatttgttttcattggctggctcaggatcaatattgtaaatactgtataatgagtttgttaattaaatgtattagattcacactgttacagatgaatgaaaacttttattaaaatatgattattttctgtttgtacaaatatttgatgaacatattccattatagtactctttttgtgagtctttttttcttttctatttagaaaagcaaaacaattcaaaatgctttgaaccagtaattacatgtgctttgaattgctgaaaatggttagttggttccctggaataagagtttattcagtcatcatcaagctgaccaggaatttaagagttctcagataatattccgttcatttccaagcagtgaatatagttccgtatagtaatggaaacaaatacccttttttcagttgtctgaaatatgaatgtatatttgattcatagagctttgctggaaggctaagtcagaaaattatagaaaaatttactcttttcgcttgagtaaacttacctaaaaaaaacaaaaacaactcacctaagatttgtgatagatgtagtgctatcatgactttcttttaataacaaaatattcggatcagcatgaaagaagtagaagtgacatccttccattctttatgtgagtagagacctttgagcagtgctcccaaccttagctgcacgtcagagtctctagggagctttgaaaaattcccatttccaggccactccaaacccattccaatctctggggctgggaatcgcctggaaagctccccaggtgattctaattgttagctgaggttgggaaccattgtctgaagccggggtttggcctgaccagaggcatcgttatatcttaaaaagatcactgaaaatttgatgaagctccacttctagctagatgacttaccctttctgtgccttgatttcctgaaccgggagccaggcccttggtctgcaggcttccttctcctgattgttgtttgaccctgtggcctacaggcggggtcactggtgcccacagaccaggagatggggcatttggtttaaccttaggttacctccgttcgccttaatgggtgctgctcactctccacccaaacggcagatcatgcacttggcctcccaaaacttgttttctggtcgcaggacatcattcgaaagcaatttgatgattgaagtgttttgaggacctaaggtggccctgctgatgtacatagtttccactcctgaggttgtatatacttggctgcgtttctgcctgttcctcttccaagccagtctgttgtagcatattgtaaaatgtgacatcctagcaggagagtaacagttgggttctattgcactggaaaatccaggcagttttaggccattttcacttttcaccctagtgtgagggtgaggcatgcggtttctcagatttaaattctgaataaaatttccccttaaatgatcttatctccaatatggtatagagtttaatttatttgggaaggttcagaatgttgtacatttttgaaagctacatgttacatatgtgcgaagtttattttcagttttccactatttctctaattttagggtttctgactctaaaatcagatgtttttcacatccagagctgctttaaatcctcctcaccactccaccccctaacaactgcttggttcccctctcagctcaatctgctgtcaccttcattacttaaagcattttttcttccatagcagtagctttaaatgttactgcctgcaacttcaggcttttccagcctcaggacaattacataaaggaacaaaaaataggctttgtgctagagcagaatagctaaggcaggagctgttggttccaatgtttatatttcaggctatattctttgtctctttgtttctctccttttaaaaaaatgtgatccactcattttcatacatatcaccgcagggcctgtttgcgcaggtctgagaacgcatcactcctggtacagtaatagtgactgtgcacacatcagcatgtgtgggatgggtagaccctgggtgtacattgtctatgcagaatcattaggactcatctcaaggatgctgaggaagtgccagtcatttcacatacagttcagttgtgagagacaattttttcctttgtaaatactaatcaccatcaaagcataagaatgctgatgagacacagccgatcactctgccatgatctctgagcattaggaggctataccatggcagtagaaagtaaaaatgtctcttcttgggaaaaacagaaacattttcaaagtgtaacctcaggagaatattaattaccttaactcaaactttgacgttggggaaagggttggcttcatgttgtgtaaatttcaatcatcatagaaattctttaccatatttgatatagttggggtaggttttttatttattttcacctctgaagatttagctgggtttaatatgctcacattccccagtgaagtctacatgaggaggctgggaagcatactggttaaggctatgggtcttaagcatacctttcccacttatgcagtgtgactctgggaagctatttatcctaccgatgccttggtttccctgcctgtaaatggagctgttgatagtactcacattttatgatacacataaaatgcctgtcagagtgattgggtctgtatatacaatataggtttgtgtattagttatctactgccatgtaacaaacccaacacttagtggcttaaataataaatgttaattatgtcacagtgtctgtgggtcagaaattcagggatggcttagcctggtgcccctgcctcagagtctctcccaaggctgcaataaaatatcagctgtggtttcatctgaaggctgaactgaaggagtggtatctactgccaggctcacttgtgtgggggctgctgcaccctctccatagggtggcttgcagcatggcagcaggcttccctcagagcaagccagatggaatgggatccaccatctttttgtagcctaatctcagtgatatcccatcactttcgctgtattctattcctgagaagcgagtcggtaagtgcaaatctcactcagggagagggaattacaaaagggtgtaaataccaggacgtggggatccctgggggccatcctataggccagtggtccccaacatttttggtaccagggaccagtttcatggaagacagtttttctacagaccagggggcagggagctagtttcaggataattcaagtgcattacatttactgtgtactttagttctattattatataataaaataattatacaactcaccataatgtagaattagtagaagccctaagcttgttttcctgcaattagatggtcccatctggggctgatgggagacagtgacagatcatcaggcattagattctcataaggagtgggcaacccagatccctcacatgcacagttcacaatagggttcatgctcctatgggactctgctgccgctggaactcaggcagtaatgtgagcaatgggcagcagctgtaaatacagatgaagctttgctggctcacccgctgctcacctcctgctgtgtggcccgcttcctaacaggccatggactggcactggtctgtggtccggaggttggcgatccctgctataggctgcctaccacagttagatattcattagtacattttttaatttggaaacttttttgacttctgtggagcaatcagtgtttagaaatgcatattaagatttctttctaaggctgggtgtggtgactaatgcctataattccaacactttgggaggccaggagttccagaccagcatggccaacatggtgaaaccccatctctactagaaaatacaaaaattagctcagtgtggtggcacgcgcctgtagtcccagctattcaggaggctgaggcatgagaatcgcttgaaccctggaggcagaggttgcagtaagctgagattgcgccactgcactacagcctggaatacagagcaagactctgtctcaaaaaaaaaaagggagcaaatccaaacggatccctgacattattaaaaagacttatttggaggaaaaaaagaggatttttttctaatctgatttttttctttttagcttcagctccataaaagaatagttttagccactatagtttaacatggaacacttcattgagaggactatagctaggttactaagtttctgagtatcaagagcagttaccccaccatatttctgaacaaagaactcgggaagctaaaccttttataacttggaaaggtccagtacttttccttttgttactaatttcagcaggtgccgcatgaaattcccatgtgcaatcataattaatgccaaagagagaggtatctgaggtcggcctgaattcacgattaagagacaaaaatattatttaattcagaaagttcctcaacataacaatagcatgtcttattttatcactgtattattaatcttctcaggctgccataacaaaaaacacagattaggaggcttgagcaatagacatgtatttcccacagttctggagcctgcaagtctgaggtcgaggtcccagcatggtctctttctggtgaggcctctcctctgggctgcagatggcccccttctccctgtgtccctacgtggtctttcctcagtgtgtggagagaggagcaagctctctggtgtctcttcttataagagcactaatcctattatattagggccccacccttctgacctcctttagcctaattacttccttagaggcctcatctccaaataaagccacactggggattagggcttctgcatttggacttgggggatgcaagcatttaatccatgataatcacctttaatttttgttaatctttgtgctttattttaaagataataaaatagtttctattcattaatatgaagtgctttattttgtatattaagtaccctatttatgtaatacatgtcacgggtgcacctagccggggtcagtgtcacaggcagtaaaggaatttaccaagacagttgcaggtaaagaaagccagatttattagagaaagtataaaaatatgttgcaagggtgcagcaggcagcacagcagagaaggggccgtctgccaagcggcagaggctggaaggaagttttatagggttgcgctggaggggcctatgtgctgaaaaaggtcactgtgcccggggttgtttgtgattggccatttctcagaatcactgttcattgttctctcccatctggggcccctttctcattgttgtttacttatcaggactccacaagacgtatcattttatctttacaagaactctgtggcataggtactgttatcatccccattctatagaggaggaatctgaggccaagtaaacctgtctgaggtcacacaggtgaggaactgttgatccctagactcaaacccagtttcagctaactctaaagcctgtgctgctcatcatctttttttttttttttttttctgagaccgagtcttgctctgttgcccaggctggagtacaatggcacgatctcagctcactgcaacctctgcttcccgggttcaagtgattgtcctgcctcggcctcctgaatagctgggattacaggtgcctgccaccacgcccggctaatttttgtatttttagtagagacagggtttcaccatgttggccaggttggtctcaaactcctgaccttgtgatccacccgcctcggcctcccaaagtgctgggattacaggtgtgagccactccacctggctgctgcttatcatcttaaagcatggcattaatgcgagtgaatttttcatatatctttcacatctcatttcaatcctaggatagctctgtgaagagagtgtttttacctacgggaaacagagattcacatgagttacgactcttcattctttcagtcatgtatttatattatattagggttctctagatggacagaactaataggatagatcgatatatataaagaggagttaaaagggagtttgttaaggagtattgacgcacacaatcccaaggtgaggtccgacaataggctgtctacaagctgaggagcaaggaagccagtctgagtcccaaagctgaagaacctggagtctaatgtttgagagcaggaagcatccagcgcaggagaaagatggaggctgagaggctaagccagtttagtcttttcacattcttctgcctgcttttattctgacagctgattagatggtgcccacgcagatagagggtgggtccgcctttcccagtccactgactcaaatgttaatctcctctggcaacaccctcacagacacattcaggaacaatactttgcatctttcaatccaatcaagttgacacttaatattaactatcacatatatgtaatggatgtttatgcatgccgatggcgtgccaggcaggtggcaccctgctgctcaggtggaaggcagtgcctggacactggcaccaggcagacccagatttgaatcctggctccatcaatccattcattcattcatttattcaacaaataccttttgggtgccatctctgttctgagcactgtgctggttgcaaaaccagctgtggggccccaggctggcagcccacttccccagtgtaaggagggcacagctctagacagatcttggtgaatgacaaacaccacctctcccttcacggaactcacagcccacttgcctgtcattccccacaccctcataaggtaaatcagagttttccatgtaggaatctgctcaaaaagagcatttcttcaatgtgattctagttctcttccacacagcttctctggcttacacccgtaccctgttttgtccagcatgtggctagagaggaggtacatttcagtcacttaaactttgtgtctttaattggtcttggaaacatatacagtactgatctgagatgacccctgtgtcagggatgatttaaatgaccccaagatggccgggtgctgtggcttatccctgtaatttcagcactttgggaggctgaggcgggcagatcacctgaggtcaggagttgaagaccagcctggccaacgtggcaaaaccccatctctattaaaaaatacaaaaattagccgggcgtagtggtgggcgcctgtaatcctagctactcgggaggctgaggcaggagaatcgcttgaacccgggaggcggaggttgcaatgagccaaggttgtgccactgtacttcagtctgggcaacagagctgtgtctcaaaaagaaaaaagaagtgaccccaagacggattctgtccagttactgcttgaagatttgccaaaaatagcctcacaaggccagatcacttgagtaaaatgtttctcaaaacatctgccaacattgaagacttttccaaatgtcatgatggcaattattgattgataaggtgacatgtctcatccactttgtccatcctggcttatgcctgtcatccaagtgaaatcattagtagcaccctctcccactctgaagcttgagtgataaattataattataggtcctctattcacttagcacttacaatcaattatacttacaatcaattataggtctcctatttacttagcacttaccacttgtgccagatattttaggtacatcatctctttgaatccttcttacagccttctaagatatatactattatttccccatttcatagatgaaggagacttcttcaccctttataaaaataataagcactgtggaatcccggggtaactggatatccgactctggggttctcgaagtcctgggaccagaaggttcttccaaggctgtgcctttcatctcttcagtgagaaattcgtgctgagaagggtgacgaaatttcctcaagggtgctcaatagatactagcaaaactcaaaagcaggtctttttttcttgcagcctgctggttttactctgcccacttaattctccaacgaataatgttctcccctttcccagcgccatccaaaagaacccggagcatacaaaccgggggacttcgggagtccaagccagctggaacccggtaatattgccagggaaggctgtccccaggccgcaggtagggagaagcagtctccagcttgtggaggggccggagagctttgcaccgagggcctgtccaatgctgttcaaagaccagcggtcgccgccggggggcagtaacttcatgtgtgtgctgcagtggagcttgctggttgacttacactttatttcaggcatcaaaggcaaagtgcactttcagaagggagaagtcatgccttgtgctgcagagaagctattattataaagataagtgtgtaattgaacctttcaagtggagagacacccctctccctccagcagaaactgtgcaggtgagaaagccgcttcctgagtggacctattccctgctgctgggagatgctgcccgctttgtttagaatacaaataggggaacgtgctcacctgaaggggagacttttgaaaggaatgaccctcctcctgaagatgactgaaattatcagcattattatgaaaagaatatgaaatatgaaaatatcagcataaagaaatacagagagagaactcagatgaaaacattttatttcagagataatgggaattttctgagctggcttcaggtattaggttactcagtagattaagaaggaaaagcttttgctggtaggcaggtcacccggatgattccagaattaccaccactctagtcaagtagtgacagtgttctgggctggagtcacgattctggggaatttgtacagcttccctcacatgcatcccaacctgtagatctcaggtggtctggtccgcaatcagtaaaactgctgtgcagcccctcaaaacagaccacccttcagaaaaattcactgtgttacagttcatgaactgcctggaaacacctgcaggtgtttggaaagtgattcagggttcatttgtattggtatctctttctagaatagctaaattcaagatgtatctttcaaactagacacagggtgaaatggggtgcgggtatagagcttgttggttgtgggggtgacttcctgcatttagtgaaaggggtggttatgcagaggcagcacagagcattctgtgttgcatttgtggcttggaatgaagtggacccagctggctgccttcggggctgtgcctgagattctgagcatcttcagctttgtgtctgtaaagaggtctagatggtggcttactaggatgctgtgagaattgcatgtagcatggtaacgtttgtgatcgtatcaaggacaggagatactcagaaaatatttatttagtctttatgaaggatcttgttttaatgtcaatgaatatgttgttaccagttttatattaggtcaatgtttaattttttgcttatttttctgtgcatctattttctttaggtgcaggttttgttgctgcttattaatcttagtaattttcatggctcagctgagagtgcagtgagtgtgaaggtgtctatacctacacatgtgatcactgttatctctgaatcctgaatgtggacagcattcaccttcttttttttttttttttttttgagacagagtctcactctgttgcccaggctggagtgcagtggcacgatctcggctcactgcaagctccgcctcccaggttcacgccattctcctgcctcagcctcccaagtagctgggactacaggcgcccaccaccacgcctggctaattttttgtatttttagtagagatggggtttcaccgtgttagccaagatgatctcgatctcctgacctcgtgatccgcccaccttggcctcccaaagtgctgggattacaggtgtgagccaccgtgcccagcctagcattcaccttctttatagatggacacccaccttagtttagagttgttcttgttaaactacatcaatgtacagcagtaaggagggttggtctggattcaaatcccagttctgccagtaaccagctgtgtgaccttgggcaagtaacttaacttctctgcacttaggtctcctggtttatcaagtgggattataaaagctcctacctcctggggttgtgttgtgaggatgaaaagacataatacaaatagagggcttacaataatatcaggctcatagtaagtatttagtatgagttagcaattttattaaaatgcagaaattacagtgtctacattgcttgcagctgcttaacctgttcctgggacagtgcctgccacatagtaggcacttaataaatatttgtgtatcagtggaagtaaaacatcatcatgaacaagaaaatattgttaagtccattaaataataagctttattttcccatgagtaacttaggcactttcagaagctgtgtgcattttttcaggccagggggtcctgcagcttaaaaattttgcagtggtgtgtgcctgcatgcatgtgtgtttgtgaacacacgtgcatgtgtgtatgaaatgaacagatttagatactgaatattcagaataccgcagcaccatatatgctatgccagcagactggcatggcttattaacacttataaatgcttagaaaaacctgtattaatttcactatagtatgttgagactttgctaaaaggatgttttaatgtgaaatgagctttgctacaaagttgcaaacaacttaagactctaaacacttttttgaaaataaatctcaacataatgaatatgaaagcctcatgaactataaagcataaaaatcattattattgaagaaagaaatcctaggcttcttagcacaacttaaaataaaaatattgcaattgagaaataaatgctaatgcttggtggtgaggtttttctcctgtctcctcgcctcctttcctttccctccctctctcctgatcttccccttcccctcctttctcccttctctctctggttcctagaatgccttttagaggaaaaacagaccttttcagaaatacattgtcatctgctaaatctccacctactgcaccagccagcctcagcaccctgctaggaggtggctggtcattctttgccgtatcttaccttaagagagcaaaatcaacttgtgatggttcctatctctgaatgctgccctggtttccattagaatatgctggggaagatgacctttcttaatgaaagtaggcagcaccctgctgtgcttttaattaaatgaactaacctttaaaaacgcgattcttagccctgcagcagcatgccacccagcagtctgtccccagtgatggttctgtgagccacctgtgtcatagggaggtaccaggggactgaagattggagtgaggggctttagcatagcgtgatctggactcttggttgttggggccagttctcgtgctttaggttcagggtaacttatcccttatctacccttctagccagagaacacaacacagccattacaagctgacttaagcaaaaagttacccaccagttgcaataggtctacacctattggtcatgctgcccatgaggctatttaatggcactggggagaaatgcatgaagagcatgactcatagtaagtaccgtttgctgatagtaggcaccaactatagattgtcacattcgttagatgatttttttatgaccaactatcactttgttaattacgcctcaaatcacagaggcgtaattaactatcaaagtaatagttggtatcccatcttctctcaacccttctttagggatagcctctgttgagtgtatgtataccctttcacacacatgtataaacatatgtggtgtgtttggaaagataaatacacttaaataggtaccatctgcatgtttacattacgtagtattagattgcatactatattttgctacttggctttttaacatgttgtggatatcttgtcagtagactcaatgtatttcttttttctgaaacagtctcactctgtcgcccaggctggagtgcagtggcgtgatctcggctcactgcaacctccacctcccgggttcaaatgattctcctgcctcagcctcctgagcaactgggattacagccacctgccaccacacccagctaatttaatgcacttcttttgatgactccctgatgattcatgattagaacataacacaactcaaccagctattcctattgattgtcatttaggttgttgccaggtttttttccctattataaataatgttgcaaatagcattctttgtttccttatgtaaatgtatttgtaagatacattgctagaagtggaatttctgagccaggaggtatggttactttacgttttaatagatactgtcagtttgctctgcaaactgtttatactgatgtattacccccagcatcgcatgagttcctctctgcccacattctcaccagtactggggattagaaatcattttgaatcattgccaggatctctgatagacgtaaaatagtatcatcttgtttgaatttgcttttccttaattaggaacaaagctgacccttccatatgcttattagtcagttgttgctttttttcctctataaactgattgtgtatatcttgcgctacttttctggtgagtttatcgtctgtacttaggaatatgtaagttatttgcttattaaggaaattagtaccttactgcacatattacagatattttctccagtttgccatttgattttatggtgtttttactccatagaattttgtattatttttatttgtagttcagatgcagaaattttgccttcctttctcctgaggttgtttcatacctaggccaagatgtataggagtaggttttcttctagaacttgtacatttttgttgttgatgtttgcttttaattcactggacattctggtatgaggagtgagttagatttctggttttctcgtttgcatgttacctgtgggatgttccaatgttgtttgctaagcagtgctctttctttgaagatttgaaataccacctaaatgatcaaatatgctcttctatcaggattcttctcttgatctttttgttcatttctaagccagtttcatactactgttttcatgactgtgatcttacattttagcgtgatttaacaattaatacagtgaattgtcctattctttttttccagtatttgttttcctggctagtatcatttgctgcttcttctttgggaactctagaagtatactgttactttcaaactgtcctctactcccttacaagaatgaaaacgaaaatggaacatccaaacctgttaatattttgagtgagattgctttgggtttatagttacttagggagagttgacgtctttacatcctaggttcctgtggtgttattctacttatgtaagccatcttttctctactcagtacagggtggaagttttctttatatagaccctatctatttctttaatttgtatttatgttttagattcttcaatatgaacatttttatgtaaatttaagaaattatttaaaaatgggatttttaaattacacttatttttacctctatatagagaagattattgtttctgtgtattaattttgtaaccaaccacctgtgctaaagcctttgactatttctaatagttgattcttttgcattttctaggtataaaatcgtatcacctgcaaataatgatgatttttccatcttgtttataatacttcaaattgtatttcaacattatagaggcagcagatgggtattctcatcttatggaaacacgctagtctttcaccactgaccatagcttgggtgtggcaatatggtattttatctcaccttcaggtatcttgatgactttccctgttacagacctagttaccccaacagacacatctagctttctttcattacttttacataggctccaagctgacacacaattcttctttaaagaagcagcttcccgaacgttctgtgagccacatctccatctgcacactctcgatgctgccctgtggaggactccctagggtggtgggagtgtcctgtatccgcactgtccactgcagtaaccactggccacttgtggccactgagtgcttgaaatgtggtggacatgactgaggaactgaacttttaatttttttcattttaattaattttcatttaaattgtcatgttattgagcacttaaaatgtagctagtactaccgaggagtgtttacttttgctaattttcattgacatagccccatgtggctggtagctgcagaactgggctgcacgggttcctcgctcattcatggaagggtaagatatgaatgctagaaaggccctggtggccactcattgtgcccagagatgctgagattgggcccacatcacacagcaagttcatgacgaaactgagactgggagcccaggattcttactctctgtctcaagctggtgtcactgtccaaccccttctttactcctcccctcccatttcccttctgtaagttatcaccgaagtcccagtgtgtgcagaccaacgcacagcacagtgagcaggcccgagcctcgcagacaccttccctagtgtgggtccagccaagggctgtgcagttgttgagttttcagccgagctccttcactccacagtgcaaaggttctcgcaagataaaggcagggaggcaaagtcctcggccctttgtcgaggtggaaagcaccctgaggtactgtgttggtgttccaacatcatcaggaaatgcccatcccggttcgaatgtattttccagtgcttctaaaagaagactttctgcatcttctgcatggcagcgggggttgctcctgtccctgagacggctctaaaccttacgagaacccagcctgccgtggtcagggagtggagagaatatagaaagcagagccttcgagaaggccctcagctgaggctccagtgggcaaggaggctttctcggtcatgcaggagccacagccctgcttgcacttcgagttttttctactttagccaactctttctctctttccccagtgagggggttccctgcatcagtccctgggcccctgtgggtctcctcagccttccctcccagtcgttcattcaaaagaagcaggagggaaccacgctacagagactctcggctttttctggagggcaggaaggcctccgcttatactggaggtcacctgttggagcttagaggttaagaaggccgggcacttgagcttcttcctggcactgctgctccctggtagcatggacatgggtgcttcagtttgcccacttgtaggatggggctcataatagccacctcacagggctccggggatggggacgtgagtccacagacagaaagtgccgagagtccactctccacagatgtcagcactgatccacactaagatgtcttctctacctgcttcaagggcaggtgacctccaggaagggccccctctgctcctcggccagaatccttgaggcaggcttatctggggagcttggcctgcatctgcgtagatggactgtgtgggggacccccagactccccttttcacacgtatgtcccacccctgccggggggtggtcagcttgtctgacaccacaggtccccagctccttgaggcagcctgtccggcctgcccagtggcccccatcagagccatccaggcagcgtgtgagtgggtgttgggagcagtgcccttccagtggccggcgaaggcagtgtgcatgcctgaatctgctgccagttgagaagtcagctcctcaggtgggacaaggaccctggccttcctgggaacctgagcagattgcgcagtttccttttctcagcacggctcctgcactggcttacgtaacagcaacaacctgcagagcctgggctccggggctcattcccagacagtgaagtctatgatgaatagatgggtctgtacactcttagcagagagccagtaatttgctcaaaggtcaaacttagcttgattcagaacacaaaattactaggattctattctttctgcgggtgttgcttctgtatttttcatggtcaaggaaaagctgtgaagcactttcttagggcttaagagctaagggatttttcctccttttttgatgaccctcttttccagcatctcagcacacccccagatgggaagaggctatgatgaatttctcccaccatttatgccacacccactctgtgcccagttactagagcaagtggtttccaggtgtgtgtgtaaggaaatgctcttagtgcatttgttctgtgtcaggcactgttttccatagtgtttgtccagtgccaggtgctgctgtaagtatggcactgcctagaagtgtgaatgcatttcatcctcacataaaccctgtgaagcagatactatgactgtccccattttatggatggagtcactgaggcatctggaggtgaagtaacttgcccatgttgcacagctaagttggaggagggggcaaggtttgaacccaggccatcttattccagagttagcattcttaaccactacccatgctgcctgtccaccctggtcccccatttcgtttgccacccaggatccctgtgaggtatgcgcttgttacgattccattttacagtgaagacacggaggcctggcgagtttgtatgggggccagtgcctgcttgggattccgatgcaacacctgcaggtctgactcctaacactgatctctgctgtgcacctggcccattggtcattgttatttctgagcacctggactgtgccttattcagtgctcctcacattacgactgtcaaatgcaagtaactgacttaggggcctgagggtcccctaaatgggtaccttgccacccttcgttttgttgttgttgttgttcttgttttgagatggagtctccctctgttgccaggctggagtgcagtggcgcgatcttggctcaatgcaacctccgcctcctgggttcaagcgattctcctgtcccaacctctggagtaactgggagtacaggcatgtgctaccacacccagctaatgcttgtatttttagtagaggtggggtttcaccatgttggccaggatggtctcaatctcttgaccccgtgatccacccacttcggcctcccagagtgctgggattacaggcatgagccaccgcgcccggcccacccttcttttgtgaaacattctcatttttttcagctatgtccctgactacagattattacatatttccatgtgcttgtttactggttctgtttcctcctgtgaattgactgttcatatcctttgcccattcagctctcagattgtttattttacgcagatctgctttctaactcaagggtcacgacaggaactcctctaatataatccatcatcatgtaacatttttgtcccctttctgttttgcaacaactctgaaaataatgacttgcctatactgctaaataagagggtaagaatccatgccccacgcctccagccccagaataaaaaacaagtggaaactaacgatttttttcttacacgtattatagaatttctaagtctgtctggagcagtgggcacccaggcatagaccacttctttagactgagcacctgctctttgagggcagggactgtacctggttccattttccagatatttttccacttgtttatttcctaaacctttttcctactccggaaaccatgcatatcctttccccatgcatcagctggcccagcagccacagcctcagcccgacctcccaacaccttgaggtccagcttctcagtctctggcaggctggcacgtctgctatcagcaggcacaggtgttccgagccaggctgccccatgcccccttctgtgactaagagacaggccaagtgggtccatgcataagagctcttcagtaaatgcaaaaggtggcaggtgtgctagccttatttggcatcgtttcataatgttgtgaaagggtggcacttctgcctgtgtcatataagccaagtctttttcataaagatgtaatgatttgataattggtaatgatgtattgagaaggttggaggaggatgagccttgcatatggtgagaacagttgtgcctattctagcagctccaggcactctgtaacctgtggttgggtgagggctagtagtattatgttgaaacacatgaaattgccaatacttgaacatttttgatgaaaagtattggtgcttcactatagtgttcccctctgtgatcaggtttttcctgtaagactattttataatgagcttctccataactaaagcaagattgggaacatcataaaagatcctagtctatataaactcagggtcaaatgttattgtaatctagatgagaaggatttaactcatgtcagagcaaaggcaggcaaatagtaatttttaatactgcactgcattgacacataaccactgtcctcatgggtcttctgtactgaagccctcatgggtacccagagtccagctccccatcctctttccttcagttcccacatgcgcttagaagaaccagcactgtggtcctttaccatgtcctcctggtgctccaattaagtaaagccattgaggttttcctgtagttgtagattgatatctctgagttaatcacgagagaacatagacatcatataggaaaatctggccagaaacaagacagcctcagccaagaaatgttttttcttggaatcggaaaacacaagaaacagatgattgggttctgttcacgtttgaggggaacgtaaatcatcatgggtttattcataaatgattatcctcttatagactggagtcccggcgtagagtaaaggcaggcatgtagacggctccgggaagggggcctcagggaaggaggtcagggatttgtgagggtaaaaactgcccatgatattactttgccatctaatcctagtgctgggaaaatgggactttgctcccctctgcttgaactgtaatcacctcctgaccagtgtttatgttcagaagaacagcagcccagccctgatccttggggtttatcgaagctttttttagcccagtcagtcagaagacagtgccaaaagggtgtgggcgtgtggcggacgccattatcagggactcatgagagctgtgctgttccaggagtgtgtctgagcccagcatggcattgcacgcagaccagggcagagggtggccttgatgccaggtgcccaggtgggctgtgaggctgagcgctgcccgttcctttccagaatggaaattcagacactggagtgcacttgcgtagttttctcaggttttctggctccccatcatttttctttcgtctgtctaagcccaagcacagggagttttgataagacagatctgaaatgctggcagggtgcaagggaggggaacgcttctttatttcatttggtggcacctttccccccagctttcttaaggcatgactgacaaattgaactgcatgtatttgaggtgtgcatgtgatctgcagtggtggataccaagaaatgactgccacagtcaagttggggaacacgtcttgatggcactttttagagctgaaatcccggtcatgttgtagtttgctatgtgaccacctacattctaatttgggtggggcagggagaattggtgcatcgagatgatggccaggttccctggacctgtgtaaaataatggacatttacgtattagcgcaacatatggatccaccatgcgagaatctcagagtcctttatctagataaatttaatcatcgaattagaacccagtggcagtttaagagacttaatgtgagctctatttagtcttaaaatagttgcactcaaagctcagctttaattttcctccactttattctgatcctccagggtttctcatgtcccacaggatagaaggtgtccctagcgtggctggttggacccttcccatctgccaccgtgctgtttgaatacatcgtgttcccccccagggcccatgcttgccttctcctggagcagttttcacccagaaagccatggctcaccttggttaggtcttggctcctcactttgcaggaaactgtccctggctacctgaccccatcccctgctcttctgtcctcagcctactttgtttttttctctgtgcccctcccttatgtccagagggcacactgtgttgtactgattacagattgtccatcttttcctatcagaatgtggacagcatgtgggcaggggtttcattttgttcacggctacattatcagctcctagaactgtgcctggtatatagtaggtgcataaatacgtatttagcataagctgggcagtgttcagggagtgaggactggatcggggatctgtcttgattccatgccctccacgaggaaaataatttttgtgtgtcctgtcaggtttcttcttcagaacactacagaggcctcgctgtgcacggatcataagggcttttattccataagcaaacccttcttaggacctcccagatgaagacataaaatattgctgtgccccaggatttctagaccatccaaatcaagtattcagagcactccaatatacagctataattctgtagataaacttaatatttcaactatgacatagctgtgtgtatccatgagattccacgcttctcagatataggaagcctgtcttctagtcctcttgtaatctcatcctgaagccctgcactcaggggccatcaaggatctgacagatcagcctttctcagtccctggccccagcagggggaaatgctgtgtaaaaaaagcacagcatcctggaatgtcagacccagtaagggcaccaggtgctgagcaggtgctgggatgggaggaggatgaaaaaatatatgtcaggataatgtggagaaaacactcacttcaggagatgcagtgtagaaaggaaattcaggacagtttttttgcctgtaggtctccagttcttattaccttctagatcagagtaataaagttagtatcctatgaggtgtgctcattatatattcatttatgtattcatttgttcattcaacaaatatttattgaattgttctggcaatgtacctggacccaggggaaaacaaagcaatatctttgctctcgtggagtgcacattttcatgggagagacagatactatttttttagtttattagattgcgattgctgctggaattaagcacatgggggctgtggtaaacaataatgggaggtgctgatgggccctggagggccgctctgaggatatgatttttaaactcagctcagaagggggtggtctggacctctctggtaaggtccaggcagaggaaatggttggcacaagggcctctggcagacagactgtggtgtgctaacacaggaagccagtgtgaacagaaggtaatgatcaaagggaaatgggtattgaagaatattcagtagtcttctgcatcaatcagggttctccagggaaacagaaccaataggatagacatagcggtagatgtgtatatagatatataaagaaatttatcatgaggatgtggcttacataattatggaggctgagaagtcccacagtctgccatctgcaggctggagacttgagactggctagtccaaaggcctgagaaccacggcagctggtggtataaatcccagcccgagggtgggagaagatgagatgagctgtcccagctcaggcaggcgggcaggaaaagggggcagactccccccttttgttctcctgccttttgttctcttcaggcccccagcagattagatgatgcccacccacattgggaagggcagtctaccttgtagagtccaccaattcaaatgctgatctcatccagaaacacccgcacaggtacttccagagataatgctcagtctgcacacaccggggccagtttgacacacgcaattaaccaccacatcttctgaactgctctaaatcttctcttattttttcaacgatcatgtccttttccaggaaaattagcatcctttacctatatctccttcttaaaactttaattaccaatcctgtaaagatagtagtaagatcagagtttaaaaagccttccagttttagcactttgctatccacaaagctttttcacaactgaagcctaatgaaaagcagtgggagaccccatttaatggatctacaattaaatatgttcttcttgatcctttgtatgatccaaagtatgaatacaatctttattatgctttgatttttttctttactaaacttttaaaaattgtggtaaaatgcacataacttaaaatttaccatctttacatgtacagttcagaggtattaaatattaaatatattcacattgttgtgtagcacatctccagaacacttttcatcttgtacaactgaaactctgtatccgtcaaacatcaactccccattttctcttccctcagcccctggcaaccaccattctactttctgtgtctatgaatttgactactttaggtttctaagtatttgttttttcatgactggcttacctcacttagcataatgtcctgaaggttcatctatattgtacatgtttcaaaatttccttcctttttaaggttgaataatattctactgtatggatggactacattttgtttattcattttcccattgatctacactggggttgctgccatcttggctattttgaaggatgctgctgtggacatgattgagcatatctcgtcaggaccctgctttcaattcttttagatacatacacagaggtggaattgctggatcatgtggtaattctattttcaattttttgaggagctgccattccgttctgcacagtggctacaccattttacattttcatcaatagtgcacaacagttctgatttctctacctccttgccaactcttgttattttctgtttttgatactagccatcctaatggctatgaggtataatcaataaaaagctatacttttctaattgaagtataacatacatacagaaaaatacacaaatcaaaaccttgctgaaattttacaaaataaacacacccatatcaggtcaagaaatagaacaatgccagcacacctggaagcatccttcatgtccctccccagctattactcaccagtcaccaccatggcccaccaagttacccaccatgctgacctccatcaccatagaggagttttgcttgtctggaactttatataagtggaagcatgtttttcatcatttgtgtcttgtttcttttgttcaacattatgtttatgaaatgcttattgactacagcgttctccagagaaatagaaccaataggatgtatatgtatatagggaaaagtttgttttaagaaattggctcatacaattatagtgactggcaagtccaaaatctccagggtgggttgacaggctggagacccaggaatgaactgatgttacagttcaagtgtaaaggatttctgctgcagattccttctttcttggggtaggctagtctttttgttccgttaaggcctttaactgattggatgagctccctgccaatatactttactcagagttcactaatctaaatgttaatcgcatctcaaaacacctgcacagaaacatccagaataatgtttgtccatatatctggtatctgggcaccatggcccagccaagttcacacataaaattaaccattatacatgtcatagtagttcacttttattgttgtttctattctgtggtgtgaatatatcacatttccatttgacttttccagttgggagtattatgataatgctgcagtaacaatctcctacatgtattttaacatatatatattcacttttccttggttatagtacagtattcttttttatgactctggctttgttttactattattttcattttgtaattttatgtttatgttcatgaaagatataggctgatcacttttcttttttataatatttttctcaggtttcaggatcaaggttatgctaaaagcataaaataagtagaaagggcccctccttttgtttcctgtattgaagagttgatgtaggattcatattatttcttaagtgtttgggagatttcactgataaagatatctgggtgtagagttttcttttgagaatgtttttaattaaatattcagttttataaatagatatagaaccaattgattttctcttctgtcatttttgtaagttgtatttttctaggaagtagtccattttacttaaaatcttaaatatattggcataatatttatataggctttctaatatctgtaggacctgtagttatgtttcctttttcaatcctggtagtgacaatttgtgctcttttcttcatcagtcctgtcagaggtttattaaatgtattaatattttgaaaagtcaacatttgacttaatttctgtttttttgttttctgtttcagtgttttccactttttttcttctacttttttttttatttttttaaacggagtttcactcttgttgctcaggctggagtgcaatggtgcgatctcaactcactgcaacctctgtctcctgggttcaagcaattctcctgcctcagcctcccaagtagcttggaatacaggagcctgccaccatgcctggctaattttttgtatttttagtagagacagggtttcgccatgttggccaggctggtcatgaactcctgatcttaagtgatccacccatctcggcctcccaaagtgctggggttacaggtgtgagccactgcgcctgtccttttctccttctactttctttaatctcttgttctgttttcttgctttttaagatcaatatgtaaatcattaatttttagtcttcttatcccatatattcacataagactagaaatttacctctaagtatggcttttgctgcatcttacaagttttgatatgtcatatccttattattttccaattcaggatattttctgatttccagtataatttcttcattgatctgtagattgtttagaaatgtatcactttgttcataaacatttggggttttttttttaatgttattgattcctagagtaattccattatgtgatcagaaaacactctcagtcctttgacattttttcagacttgctttgtagctcaacagtaagtcggttttgataagtgtttcatgtgcacttgaaaaaatatgccttcttaacaacaacatatatagatgcagtcatgtaacaacaacgtatatagacagttgggttaagtttgttattcgtattgtttatgtcatctatggccttactgaatttcgtctattcttatcagtggctgagagaagtgtgttaaaatttcccaccatgatttggatttgctgatttctcctttttgtcctgctagcttttccttcatatagatttgaggctatattattggatatatacagatttaggattgttgtatcagcctggcaaattgacccttttttattattaaatgtccatcttttttgctagtaatgcttcttgtcttaaagtctattttgcatgatgtgccagctcttgtttggttagtatttttatagcacatttttccatccttctatttcctgtcatcttactgtttgttttctgtttgttctacttgttctatattccttttctttcttatcttcctttgaattatgttttttttttttttttttttttgagatggagtctcgctctgtcacccaggctggagtgcagtggcacaatctcggctcactgcaagctccgcctcctgggttcacaccattctcctgcctcagcctcccgagtagctgggactacaggtgcccgccaccatgcccggctaattttttgtgtttttagtggagacgggatttcaccgtgttagccaggatggtcttgatctcctgaccttgtgatccgcccacctcggcctccgaaagtgctgggattacaggtgtgagccactgcgcctggcctgaattatgtatttttaaaaattgtttcattttccccctctactaacttgcctgttagacattactgttcttttagtggttattctagatattacaaaatgcatccttgacttattttattaaggtctaatatgaatttaaaattaaagctgatatcttagcatgtgctgcttctgtagctaatgacattagcattattctaagaatgcttataaatgtgtttcttttttgtataacaaaatggcccttaaaggcctcttagagctgttaatgttataaataatcaccaaagtaagtgattattaccttaaatacattaaaagagtgaagttgaaatcttaatctttagaaattattcaacttttttgaaattctgttactaattctcctaaaaaaattttgttttaaacaagaatgatttataaattatttttcataataaactacactgtttgtggaaactgaacattgcccttggagcaggcagaagtaatatccattaaatgcatagcaaaacatgaccctcagataatttttgttttcagtttctaatgccacagatttacatgaagcgattaaggacgggtggttagtgtatatttaattttgttatttggattcaggatgctcttatgaatcctctggtgaaagtcagaaagcagaattatgggtacaggttgattttcaaaaagactttgtcaccaggcaagcaggtacacgcttctgcaatggtttgaggaaggtattatcttttcagtttttacctcctttggactgacgtcctctgtgtcctttgtagttttccccctggctgtccctaattacaccatctcatctagcaatttgatgaaaacctcaataggtgttactatcaacaggattatatttcacagtggaatgtaattttccactgcagtcagtgatggaagaagagtggtcagtaagagaaaaccttttttgcaagagggatgtatttgaggatttattcacaagaacgaactatcattatgaagttttatttttgcaaggtacaattttttttttaaccatggtgacatctgttttcttagatgtggtagaaacattcaaaaagagaaatactctggtgttggaaggcttatttttcatcatcattttgctttgaagttgtttggtgaatgcattctgaatgagacagtttggctatttctagcacaattgagtttctgatttccctttggattcttaatatcttttgagggccagggagggatattaatagagattacttgaaataagctgtgagatttttctgcgtctagaatacaggcaacaaattgttgcacgatgacagcagcaggctgtgattgttccaggctgtccttggccagtcctatcttcaggaatccaagtaggagcaggaacaaccattcccttattccattcaggaggaggctcaaagaaaagttgttccaagttaattgggagtaaacagaaactcatagttagactttatgattataatcaataacaaatatgtgtgtatgtgtgtgtaataataaattgtgtgtgtgtgtatgtgtgtgtgtgtgatataggagggtgtagttttttcagtggtcagccttcaggtctctgcagtggctgatatggtcatggggtctctaacttgtggttaactttgtcaactcatagcaattcaaagcaaaattgaggctatctctatcagtgtgctagggcagctctaacataataccacagattgggggcttaaacgacagaccttttttctctcacagttctggaggctggaagtccgagatcatggtgccggcagctttggctcctcctgaggcctctctccttggcttgtagacggctgccttctccctgtgtcctcacatggtcttccctctgtgcacgcacatgcctagtgtccctttatgtgtccacattctctcctcttacaaagacaccgatcagattagattggggccccaccctcatgacctcattttaacttaattgcctctttaaaggccctatctccagctgaggtgggtggatcacctgaggccaggcgtttgagaccagcctgaccaacatggtgaaaccctgtctctactaaaaatacaaaattagccaggcatggtggcacctaactgtaatcccagctacttgggaggctgaggaaggagaatcgctgaacccaggaggcagaggttgcagtgagctgagattgcaccactgcactctagcctgggcgacaagagtgaaactgtctcaaaaaaaaaaaaaaaaaaaggccctatcgccaactgtgtagtccagttctacggtactgatggttagggcttcaacacataaacttgtggggagtgaaggacatgaacatagttcagtccataatgctgttagagccagctgagctctctcagttatattcagagtgtctgcaggaatttattagccaacactgttgttcctaaaacaaccagcaagaggctctctctctctctctgacactctttagaatggcatcagcctccatctccacaccgcacagccaacccagcagccagtcctgggtgcctcttcagatgatgttctgggctcctctgctttttaccctccctctctcacccctgtctaaaccagtgtcctcccctgcctgtgttatcgcggaagcctccccattcttgcttccctcttgtcactctggagctctgcctctcaatggagcagccagtggtgttttgaaaacatgaatcaaacctggccactctcttgctctgagtcctctgagcacatttagcgcgggctccagatgcttgcctgggcatgtgaggacgtggcccgctctgccctctccagattcagctcctcctcgcgtctccaataccacagctgggctactctggccttgctgctactgctcccatgtgccaagtgtggtcccttcctcaaagcctggaattcccggaaggttcttcccccagatacccacatggcttactccctcactcctcccaggtcgctgcccagatgctccttcctcagaaatgtcttcccgagcccctagctaagcgagcgcaccattccccccaccccagaccatctgtcctcaaagtgtcttcatagcactggtcactccccaacatcagggtatataattgcctgttgtctgtgtttgctagaacgtcagcttcacgaaggcttttgtctcatttaccactaggtgcccagtaccttaggagcttggaagttcttagtacctaagaatagcacttgcttcatgaatatgtattaaattgataaatgacattctgtggctcaagtgagtccgtggtgtcaaaggttatgctgggcagactgcctttggtaatgagcatagacccctctttaggtccaaagcaacccccgggagaaacttgcatcttcccctacctcgtgcccagaatacaccttgccttggatgatgagttgagaagctacccacaagggtagatgactcgtctggcttgaaagagatcggccctgttggcattttgatagcaaatttagagttgggaggtcactaacaaggctagtccccaattctgcgacctaaatggagaggcagttgctttgcaagagtactgtagagcccgtgggagacacgcttctcagcctgccttttggtccacatgtaggccagccacttcctgggctgcctttttttcaaagatttttttcatgaataacggtattaaaactttcatgcaaagtgccctgatagtgtgtaatatttttagggcctgtaggcaatggaggctttacatttttagtgattttttttcctcatatacactggcattgaccctgggaatgatggctgtttttcttttaggcttgcttgactgccataaccagagacgtggagcaggggatttattctgtttcctcctcctccttcttcttcctcttattcctcatctttgatttgagggggcttttcaggtatgagggcagaggggcatgaataatacttcctcagactgaaagggtctttgggggcaacagcaattcatttttcagctctctgagatactcattttgttttgtttttgaatactccttaacttgtagtcttcctttctctacccagtctgagaactgcctaagcagaggcagtttggaccctacaaacagcgtcttgatttggctgggatgttggaatagggattggaccctagaaacagcatcttgatttggttgggacgttggaatagggatctttccattctaagaccttaaaaaaaaaagttattagagaagtgaaaacattttagttatttagactttccagtctagaaggcattttcagtggttttccctgtagagactaaggcatctctgagacaacggtgggtccatctccacaaggacttagaactcccgactcgtgacttctgggtggttctcctagtgcttgtctaaagaacatttttgagcttttggcctaaaactctcttcttccttctcacccctccttttccatagacctcccctgtgttgcctgcctgcctgtgctttgccttgatttacagcatccatgtgcatacgtaggtgcacgagacagccaggtgctagaaagtttgcaaggccaggagggatatcacagggtcctggatttgggtcccttcttcgtgcaagcaccagccagacacttgacctctctaggaaggattccttcatctatagagtggggcggagatcatggtgagccatgcacaaaggtgaggaactgtagagaaagcatccgggagccaagtcagcccttcacaggtgtctgtctgtgcaggcagtcaccacacccatctctccacccagcttcagctccaaggagcctgcctggcctgcttttgcaaacactgtctccagctgcttcgggttgcagcatctcattcctgaaacccggaggacgtgactggataatagccgggcaagtgagctgtggtgatattttaacacaggcctgatctgatcattcctcactcattcaaccctaggcaagcctggattcatactttccatggccacccgtgccagccagtttccatatcagccagggcctcaggaaggtggaaggacacactgtcattctttccatttgcgctgaccctgcctactatcaggcctgaatgccagcaggtttagctaaagaaagttgcaactgctgaccaggctgtgcaggccggcctctgtctctagcatacccgggggtagataagatggttcctgatgctctaaagctgggcttgacttcccaggaaagtaaatcaaacagggcctcttccattctcactgggaatccttggttgggctcttttttattttgaaccattgaaatatttgtgcagacacggtgggtctgaaagtaatgcactgtgacactttcccctctgttctctgacaccgggtgttagtgggagaatcagacggatagtaatttccctgtggattctcagcagccctaggagataggttagcagtggttatttctattttacagagtggaaaggcaattttaaagaaaaaaatattcttctgctcaaggtcacaactgcaaaccagtggcctggctcatggctctggacctgccaacctgtcgctctcctcttctgaggactgggttgtggctggtactgtgtttcagttttagaaaatgtaatttgaaggaaatgggagactggggtctattttgagactctcgaataattcattttactctattttctataaagcctaagagtgattcattagcaagcataagtaatgtctgagtgatgcaactgtactaggttaggttttgggacctggttgttgaattggtcatgaacatttgtcacatacatgcattgagtcatacattgctagagatggaaggcagcttagtaatcatttagtccagtgggtcccaaatctagctgtttatcagaatcacctatagagcttattaaaaattcagatgccctggtgctacccaaggcctggggtcaaagatctggaccctttatctttaacattgcatttttggggggtgggactctcgctgtgtcacccaggctggagtgcagtggcgcaatctcagctcactgcagcctctgcctaccaggcccaagtgatcttctcaccccagcctccagcctcccaagtagctgggactacaggcatgcaccaccgtacctggctaattttttgtatttttggtagaaactaggttttgccatgttgcccaggttggtctcatactcctgagctcaagtgatctgcccacctcagcctcccaaggtgctaggattacaggcatgagccaccgcgcccggccataacatcgcatttttaacaactcttccaagcagttcctaaacaactggcctaaaaacctttgagggaccccacatttgagaatcactggatgcaagtccttttttttgttggcttgtttttgtttgtctgtttgttgtatgtgttgttattcaggtgaggaaccaggggcccaaagggtagatgaccttgcctggagtcacacaaatctgtcactgttggagtcgggatgggaaacccagctacgctcttcccaggcatggtgtgaccacagcccaaccgagtggccaggaggacccactctgttgggcgctgtatttagagcaaccgagaccacttctggtaacacttggtaacatgccctgcactcttggaaaggcactcttgtcagggcgggtgtcttagagaacccacaaagttcaggagattcttccagagcccttagcaaagggccatctgcaaagcctctcttcctccctgggcaggtccattcccccagggcccagagtggggccaccaagaccagagcagacaccaggaattgaccctggtctggaactagtctgtctgttctgatctgccgccctgtgacaatcacctgcctgggaaccctgctcacagatgaccaggcccagtggagagatgataagaataggtagtttgttctgatgcagattcctaggggatctggctgatgctggctgatggctgcttacagcaggagacctcaagtttctcaatctaatgttcttagttctgcatcaaacagatgggtttattttctggatcctgtctattcacggaactcatttaatatggagggcgttatgatgtcctgcctcatctgctactcaagctatatatttgcaggtgaggggagaagaatcataaggtaagctctcagagatacgagggtcaaggagaatataagatcttacattccctaacgcacctcttgctcttttgtgtttttgcatgtggccttcatgctggttgtcctctggactgtgtgaccttggtgccctcagtttcctcatcttattggtccctgtacttctaatagtcagtgggctgacagtccacacccctctgcagggctccagacctggctgtctgactttccagcaggctgtcccctcggtcatgccgcagacttttcacactgtgtccgaagctgagccttgatctgttcctgaacttgctgcccctcttttgtcctctcccatccactccactgtttgtgctagaaagtggggagatattgttggcaccttccctctcactcctacatattagccaaaggttttatagatttcacacctaagcagtgatgtttcagcctgcttccactctcccgtgctcaggataactgccttggttcagtcactttcatgtaacactcctgcctggagtacgcagcagctcctacctggtattctgattcctctccggcactcttcagtggccctctagtgctccctgagtgatcttttgtttgtttgtttgtttgtttttgagacagggtctggctctgtcactcaggctggaatgcagtggcatgatcacagctcactgtagcctctaccacctggactcaagtgatcctcccacctcagcctcccaagtagctgggactacaggcgcacaccaccatgcctgaccaatttttgtatttttttgtagagacagggtttcaccatgttgcccaggctgatctcaaactcctgggctcaaaggatccacccacctccacctctcaaagtgctgggattataggcacgtgccaccatgactggcccaagcgatttttctaaaaacctatgtatgtcatcatctcactatcctgtttctagatactcttcagtacttatctgttgttcataaggtaatgttcaaaatccttactttgtgaataaggcctctcatttggaccctgttgtgtctcagctcttgcttctccctcactcagctcattagtgcagtggtgctcaactacctgaggttcccaggacacagggcaccgtaggatggaaactgcagttgcctccgcctgggatgccccagacctcttctccatggagctgacccctgccggccttctgatggccttttctcagtagagggtgactctgttcccaactaatctctgatgttctggaatgaagaaacaattttagtattgccagctcctagcacagtcattgccatgttatatgtgatcaatacatgtttgatgagtgaatgaatgagttagcagctcctttagaaaccaagtcctataattgaaccaaagacaaagtattatccattagctatctttggattttcttccacctgcttgtttgtgttataatattgatgtgattagcatagatttcttgctgagcggtgattagagtctcagtaaactccatccagtttaaactttgaaacattcacagacattgaccaaaatgttcagacttctccagtgctagtacattgttttcaacctcctgtgacttatttcttctaaagactacttgctggctgatttgcgttttatttttaatattcatcattcttcctgtgtgcacacaagacaatcaaagactgatttaaagtaaagggaaaaataccatcaagcctggaacgtgtcacagccacccaccccacacttgggtttgtgtccgagttggacagtgtccctggggctctttttctcttgtcctgggttcctctggaagctgtccagatccctgccgttggaggggccccaactcttattgccagaaaagaacagctcgggtagaggacacagcctccagagaggggtggtgcaggtacgaacctgcagagctctgtgacttgtttattgcacttatctgacaaaggtaatgcaaaaccctgtgcttttattgggaaatagaaggaggaacttgttggacaattatggaatcagagaatgatgtcactgggtggttccttagggatcatctaaggtaaactacattgttgagctgttgggtatgaataaaaattttccacaagctttcctgcatttcttcccctccagtcaccatattatagggcacagcagttttggagaattccacaggaccctggctcactcagagttaaggatcccatgcagtgtgatggaaggaacccagactctagtgctagacagacctaagttgggcctgtccaaattctttgagtttatttcctcatttgtaaaataatgcctacctcagggctgtcctgaggattaaatgacaccttttggggtcactagtggtcccttaacacaccgctgtctcgtctcttcttctgaggttcagctacaggagctcattttgcacgtgtcgttgctgttaatggaactgcgcttaggaagtccagtcaccaatcttcctatgttaaatgccttttgaaaaacactttcacctggcacggtggcacacacctgtaaccccagttgcttgggaggctgaggtgggcagattgtttgagcccgggaggttgaggctgcagtgagccatgatcgtaacactgcactccaacctgggtgacagagtgagagcttgtctctaaaaatatacatctaaatgaaataaaaaacactttaactttgcataagcttctttctcacccctagtcatcaattctccgggctgtaggtttgacctcctttcagtgggctcgccttgagaataagaccgtctcagccatagtgcttggcatacgctagaagctcagtaagtaggagaggcaagagggaaggaggaagagaaggaggaaaggagggaagtgggaaatgctgctactagcaaatgagcatagccgctccagatggggagaaggtgaactgtgtttgtgctcccatggagccctgtgatgcacactgtgcaggctcggatcctgaagaaaggccaggtagctgtgcagacagaggctcctgaccacatcctctgagaaaccccaggaccagatgtggtagagagtgacccacgggtgctgttcgcaaacatttgatgtagatgaactagttttagcagatgccctcacattttgcagttgtgagtttcctcccatttcttcttgattcccatctgcccgtgcagttctgcctccatcagccatgcgttgacatttaggtgattaacacttgatgccgtaaccattgtccatgttttattcataatttgacgctaaaacctgaaaagttgtcagtacggtttatgctaatacagctataaaaatgttcttcgatgccagctaagcagctggtgaggattacgttccttctgagtaggtctagcttctgacgcgggaggcacccgaggagaacgtgctcagccgcggaagcagacagacactccgtgtttacactcaaacaactgctgaaaatcatttcatgtcacgttttacttcatatttggatctgactttcttgaatggcatttttatttttcttagagtttgtattatctttttttgacgcattgtgtgctttatcagatcctcaagttcttgtatcttctcagttatgacaaacattctattattcacgtttcctattctggactggcttttcccaggacctgaggctgatctaccttctgggggctcttcttcgctctgtccctaagttgggtctagtgcatcctaaatctcatgtctttctcctttatggtttatgccatcattttgctggactacatttatattttctcccctagaaaagagaatgaaaagtcagttgtctgatttcttgaaaatatacgtagtatctcaccctcacgcttgattgatagcttatctgcaggtagacttctccagtggacattgtttctcagaacttctaggaaagctcattggcttatagtgtccaatttagctgatgcaaagactgatgtcagtccaacttccactcccttgcaaatgactgattttttgtctctcttgaaacatccttctttgtcttggatattctgaaatgctttgtggatgtgtcttcacatgggtctgtattcatagtaggcttcatttggtgagtcccttccattggaaaattcatcttctttagaacctgaggatttttgtagcgttccttaagctctgccctttgatttctgttctttctgggcctcctagtaatgctgggcctcctaaataggaactctgtatgtcttatattttcctcctttatatgttttcatgacacgtataattttgacggttttctaattagaaaagcaatgtatattgtaacagcgacaacaaaaattacaagtaggcatgattataaaatgaagcaaggccttggaggaggcaggaagatgcagaattgagggaacaaaagatggcattatctttgggaggaagaggaatgctccttattgacataccagagaaaggaccaagaaagagtccagatgcaggaacatgttgtagcacacaggggagcagtgaactcgagtcacttggccttgctagttttataaagtggaagttgaggtcacctacttagactgaagacttggggtcataagaaggtgtgaaacatgtacagaggaaaaaagtggtgactggcagtttgacccagagccttgaagacctatctgcatttgtagtgggaccagttggcctggttttgtaatgttcgattattggaacctatgagcaggagcagggttgaaatttggcaaggcaagcatggtaacaggacattgatgagggaactcagtgaaggcaaaatatttccatcagtgatggttaatacaaaagattagctaaataatcctttttccatgtttgtgacttagtctgtctgtgtctccctgccccattcaccattaccatgccaaaatgtgtcccaagaagaaccgagaaaaaaaggatgttgggaacttttggtcccagaatggtctctgctaaaaatctatccatttacatcaagtcagttttcaaaaagcatcctttgatcactgttgtaaaaccaacatttcacccaagagaataatttcatcttgcatgcagaatttttagctgacatttgcttggatctaggaggagagtccagataagccaaggatatggtttggctctgtgtccccatccaaatctcatgttgaattgtaatccccagtgttgggcctggtgggaggtgactggatcatgggggtagattccccccttgctattcttgtgataatgagttcttttgagatctggttgtttaagagtgtatagcatctcccctttcactgtctctctcctgctgtcatgtgaagacatgcttgcttctcttttgcccttctgccatgattatacatttcctgagacctttccagccatgcttcctgtacagcctgtggaaccgtgagtccattcaacctcttttcttcataaattacccagtcttgggtagttctttgtagcagtgtgagaccggactaatacagccaaattcaccctttttcatggactttagaatgttgagactggaagaaaccttagagatggtcaagctcagtggttttgaaacagtttcattttattttgttgttgttgttctgaatgtcagatctttataagtgaattctttcactgaactccaacacataaaacagcaaagtggagcagcccctcatgaagtaggggtccaccctggggccccctgattagctcctagtcaccccctgtgccacctccaccagccccaggatgtcccttattttacagttaatggaactgagccagaaagagggcacatggtgtcggagctacaggcgcctccagtattctgtgatcttctgcctgccactggagaagcagtgggtccgggacccaaaaggcatgtggatgagtccagccctcggacaacctagtcctcattgggcagagggagccatctcctggaatttttaattcgaggactttttaccttgacctcttgcgaaatccctgggccatagtgggttaactgtttgtattctggtcccactgattttctgtgtttgcttcagagaaggtgaaggtgaattctgcagattttccatcctaccgtctttggaacaactgggtactgtgtctccttaatgataaaagggagctcttcttgaaataggatgatcattttccacagtttcttggtaaaccaattacactagtggtgattaaattaggtctttgataggcatgcaagtaaaagcatttgttgtaatttacaacaataagtaaattgtctaaatggttttaatatcattaaaaatttttatctggcaggcacagtggctcacacctgtaatcccagcactttgggaggccgaggcgagagggttgcttgagcccaggagttcgagaccagcctgagcaacatgctgaaaccccatattcacaaaaaattagccaggcatggtggcacacacctgtagtcccagctactcaggaggctgaggtgggaggatcacccgagcctgggaagtaacactacagtgagccatgtttgtaccactgcaccccagctggggcaacagagtgagaccctgtctcaaaaaaaattttatctgtattctgtgtacagttctaatttaaaacaaactgattgacactgttagggaaatttgctctctttaattaaaaatacattaatattttaacacaatacttctgttgaagaggtagatacaagtttaaattttgtaaaatgtatttaattgattttaagtggtaactttttttcaggataattttgcaagtatgtcagaaaactaaataatgtgacaaatttaaacatgttacatttattttatttatgtatttatttatttttggagatggagtttcgctcttgttgcccaggctggagtgcaatggtacgatctcggctcaccacaacctccgcctcccgggttcaagtgattctcctgcctcagcctctcgagtagctgggattataggcatgcatcaccatgcccggctaattttgtatttttagtagagatgaggtttctccatgttggtcaggctggtctcgaactcccgacttcaggtgatctgcctgcctcggcctcccaaagtgctgggattacagggttgagccaccacacctggccacatgtttcatttgtttataaaggaactcccctctaagaacagatcctttttactcttcttcatcatggttaatttttgtgaatttttgttaaagtttgcaacttgcttgagtcaatgattggggaaagaattttttaaaaaatatattttatcctaagtcatgtaaatttctataaaaaaaggatattctagcactgtgctaaaagcagtttgtagctcttttaaattgtatttggagcaagttcacttgagaaaattagatgtggattctggtcacattctatttttggtttatcgtagtgttactgggttgattgtgcacttcatgtatcatattttggttttgagtgttccaaaaaaaaaaaaaaaagagtccactatcatcacaagacagagatgtatcagcagaaaaaagtgttctagatgaaggcaaaaagagttttgagccactcagcatggatatgtggaaaacatgctccacgtgtttcagtggtagaccactaattcaagacgtcagtcatgctgctttataatcttaactcatattgcctaagaggttgtcatttacatcctgttcttaggatgttttttccatatttaccagacctcttacaccactggtaagtaacgaaagctatatgcagaagcaaatcactctagtctttttgagaatccttgtgcttaaaaagctccttctttcttttttcttaattattattcccttacttgtctagttctcttattttctccagatcatattttacctataacagtttttaacctctacatctttagaaaggaaaggccctttttcactatctagaattttctagactggatggtttttaaaaaaaatctctacagttactacacttattgaacactgcatttatatagggatttagggtccttcagctaccccagggagcttgggcctgggccctcccgtctgtccttcaactttagtctgtagttgggctgtgccaccagcttccagaagaagccatgggcaggcccaccactaccttcacctcccttcctccagcccctttgcctctaccaaaccccacccgaagccccttgagtggatcttgtgagccctgtggtctctgcattcaaagactggatccgggaaggaattaatcagtgtccctgggcaaagtcttgaattctttattgtttgagattatgacatgagattatttcctcatctgtaaaatgtaaataacacctacctcagagccaagataagaaatttaagatgatatatataaacacctagcacagttgctggcacacaggatgtgcttaaattgtgagtcgctttttccttccttttccttccttttctctccagttgttcctcccctgtatcccatcaggcactccatcctgaaagctctgccacagtgatttctccaccttagcctctggcagtgactccagggtaggcaggtggaggaaggacaggccctgcctttctgtctgagctcatagatgctatcataagtgggtttctaatctaggatatggtaacacataaaacatcaccatggaagaaaggtgcgtttgttagtatttgtattaaattattttgagataaaagaaaaaagctcttatttgaggcccagtcttttaggatttatggtgattcctatatagcaattcttccaacttcaaaaataagctatagtctaaaaaaattctctctctgcacttgctgtttagtgctggaaggcattttccacagagacaatactgtattctcaagcccacagaaacctatgcaacctatagtgtgactaaataatactgctcagaggctactctaaaatttacacactaagtgatatggtttggctctttgtccccactcaaatctcctattgaattgtactcccataattcccacatgttgtgggagggacctggtgggagatcatttgaatcctgggggcggtgtcccccatgcttttctcatggtagtgaataagtctcacaagatctgatgggtttatcagaggtttcacttttgtttcttcctcattttcctttgccgccgccatgtaagaagcaccttttgtctctcaccatgattctgaggcctccccagccatgtggaactgtaagtccaattaaacttctttttcttcccagtcttgggtatatctttatcagcaacgtgaaaacagactaatacactaagaaagatcttgcagaaaggaagacattgaagaaaaaagggatgaaatgaaatcagacttgaaatggctctgggccttctcagagctactggaaagcaggcccaagtgcacgctgcctgctggttctgccccagcaattcatgagtatgattcctcagagaagcaaggctcctttcttcttaaagacctccttcacgtatgattagcatgcaattcctccagtggatgtaaggagagccctctaagagctcattctgctgtaaacacagggaaccaaggtggcacaaacacaccgtgactccgggcatcgctgccatctcgccaacaaacacactttctagactcaaagttacaagctcacttcattgtgaagttggaaaaccaaattctcaaagttaactgaaaagttaaaaaaacatttgaggtcaagctcttgccagctcatctaattatatatagcaaggtcctgtgttggatttgtgggaggcaggggggagatttgcatcaaaggtagagcacttttagttcctttttctaacatgagcacaaaaaagtgtctagatttcaaggctgaattccgattgtaggggctgatgaggtcagtggaagtggccccaggcagctgcagtgctgaatgaagcagaggtcagctttcaatgtgcacttcgggcttccttctaaagggaccatggcatgctatgaaagctggggcagaggtcccaagcaggaggctcacatcctggtggaagctgtcttaagagtattgccatacagatccgccaacaccctcactgctcccagagccgagccccttctgtgcgcttagctatcagatggaatttggtccttactttgacattgaccaaccaaatgcagaaggaacatagggaaatatctatttcactccagttatcttctgtccatgtagcagaatgaactctggaagataagtggcaaaagcaagcctcgtggctccaaccccattttcctcttatgttgcgatttccttgcatcaacagcagcgacaagtgggaaattccagtggcgcccgtgctgctagggacttcttaggtgtaggtagaaccttggcaccttcccagtcagtaactagaccgaagttctgaatttgaaaatagatttcagattagcatgagtggtgaaatattttttttctaacagaagtatgcctcttagagcttgtgttctcaactttcgaagtattcaggagtttctttcttttttttttttttttgagatggagtctcactctgtcttccaggctggggtgcagtggcttgatctcggctcactgcaacctccgcctcctgggttcaagcaattctcctgcccctttcccttaggccagaaatatttccacttctgctgcagtgttgtgtagtacattccagagtctcccgagtagctgggactacaggcatgtgccccccacgctcggctaattttttgtatttttaatagagatagggtttcaccatgttagcctggatggtctcgattctcctgacctcctgatcctcccgccttggcctcccaaagtgctgggattacaggcgtgagccaccgcgcccagcctcgggggtttctttttagtggaaattacttgtacctttcttactttgaagcattttgtttgtgtctacacaaattttgaaattttacatagaaccacagcaggatttagggggtggggaggtgggaggcaaagcagtaccattgatcaagtttgttagtttaaagctggtgtagtttggatgtttgtcccctccaaatgtcatgttcaaatgtgatccccagtgttgcagggaggcctggtgggagatgtttgggtcaagggggtagatccctcatgaacggctgggtgctgttcttgcagtagtgagttgagttcttactctatgagttcacagaagagctggttggttaaaggagcctggcacctcctcctctctcgctctttctcttgccatgtgacacgcctgctcccccttcaccttccaccatgagtagaagcttcctgaggccacaccagaagccgagcagagctggtgcgtgcttgtacagcctgcagaaccatgagctaagtaaacctcttttctttatacattacacagtctcaggtattccctgagagcaacacagcagggaccaacacaaaaaccatcaggtcagagaacagtgaagtgagtttgcttggtgtgcttctgacccctcctctgcccctttttttcaggtaaggcctgggtcttcaggtgaggcctggtcccactctccattctttgtccattccagtgagggactccagggagctgagaatcctaaatttgaatgtggccttccaggtcactgtgaccacatttgttttcaaggaaggaaaatggaacatattttatttacagtttgttgccatgaagtgtaactttcagccatgtggactcagggaatgttagtggccatttgttcaggaagggtaacctgccacagaccctagtcctggaatattgagtgggtctggggttcgcacagaatttggagaccctggattaggagaagactctgggagtcatttgcccagaagcaatccactctggggctggactgcccagccacatgccacatggttgcccggcctctacctactcgcaggaaaaggcagcttcctctgtccctagacagcccatttcatctttatgcagctctgaaatagtgcccctttcccttaggccagaaatatctccacttctgctgtactgttgtgtagtacattccagagacgtagcaggttcagcaggtgacggaaagtgttcctgcgtgaacgtagtctccagccccgacacctggtagatggttcacacgaacacacacacattggggagcaaaacccaggtgtgagctccgcccttgcagagcttcaggcaaatgtgtatacatggtcgctggggaagagatactgtgaagtgtattatatcacaaggtataccagctctttgtgctagttatgtaagccacacattttgccgagcacacatagaaggaggctcattgaattcacctaatactgcattttaaaatgacaaaaaatgaatgtgttggtcaggaaagagttctggggctatgtagtggcaccatttcttgtgtaggccatgttttcccatctgttgaacagtttgttcaatacatatacacacacactcatataagtggttattaaagaagcatcttcctcagttatggctgtactcctgtgtaatacagctgtttcagctgcagcgccctcaccttcccaaccagcgtgtcagtggagcagtagcccccatttgagggcacgggataggataggtgacattgccacagagtgtgagctggagcaggctgccctctgtgcactgccaagccctgaaagcccagcaggaatgtgatgtctttagttagcacttctcaaactatctaccagggaaacctggtttttgtttaaatttccaacctgttgccaacggataaacataatatgataaaagtgaattactagaagaatgaagtggaacaaaaagagacatggaatacaagccttagctttttcttttctttttcagacaaggtctcactctgttgcccaggctagattgcagtgacaccatcacggctcacttgttgactttgacttcctgggctcaagcaatcttccccagtagctgggcacaggtgcatgccaccatgcctgactggttttgtttgtttgtttgtttaattttggtagagatggggtctcacttgttgcccaggctggtctttaactcctgggcccaagcaatcctactgtcttggcctcccgaagcactgggattccaggtgtgagccaccacacccggtcagctttttcttattagttccaacagtcatacaagttttctgataaatttaaaggttttaaaggctaattctctttttctggttttccctcatgacatgttggcccctccccactgatcacatattgggtagcactatcttagatgacaagcagaggtcaagcccaggattttaaaatataaatatgtatatttatagttatgaggcttttataaacttcatagaaaaataattaatgaatattgtatccaacttacattacttcagctttactttaaattttttccagtgatcacaacccacatttcatgtggttgtgactctccgctgtgttgctattccactcttattcactggcctggccctccttgctaccctggctgtctgtccctgcctccctgttctctcctttccccagtctcctttcacatcaggctctgggcggcccagggcagtcttcccccaaatcgcagcctggctgcattccttccttctggcagtctcacagttcttatgggacagtgtccgggttcctccaccaatggatctggcccctgcctgcctctccagcttcatttcttattcatttcctgccctgtgatccccccgcctgatatggtttgctgtgtccccacccgaaatctcatcttgaattgtaatccccataatgcccacatgtcaagggtggggaccaggtggaggtggtcagatcgtggggacggtttcccccatgctgttcttgtgatagtgagtctcctgagatctgatggttttataaagtgtctggcatttcccctgctggcactcattctctcttctttcaccctgtgaagggtgccttccaccatgattgtaaggttcctgaggcctccccagccatgcggaactgtgagttgattaaacctcttcctttataaactacccaatgtcgggtagttctttttttcttttttgggacagagtctcactctgtcgcccacgctagagtgcagtggcactatctcggctcactgcaacctccgcctccctagttcaagtgattcttcagcctcagcctcctgagtagctgtgattataggcacctgccaccatgcctgcctctctctctctctctctctctctctatatatatatatatatatatatatttttttttttttttttggtatttttagtagagatgggtttcaccatgttggccaggctggtctggaactcctgacatcaagtgatccacctgcctcagcctcccaaagtgctgggattacagacatgagccaccgtgcctggccattgggcagttctctatagcagtgtgagaatggactaatacactgccctaccccatggacttcagccatgctaagttcaatgcagttctggaagccttttcatgcttccctgcccttggtgctgataaaccagcactctgctgagtgaacggtagctgtttcttcatttccccacatgttttttctgtcataaacagcagacttaaacatctttatacaacttatcttttttaatgtaggaataatttccccaaatggaattaccaactctcaagactacggaccctttataaatatgattgcattttgtcaaatggttttccagaaaggttggattacttttcagtgtccacatcaataaaccctaaattttaactcaaaaatattctgtcagattggccccaagttgagttttatgctagattttactgtgtattctcaggtttctggtggctaaagtgagagaactggctttctgctttagatgttagttctaacaagttggggtctttgtctccccatgttcctttaccctgaaaacagcggacaccacaatcaatactgatggcaatggtgtgcgtgtggaggtaaggggaagttaaaaggtttgtttatggaagagtccctgttctgtgtgtcaaacaaaggtggaaatgaagaggaacaaaataggcaacttaataagataagctgatggcgtgctggtggcagcaggttgccatggatgcaacatgaataggatctctgattatcgtagataagaatatcctactgtgcgttattataatatcactgggtaccatgagcattttacacctatctcattgaatcttcatcaccactgcacaagctaggtaccatgttattattattgtattttatggatgagaaaactaaagtacatggagatcaaataacttaccaaaggtggcgagggctgagcgaatctgggatttgatcctgggtagcccagagccctgataccaccgttgacaatggagaatttaacttttgcatttgcctgagttgatgtgaaagtgtccttttgaaagtattctagactttcaaagtctaggataagtttcaggtgagtgagagcaccttgggaagagggactgaggtggcaccacccatgtcgcctctgctctcccacatcactccttggggaccctctgtgcatgctccccttgcccacagcatttgtcacctggctttattcatatgccaccatggaaatacgctttcctgggaatgcctggcacatggtaggcatctaatcagtgatgaccaaatggagcagaatattcggggaagtcatggaatatagagtgtttgattttccaggagcgtaagaatgtaccaaaagatgtcactgcagagtaaatcggtgctccatgaagtctttattgacttctggccaaaacgtagccttaagaaattgcccctgaaggaaatggagcaagatgattgttttatatgccttcataatggaattcatggagcattcagtcagattttcttgaagtgcttgttcagtatgacctcacagaaagtatggggcagatctgggagtgccccactctggttaatgcagtcacatggaaggaaatgtaattgagtgtggcaccagtgcactgcagtgataaatgaccagggattttctgggtagtctccgaatgagaagggataggatctcgagccttttaaggaaccaaatccctcaatcctgtgtgcctatagaaaattgcagtgggcaggagcagcccagcgtgctccagctgtcctcagctgtgggaccaccgtggccctgaacgtcgggccaatattgacggaatattcttgagttaaaattcaggtcttgagttagaattcagtatcaaaagcattgacactgtgcatggattcatgtttagcttctctttttttcataaacagtttactgaggtagctaacttctttataaaattatccagaaagaggtcaacactttccagaaagtgctagttcttgcagttctgctttcaagtatttcagaccagccaagcaaaactagctccagcatttttaactcttggagaaagatttcactatttcaaatgtatttttgtttaggtagagagcattagaataatatctaaaataagttggatattgtaggtgaatcacagttcctgacatcaaaaatagtcaaaccatagcttacaaatacacttttgggatcattttcccttgtactaaaaataaagttttaaagtaaccacttgcccaaaaaaaagtttctcctgctggagaaagttgcatagcttgggaacttttatcccgtatttactctgatcatgatgtcaacacagcactagtttgtgaattagtccattctcatgctgctataaagaactaccctagagagggtaatttataaaggaaagaggtttaattgactcacagtctgcattgctggggaggcctcaggaaacttacaatcatggaggaaggcaaaggagaagcaggcaaccttcttcacagggcggcaggatggagtgagtgcaagcaggggaaatgataggcacttataaaatcatcggatcccctgaaactcactcattatcaccagaacaggatgagggaaaccacccccatgatccaattacctccacctggtcccacccttgacatgtggggattatcgagattacaattcatggtgagatttgggtggggacacagagccaaatcacatcagtttgtaagagtatagtcagaatggctttatagtcagaatggccttactggacattgctctcttttgtttctttatttgaccactaattttccatttagcttcccccaggctcttactgtacttcctgcacaaatgtatcattcttctgatgtctttgtgaaatcatgtcaatatttccaatttttcacacatgattttctttttgtcatcacttcaaccaaattttcttctggtgctaattattaagtattaaaattattaaagaattgagaaatggtttccgttataaagccctgtcttcatcatttagaactttacaacaatcctcttttgtaaagttttccaggaaatggatgtcccacaaaaatcaacaatcttaaaataagtatcagtatgggcactattgtttgcctctgttctttctccttgatttttattcttattctttgttacttctttgttctaagcgtaaaagatggaaaaatgataaagtaagatcctgctttcaaattcttagggaagtctaggttgctttgcttatgtggagcagttcacagaaggaactttagaattagccacctgtccgaagcttttagcccctcccagtgtggacttctttccctgggactttcatgggctgcctgcatctatcctagaatgtgcctgtaccggcaaccccgtcagactaaaccaggcttgttacagtcatgatttgtgcatcctcttttgctcgcttaggcaaattctggatttgtgttagagtggtcagaaatgccaagaacctgacttcttagattaaaagacaaaattgttggggggagaaaggttttttaatggtctgaacattttctcagttcagagcctgagatctgcatgagctcaccattgctctcgttaagtaatgttcactggctcaccgtggaaacttgaaggcatgtcagtgtacctgaaccgtgcctttttcaggactaactcaaagaccttcaggaagaaatatttgggtacagccatccgggaccacagaatcacagggcaggaatgtgaatgttgatgctggcgattgtgagctgcctgaccttaggcaagtagtctcaattcaccaagcctcctttcttcaaaggtaaggatagttaacaccttccctatatcctctccaggttttagagaaacttgaaagagttaatacatgtgaaatgaccttgtaaactgcaaagtgtaggttgactgtgacagaattattatcagtcagaacctgcataataaactggaaaatgtgagctatgttccaaagaacatcaggaccctctgtgggacccagttccggatactttggctgactcaatccaccgaaacaaagggttatttcagagcatggcatttaaattgttaggcttattagaccattaccagcagggcatttgtataccttacaaatgagttctttatcttcttccttgcctacgaaagttaaagaagtgctgtggtggccgcctacgtaattggattcattgtggagctctacttgaagttgcactcatctgaactcattcttgaacatataagccactgcccagaacaaacagggctcttcttacagaaagactcctgcgctgtgaatcagtcacagattgtattaaacttcccaacactactcaatttgtcaggcaagttttgttttattttttccctaatcctggccttattccaaattttccaactattcctggaataagtagactacatccatccatctttgcattctctcaatttccagtggccctagtgggaatttcatgtagctagactgacagcaatttgtattttgttaaattatgattaattggaaacctgtttttagcatttaggtggaatgtttcttgtagtattccattagcatagatattaatacacttgagtgctaatacctctgccttgctttcccacactttgttcacttatataagctgaatgagattatccatgattgtgttctttccggtcacatccttttggattccctgaattccattggagcattggagcccagggagcctttaccgttgattttgcgacagacagggcgagatccaggagatgaaatgttctccccagtgcaactcagtttgttactggaaaagcgagagctagaaaccaggacttcagactcctagaaccagtgtccttttgaagatgccgtggttccttgaaaaaccagagtaaaactctacaattcaaaatctttaggaaatacgttaagttgtttgagatggccagattttctgtagagctgaagggtatatagcctcttggttgttagaaatgtgatgtttaaccatttgaggaatcagtgtctaaaatggacagtccaaccctgccttcttaaacaatgatgaacgttttcttcttgatcatttcctttcctgatgattcttagcctttcttgatcattccagctcatcagtcatctcaattctcagtcacggtggaggtggagttgggtgtcagcttaaacaggtctgaacctgaggcctgctttcctagaggaagtcctggcctggcaaacctttccatctctgactgtctcatggagttctttgtcagagtgttggtgcagggctcctgcaccgggtagcagggcaccccagctgcagagtggtttggtgatgggaacctgaaacagccttctccctcggagttcgagagggagaatctcttttatggaatagccaaatgtcttgtgaatggtcggcagcatgaaaagcattatccttttctatcagtaacgcacaagcacctcctcaacagcttgaacttgtcaacatagttcatcacaggcttgatggattattcttcactattttaagaatttgtgttaggctgggtacaatttcattgtcactttacctcaaattctgattccaggtcggacatccaagagaattaagcacaacatgtagccttagttcctcacctataaaaaagtgatagtacctgtctcctagagtggcttgagggttacatgagagagtgagtgttgactgcttacatccatacctgataggtgactggcagtcaatttcggatcgctgctatttctcatcatcttcatcatcgccatcttcatcactagtggctgttaaatctatcagcatcatctttttttgtgaaagatggccaccacctttctcatctttcaagtatgttaaatgagaaagttgtgttgatgtttactattttaaaaaattgtctcaaattttaaaaagccaccacgtgttacttgctaatgtaactgaatctgtcactcattttagcatcttccccaggcttggcaaaggcacactgtgatagttaaaggtgcctgctgggatctcagggtgttgggttggactgtctttctagccttccctttgactcattccccgacttgagcaatcacgtgacctgcaccagccttccatagatggaacagaaacatgtgggctgccacctgcacacctcagtggggcgttgtgggaattatgagttagtgtttctgacataggtggctggagtgagctatccaagtgtgaggtgtccatgtggcttatctagccgaatggacattacctttaccaggggctctggtgtggtcttcacagcttttttaaatttaatttaattttattttatttttcgaaacagagtctcactctgtcaccaaggctggagtgcagtggcgtgatctcggctcactgcaacctccgcctcccgggttcaagaaattctcctgcctcagcctcccgagtagctgagattacaggcgtgtaccaccatacccagctaatttttgtatttttagtagagatggggttttaccatgttggccaggctggtctcgaactcctgacctcaggtgatccgcctgcctcggcctcccaagtgttgggattacaggcgtcagccaccatgcccagccttttacagcttttaaaggaccataaatgtgtccccatattttcatcaggagtgcagtgaaagcacccttctcagcatggccctgcaacctcataggtaatgtgattgacgtcacaccactgggctcagtattcttctgttacattggaagaaacaaaaacttcaataatacttggtcttcacctgaacggtgcactgaaacgttctgtcatatttttttagccttttgaaaagtgttctaaatatttttgctactgactgtattacaatgattgcaaaaataaactatttccaagagagttctgttgtatatttttagtatcatcagagtatcagagacctcacttgaaaaatcattaaaaattaaattacatattttcaacttgtatgaattgtacattttattgtgaaagccatcttatgccacatccctttagaattagcatgggtagtgctgaccttattttaaacctattattattattattattattattattattttttgagacaaggtctcagtctgtcacccaggctggagtgcagtggcacgatctcagctcactgcagcctcgacctcctgggctcaagcgattctcctactttagcctcccaagtaactgggactagaggcgcacaccaccatgtccggctaatttttctattttttgtagagattgagtttctcaccatgttgctcaggctggtccgaaactcctgagctcaagctatcctcccgcctcagcctcccaaagtgctgagattacagacatgtaccacctcacctagcctcaagtctttactgctcttttttttttttttttggcctttaattatttatttatttatttatttatttatttattttttgaaatggagtctcgctctgttgcccaggttagagcgcagtggcacgatctcagctcactgcaagctctgcctcccgggttcacaccattctcctgcctcagcctcccgagtagctgagacgacaggcacccgccaccatgcccggctaattttttgtatttttcgtagagacagggtttcatcgtgttagccaggatagtctcaatctcctggacctcgtgatccacctgcctcggcctcccaaagtgctgggattacaggtttgagccacggtgcccggcctgccttttatttttttaaaaatacctttttattatggaggttgtcaagtgtatacaaaagcatggaagatattctaatgaactccctatattcagctcctcacccagcctcaacaatgatcagtacatggaatcctccttcccacacttcccaccatggagtaattttatttttttattattattattattttatttatttttttttttgagacacagccttgctctgtcgccaggctggagtgtagtggcacaaccacagctcactacagtgctgacctcctgggctcaagcaatcttcctgccttggcctcccacagtgctgaaattacagacatgagccaccctgccaatcatgggatcattttaaacatatcccaggcatcatatcatttcatttgtatgtatctctaagagataaggacacttaacaaaaataaagtaaatgtactttcttaatatcaccaaatatccattctgtgttcaaatgtccccgattggctcatgaatgtctttttataattagcgtgtttgcgttagaatccaaataagaggcactcactgcatttcagtgatctgtctcttctgtctcttttcatctggtttctccatcctttgtcataggtccccagtgaaactgttttcatatgtctcataggctgtcccacagtctggaaacagcaagtgcactgttagcactgtttagcacatctctgcattccctctgatatggtttggctctgagtccctactcaaatctcttcttgtagctcccataattcccacgtgttgtgggagggacccagtgggagataattgaatcatgggggcaggtctttcccatgctgttctcatgatagtaaataaggctcacaaaatctgatggttttaaaaatgggagtttccctgcacaagctctctttgcctgctgccatccatgtaagatgtgacttgctcctccttgccttccaccatgatagtgatgctttcccagttacatggaactgtgagtccattaaacctctttcttttgtaaattgcccagtgtcaggtatgtctttatcaacatcatgaaaacggactaatatacatctatttatctaaactcagaggcctgggagcttgctgaaaaatcagagttttttgtttttgttttgtttttatttggacaagactacttcacacgaaatatcctgtactgactattgctgtacaccaagacgcatgtgatcactgattgtctccttctgtgatgttaaaagcaccatccctggcttcaggtgtgttcagtctggcccagcttctgcaattcctgatccgcctctcacctggtggtttcagcagccagtgtttaccccagcctccagatgtatcagcagctctgtggtttcagcaccacactttcagcacctaatacagaattcactttgaaagaaagatttctaaaaatgacttgctagtaggtagttagaaatactgagtgattcttaataaaataatgatttcaaggtgaaagcgatggcataattcaaaatgtgtttacattttttccatagaaacacatacttgattactaactaggaaaataaaaagatttctgtctcaaagaaagaagatgagtatgagaagcaaccagtagagttatcttgtttactctcctcccgagagctctagctaaagattcgaatagtgcattgtttctgagatttttgtcttaatcataagtaattctaaagcatttatcttccttaaaatgccagcaaattgaggcaacttaaagtactccagttcctttaggtaataatgtaaaaaatcgctgattaaatattgaggagtccctttgagtaaggtgtaatgacatgccgtcttacagagccagggtgtagttgctgcttcttatcccctttgcatcctcattatgtttcttctcgatttcagacctctctttggtctgaaaagatttcgctttataggttatttgtttcatcacaagtagagctgactctggaatgaactcagtgcgttttgatcatgaacccagcactgtgctacaggcttgcttactggaatatacagtgtcctttagaatccagaaacagtggttcatcttaggaatgtatggccaaatgttgatttgggatttagagttaagatttttaaattgtacctaggtgtctgggttttatatattgttccactttttatgtggaataagcttcatcagaatcatttcaggaaatgagaaaagtaggatatggttatgaatcagccatggaaaactacggtatggaatgaattagtcagaaaaaaggtttcagtggccagcgtgagctgtgtgctatcaggaagtggcatgactttccatgattttatgtgctataaatcatgtggcatactgatccagacacctagagtctttttttttattattataatttttgaaataaaactgaaaagcaccaatgaagcaaaagcaccaaagccctttcagtagttgcttgctcgtccctactatcagctggaatggatctccacccccactgtgagctccgctggtgagggatcattcatctaaaagtccattgtggctgctgggtcaggtttgagaagcagttggcttccgcagagttgctgctacaaaaatgtggcatctgtctgtttcttttgtttgtaatactttttctcataccccttgtctggccgcttctagatctctgccatttatggtctagaaggtagttgcttctccctgtgttgtgctgtgtttagaaagatagtctgaaattcagaattaggcagttatgttccagtcttctatcatcctattaaagagaaaaagaaaaacttgcgcaaatggggtggattaaaagtttgggtcatgtgaagttcataaagctatatctccagagggaaatgctaaaaatatactcaaccactaaaattgcccatggagggaaataagtttattgctttattggtcatgtaagtcagttaaaatataatcaagtcagcctcctcactgtcttttattatcgatacatccatgaataggcattcaataatgacagcttggtatgtgtctatgtgtgcatgattggtttttttttttaataggcacatgtaatggaataattcagttaggaatggagtctgcatgtgagtggctacactactattgaatattgatgtcatttccattgattctgatgcctttggcaacctggtaaacattttctctggaaaaaatctcgtaaaccaggtttgccctgtttctctgccctgtttgccgtttgtggtaacctggcagggttcctatggagaattgttggtctggaagttaacccaacttaacatcgcatagtatcacttagcaatcacgtggtaaaaattggcatgttcttcctccccctctaccttagaccaatgcctcccagaccttactatgtacaggagtcacttcggatcttgttaaaatgaaaattctccttgagtagatctcaggtggggctctagattctgcgtttctggcaagctcacaggtgatgccactgttcttggacactatataccaaacaacatctgtagagttcaacaagaagccaaaccctaaagggtatcgtgcctctaacgctagtaatgcagagccagcccttctgtatccaagacctcaaacctctctacatcatataaacaccagccctccagcaggagtgaggaacaccctaggatggagaggaaccctgatagagacatcacgtgagtcctactggcctttccaccttgtatcttaaacttcacttgatcctctgagcacacagccatctgtcccaaattctgccaaagccttatcaagagctaataatgccttcctttctccattgactggacactttctgagcaaggaaggtggttagaactgttggtcatctaagtcttcccctgggacccatgatcgctattcctaagtcttcattctaagattttttttttacacagcccacttgtcttcatcctccaacattcagggagagttcagaaagtttagtgggataagaagggattttgacattagtggcaagggaaaaatgctggaagtccaatgaacaaaggtttgggagacttcagaattctttaagattgacttaaagaatcaaaaaagaatgttcactaggggaagtgtcccagtgtggaaacttcagcagctgtatttcagaatcaccaatcaccagaacatgggttttggactagctgaagaattgttgaaccagtgagagagctgccttctgcctcctcctgttttccctcaattgtcccagtaaaagtaggttaaatatttaattggttactttattaccatggaattttcaaataaaccagcaaatcaacatcattattttaaaattttaggaaatgtgattcagggtttgtcattattttttccaaggaagaaatgattatagatattttctgcaagggtaaatatctgtgacttttccagtttagaagccagccacagaccttcatacacaccatccaaaaaggaagagtgttcaggacataagattaaaaatagttactattggtatgcacccattctaatgttttcccttagcgtcacgggtgcctttaaaagcctttctactattttccttgggtcttcccagttttaaaaacaagagccccattccagatgattaccaaaatgtggcatttgaaaaggtgagtttaatcgttgtcatagaattccttgtctgactttatcaacatcattgagttatgtgcattgagttgtgcatatgtgaatgagttacttacagcttggtattagttgatagcaggatacagattctatcggctatatgataaagctctgcccactccattggatggatctaaaggtagtgggggcatgccttagtatgggggactgaagctacattcattacattcctgtctcatcattttctttcagaggcttttccttgagaacattaaagccaactgtagagacctataaggatgaaggtggtagtttgagatgggcatattttatattgttacatgctcttaagttggcagtggtgttagtctgcttgggctgccatgatgaatactacagactgggtggcttaaacaacagaaatgtgttgtttcacaatcctggaggctggaagtccaagatcaaggtgatggcagggctatttccctcagaggccttgctccttggctcatagatgacatgctatctctgtgtcctcacatggtcttttctctgtctggtgtccaaatctcctcttcttataatgacacccagcagattggattgggctcctccttaatggcctcaatttaacttagtcacccatttaaaggccctacctccaaatacagtcacattgtgaggtaccaggacggttaggactcaacatatgtatttttgggaggagttcatttcagccaaaacaaagttcacagaagccactttgaatttgcaaaactgtttctcaaatggagattacttcatggttcttccatttctttttgagaatagttttgtcttcatcttcattgggagatgacacatctgctgttttgtcgtggaagtaagaattgggacaataataacataattgtctaaatgatattttagggtatcaggtggttttgctctgtgagaaaacctctttagaaatacaacgagggtgtccacagataatagaatgggcctctgccactcaggagtcttggcagtgcttccattcttccatactccacctcatcattgatgtgccgccctgtcactgccaccaccagcaggcacatctcggggaaggagcaaggtgggcctcagaacttcacctgggtctgtgttcagtgcctcctggagtctgtctgggtggcatggtcatctctgggttctagtagctggcatggtcagtgcctgtaggtgttcggtggatggatggatggatggatgatggatggacaaacgaataaactgataatgttggcaaaccacttcccccttagctccgctcagaaatatttcagaacatcagccattgaggctgctgacctcctcctggtccccatcattgtcctccatcttggagacagctgctgtagatgccacagatagagttaaaccttgttttgcttgatgtatattaaaaacaaggcaaatattttgcttacctgttttagcctggactggagggtcaccagcaccactctggctgtgagagagtactacttttctaagtttccctccgtaatttttcattttgggatcctcggtattcaccacctcggcagccaccatgaatcatctggtagatgcattttcaaactcaaaagcagattagaacatcacctgaaccaccttcaggttagaaaatgaacgttgctataaaagaagtaaaaataataattatacaagggcataggttaagtctttgaaactgcctgcatggcagattttacatttttgaaccgaggctgccacagctgtggctagtggttgtctgaccctcttctttcacctggtgccttcgagggccactgagagcatgagtcagagcacaccaacacccaaacaaagcacacatgctcatggcgccttagtccctggccagagacacgcctgtctttcatcacgtgggatggagacagtgaagagcctgagcaacagaagactgatgaagagcttcaggcgtgagatgattgaacaccacctagcacctggcaaacggtctcatagtccctatcctgggtgttggaccacaacgaactgtttgctgaccgtgcaatttggcaaaatcatcaaacctacacaaaacaagaaacaagcgcacaaaataagtgcaaagaggaaaagtaggcatttttctctaattgctatatattctggcatagtcctttgctttgtttacaatagaacttagaagaaatacagttttatttagatggcactaagagaatttaagattcctttgccggcatattttgaactaaactttagtagatttactgacagatgtagaagttaatagcagctttttaaattatcatgaataatgttttcaattaaaataatatttcttatgttaagcaggatatcaatgttatcacaatacagttaaagacaaaggttttacaagtgctaaaatgggatgtaaggtatacctcagtgaaactgtttttaaaagttttatatttcaaaagtttcgacattgcagagaatttaaattctcagcagtactgccttaacttttttttattattatttttactcttttgaaaactctactttccagctttctcagtttgagaggacactgaagagcttttgcagaaatcagacatgtcattttattaggaaaactgatttgattattgatatgccaattataaaattcttagtcatccagcacatatctagccatgcaaaaaaaatttcatatgtaactttgaaagcaaaagtaatgaaaatcaatgtgaaattacattgattggctaaattcagttcttctcaaagagtagtaaaatgcagttgttaagaacataggatctataggctttggttcagaatcctggttccaaagctgagtggtggtaggtgtcttcatctgctcgggctgctataacaaaatgccctattctaggtgccttaaacaatagaaatttatttctcacagttctggatgttgagaagtctgaggttaggctgccagcatggttgattcctggtgagggctctcctcctggcttgtagactgtcaccttcttgcaaaaaggactctactcacctgacttcacctaaccctaattacctcctaaaggcctcacctccaaataccatgtcttagtccattttctgttgctataacataacaccacagactgggtaacttataaataaaagagatttatttggtttgcggttctggaagctgaaaagtctaagagcatggtgccagcatctggtgagggtcatcgcatggcagaaggcagaagctgaagcaagcacaggagacagggagaggacatggagccaaactcatcctttttatcaggagcccactcccaggataactaacccactcctgcaacaatggcatgaatccctttgtaagggctctgccctcgtggcctcctcaccttgtcaaggccctacctctcaacactgttaaaatggcaattaagtttctaacacataaacttttgggggacacattcaaaccatagcaccattgcactgggtgttaggacttcaacatgtgaattttaggggaacagaattcaatccattagcattggacaaagtacttaattgaggtcatttgcctggcctcttcatgacagcctttttctcttgggacgatgtttttcaaaattgtgtgtttcctggggtgcattcccatacatggcagtgagcaggtgagggagggggagaaaggtgaggggaagctgtgatgtggaaagagtagtagacctaggtaaaaacctggctgctgtgatgggcctggactcctggatatgccctattctcttggcatgtgggacagtccccgctcctgggctcaggctcctgtagcacctgggtgacgtggaacccgaacccttcgctgaatcctcagctactcaattttggcaggggtagtggctgcagctgagtaggagtttgtttgcgaccctttgtgttccaaagaaaacgccagccacagaatttactgtcttactcactggagaccttgcaaaagtgtgggccccaaactagggtttggggagagatttattcacgtaggtattatctggtctctgttacccagaaagtcatttttaataagtcatgcactcatgactaatcattttctccacttaaaaaaacttttttccaggtaggacataataatgggtcaagctacttatacttttcctgtttcccccttttaatgggaaaaacacgctctttttccatatctaaaatggaattgaatgcttcttgtaaaatgtacatctcagggaaaaacccattgctattctaaacctgcttcctcctattcttcagttcctggtacggtggatgttgtttgcgtcttctgacttctaccctctgagttggagactcataattattgttagtatgtgagcatgcagtgtctgtctttaaactgctaagacggtgttgcttttaagcgacagcgattgttttcttgttcatgtttgtgctgtcttctttgcgtcagctcctaaaatagaggggagttgtgtacctgttaacaacgtgttaacagcattgttggggtttttcagacaatttaattgtacaagtaaattattttaagttagagcctattcgtttgaaacaaagaaaatagtttttacatttctaaaaaaaaaaaaaaactaataagtaactgccaacaaatgctagactatatacctgtaaagtcagcattttaatgtcattttcttctagagccagagtttagtaagttcttggcctgctgggaagaaatgtaaggaagagagtgttgttaggtggggattttttaacacaaaaatataaacttgcctgacgtgatttctcgccattttctaagtcactgaaatgtttgttatctattttatttcagtaaatcactttcttttagcatccttcagatggtcaaacagcatgttgtatctctgagaaatctcatcttattaaagattgactgatgtccttcaacatttctatgagcgtttttcaacccacagagatccagttaagatacagacaaatatcaggatcttcttaggacctgtttgaaatgacatgtttcaaagcagctctgtattaaaagaggtcattcttttctgttgaacaagaaattaagtgaatgcatttggtgtgctggggctattcttcgaatgttagagcaacctgtttcattttagggcctggggtcattattctccatgggtggcaccgctatcctcccagtggcatttgaaaatccttgcgagactttgtggttgcagcaaggactgggggaaagctgctggcatttgtagggagaggggactgaccagcagggaggctaaacagtctagagtgcaaggggcagggccatgcaaggagaagctgtttcctccacaatgtcgttagtgtaactgctgagaaacagcgggagaagtcacaggctcagggaacacaaaggatctttgtgcctggcctggccagccccccacttcttcaaggaagcatactgggggtcacatctattttctcagtgtttccctttcacccatgccccacattgcagcatttttcatcagaaaccacaggagcccaaaatacacttcctcatttctgagatgcctttcttagtcagggctgaaattagttttcagtggacacccacactcaggcactgtactagcaaagccttttgttagaaactgtcacactggtgttcagattgtcctctgcccgagttttggaagggtgggtgacaagggccagcaaatagtcaacactgcccgttgtgcaatgctgtgatctccctctgagagcaagaagcaaacttgaggtgacactgaaacaaggggcgggggcactgagcctgctttcgtagctttgctttgcttttgcctcttggtttactttctatggggaacatatcccactaagaaggctggtccagcccgcaccatgatggcaggcatgggactcgggagacgtggtcccagaggctctcgctccactgatggtgaggagtaaatgacacagtaggctttgcagaagtgaagtcagaaatcagagggctccatctttcaaccactccctggccttcaaggatagatcttggagttcacgtcatacagtctttaaaaggctctcctgcccacaaggtgccctcactacccctcttccacgtgcgtccctcgcactgctgtttgctgagacttacagccccgtcccatgtgtgacttttactccaacccgaggcgggtgcttcctgacagcagggctgggtctcctttactttctatcttggggaccagcagtctcctctgacaaggaagagattcagcaaaggctcgttgagaccagcctgggtgacacagtgagaccctgtctcaaacaaacaaacaaaaaccagcagagtttctgattcagtaaatatatattagttttctattgctgtgtgacaaattactacaaatctagtggcttacaatgcccatttcttagttgacaggtctgtaggtcagaaatcaccatgtgcacaacagggttctctgctcaaggttaacaaggctggaaccggttctctcctgggctgcgttcctgtctggagactcttgcggagaatctgcttctaagcacattcagatccccgtggccactctagctccttgaggccactctcagtccttgccacatggccccctccatcttcagaatcagcaacagagaatgtctctcccatcctttctccgacttcagaaagaacccggtcccttttaagtgttcaccccacataatctcccagggtaatataacctaactgtggaaacagaatccatcacagagtcccgggatcatgcaaagcttgtccaccagggggccatttgagaattcagcctaccacaataggtagggcaagaattctggcaagttgccaagtaaggcagctactgctgctgtggcagccacagtctgaaaagcacctacctatgcacattctacaacaacctttgacttagattgttcccaaattgcaaatgaggaaactgaagttcataggattcagtctagagataatattcatagcacatagtaactggtacctcgtgggcactgaccactccgaatggctagcaggcaactgactctggctgtcagtgccactgtggtcatcttggccagcaccaccagttgactgaggacccccagcaagtaaggactgcagccagggttcctgcccaggcccatctgacacccaagcctgagctttggccacttcacatgctaggattaaaaagaaaatgtcatccctcgaagcctaagtcaggagaagaagaaataaaaggacagcagtttattgattccaaagcccaacttcctttgaacattctagctgctggatgttctataaagctacctttctccagtcttaaatttgtatttgcttcctgttgctgatgtaacagattaccaaacaattttagtggctgaaaacagcacagatttatgactgtacagttctggagatcaaactccaaaatcagtctcaatgggctaaaatcaggtgtcagcctggctgcgttacttctagggcaaaatccgtttcgttgccttttcccaggttccaaagactcccactttccttggctcatggccccatatcactcgaatctctgcttccatcatcctgtctccatctccgactccagccctgccatatcctgcttataaagacaccttgattacactgggcccaccctggtaatccatcatctcctagtctcaagatccttagcttagtcacacctgcagagtcccttcttccatgtatggcaacatatttacaagctccagggactagggaggggctgtcattcagcccagctcatagtctgaggcccacacctatgtggatcataacagtgaacgctttcatggaaacttcctatgcaccaagcctcaatgtaggcattaggtcaatttgtgccaccaccaccacatgaggtaggtcctgtgattatcctctttacagatgaagaatctgaagcacatgggacttgagaaccttgcccaaggtcacacagctaagaaatggaacaccaggttcagacccaggtggcctggctccagagtccatacttctacaactctgttgtacacctctcacagatgtgcaagtaaaaggcagaccctacatatgtagatggcaagaagccccacacccacccatctctccttcctcttacacccactgttccactaaggaccctgcttactcaggtgacctcgccttctgagtctaatgagttacaatccttgccacttctgcccatcgcagaaatgttgttccagttactattgctgcacaacaagccacccaaaacgtaatggctgtaaataacaatagtcatctgttttgcttgtgaatctgcagtttgcacagagatgattcttctctcctccatgcatcatcctctgggtttcccttggctggcgactggagggtccactcccaagttgtcacacttatatagctggcaaaaataccagctgccagtgaggagctcagccagagctctgggccagcagcctcagttcgtctctgtatgggctcttcatgggctgcttgggcttcctgaaagcatggtgggcaactgggttccaagaggaagtgccccgagagaacaaggcagaagggcatggctttttatgacctaaacttggtgtcttttccaccatatagtgtcacttgaggcactcacaaaggtcctccacattcaagggcaggggacatacattccttctcccaacaggaatggcaaggctgtaggagagcatgtggagtaggagacagtgttgcagccatcttcagagaatttgttcttccagaattgtctttatcatagctacctatgacatcccaccacaccacacatggcatcctccccacctcacctctgtttataggcactttccaagcccaaatttgggtgtatgcagaaacacaagattttgtccaatgtatttatttttatgtccttaccaaaattttaaaaatgtgttgcatgaatagcattaaaaaaattttttttatttattttattttttttgagatggagtctcactctgtcacccaggctggagtgcagtggcgcaatctgagctcactgcaagctccacttcctgggttcacaccattctcctgcctcagcctcccgagtagctgggattacaggcacccgccaccacgcctggctagttttttgtgtttttagtagagacagtgtttcaccgtgttagccaggatggtctctatctcctgaccttgtgatccacccacctcggcctcccaaagtgctggcattacaggcgtgagccatcgctcccgccccgtgaatagcatttatttttaaaatgaaatatgcaaaggtaggatttcctaagaaatccaggacatccgttaatagatattagcactaacccaatgccatgcaaaaaaatacaagccatcaaatttgttcaaaatgagtaaagtatatatgtcctttaataaaagcacctgcttatttgatgccacatgacagtggatgatagtggaacgttaactaactagtataagcgcctacactgagcagattcttgtgtaggttgattggggaaagctttccttataccttttctttttaggtagtaatgaggaaatgcagaggtatatctttttcccacttatttaaagcctaaccctattctcaagtccttcatctgtaggactttttgtaactggaccaattggaggttgagatgggattcttatatacctagctagacttttctgattgctacgctccacttctagtatcctgagctctgagtgtctgtgacacacaagagagatcatttatattatcactggagctgcagtctcatcactcaagcttccatcttaagcccctgtagggacagaaactgaggcttttggaggccctagtagactactgagcacctggtcatggcttagtatttcttgattgatttcactgtgagcttttttttctttttgagacagagtctcgctctgtattccaggctggaatacagtggtgcgatctcggctcactgcaacctccacctcccaggttcaagcggttcttctacctcagcctcccaagtagctgggattacaggcacccgccaccccgcccagctaatttttgtatttttagtagagacagggtttcaccatgttggtcaggcttgtctcgaactcctgacctcatgatctgcccacctcggcctcccaaagtgctgggattacaggagtgagccaccacgcctggcccactgtgagctttttgaaggaataaccataccttcctcatctttatatctctaaggaagagtcagttacttggctgcatgcatttgttcaacaaatgtttatgaagggttttaagggttccagggtctctggcttggtctacccttagttcggtgaaggaaatcaattaaagtgtggtaaatactaagaactaggggtaattttacccagccaaggagttcgagaagtcacgtgggagatctttaacaaatggtggttgaatgaatggagacatgagtgatttcttggaagtctgcccttaatcccagtcagtccatgcaagaatctgctcagtgtaggtgcttgaacaatacgtaggcagcacccagccccggaagagcccacctgtgcagagaattttcccctgtaactgacttactgcctggaattttccccttagcaatgcattcctttgagatgcagactgatctccagaatttgctgattaaatacaaattctctgggaaggccttatatattaaacaactgtcatcattaatgctgtaatggggagaagtttattatgtaaccttccagtcttgttagaaaggagattcagaggaaggggtcatccagggagaaagaaaaggggcttggatgtgattctgggactgcaagaagaatggggaaaataatgcaggtgagcaaggaatagatgtagggacatggcagtgacaagaaacaattcagatgagtgtcccctggcactcagacagccctgactccagtgagaatggctcagccaacactactgattaaatgagaatttcaccagataaagatggcaggcaggagaggtaatcaaagaaagacaaaatcagtattttctggtgaaatccctgtttctaggtatgaaataggattctttcaataactagcactccaaaatgttaatgggttaaaatgagcaggtttagagattgtgcataacagatacagagcaaatattaaaagccgtgataccaaaccactacacaaaaacaggcaaagtcgattttctctccaactaacctttacccttacatattgtgtctgttaaccacggttaccttgaccattgatatatagcatctagtgagggaaggggaaaggagaagcttttttgttattataaaagtaataagtgttcattgtggaaattcatgctagaatctaaataatccaaatccaaataatcaagaagaaaaacacaggagtcttctaatactatcacacatattctttcttttcaccaaaatgagaacaataaacattgctttgtaacctggttttttctcctaacagcaagtcttgaacatcttttcatgtcattagttttcaccaccttactatgagtggctctatagtctactgaatgaatttagcatgtatattatctgatcacggatcttgatgtattttatttacataaaactatatttttgcatattttatttgccttgcaggaacatatttgcatctaatgtttgcccacagccatgaggatttctttagaataaattcctaggagtgaaattgttgagtcagtattcgggatttgagttgatgcggtttatactgaaagtttaaactgtttgaatttaccgctaatcttaccgatattcttcttgaagctccttacatggatgatgagctaatgatttggagtggaataagcagcatttttgtagtgttcagtttaaaggctgtcacatttctgagacttcagatgattaacttagggtgcaagtctggagccttctaattccttgagcttgggccttgcgggttggtcggttagctggtcggtgcactggtcacagtgacacaccccaggtcacttcagaaaaatagaatttgtctcccagcctcccttgacagtcagccctgttggggcagagcaaagccaccttgcccaagttccacccccttctcagggtagccccttcccagaactgaccaacgtgggggtatcaaggcccggtcctcctgctccgataagggtcgtctcatcctcaaagctccctgtagagtcggctaggcttccactaggaccacttggtagcttcactctccctctgcccagtttcctttcccctccccaccactcgtcctaataacctcccctgcgcaagaacctctgtcttagagtctggaagcggccagtacccatggcggggagtggatggggaattggctggggagttggcagtagctgtggttgatcacagtatgtgccacataatttcacctctacagaggacagtagagccactgtgtcctccctcaggatggaggagcccacggtggcttggaccaacagggagcgtttcttaaatgggtgaaacaggcacaatcttcccatcattttcaacataaggaataaaatgtaccatagatttgtacaagagcagtttaaaatgctctcttctccgaatgatcttttaagaaactatcttaaagaccacactctgaaaacacctggacctcaggctcctttcaaattgtttttctgtgtcttcgaatgccattcctgacaaaactttttttgcctccatgaatcatgagctaattctgtagaaatctgtaagtgaattacagttcagattcttcctctgtcttcctctgacatggcccaatcatttcttaataattgctaaagaaaccaactgtggtttatgtttgagcagaatcaagatcgtcgctataaccatgtcaccaccattccctggcatttacagcataatttcaggagtgggagacaacatttcacagatgcccagggagtcacccataggaatgtgatgtgcccatacatgggccagatgaaaaaataagtacacacacacacacacacacaattaccatgtgggagtgagggccatgccctctccatgtataattcggtgtaaattgttaggcatagaacagcttgagccccagagctgggtaaacttctctgcctgtacgcctggcacctcacaccatggctggccctagcaggtgactaatctgtttttgatgaattaccaaattaagccacaaattgaaatgccctgggggctggtcagccagcagccatcattggtggaggggcgagtagaccacagacagtgatgaggcctggggtatttgaagagcatgggttccccaacaaggggcatctgctcggccacagtgaaatggagctctgggcccagggtggccacatctccccgggccaccaccaccaaaaagaagtcagaagttctatttctgtgtgacacctcccaatttttcaatattaacaactaattttccgtcaatgttaatgggctacagttcaccaggagaaaactaactgggccattctaggcctgatggaaagggaacagctcttaggaatcagatactcggtgcaaagatgtgtgcccacattttagtcacttgacgggaacacctagattttcctgatgaaccaggttggcacagttgttctctctttgggtggacagagataatatccaagttgtggtggggtcttgcttgttctttgtatgtagtttattgttccttcagtatgttttgaatcattggtgaccttcatgaagatgacaggacatgcttcctcgtgtgacttgttatcaggcttttaagtcatcagcaaagaatgcaggccaaatgcagaaagaaagcgtttgcagtgccctgttgggacttctcaactgcagacatggaaacagggtgtgtgtatggtaatggaaatagcaggtaagagcacataactcacttttctcccagcacttggtgaaaaagaaaaaacaaaccaacaacagaaaaccatttctgacctgcctcttgagttttgaaactgggtgtggatacaaacgatctttagcgaagccattcagaactgggttttctgtctttattgaagagttgcagattttgatcttgctcatttttttccccttccctccatgaccctctcacctttactcctccgctgacattcagccagctattcaccaggtgccggcgtggtgtgtgcctggacccctcactgcgccagcctccctgggagaatcatctcctctaaggagagtatggaatgctgcagcggaaggaaaaggttttccaggcagcattaaccctggaaagtagaattcctactttgcgtgtgaaggactgacttgttgagaatgaaccagccgtggggttgtgaaagctgcttagcgcagggatgagggctaaccagacactggtgttccctgggcctgagtgaccacagccagcccactcctgggtgattgttcttccccaggtttttgctgctgcagtgctgtgcccctggctgagaatggcatcaaagcagaaattaaagtcagtaattaaagcaaggtggctctggaaagagagaacaaataaagggtaattaattagggtggctttggccccagtaatctccaaataaatgttgcctcccctaatcctcatctgctggtctccaagtcattaagtagagttttgatttgcctgtggctattttttcatcttaaacattgcaagcagtgcgtttccaagaagttacagtggggtggttaacctttacatattaaggaaagattgaggcaatacggaataagagttaatggaattctgagcgcacatggaatttaacaaacaagatgaaatctagtatgaactgtgacctcagtcttaagatgtacatttgtacacactcttcctccctgtttttcccaattattttatttttctcttttcttttttattcttttttttttctttatacttggattttttttttgtttctactgtgttaacagatcatgatcaccattctgctaaaaaaaaagtctttagcattttcacctttaacaacatgaatatagagcaggcataattgcagccatcattttggtcactggcataaatcagccactcagattttttatctaaggaataaaagttctgtgttatcccagaaatacatatttgtaaactctcttgtagtaattcaggcaaagtatcaaaagatacttcagcgtttcttatttttttttcaaagtatcagaactgtgcctggctgaagtttaatatcagttattgtgttttcttacagaaaattaatactcattaaacttcaaagtgtttttttaaacaatttcattatttcagatttagaattcttagttgtcattctctgtagttgcagaaccagcacctcccgtattttctccggggcattctggttaacaccttcaaagcccatcaaaaaaaaaaaaggttatgtgttttgctttataccacttccctgtggccaagcaaattttaccagtaagagagcaatactaagagaaatacactcctgagcccatttcctgattgccctaaaagtgaacaaaaatagaaattcctttaactatatcaagaagaatgttcttctgttctctttcttacacttgcttatcatgaaaaagcctaaagaaaactgggaatttaatcacactattgcttaaacacatggtctccaagtgttttggattatgaacctccttggtagaagattttttagtacatctgccagtaaagcattttatttgtaaattctatacaaattctcctatatgctggatactttatgaaacatgccctaaagacaggtccttaaggtggacatgcatccaattgactctgctcttcctcttgtcatggggttggtgctggagatctctgcagtgtacccataagaagaatcctggccctcagcagtgtccatgtggtcgggcctcccagtctccatgtgatggtgcgggccagtgcctggcatcctgctaggccccccacagcaaggacataggaagcacatccgggaatgtgacacccacagagcacacatgtggccctcaagcacagtgcttcccctgaggcctgtgagaaatgtcatcacaaccctacaccacctcctgtgaccacaatgaatggcctggcctttgctcaaaccacagacaaaggctgcccttcagtctgtcacaccagaagccatggccttttgatgccctggtgaattctggctcttggtttgcatcagatgagcccccactggtgcagttctccgaattttggtgtcattgacttgcacaagcttttgtctacatctctggggagctgcagaataagctgcattgtcctcatgaagcttttgttgtagtatgaagattgccaagtcccaacatgactatgatgccaagcagactatggtgacagcgggaggtgggagtcaccaggttacaggtgggaaagaacacttagttgggggatgggggagctcctggaggaattggacttaatgataggctttaaaggatgaacaagagttcaacaggcaggaatgagacagggaggagctggctgaggagctttagaaagtgggtactgcagagggggtccctggaggaggtatggacactggttggagaagaagctcccactgccctgcctaccccagctgtctcctcatgggtaccttgcttccccctcgccccttcgctgtattctgaacacagaaaccagagtacttctgtaatatggaaatcatgtcataacagaccatgctaacctttgctcaaacccccttatggctcccacttctgtagaatacaagccagggtccttccaatggctaaaggtctctcttgtcctcattcccaaccactttctccatgaccctcctccgcagccaccctgagcctccttgctgggcttgcagcatgccagattctcctgcctcagggcctccacacctgctgttccctgggccagaatgctgttccccagcatccaacggttcactcccctacctgcttcaggtcctcatgcactcgcatgtccccttctcaaggatgccttccctggccgggcttgctttcaccacttttccagcttttctgcccctccgcgctgctctgttgcccacactcaaggctgtctaaacatactgtggattgtacccatctatcttgttttgtgtcttttttccccatctggaatgtaagctccaagagggcggggagttttgtctgttttgttcatatttgaattcctagtacctagaacagtgtttagacaaatgaatgaataaatggagggatgcgtgaatgaatgtgaaccagaaggcttaggttcaacttcaggagcaaagggaagtcattgaaggtttgttttgtttaaatatagcatgttaccttttatttacttaaagtgggggaaataaaatcataattgcttttatttgattaaaaaaaccccaaaataataaaaatggtttaaaaaaatgaggttacacctaacaggcagagtgagaatggagtggacagggacagaggtaggaaaagctttctcagtgtatcctatttaagtatattttgggcctggcgcggtggctcacgcctgtaatcccagcactttgggaggccaacgcaggcagatcatgaggtcaggagatcaagaccatcctggctaacacggtgaaaccccatctctactaaaaatacaaaaaattagccgggcgtggtggcgggcacctgtagtcccagctactcgggaggctgaggcaggagaatggcgtgaacccgggaggcggagcttgcagtgagccgagatagtgccactgcactccagcctgggcgacagagcaagactccgtctcaaaaaaaaaaaaaaagtttattttgttttttatcatatgactgtattatcaaattttaaaaatatttgtttaaatgagactgataaggtgggcagtggggggttggaatttgcaatgttcgaaagtaagatccaggaaaactatccaaagttctactcatcttagtggcagggtttacacttcatttatctattcttttctagagtatctacaatcatatctatcatgtaaaaggctattcagtatttgctgatcaaatgaatggatatgtgaatgagatgacatctgtcgtcaaatgtatgaatgactcttgtgtcaaagaggaactagtttttagttctatgtgatcaaagtagaagcagtggatgacagtgacaggaagaaagacatcagtttgtttctttagctggcatttttgagagactattttgtaccagcaccaggactatcaagtggaataagatgtggctcaagccgtcaggaggttcaccgtttagaaccagggtgtcatcacataggtggtcacctactgaagtgagcacggtgctggagacagacgtaggaagtttggagagtgcttaacaaaccttggacaagggtatgagtgggtttggggtgacaaacattttttgcttggccaaatttgggtcaggtttctgaaccttttcctaggctcacctgtgcacttccttataaaacccagttttagcaaagaaccccgcaaagtcagtttaacaggaacccccccacccttaatatctgattgggttcttcatcttctaccatccgtcaggtgatgtctgatcacccgggcctgtcttcagcaagaatcctattaggtcagcttagccagagtcctctttaccccgatgcctcctcttagtaattttccaccactgaccctgacactgcttcttggccatgctgtattcggagttgagctcaatctacccccgcccccagcccccactgcaagacctggttgtggtggtctctatacccatcgtggtggtcctgaataaagtctgccttgtcgggcttcagcaggcatcattgaataatatttttttaacacggggggtcattgttggcttcctggagaacgacatgcctgcactcaatcttaaggaaggaaaggaaaggggagaaaggaggaataatccagggagagggagagcacgagcagagacttggggaagagaagaggggagtgtgttttgaggcatataagccatttgtcttggaggaacataaaagtgagagcagcactggcaggatatgtgacaagaaagacacaagacgaccttgaacagtctgcctgggctacagcaggaacagtgcttatcactgaagcttatacagcgggagaggaacgtgaccgagcttggtcagcatcagggatttttatgtgtcagacttgcacattatgttggagtggtaagacacaggccaagcgaggccagttgggaagatattacagttgctgagggctgcctacctgcagcactatgcacggtgaaggatgggatagagaacctacaggactttctgtggacctgcagggcacataggaggacatccaaggtgccctggaccacccagagagatggggaaatgagctacagtaccacagggcattggcccaaggcgggcatagttccttggaacaagcgtggaatctgcaatgaaaagcccagagtgagttccggctctcctaaacatagtgtgtgccactctgaacctcaatatctttatcgatgaaatcggaaatagaaaggcaactgatgtgctttagccgccacctgtgtttcaggcattgtgctaggcactttgccaccatcactagatgaatcctctccacaactctgaatttgatattaatccctcttaaaagttgagaataagaaccttctccttagttaataatgccttttagaccacaaagtggtaaagatgaggaagagagcaaacccttgtggggttgttttttgttttgttttgtttttgtgtagtaacttaggctggggaacaatgctccacattctatagggaatggttacacatgtgaagtaacagtaaaactactttaccactttgggaggccgaggcgggtggatcacgaggtcaggagtttgagaccagcctgaccaacatggtgaaaccccatctctactaaaaatacaaaaattagctgggcgtggtggcaggcgcctgtaatcccaactacttgggaggctgaggcaggagaatcgcttgaacccaggaggcagaggttgcagtgagccaagatcacgccattgcactccggcctgggcgacaagagcaaaactgtctcaaaaaaaaaaaaaaaaaaaaaaaaaaactatttcactatcttagaagcaaaaaactgaaataaaatgtaactgtcatcatgttcattcacaagagagcctttgcaagttgcctcattttttgctcagtgttggaagtcaaaactcagtttctgtctttggtcagttcatgttgcagacagcttcacagggggcacattcttggtgcagttgtcaactccttagagttcataatggatgtgctgaagtcatcctaatgatgctttcagaatgctgtaatgggaatgatggaattcatcataaaccttaatttttcctcactgaaaatggaaacttcctaatggaaactgtttggagccagaggaggcaaatgcaggttaaaaagactcatttatgatttttatggtgtgagtggaagaaatgcaaaacttctaaagctctcagttgactaaaacattcatttactttaacttctgggttcagttttatcatgttgagtgcaggttttagaatgcttctcaagagctctaatgagactatattagtccgttttcacactgctgataaagacaagacatacccaagactgggaagaaaaagaggtttaattggacttacagttccacatggctggggaggcctcagaatcacggcgggaggtgaaagacacttcttacatggcggcagcaagggaaaatgatgagaaagcaaaagtgaaaacccctgataaacccatcagatctcgtgagacttattcactatcacgagaatagcacaggaaagactggccccccatgattcaattacctccccctgggtccctcccacaatatgtgggaattctgggagatacaattcaagttgagattttggtggggacacagcccaaccatatcagaggtcttgctgtgggtcttgctctgctttcttcagatcactgacatccaaccagcaagcaagaatcaggaatatacttgcctccaaaaccacaaggaatatacaagtaggaaagtcagctttttaaatacttgctttggatccgtttttattctcagtggggagaatcactatttataaagtaaattcatttgcataggacctttagaaatgcaagttcacgtataatagacatgcagtcaaagacagactctcttagcaagaattgtcagataagcagatgaggaggcattgatatgagcataaggcagtcttaccctatgggtacagggacaggtgtcccaggaaaccctgtgctttgccctgttggccaaccagagtgtccaagtgccactaaggattcctgctactcagcaagacgcactttggaaactcaaatctgctccatacctctcacattttagccaaggaaaaccaaggtggcagatcctaagtgccctccccctgatccagggctctggtacaatttgtgaaccagtgatttttttgccagagaacatgcattccagtctccctacaaagtggcagccaccattttgaccggctcttactcctgatctaaaaatggaagtgctcaagtttactaaattcaattcagatagatagaaccgatcaattcaaaggcagatatagaattacatgtttttgggcaatctagtgaaagatttatcatttctatgagcaaagacagttgaataatcttcaaatacctcaccgttctttttttttttttccatccatataacgaaatcaaaattgtatattcgggtgagcccacactgttgtctcagatgaacagagatgtttgagatttgcccacaaaattgagctggaactttgtgtcatgattttaaaagagaaaagaagacagtgaaatcagcctcttgtgtctaaattagcctcttctgtctcttctgatcaccttttaatggaatttgcccaggtgcatgccaggagaagagaaaagggggagacaaagagttggagagggggagggaacatcagagaagttccaagcccctctggaggagtggaatgcaggactgtgtctgctcccctcacctctgtttccccttagcctctcctgcccaccaccacaatcttcatgtgcctgctggacagacaaaggctccctgtactgaaaatgcaggactgcaagcatacacattccctctcgaagcatcatccaggatgaccacttccccttggtgtttgatgcatgttgcattgttcagtattctacacttttttggaatacatgcgtttatgtcttttcaggttgggagttatggataatttggcaaagcaaacaccataactggtttcttacataactctacagttggcagcaaggcacagtgcgttgaaattaagcaacactcactcatccaaaaggactttgcttttccttttttggaaggctaaatgccctgctttgtttcttcctcttgcatgtattttaaattattggctgactttaatgattctttgaagttaatttttaaatgtgaatggcaggattccatttaacttctggaagcttgagagctgtccctgtgtgcccctaaatcagagaatgcttaaataacttgagtgcttttaggtgataataaaattggagagagtgagaagaacataggacccaggctgccatagggatctaaactggtaaaatacttagaaggttcaagagttgcaaccttttgaaagaactagagtcagtcttgcatcgcagagcacttctccaaaccaggcatcttccctgcatcttccctttcaattatagtgtacattctttccatttcttcttcctttcctttttttttttttttttacatttagtttatgagtctttaagcaggacctcttaacccatttatgcctagtgttccattattggaacgctaagcatgtgggagttatttatatcctattgctcaaggtcattgccaaggtctgatggcaaaaattcaaaaaattgcaacctctggcataaatgggttaatgcttctttgctcagtttcaaaggctagattgctcagtttcaaaggctagtgtttttgtatcctttgcctgaattcagtagtgctttgaaaatgatcgaagtgtttcatatccccagttctcaaattataataatgaagttttcaaatgaaaatcctaggattgttttaggttctgtttgctccattccactgtgggatacaagtagaaattgggacattcatccaataaaatgtcactggggaaaaaaattttaactacacttcaaaatgattcctctttttgtcctttaaaatttttattgaccaagacagatttcaaaatgttttctctaataccccaaagtgaaactttgattgaggttttcaggaaattccagggatcaagtatgtcacccggactttggtttccaggtttcccaaagccttgaaatttccctacagtctaattgctgtttattgccacagaccttcatcctttttcttttgtaacattttccatcttaagaagggtcgtcccattcggccgaggagcgtgttgtctgagtagctgaatggaattactaccagtggaaactatgctgcaagagaggttgataaagcagctgtgaagcaaacctcagctgttttttccattctccccaagcaaagttaattagcatagggaaaatgactaaggtgttgacgtcacctctttccagtagaaacttacactttgtccctgtctgcctgcaagcatgcaggacttgactcaggaatttgctgtccaaacaggatgctgtggaagctgcactttttttttccccagggagtgggggctggcccttactgctttataagcaccagctcaagaaggaacctacagcctcttggaaaggaatctcactaggggcttgactgcgtgggtctgtagcgctttcactgtaagaaagcaagatgcattttagaaactttaactacagttttagctccctgattgcctgtgtggcaaacagtgatatcttcagcgaaagtgaaaccagggtaaggcttctaatataacgtgattttctttagttttcaaagcattatgctaactgggactattaactgaatacttgggagaatgtggctctcttgtgggtttgggggttttgaaagaaatccaaagtctttcgagccttgaaaatcaaaagctgttgcctgaggaattaactgaggaaggaatttctaaagatctcaatatttgacaacatccaggcccctgaaccaactcactaggaaggcgagagttggggcatcgtgtgtttttcattctgtgtatgttgtaagtgaacttttcagaaagaggcctcttctgacagtgaatagtgttttacttttgtagccagcgttgtgaataatttcatttcgtcttaggaaataaatgttataaagatatttgtatgtttgtagtaattatgagggcctggcctcaagctcccagatttctctaacaagagaaaatgccgccagagcaaataataaaactggagaaattaagtgtgagatcagtgtgcctcctgggcagcagctctctttgatggtgattaatataatcattttaatcactacacttttcttcttcatttgattaaaatgtaagttttttcatcagcagctatccggctaattgagctttaataatactgtataggaatgaatcctgtatgctctatttgaggggtggtatttgtgcctggtggtgttatatgctttatatccaaagccatattgggacatgcgaaggtttctttttttaaaaaaaatcaaatgtaactccataattgtatataatgcttatgggctcgcaccatagtgtttggactagattgcagagcacattctatgtttttaaagtactacaaagtgagttcacttaacatgagccttatgtgagtaaaatcactattttttaaatgaagtagagatgccatccaaaagctataataactaggtatcagttattagaacaaataagattcttttataagagaaaggcatcatagtaatctagattttaaagataatgtgaattctcttttgttctggtcctaagccctgaacctgtattctaaaaatattcttcaaagtcatctctcccaaattctgaatcataacttcaaaactaaacagtgggtcacagtgcctattgatgaggtcatacaaaattccaaatgtacgaagacacacttttgccagaaacttgcccgtgctcaagagaggtggggaaaaagagtgagaggcggccagatgaactctaccgtccgccagctccgcgttccttcgcacgtgcctctgcgggatccctcgtgggaaagtctcagaaatgtccctaaactgaagaaaagccggggaatgcaaggagagcaaggtcgtaggttgttccgactgctccttaacgacctgcctggcagggaccgactaccctgctcctacccgcagccccatgtggagcaggcatccaccagtgcctccccgcgcttgctagcagtgaacattcctgaagacactctcctctcttatcctgaatcctcgctcccactgcagagacactgcgccttccataggttctccaaggtcctcagtgagctctgtccgcgctgcctaccatccacaccctgcgccatccccttcttcctggccagccccttctgcctttcacacgggctcccacaaactgtcctaagtgtttttgcctggtaaaaagattcacaaaacccggcgactagaagcccatgcagtcttccttggagctttgactgtccaccagttaaactccctctctgaggagttgcagtggcccccagctgcccccaccgacagccacactccaggacccagcctagggggctgtcccctgagcaacctaagcttgtaatcccccacctcgagctttgcattctaagagctcaggacatctcctaattctcactagccctatggcaccagagcgaggtgtgcacagacacgaaagccaggatgcagaaaatggtccatttgcagaacattaatttttaaaccagtatcattttagagagttaaaaagtaacagactgagataaaagcgatcgtggaaatttttaaaaactacttattttaagaaatgcaaaactttctaccaactttgttatttttcaagtcagtatttctttttttcaaattagctgcagttcttttaagccttaaagaaatctttgatatatgcaacactgccctgagctgaacggtggggttggagttggctagccggggaaggctataggacagagaaaaaagggggggtgagtgggggaaggccataggacagagaaacatggggagcaaattaccaaactgtacctccctggaaaatgctcattctactttttaaaaaagtttgttaccgtaagtagtgtctatgtattggcaactgttctgctgattcgatgaatgtaataaatcataccttcttaccttcttgtaaaatcacctgcattgggactaaaggccatagtcccctaagaggggaaaggcttttctctaagaaagaagttaggagttcttgaaaggattgatgatccacttcctcagtaaaaaatgtattgaggaggccaggcacggtggctcatgcctgtaatcccagcactttgggaggccgagggatcacctgaggacaggagcttgagaccagccttgccaacatggcaaagccccgtctctactaaaaatacaaaaattagccaggtgtgctggcaggcacctgtaaccccagctactcgggaggctgaggcaggagaatcacttgaacctgggaggtggaggttgcagtgagccaaaactgcaccactgcactccagcctgggtgacagagcaagactctgtctcgaagaaaaaaaaaaaagtaatgacatcatctagtcaagggtcatatgcaggtaaatttcaactccttttatttttattgttatttttcaggccaaatttgagtccctctttaggacgtatgacaaggacatcacctttcagtattttaagagcttcaaacgagtcagaataaacttcagcaaccccttctccgcagcagatgccaggctccagctgcataagactgagtttctgggaaaggaaatgaagttatattttgctcaggtgagttgggttcattgctatgcatgcttctccctcctccctccctcccttttgtaaagcagcttatacgttgcttatgttatatgctgaccggaaactctgagacttcaccttgagaaagacaaaattcctactctgaatgttcagcgtctcacttgttttaagaagatatcaaggtgcatttgaaagcaacctcagacattgcccctgaccttcctgggttgataatgatgggggaaagaaagccttccctgttcactggggagcttgcagggtgcagcggggtaggcgtggctatgcaaacaccctaaggtttgcgcagcaggtttccatgaatttgctcaagggttggagctcatgacccactctagactgagcagaccagagtggttccctgctcatgtggtgctgggggtactcagcagagaaacaggagtctgcagaagatgcctgcaaatcagcccaggactgccaggtctggcttgaaaggaaaataggggataaccagactgggcgcagatgctaagaaaccctctggttggcagggttcccagccccagggcacccacggcagggagaggggtagctggggttgggcttgccttttctcctgcccactaccattttgaccctcctctggggaacttaggacaggtgacccaccttcaaggcagctcccagagttccatttgatgtccttaggggctgacagattgtcagggaagaagagaggagcttctagaatgcagccagctcctcagtaaagcaagtccccctcaggctctgagcacccccccaacccgcccccaccacacacacacatacacacataccttgctgggatgggagaggaccctgtccaaaggcctcccccagtgggaggaagctcatctgacaccacgccagagagccaaagtgtcttttcttcctcaaagtgaggacagcgaacttgctgggcccttcaagtataaataaagcatttgggatccccgccccacccctgacctttttgccctgggaggcacaggctgagctttgaccttgggtgcctaggccttcctgtgtgagtacactcctttctgcacgggataagattttatgcaaataattacttagtactcctctgaccttttctgtttgtaaaacaatgcatattcattgtgaaaacttggggagggcaatctggaagtgcagagaaaacctacaccgcgcagcttgagatgtaagagctctatggacagccctctcatcactggtcagcatttctaaaaccaaactaggatcgtaggttattgttccttattcttatttcttaaagtctcctgggaagtggcttttttttttttttctggcatctgatccagagtcccggagagggaggtgcagagctgctgctgggtggggaaccctaggggcaggtggagccctggctccctgtccctgagaagctgtgtcctctcagaactgtggcctaggctttggactttcagagcttgcctctgtggtatgaggagcggggagagactgattccaagagccctcctgacctcaatgacagtgacttaaatttccatatatactaaagtcacctctgctgattttctgtccatctaggtcaagcgtaattatttgcagtccctgtgcctgtgactcccatagccctgggagggggctgtcatcctatctgtgccacaaccagagttcatatgtccttttgccctccccattacagaccatcttacaattggtcctggaatcacacctgtcctgacgcctggacattgacctgcccatctcccggaactggcgttaggtgctgttgcctcactgcagttcttccctggcaacaactgacctgtgcttattttctctcctcagaccttacacataggaagctcacacctggctccgccaaatccagacaagcagtttctgatctcccctcccgcctctccgccagtgggatggaaacaagtggaagatgcgaccccagtcataaactatgatctcttatatgccatctccaagctggggccaggtgagcagggccctcgggtgggagggaggcagggggagacacagctgctgccctgcaccagggagcagtaccaccactacccccgtagctctcctgagcccatgccggcatgttttgtgagcttctctgtattcttctgcgccaccgtcccttgtgctgggagcatgcctgcctcttggcaccacctgcagtgttagagagactgcggctgatcgtggggaccctgcatcacgcccctccaccccccgcagtgtcccaggaatccattcctgtgtccactgagcacagcctgcgtgggaggcctgagccccggccccaggttctgtcgctccggatagggatgagtgattggactttggaaagggaaaatcgatgccccctttaagaaatgttatttttaatcaaaataaattctccctttcctgtgattctcacctggccttcttaaaggaaaagggaaggagaaccataggccatggtgagggaagggccgcggtcgggctgccctaccccagggcctgtgggctggtcccctacagagcttgctaaagaaagaggaagttcccgtcctctggagggacaaaagtgtgagcactgcggggagggggtaggttcctcaggctctttgtccaaaatgtgggccttaactggtggaattgtgagcagtagatgagatcatcgagtgaaaggcacttccatcagcacctggctcacagtcagtgttcaatgcaggatttttgaaaaccataaaatgttggtggttcctgtcctgtcctctagggtttgggtgaggaggcaggtgtgagggagagtcttggggtgaagaggtttgagccttctcctgctctgtccgtggagcaagtcaaataaatgctgagaccgtcagctcctcatttctccttgaccagcaatctgatgttcccttgggttgagggttttgttttcttggtccatcagcagtttcatattgaaaagattacatttctgaaaacattgtccaaacggaaattccctctgtgggataaagcaagactcacattacttactgctaattgtggcgtgaaggtcaagatcagaaatggccattttgaggaagcgtgtgctccccccacagcagctcctggcccgggggcatgagcatggctgagggtgtggagtcttcccctaggttaggaatgggagaaaacagggtctccacttgcaaagaggtgtccacagttccagaggcaaatgctgttaataaaaattctgcatactccagaatataccacttccttcaccgagggcttattggagaaggctttttaggaaatagacgtaataaaatcagtttgtccttggttcacttaacagtgagcttgagtgagatttcatatttcacctgtgcttttcaaccaacaggattgcggagattttgcaaattatggtcctaaaccctgagctttctggattttcgatgattagtaggtagataagagacttgcaaagaggtagatttgtaagaggctcttaaccagcattttcagcaatccatctgacctcccatgcctgaattctctctctcagagagctgagctcctttgcctttttcagtgcagttataataacattccagtcccacatgtgatagagaaaagatcaccaccttccttatcagtaaaagtaccttccaggtttagaggagtaaccagtgtggctggaggtaggaagctctcctgggccgctcttgtcgggcggaaatcacacagtggttggtgcggtgcctcctcgcttacccgaactgcaaagaaatcccaagcacaggccgggcgcggtggctcatgcctgtaatcccagcactttggaaggctgaggcaggcggatcacgaggtcaggagatcaagaccatcctggccaacatggtgaaacctcgtctctactaaaaatacaaaaattagctgagtatgatggcatgcgcctgtagtcccagctacttgggaggctgaggcaggagaatcacttgaacctgggaggcggaggttgcactgagccgagatcttgtcactgcattccagcctgggcaacaggcaagactctgtctcaaaaaaaaaaaaaaaaaaaagaaagaaagaaagaaaaagaaaaaagaaaagaaaagaaatcccaagcacaaagccctggaagaaaactgaccatgaggccacaccctgtgggtggagcaggttgaagcaaacctcctgcccctatttcagatccctgcccagcagggcaccaataacgatgcagtctccattcttaaacatctttctaggtgacatgggctggacaagcatgtggtgagccgggttctcattgcctcgggcactcactcatgctgttagctccatgaagtcaatacctttaccgtctcctttactgaggagggaactgaggtgcacagggaagcagaataaagtgcccatgagccctgggtactaaggagccaggctcagagctgccttcatgagcaccagagatgcacactcttcccgtggccagagcggcaccccagcgggaggccccagtcccttcattctacattgccgggtttttcagttgcagaaagctctccccacccttgctggaccagagtggcctgaacttggccaacctggtagaactcaggctgacatagaacagcaggacactcctggtcccggggattagaagttgttctaaggaaaagatgcccaggtcaaaaacgtttccagagcacctggctccgtgcagccacccctgcgtctgctgcagggcctcctgtggcgcccttcctgggcgtgcactgcgaccctcaaataggagctgcatgagggaggcccagggttctgtttccaaatacgtttcttcatccatctttttcctgaaccgaagtttctcacattcacacttgaggaaatgctgacagaaagggagttctctgggtagtttagatatctggtggacatgtgaagtataactagaaaaatgcattccttctatacttctcatgtgcctggactcccagaatgtttgactaaaaacagagtcatgcacaatggaaatctctctttttctgaatgagctagcaaagaaatacaaacccaaaatatgtctggctgtgtctctcagcccaatcgaatggtcacgagcagctggcccagcagagccctgaatgctcttttatgtttgccttttgactcccaaggacttgtctgagtgaccctgcgattattttccctccttaggggaaaagtatgaattgcacgcagcgactgacaccactcccagcgtggtggtccatgtatgtgagagtgatcaagagaaggaggaagaagaggaaatggaaagaatgaggagacctaagccaaaaattatccagaccaggaggccggagtacacgccgatccacctcagctgaactggcacgcgacgaggacgcattccaaatcatactcacgggaggaatcttttactgtggaggtggctggtcacgacttcttcggaggtggcagccgagatcggggtggcagaaatcccagttcatgttgctcagaagagaatcaaggccgtgtccccttgttctaatgctgcacaccagttactgttcatggcacccgggaatgacttgggccaatcactgagtttgtggtgatcgcacaaggacatttgggactgtcttgagaaaacagataatgatagtgttttgtacttgttcttttctggtaggttctgtctgtgccaagggcaggttgatcagtgagctcaggagagagcttcctgtttctaagtggcctgcaggggccactctctactggtaggaagaggtaccacaggaagccgcctagtgcagagaggttgtgaaaacagcagcaatgcaatgtggaaattgtagcgtttcctttcttccctcatgttctcatgtttgtgcatgtatattactgatttacaagactaacctttgttcgtatataaagttacaccgttgttgttttacatcttttgggaagccaggaaagcgtttggaaaacgtatcacctttcccagattctcggattctcgactctttgcaacagcacttgcttgcggaactcttcctggaatgcattcactcagcatccccaaccgtgcaacgtgtaacttgtgcttttgcaaaagaagttgatctgaaattcctctgtagaatttagcttatacaattcagagaatagcagtttcactgccaacttttagtgggtgagaaattttagtttaggtgtttgggatcggacctcagtttctgttgtttcttttatgtggtggtttctatacatgaatcatagccaaaaacttttttggaaactgttggttgagatagttggttcttttaccccacgaagacatcaagatacacttgtaaataaagctgatagcatatattcatacctgttgtacacttgggtgaaaagtatggcagtgggagactaagatgtattaacctacctgtgaatcatatgttgtaggaaaagctgttcccatgtctaacaggacttgaattcaaagcatgtcaagtggatagtagatctgtggcgatatgagagggatgcagtgcctttccccattcattcctgatggaattgttatactaggttaacatttgtaatttttttctagttgtaatgtgtatgtctggtaaataggtattatattttggccttacaataccgtaacaatgtttgtcattttgaaatacttaatgccaagtaacaatgcatgctttggaaatttggaagatggttttattctttgagaagcaaatatgtttgcattaaatgctttgattgttcatatcaagaaattgattgaacgttctcaaaccctgtttacggtacttggtaagagggagccggtttgggagagaccattgcatcgctgtccaagtgtttcttgttaagtgcttttaaactggagaggctaacctcaaaatattttttttaactgcattctataataaatgggcacagtatgctccttacagaaaagttgtcattttatttctagaataaatctgtgaaccttctaaattctgcagtttaaaaggcttttaaacctttttaaacattttaaattcagaaggagacatcctttgtcaatttgagcttagaaactcctaattctgtgctgtggttcatggagagtccaccacactaagaatgcatcacttgcaaaagaagaaaatggataaaactgaaatcagaacttcgagtatttcgtttgtacaggtagatgctactgtgatgaaacccctgttcaccagcacctccacaaaacagcaatggttttggtcatttgaagagctttcttttctattagaaaagatgtccatggaagatactaagttatcttcagaagatgcatctgtaagccttctgtttaatctctggcagcttttcccctgaaagtctcatttcaaatggtggtgaccttcctgggaagcccacaaaggcctaagtaacccagtgtttatttgctgaaatcta

SEQ ID NO: 2 - DNA, 2457 bp, Homo sapiens
ggagcgcgtgaggctccggcgcgcaagcccggagcagcccgctggggcgcacagggtcgcgcgggcgcggggatggaggacggcgtggccggtccccagctcggggccgcggcggaggcggcggaggcggccgaggcgcgagcgcggcccggggtgacgctgcggcccttcgcgcccctctcgggggcggccgaggcggacgagggcggcggcgactggagcttcattgactgcgagatggaggaggtggacctgcaggacctgcccagcgccaccatcgcctgtcacctggacccgcgcgtgttcgtggacggcctgtgccgggccaaatttgagtccctctttaggacgtatgacaaggacatcacctttcagtattttaagagcttcaaacgagtcagaataaacttcagcaaccccttctccgcagcagatgccaggctccagctgcataagactgagtttctgggaaaggaaatgaagttatattttgctcagaccttacacataggaagctcacacctggctccgccaaatccagacaagcagtttctgatctcccctcccgcctctccgccagtgggatggaaacaagtggaagatgcgaccccagtcataaactatgatctcttatatgccatctccaagctggggccaggggaaaagtatgaattgcacgcagcgactgacaccactcccagcgtggtggtccatgtatgtgagagtgatcaagagaaggaggaagaagaggaaatggaaagaatgaggagacctaagccaaaaattatccagaccaggaggccggagtacacgccgatccacctcagctgaactggcacgcgacgaggacgcattccaaatcatactcacgggaggaatcttttactgtggaggtggctggtcacgacttcttcggaggtggcagccgagatcggggtggcagaaatcccagttcatgttgctcagaagagaatcaaggccgtgtccccttgttctaatgctgcacaccagttactgttcatggcacccgggaatgacttgggccaatcactgagtttgtggtgatcgcacaaggacatttgggactgtcttgagaaaacagataatgatagtgttttgtacttgttcttttctggtaggttctgtctgtgccaagggcaggttgatcagtgagctcaggagagagcttcctgtttctaagtggcctgcaggggccactctctactggtaggaagaggtaccacaggaagccgcctagtgcagagaggttgtgaaaacagcagcaatgcaatgtggaaattgtagcgtttcctttcttccctcatgttctcatgtttgtgcatgtatattactgatttacaagactaacctttgttcgtatataaagttacaccgttgttgttttacatcttttgggaagccaggaaagcgtttggaaaacgtatcacctttcccagattctcggattctcgactctttgcaacagcacttgcttgcggaactcttcctggaatgcattcactcagcatccccaaccgtgcaacgtgtaacttgtgcttttgcaaaagaagttgatctgaaattcctctgtagaatttagcttatacaattcagagaatagcagtttcactgccaacttttagtgggtgagaaattttagtttaggtgtttgggatcggacctcagtttctgttgtttcttttatgtggtggtttctatacatgaatcatagccaaaaacttttttggaaactgttggttgagatagttggttcttttaccccacgaagacatcaagatacacttgtaaataaagctgatagcatatattcatacctgttgtacacttgggtgaaaagtatggcagtgggagactaagatgtattaacctacctgtgaatcatatgttgtaggaaaagctgttcccatgtctaacaggacttgaattcaaagcatgtcaagtggatagtagatctgtggcgatatgagagggatgcagtgcctttccccattcattcctgatggaattgttatactaggttaacatttgtaatttttttctagttgtaatgtgtatgtctggtaaataggtattatattttggccttacaataccgtaacaatgtttgtcattttgaaatacttaatgccaagtaacaatgcatgctttggaaatttggaagatggttttattctttgagaagcaaatatgtttgcattaaatgctttgattgttcatatcaagaaattgattgaacgttctcaaaccctgtttacggtacttggtaagagggagccggtttgggagagaccattgcatcgctgtccaagtgtttcttgttaagtgcttttaaactggagaggctaacctcaaaatattttttttaactgcattctataataaatgggcacagtatgctccttacagaaaaaaaaaaaaaaaaaaaaaaaaaaaaaa

SEQ ID NO: 3 - DNA, 44749 bp, Homo sapiens
agagaggacaatggcattaggctattggaggatcttgaaaggctgttgttatccttctgtggacaacaacagcaaaatgttaacagttaaacatcgagaaatttcaggaggatctttcagaagatgcgtttccaattttgagggggcgtcagctcttcaccggagacccaaatacaacaaatcaagtcgcctgccctggcgacactttcgaaggactggagtgggaatcagagcttcacgggttaaaaagccgatgtcacatcggccgttcgaaactcctcctcttgcagtgaggtgaagacatttgaaaatcaccccactgcaaactcctccccctgctagaaacctcacattgaaatgctgtaaatgacgtgggccccgagtgcaatcgcgggaagccagggtttccagctaggacacagcaggtcgtgatccgggtcgggacactgcctggcagaggctgcgagcatggggccctggggctggaaattgcgctggaccgtcgccttgctcctcgccgcggcggggactgcaggtaaggcttgctccaggcgccagaataggttgagagggagcccccggggggcccttgggaatttatttttttgggtacaaataatcactccatccctgggagacttgtggggtaatggcacggggtccttcccaaacggctggagggggcgctggaggggggcgctgaggggagcgcgagggtcgggaggagtctgagggatttaagggaaacggggcaccgctgtcccccaagtctccacagggtgagggaccgcatcttctttgagacggagtctagctctgtcgcccaggatggagtgcagtggcacgatctcagctcactgcaacctccgcctcccgggtttaagcgagtctcctctctcagcctcccgaatagctgggattacaggcgcccaaccaccacgcccgcctaatttttgtatttttagtagagacgggttttcaccattttggccaggctggtctcgaaccccgacctcaggtgatctgcccaaaagtgctgggattacaggcgtcagccaccgcgcccggccgggaccctctcttctaactcggagctgggtgtggggacctccagtcctaaaacaagggatcactcccacccccgccttaagtccttctgggggcgagggcgactggagacccggatgtccagcctggaggtcaccgcgggctcaggggtcccgatccgctttgcgcgaccccagggcgccactgccatcctgagttgggtgcagtcccgggattccgccgcgtgctccgggacgggggccaccccctcccgcccctgcccccgcccctttggcccgccccccgaattccattgggtgtagtccaacaggccaccctcgagccactccccttgtccaatgtgaggcggtggaggcggaggcgggcgtcgggaggacggggcttgtgtacgagcggggcggggctggcgcggaagtctgagcctcaccttgtccggggcgaggcggatgcaggggaggcctggcgttcctccgcggttcctgtcacaaaggcgacgacaagtcccgggtccccggagccgcctccgcgacatacacgagtcgccctccgttatcctgggccctcctggcgaagtccccggtttccgctgtgctctgtggcgacacctccgtccccaccttgtcctggggggcgccctcgccccaccagccccgatcaagttcacagaggggcccccggccaccctcaaggcctcggttccttacgaggttgaaacgttgcctcagaatctccccgcccctccttggtctgcagccgagatcttcagccacggtggggcagctatcccccgggaccgaccccctggggtggcctcgcttcttcagaggctgtgaatggcttcggttcagctgtccaagcggcgatttttcctctgggtgaaatggattagattttagatttccacaagaggctggttagtgcatgatcctgagttagagctttttaggtggctttaaattagttgcagagagacagcctcgccctagacaacagctacatggccctttccctcctgagaaccagcctagcctagaaaaggattgggattgcctgatgaacacaaggattgcaggaaactttttttttaattggcaagggggttggctttgactggatggagagctttgaactgccttgaaattcacgctgtaactaacacaccagtttcctctgggaggccagagagggagggagggtgtaatgaaatacggatgattgttcttttatttttatttacttatttattttttaactttttgtagagatgaggtctcgcttggttgctcaggctggtcttgaactcctggcctcaagcgatcctcctacctcagcctcccaaagtgttgggattacaggagtgagccaccgcgccccaccggggatgatgatgattgcaaacattctgccactcagttttacaaaagaaagagaggcactggattaatgtgtatctcactcaccaatcaacctcttccttaagagaaaatgttaaggaagtcttaggcaaggccttgtttgttcatcactttagtttctctctcccgggatggctgagaatgtgatgtttcctctgttgtcaaggagactacacccctgatgttttcctccagacttctgagagctggtgtgtgtttctagcactttctagctgcaccacctcacgctgtagctggcttcaaggcatatccaggggggagtttcttgtccatttcctttacaaagggaagttgttggaatctgaaccgcaagccttcacttagaccaaaatcaggcaacagcggtgagcgcagctccaaacgtgtcaatgactcacccaaatttgagtaagggagttggctgctttaacgagccgcagggtgattcccttgtcatttccggaaatacctatcttccagggaacactgggaaaaaacagggagacctttgttgagacagaaaacctgtaggggaattctgttcctcattcctgctcttatctgtagacttcctccctgataagatccaattctagatgggtcggttgctccttgctttgatgggtgctttgatgggctttattattattattattattattattattattttgatgggctttttgatgtcccttttccttccacactctgtcccaactgtcaagcaaatagccttttgttgctaagagactgcagatgtaaccgaccagcagcaaacagtgagtcaggctctctcttccggaagcaaaatcaattgctgagatcactctggggaaaatacccaccttatttggaaagaagcactgatcaattgatgtctattttttttttttttgagttggagtctcgccctgtcacccaggctggagtgcaatggcataatctcgcctcactgcaatccccgcctcccgggttccagcaattctcctgcctcagcctcctgagtagctggaattataggcgcctgccacaacacccggctaatttttgtatttgtagtagagatggggtttcaccacgttggccaggctggtctcgaactcctgacctcgtgatccacccgcctcagcctcccaaagtccaaggattgcaggcgtgacccactgtgccagccaatcaattgatttctcattcattttcagctggctctgttcccttaagccaggggattttcgtttgtttgtttccccttcaaggaaatgattctagctacagttttgatttccttgtacaactgttttcagtagcacagggaaagaaaacatcgaaagcattcaccacctcatttgtgtgctgggggaaaaagcagaaatgtgtattctctttttttgtttcgatgaccttgttcctgacttgttactcgtgacttgagagatcagagggctagaggactagaatttatagaggtgttttttttgtttgtttatttttgttcgagttgcccaggctggagtgcagtggcgcaatctcggctcactgcaacctctgcctcccaggttcaagcgattcttcggcctcagcctcctgagtagctggaactacaggcgcccgccaccacacccagctaatttttgtatttttcagtagagatgggatttcaccatattggtcaagctggcctcgaactcctgacctcgtgatccacccgcctcagtttcccaaagtgctgggagtacaggcgtgagccgccgtgcccggcctttttgtgtttttgtgtttttgagaggagctcattgctttttaggcttccctagcgtgagaaaatctggggatccatgctctagtttacttcctttttttttttttttttgagatggagtctcgcttagattgcctaatctcagctcattgcaacttctgcctccggggttcaagggattctcgtgtctcagcctcctgggtagctaggatacgggcacccgctaccatgcctggctaattttgtacttttagtagagacagggtttcgccacgttggccaggctggtctcgaactcctgacctcaggtgagccgcctgccttggcctcccaaagtgctgagattacaggcgtgagccaccgcgcttggcctaatttgcttttcctgaaattcaaatggtctaatatgaaaaacgccaaccttgcttgaaagaataagaaagaggtgcggtttcgttgggccgttgatgtttggaacaggactggttttgtccccttgctcggaaagggcagcaactgtgaggacagctccctgacgtgctctcactcagcactgttccgttcctgagcactgtccccactagctaggccaagggagctcatttggcaggcaactgctgtctggctgcgcctgtggcagtaaaatctgcctttattttttggaggcagggtcttgccctgtcgctcaggctgaagtgtgcagttatagctcactgcagcctccagcttctgtactcaactgatcctcctctctcagcctcctgagtagctgggactatacgcacgtgttaccactcccacctcagtttgtttgtttatttatttatttatttatttattgagatggagttttgctcttgctgcccaggctggagtgcaatggcgcgatctcggctcaccgcaacctccacctcctggttcaagcgattctcctgcctcagcctcctgagtagctgggattacaggcatgcaccaccacgcccggctaattttgtatttttcgtagagatggggtttctccacattggttcaggctgttctcgaactcccaacctcaggtgatccacccgcctcagcctcccaaagtgctgggattataggcgtgagcccccgaacccggccactcccagctaagtttaaattttttgtttgtttgttcgtttgtttttattttttgagacagagtctcccgcccaggctggagcgcagatcactgcatccttgacctcccaggcttaagccatcctccccactcagcctcccaagtagctgggattacaggtgtgtgccactatgcttggctaagttgtgtattttttgtagagatggggttcaagggattctcgctttgttgcctcggttggtctcaaactcctgggctcaagcagtcctccctcctcagcctcccaaggtgctggggaaatccacttttgaaacattgtctggagagttgcccaggtggtagatcacagaaataggtcatcgtggggtccttcccatgggtgcagtcttgagccacctgtggccagcaaatatttggagaataatagtcaggggagagcttgaggtccagggaaaggttttgtttttcttcagggaaaggtttttattgttctttatccctccttaaaggaccttcaggtgttactgacattcccggtctacccagtggcacatttagtttgtaagctgggccctcgtacagaggtagggaggtgagagcattggattagtggtcaccaaagctgcggtcacctagtggggtgatcagaggctcctcccttaagatcttgattgccaacgcctctggcccaactttcctttttatttatcgcaagcctcctggaatctcaattgctttttgcccacccggtgtgtcagcacaagaaatgagtcatttcctcctttaagcacagttgaaattgagctgtgagtcagtgaggtgtgtacgatattgtcaaagcggggtgtgtacagtattgacagatctgtagttgggcaagagaattatcagagtttgtgaccacagcagattccaaagctcgactcattttcttctctcttccttcccttttttcttttctttttttttttttttttgacagagtctcgctctgttgcccaggctggagtgcagtggcacaatctgggctcactgcagcccctgcctcctgggttcaaatgattctcatgtttcagcctcccgagtagctgcaattacaggcattcgggttcaagtgattctcctgcctcagccacctgagcagctgggattacaggcgcccgccaccacgcccggctaatttttgtatttttagtagagacggggtttcaccatgttggccaggctggtctcgaactcctgaactcaggtgatccgcccacttcggcctcccaaagtgctgagattacagacgtgagtcaccgcgcccagcctgttctgttctttaattctcaaaacaccctctaggaagtagagactgccattctcccccattttacagatcaggaaactgagtcccagaaggatttagtcagttacccaagttgttctagttaaatggcctggaaagccagtgaagcccaggattgtctatctaacccccttactactctaactttcagggaatccacatgaatgtgctgggtcaaccatcaaagttgaaatggataaagggggctggatgcggtggctgatgcctgtaatcctagcactttgggaggccgagatgggtgggtggattgcttgagcccaagagtttgagaccagcctgggcaacatagtgagacacctgtctctgcaaaaaataaataaaaagttagctgagtgtgatggtgcacccctctagtcacagctgttgagttaggcttaggcaggaggatcgcatgaacctgggaggtggaggcggccgtgagcctcagtcatgccactgcactccaacctgggcaacagagtgaaagccggtgtccgaaagagaaagaaaaaaagacatagatacatcttttaaagttaggttgtatgttaattacctacaactcagtttcaactgtgcttaaaggaggaaatgactcatttcttgctacatatcaaattagcccaaaatgtagtggcttaaaacaacacatttatgatttctcagtttttgcgtgtcaggaatttggaagcagcacagctagacggttccagctcagggtctctcatgaagttgcaatcaaaatattggcaggagagaaaaacatattttcagaagctgcaggcataggaagacttggctggggttgaaggatccacttccaagatggcgcactcagtggctcttggctggaggcctcagttccctgctgcgtggagctctccctccagctgcttgagtggactcatgacatgcagctggcctcccctggagcagtcgatccaacaatgagcatggccatgaactaggctcagaagccactccctgtcgtctctacattttcctatcagaagcaagtcattaaaagtccagtgccactccaggggagacgaattaggctctgccttctgaaaggattatcacagaagatgcggtcctatattctttttttaaaattattcttttttttattttgtagagatggggtcttggtatgttgcctaggccagtctggaattcctgggctcaaacaatcctgtctctgcctcccaaagtgttgggattacaggcatgagccactgcacctggtcatgtggtcatattttctttttcttttttttttttttttgagacagagtctctgtcgcccaggctggagtatggtggcgtgatctcagttcactgcagcctccgcctcccgggttcaagcgattctcctgcctcagcctcctgagtagctgggattacaggcgcccgccaacatgcccagctaatttttttagtagagatggggtttcaccatgttagccaggatggtctcgatctcctgatttggtgatccgcccaccttggcctcccaaagtttcaaccatcgatcagaacttattgatgtacttatgtagctaggcacggtggcgcgtgcctgtaatcccagctacttggaagggttaaggcaggagaatcgcttgaacctgggaggcagaggttacagtgagtcaagatcataccattgcactccagtctgggcaacagaatgagactctgtctcaaaaacaaaaaacaaacccttgtatgtgattttcctggatagcatctgttacatcttcacaaagataaaaagtcagacttggctgggcatggtggctcacacctgtaatcccagcactgagaggctgaggcaggcagatcacttgaggtcaggaatttgagaccaggctgggcagcatggtgaaaccccgtctctacaaaaaatacaaaaattagccgggtgtggtgtcacgcacctgtattcccaagctactcaggaagctaaggcaggagaatcacttgaacccagaggtggaggtttgcagtgagttgagattgtgccattgcactccagcctgggcgacagagtgagactctgtgtcaaaaataaaataaaataaaattttaaaaaaggcagatttttttttcttcttggtattgttaccttattatagtaataataagtgcatagtgcatgctgagataagcaatcataatttgttattgcggccgggcatggtggctccagcctataatcccagcactttggtcaggagttcaaggccagcctggccaatatagtgaaactccatctctactaaaatacaagaaattacctgggcatggtggcagttgctggtgatccccagctacttgggaggctgaggcaggagaatcgcttgaacctgggaagcagaggttgcagtgagccaagattgcaccactgcactccagcctgggtgacagagtgagactctgtctgaaaataataataataataatttgttattgcttttattgccttagtttacatagggaatcaaagtttatactttgatttataaaagttgctttgattctagttcacagaaccagaatctttcatataaaggtattagagggcccagtgtggtggctcatgcctgtaatcccagcatattgggaggctgaggagggaggatcactttaggagtttgaggccagcctaggcaacatagtgagaccttgtctctacaaaaaattccaacattagctgggcatggtggcatgtgcctgtagtcccatttatttggggggctgaggcaggaggatcacttgagcccacgaggttcaatccaggttgcagtaagccatgatcctgccactgcactccagtttgggtaacagagcgaagctatgtctcaaaaaaagaaaaaaaaagtattctaaatccaaatttaatatataaaactaaatgcaggccaagtgtggtggcatatacctataatcacaacactttgggaggctgaggtgggaggattgcttgagcccaagagttcaagaccagcctaggtaacacagtaagaccccatctctacaaaaagtagaaaaattagcctggcatggtggtgagtgcttttaatcccaactacttagggggctgagatgggaagattgcttgagcctcagagtttgaggctgcagtgggccgtgatcgctccactgatcgctctaaagtgagaccctgtctcaaaaaaaaagaaaatagaagaaaactaaatacattcaataagactttgatctcttttccaaggtgtaaatatattttgggaaattttccagttactttgttctcattttaatgtaataatctaagtcttggttttctaaggaaaagttttctcttattatatcttttgttaatgtttctctcccatttcttttgatctgatcttcagatacatgattatcttcactgctaaatttgtgttctctggcctctacatttataatttctcataattctttatctaagtatttcttccctacctactgaagaaaactcaagttttcttccaccttaatgattatgctgtgtctgtgagttttcttcatgactctttacagtacaagttttttgtttttgtttttttaatggtcagatggatagaacaacacaggttttgtttgttttgttttaacttttaaaaaaattataatagataaagggtctcactacgttgtccaggctgatctcatactcctgggctcaagcaatccacccacctctgcctcccaaagtgctgggattacagtcatgagccaacatgcctgggcagtacaggttttttttgagacggagttttgttcttgttgccgaggctggagtgcaatggcacaatcttggctcaccacaaagtctgcctcccaggttcaagtgattctcctgcctcagcctcctgagtagctgggattacaggcatgtgccaccacgcccagctaattttgtatttttagtagagacggggtttcaccatgttggccaggctggtttcgaactgctgacctcaggtgatctgcccacctcggcctcccaaagtgctgggattacaggcatgagccaccatgcccagctgtagtacaggttttaatatgctaaatactcttcctttctttattaatgtgcatggaagttctaatatttttttcccataccccagagagtccatattttggaatcaacaacactagcctttgttgacaagtgtctctcttgggttccttctttgtgtcctccactgaattttggggttcataaaatttcatttgttgtgcttgcttaattccctgggaatcagactgttcctgatcggatgacatttctggttaattctttagttggcaggaaatagacacaggaaacgtggtcagtttctgattctggcgttgagagaccctttctccttttcctctctctcagtgggcgacagatgcgaaagaaacgagttccagtgccaagacgggaaatgcatctcctacaagtgggtctgcgatggcagcgctgagtgccaggatggctctgatgagtcccaggagacgtgctgtgagtcccctttgggcatgatatgcatttatttttgtaatagagacagggtctcgccatgttggccaggctggtcttgaatttctggtctcaagtgatccgctggcctcggcctcccaaagtgctgggattacaggcaccacgcctggcctgtgacacgattcttaacccctttttgatgatggcggctggaaaagtggccagtggattttgatgtattcaatcatgaattaggaggtggggagagaatgaattattggagctttccttaaagccattaaatggctctattgttttttcaattgatgtgaatttcacataacatgaaattaaccagctcagtggcattaatacatctgcaatgctgtgtggccaccacctctatcttgttccaaaactttgcataacctaatgtctttttttttttttttttttgagacggagtctcgttccatcacccaggctggagtgcagtggtgtgatctcagctcactgcaacctccgcctcccaggttcacgccatcctcctgcctcagcctcccgagtagctgggactacaggcaccctccaccacatccggctaattttttgtatctttagtagagatggggtttcaccatgttagccgggatggtctcgatctcctgacctcgtgatccacctgcctccgcctcccaaagtgctggcattacaggcgtgagccaccatgcccggcctatttttttttttaagagatggagtctaattctgttgcccaggctggagtccagtggtaccatcatacttcactgcagccttgacctcttgggctcaagtgattctcttgcctcgaactcccaaagtattgggattacaggtgtgagccaccgcactcagcctaatgtccagtttttaacaagctccatttaaatgccctccgttttgacccataaaggggtaggcttggccgggcacaatggcttgtgtctgtagtcccagctacttgggaggctgaggcagaaaggcagaaagattgctttataaagcccaggagtttgagggccacctgggtggcatagctagacctcatctctaaaaaataagtaataaataaatatttgtttttgtttttttctttttcttttcttttttttttttttttgagacggagtcttgctctgttgcccaggctggagtgcagtggcgcgatctcagctcactgcaagctgtgcctcctgggttcatgccattctcctgcctcagcctcccgagtagctgggactacaggcgcccactaccacgcccagctaattttttgtatttttagtagagatggggtttcaccacgttagccaggatggtctcaatctcctgacctcgtgatccgccagctttggcctcccaaagtgttgggattacaggcgtgagccactgagcccgccccatatgtatgtatatatatatttttttaaaatgggagaccaggcatggtggctcatgcctagaatcccagcactttgggaagctgaggtaggcggatcacttgaggccatgagtttgagaccagcctgctcaacatgatgaaacttctatctctactaaaaaaaaaagtgggattaggtcaggcacggtggctcacacctgtaatcccagcactttcagaggccgaggcaggaggatcatgaggtcaggagatcgagaccatcctggctaacacggtgaaaccccgtctctactaaaaaaatacaaaaaattagccaggcgtggtggcgggtgcctgtagtcccagctactcaggaggctgaggcaggagaatggcgtgaacccgggaggcggagcttgcagtgagccaagatcgtgccactgtactccagcctgggcgacagagcaagactctgtctcaaaaaaaaaaaaaaaagtgggattgacattctcttcaaagttctggggttttcctttgcaaagacaggattggcaaggccagtgggtcttttttgtgtgtgtgtgtgtgacggagtctcactctgccacccaggctggagtgcaatggcaggatctcggctcaccgcaacctcctcctcccaggttaaagtgattctcctgcctcagcctcccgagtagctgggactacaggtgcccgccaccacacccaactaatttttgtatttttagtagagacagggtttcactatattggccaggctggtcttgaacccctgacctcacgtgatccacccgccttggcctcccaaagtgctgggattacaggcgtgagccactgtgctcggcctcagtgggtctttcctttgagtgacagttcaatcctgtctcttctgtagtgtctgtcacctgcaaatccggggacttcagctgtgggggccgtgtcaaccgctgcattcctcagttctggaggtgcgatggccaagtggactgcgacaacggctcagacgagcaaggctgtcgtaagtgtggccctgcctttgctattgagcctatctgagtcctggggagtggtctgactttgtctctacggggtcctgctcgagctgcaaggcagctgccccgaactgggctccatctcttgggggctcataccaagcctcttccgcccttcaaatccccccttgaccaggaggcattacaaagtggggatggtgctacctcttcgggtttgtcacgcacagtcagggaggctgtccctgccgagggctagccacctggcacacacactggcaagccgctgtgattcccgctggtcgtgatccccgtgatcctgtgatccccgccccgtgaggctgaacacatagtgacgcttgctagccaagcctcaatgacccacgtaacatgaagggggaaaagccagaaagttctgccaaggagcaaggccaagaatcccgaagggaaatggactttgaagctgggcgtcttcttggctgtcttaatacaagtggcacatccaaatccaaaaccccgaaattcaaagtcttgagcacccgaaattctgaaacgtcttgagcactgacctttagaaggaaatgcttattggagcattttggatttcggatttttaccactgagtgtggagtcctaattaggaaaaaaaccaggctgaccgaaccaaaggaaagcaataaaagaaggcagatagggtcaggcacggtggctcacccctgtaatcccagccttttgagaggctgaggcgggtggatcacttgaggtcaggagttcgagagcagcctggccaacacggtgaaaccccatctctactgaaaatacaaaaactagccaggtatggtggcgtctgcctgtaatcccagctactcgggaggctgagacaggagaatcacttgaacctgggaggcagaggttgcagtgagccaatatcacgccattgcactccagcctgggggacaagagcgaaattctgtctcaaaaaaaaagaagaagaaggccgacaaactatgtaactctgcctttctccatggtccagaacacacagccctcctgcgtaaataactccttatcttcctgctcccagctatcatcagacacctcggctgatagaaaattgcaagttagctcactgcaacctcggcattataagtactgcacaaagccctcttcagcgcacagcacaagcaccattctataaaatctccagcaagcggccaggtgcagtggctcatacctgtaatcccagcattttgggagactgaggcgggcggatcacctgaggtcaggagtttgagaccagcctggccaacatggtgaaaccccgtctctattaaaaatacaaaaaaattagccaggcgtggtggcaggtgcctgtaatcccagctacttggaaggctgaggcaggagaatcgcttgaacccgggaggtggaagttgcagtgagccgagatcttgccatcgcactccagcctgggggacaagagtgagacttcgtctcaaaaaaaaaaaaaaaaattcccagcaagcctttgtcttctggcagtcagctcctctcttgctgacctgctcattgctttcttgcaaggtattttcctacctactttctggaataaatctgtctttctgtacttacaactaccttttttaaaatttctttcttttttgagatggagtctcactctgtttgcccaggctggagttcagtggtgcaatctcagctcactgcaacctctacctactgggttcaagcgattctcctgcctcagcttcccgagtagctgggattacaggcgtgcaccagcacgcaggctaatttttgtatttttagtagagacggggtttcaccatgttggccaaggtggtcttgaactcctgacctcaagtgatcctcccacctcagcctcccaaagcgctaggattacggccatgagccactgaggccggctgcacctacaactgtcttgataaattcttacccccacaccactggtccagatagtcagtgctcacccacaacattaaggatattccaaatttgaaacattccaaaatcagaaaaatattccaactctgaaaatattccaaaatccaaaaaaattcaaaatccaaaacacttctggtcccaagcattttagagaagggatactcaacccaaaataaggacagcaattctataaattgtgctaccatcttgcaggtctcagtttaacagctttacacctattagcgcaccagtgctcatagcagtgctgggaaatgtgtacagatgaggaaactgaggcaccgagagggcagtggttcagagtccatggcccctgactgctccccagcccgcctttccaggggcctggcctcactgcggcagcgtccccggctatagaatgggctggtgttgggagacttcacacggtgatggtggtctcggcccatccatccctgcagcccccaagacgtgctcccaggacgagtttcgctgccacgatgggaagtgcatctctcggcagttcgtctgtgactcagaccgggactgcttggacggctcagacgaggcctcctgcccggtgctcacctgtggtcccgccagcttccagtgcaacagctccacctgcatcccccagctgtgggcctgcgacaacgaccccgactgcgaagatggctcggatgagtggccgcagcgctgtaggggtctttacgtgttccaaggggacagtagcccctgctcggccttcgagttccactgcctaagtggcgagtgcatccactccagctggcgctgtgatggtggccccgactgcaaggacaaatctgacgaggaaaactgcggtatgggcggggccagggtgggggcggggcgtcctatcacctgtccctgggctcccccaggtgtgggacatgcagtgatttaggtgccgaagtggatttccaacaacatgccaagaaagtattcccatttcatgtttgtttcttttttttcttttctttctttattttgtttttgagatggagtctcactctgtgatttttttcatctctaaatttcctacatccatatggccaccatgaggccccaggctggccgatggttgctgttagcttattgggaaatcactgtttggaaggtgctggttgttttttgttgtttgttgtttttgtttttgtttttgttttgagacggagtctcgctctgtcgccagggtggagtgcagtggcgcgatcagctcactgcaacctccgcttcctgggttcaagccattctcctgcctcagcctcccaagtagcgcggattacaggcatgtgccaccacctccggctatttttttttctatttagtagagatggggtttcaccatgttagtcaggctggtcatgaactcttgacctcaggtgatccacccgcctcggcctcccaaagtgctgggattacaggcgtgcactgctgcacccagcctttttttgtttttttgagacagggtcttgctgtcacccaggttgaagtaaggtggcacgattatggctcactgcggccttgatctccttggctcaagcgatcctctcacttcagcctctcaagcagttggaaccacaggctgtaccaccaagcctggccaatttttttgtacagacacaggctggtcttgaactcctgggctcaagcaatcctcctgccttggcctcccaaagtgctgggattccaggcatgagccgctgcacccggcaaaaggccctgcttctttttctctggttgtctcttcttgagaaaatcaacacactctgtcctgttttccagctgtggccacctgtcgccctgacgaattccagtgctctgatggaaactgcatccatggcagccggcagtgtgaccgggaatatgactgcaaggacatgagcgatgaagttggctgcgttaatggtgagcgctggccatctggttttccatcccccattctctgtgccttgctgcttgcaaatgatttgtgaagccagagggcgcttccctggtcagctctgcaccagctgtgcgtctgtgggcaagtgacttgacttctcagagcctcacttccttttgttttgagacggagtctcgctctgacacccaggctggagtgctgtggcacaatcacagctcacggcagcctctgcctctgatgtccagtgattctcctgcctcagcctcccgagtagctgagattaaaggcgtataccaccacgcccggctaattttttgtatttttattagagacagggtttctccatgttggccaggctggtcttgaactcctggtctcaggtgatccacccgcctcggcctcccaaagtgctaggattacaggtgtgagccactgcgccaggcctaatttttttgtatttttagtagagatgcggttttgccatattgcccaggctggtctcgaactcctgggctcaagcgatctgcctgccttggcctcccaaagtgctgggattacaggcacaaaccaccgtgcccgacgcgttttcttaatgaatccatttgcatgcgttcttatgtgaataaactattatatgaatgagtgccaagcaaactgaggctcagacacacctgaccttcctccttcctctctctggctctcacagtgacactctgcgagggacccaacaagttcaagtgtcacagcggcgaatgcatcaccctggacaaagtctgcaacatggctagagactgccgggactggtcagatgaacccatcaaagagtgcggtgagtctcggtgcaggcggcttgcagagtttgtggggagccaggaaagggactgagacatgagtgctgtagggttttgggaactccactctgcccaccctgtgcaaagggctccttttttcattttgagacagtctcgcacggtcgcccaggctggagcgcaatggcgcgatctcggctcactgcaacctctgcctcccaggttcaagtgattctcctgcctcagcctcctgagtagctgggattacaggcgcccaccaccaagcccgggtaattttttgtatgtttagtagagatggggtttcactatgttggccaggctggtgttgaactcctgacctcatgatccgcccacctcggcctcccaaagtgctgggattacaggcgtgacccaccccatgaaaaaaaattaaaaaatgaagcgatgctgggcgcggtggatcacgcctgtaatcccagcactttgggaagctgaggcaggcagatcacgagggcaggagattgagaccatcctggctaatacggtgaaaccccatctctactaaaactacaaaaaattagccgggtgtggtggcaggcacctgtgatcccagctactcaggaggctgaggcaggagaatcgcttgaacccaggaggtggaggttgcagtgagccgggatcacaccattgcactccagcctgggtgacagagtgagactctgtctcaaaaaaaaaaaaaaaaaaaaaagcgaattctgaaatacatgaattcttttccttagatgcctgcttctgtcttgaggtttgttgttgttatttcgaaacagagtcttgctctgtcgctcaggctggagtgcagtggcatgatcttggctcaccacaacctccggctcccaggttcaagcgattcttctgcctcagcctcctgagtagctgggattacagctgaatgccaccttgctgggctaatttttgtatttttagtagagatggggtttcaccatgttggccaggctggcctcgaactcctgacctcgagtgatctgcccgcctcctgaagtgctgggattacaggcgtgagccacctcgtcctggtgagggtttttttttttccccaaccctctgtggtggatactgaaagaccatattaggataactgtacagtatagagaaggcagtggcaagttttctctgtcatataccagagtgggcttgggcatggtggcatactcctgtagtctcagctaatcaggaggctgaggaaggaggatcgcttgggcccaggagttggagactgtagtgagctgtgatcacaccaccacacttcaatctgggcaacagagcaagagaccctatctctaaaaaaaagtaagtatttcggacactgtgggccatacggtctctggtgcagtttctcaacatggctgttgggtgaacacaaccacgcacagaacgcaaaccaatacacgtggctgtgggcccagaaaatgttatttatggacacaaaaattggaatttcatataactgttttgtgtcatgaaaatgatttccctttttatttttatttttcttctcaagtatttaaatatgtaaaagccatttttaggcctggcaggatggttcacagctgtaatcccagcactttgggaggtcgaggcgggaggatcacgaggtcaggagatcgagaccatcctggccaacacagtgaaaccccgtctctactaaaaatacaaaaaattaaccaggcttggtggcgcgcgtctgtagtcccagctgctcaggaggctgaggcaggagaatcgcttgaatgcaggaggcggaggttgtagtgagccgaggttgcaccactgcactccagcctgagcgacagagtgagagtccgcctcaaacaaaaaaatgtttgcccatgctggtcttgaactcctgggctcaagctatctgcctgccttggtctcccaaagttctgggattacaggcatgagctacagcgcccggacttttgttgttttatatctatatatctatatataacttgttttatgtatatatataacttgttttatatatatacataaactgcagtaaaaaacatgtaacataaaatttaccttctcaaaccttattaagtgcacagttctgtgccattagcaaattcacactgttgtacaacatcacaaccaccatctccagaacttttttttttttttttattctttttgagacagagtctcactcgtcgcacgggctggagtgcagtggtgcgatctcggttcactgcaacctccacctaccaggttcaagcaattctcctgcctcagccccctcagtagctgggattacaggtgcccgtcctaccacgcccagctaatttttgtattttcagtagagactgactgggtttcaccatgttggccaggctggtctcgaactcctgacctcaagtgatcctcccacctcagcctcccaaagtgctgggaatacaggcatgagccactgcgcccggccccagaactcttttatcttcccaaactgaagctctgtccccatgaaacactcactctccatcccctccccaactcctggcacccaccattctactttctgtccctatgaatgtgatggctctagggacctcctctgagtggaatcagacagcattttccttttttgactggcttatttcactgagccaagtgcggtggcacacgcctgtaatcccaaaactttgggagaccgaggcgggcgcatcacctgaggtcaggagttcgagaccagcccggccaacatggtgaaaccccatctctagtaaaaatacaaaaaattagcctgtcatggtcgtgggtgcctgtaatcccagctaagtgggaggctgaggcaggagaatcgcttgtacccaggaggcggaggtcgcagtgagccgagatcgtgccattacactccagcctgggcaacaagagtgaaactccgtctctcctaaaaatacaaaaaaattagctgggcatggtggcacatgcctgtagtcccagctacttgggaggctgaggcaggagaatcacttgaacccgggaggtggaggttgtaatgagccaaggttggcggcgaagggatgggtaggggcccgagagtgaccagtctgcatcccctggccctgcgcagggaccaacgaatgcttggacaacaacggcggctgttcccacgtctgcaatgaccttaagatcggctacgagtgcctgtgccccgacggcttccagctggtggcccagcgaagatgcgaaggtgatttccgggtgggactgagccctgggccccctctgcgcttcctgacatggcaaccaaacccctcatgcctcagtttccccatctgttaagtgtgcttgaaagcagttaggagggtttcatgagattccacctgcatggaaaactatcattggctggccagagtttcttgcctctggggattagtaattaagaaatttcaggccgggtgcgtaatccctgtaatcccaacaccttgggacgccgaggcgggcagatcacctgaggtcgggagttccagaccagcctgaccaacatggagaaaccccgtctctactaaaaatacaaaattagccgggcttggtggtgcatgcctataatcccagctactcaggaggctgaggcaggagaatcacttgaacctgggaggtggaggttgtggtgagccaagatcgtgccattgcactccagcctgggcaacaagagtgaaactccatccaaaaaaaaaagaaaagaaaagaaaaaaaagaaaagaaatttcagctgacacagcttcacactcttggttgggttcccgtggtgaatgatgaggtcaggtgatgactggggatgacacctggctgtttccttgattacatctcccgagaggctgggctgtctcctggctgccttcgaaggtgtgggttttggcctgggccccatcgctccgtctctagccattggggaagagcctccccaccaagcctctttctctctcttccagatatcgatgagtgtcaggatcccgacacctgcagccagctctgcgtgaacctggagggtggctacaagtgccagtgtgaggaaggcttccagctggacccccacacgaaggcctgcaaggctgtgggtgagcacgggaaggcggcgggtgggggcggcctcaccccttgcaggcagcagtggtgggggagtttcatcctctgaactttgcacagactcatatcccctgaccgggaggctgtttgctcctgagggctctggcaggggagtctgccgccctgttaggacttgggcttgccagggggatgcctgcatatgtcctagtttttgggaatatccagttaacggaaccctcagccctactggtggaacaggaaccggctttcctttcagggacaacctggggagtgacttcaaggggttaaagaaaaaaaattagctgggcatggtgccacacacctgtggtcccagctactcagaaggctgaggcgggaggattgcttgagggcaggaggattggttgatcctcccacctcagcctccggagtagctgggacctcaggtgcatgccactatgcctggctaattttcttttttctttttttttttttttcgagacggagtctcgctctgttgcccaggctggagtgcagtggcaggatctcggctcactgcaagctccgcctcccgggttcacgccattctcctgcctcagcctccccagtagctgggactacaggagcccgccactgcaccaggccaatttttttgtatttttagtagagacggggtttcactgtgttagccaggatggtctcgatctcctgacttcgtgatccgcccacctcggccttccaaagtgctcggattacaggcgtgagccactgcgcccagccgctaattttcatatttttagtaaaaacagggtttcaccatgttggccaggctagtcttgaactcctgaacccaagtgatcctcctgccttggcctcccaaagtgctgggattacagacaccacacctggctattattattttttagagacagggtgctgctctatcttccagcctgtagtgcagtgcagcctccatcatagctcgctgcagccttgacctcctgggttcacgtgatcgtcccgcctaagcctctggaggagctgggagtactggcatgtgccaccatgcctggttaatttttttttttttttttttgagacagagtctcattctgtcacccaggctggagtgcggtggtgcgatcttggcttactgaaacctccacctcccaggttccagcaattctcctgcctcacccttctgagtagctgggattacaggttccggctaccaaacctggctagtttttgtatgtttagtagagacagggtttcaccatgttggtgaggctggtctcgattctcccgcctcagcctcccaaagtgctgggattacaggcttgagccaccgtgcctggcttttttttttttttttttttttgtggcaataaggtctcattgtcttgcccaggctagccttatgctcctagcctcaagtgatcctcctccctcagcctcccaaagtgctgggattacaggtgggcgccactgtgcctgttcccgttgggaggtcttttccaccctctttttctgggtgcctcctctggctcagccgcaccctgcaggatgacacaaggggatggggaggcactcttggttccatcgacgggtcccctctgaccccctgacctcgctccccggacccccaggctccatcgcctacctcttcttcaccaaccggcacgaggtcaggaagatgacgctggaccggagcgagtacaccagcctcatccccaacctgaggaacgtggtcgctctggacacggaggtggccagcaatagaatctactggtctgacctgtcccagagaatgatctgcaggtgagcgtcgcccctgcctgcagccttggcccgcaggtgagatgagggctcctggcgctgatgcccttctctcctcctgcctcagcacccagcttgacagagcccacggcgtctcttcctatgacaccgtcatcagcagagacatccaggcccccgacgggctggctgtggactggatccacagcaacatctactggaccgactctgtcctgggcactgtctctgttgcggataccaagggcgtgaagaggaaaacgttattcagggagaacggctccaagccaagggccatcgtggtggatcctgttcatgggtgcgtatccacgacgctgagggctgcagagggaatggagggagcaggaaggagcttcaggaactggttagtgggctgggcatggtggctcaaagcacctgtaatcccagcactttgggaggccaaggtgggtggatcatcaagaccagcctgaccaacatggtgaaacctcgtctctactaaaaatacaaaaattagccgggtgtggtggtgggcacctgtaatcccagctgctcgggaggctgaggcaggagaatcacttgaacctgggagatggaggttgcagtgagccaagacagccccactgcactccagcctgggtgacagagtgagactccgtctcaaaaaaaaaaaaaaaaactaaacaaaaaactggttagtggctagacaacaggatggtatcttccaagcccatggctgactcagcagctcctgggtcaagacactgtgacctgtgtcccctggcaggaagcatcgcccctgccacctgcccggtgtactctgtacctgtcaggtgacatctgctacctaagcacgtgagaggtggcatttcacagtttcagtgtggtgctgacaacccgggacgcacactgtccttgcagctacaatcaggaggtgaatgttgggtttccagcagagaacactggagaaggcacacttggtgtctggaagggaaaagcagggaagagagcatcatcagatgcctgcgggtgaaggtgggcccgctatggccagcgtccctttttatttttatttatttatttatttgagatggaatctcgctctgtcgcccagactgtagtgcagtggtgcgatcacggctcactgcaagctccgcctcacaggttcacgccattctcctgcctcagcctcccgagtagctgggactacaggcacccgccaccacgcccggttaattttttgcatttttattagagacggggtttcaccgcgttagccaggatggtctaaatctcctgaccctgtgatccacccgcctcggcctccctaagtgcttggattacaagcgtgagccaccacgcccggccccctttttattttttattttttgagacggagtctcgctctgtcgcccaggctagattgcagtggcgtgatctcggctcactgcagcctccgcctcccaggttcaagtgattctcctgcctcaacctcccaactaattaggattacaagcatgtaccaccatgcctgactaattttttgtatttttagtagagactgggtttcaccatgttggctaggctggtctcgaacccttagcctcaagtaatctgcctgcctcagcctcccaaacagcggggattacaggcatgagccactgtgcccaacccaaccctggatctcttttaaacaagacaatgctcgctgttgccacagaacaatgggtggggtacatgtggcccagtgtgtttggccacataactgccaggccagagggaaagagactctcagactgtctccactcagatacaaatgtgtgtgttgtgtgcgtgtgttctggtctcatatttgtttgttttgagacagggtgtcgctctgtcactgagtctggagtgcagtggcgcaatcagagttcactgcagcctcaaactcttgggctcagttgattctcccacttcagcctcccaagtagctggaactacaggtgaacaccactgtgcccagctaatttattttatttttagtagagatgaggtctcactatgttgcccaggctggtcttgacctcctagcctcaagcaatcctcctgccttggtctcccaaagtgctgggattacacgtgcgagccattgcgcatggcttgtgttcttgtgtttcttcctttttctttcgagatggcgtctcagtctgccacccaggctggagtgcagtggtgtgatcatagctcactgtagcctcaacttcctgggctcaagcaatcctcttgatttcagcctcccgggcctggccagcatggtgaaaccccgtctctactaaaaatacaaaaatgtagccaggcgtggtggtgggcgcctgtaatcccagctacaccagaggctgaggcaggagaatcgcttgagcctggaaggtggaggttgcagcaagccaagatcgtgccactgcactccagcctgggcaacagagacagactctgtctcaaaaaaaaaaaaaaaaaacccaaacaagccacatttggagtttggggttcccagcaggactatttcccaagcctgagcctggctgtttcttccagaattcgttgcacgcattggctgggatcctcccccgccctccagcctcacagctattctctgtcctcccaccagcttcatgtactggactgactggggaactcccgccaagatcaagaaagggggcctgaatggtgtggacatctactcgctggtgactgaaaacattcagtggcccaatggcatcaccctaggtatgttcgcaggacagccgtcccagccagggccgggcacaggctggaggacagacgggggttgccaggtggctctgggacaagcccaagctgctccctgaaggtttccctctttcttttctttgttttttctttttttgagatgaggtcttggtctgtcacccaggctggagtgcactggcgcaatcgtagctcactgcagcctccacctcccaggctcaagtgatcctcctgcctcaccctcctgagtagctgagattacagacacgtgccaccacggcagactaattttattttatttttgggaagagacaaagtcttgttatgttggcctggctggtctcaaactcagggtgcaagcgatcctcccgcctcagccttccaaactgctgggattacaggcgtgggccaccgtacccagcctccttgaagtttttctgacctgcaactcccctacctgcccattggagagggcgtcacaggggaggggttcaggctcacatgtggttggagctgcctctccaggtgcttttctgctaggtccctggcagggggtcttcctgcccggagcagcgtggccaggccctcaggaccctctgggactggcatcagcacgtgacctctccttatccacttgtgtgtctagatctcctcagtggccgcctctactgggttgactccaaacttcactccatctcaagcatcgatgtcaacgggggcaaccggaagaccatcttggaggatgaaaagaggctggcccaccccttctccttggccgtctttgaggtgtggcttacgtacgagatgcaagcacttaggtggcggatagacacagactatagatcactcaagccaagatgaacgcagaaaactggttgtgactaggaggaggtcttagacctgagttatttctattttcttctttctttttttttttttttttgagacagagttttgctctcgtttcccaggctggagggcaatggcatgatctcggctcaccgcaacctccacctcccaggttcaagtgattctcctgtctcaggctccccagtagctgggattacaggcatgcaccaccaccatgcccggctaattttgtatttttagtagagacggagtttctccatgttggtcaggctggtctcgaactcccgacctcaggtgatctgcctgcctcggcctcccaaagtgctgggattacagacttgagccaccgcgcccagctatttctgttttctttctttcttcttcttctttttttttttctaagagacaggatctcactctgtccccaggcaggagtgcagtgctgtgatcatagctcactgcagccttaacctcctgggctcaagtgatcttcccacctcagcctcccaagtagctggaactacaggtgcacaccaccatgcccagctcatttttgtattttttttttttttgagacagtctcgttctgtcaccccggctggagtgcagtggtacaatcttggctcactgcaacctctgcctcccaggttcaagcgattctcctgcctcagcctcctgagtagttgagattacaggcatgtgtgccatcatacctggctgatttttgtatttttttttagagatggggtctcagtatgttgaccaggcttgtcttaaactcccggcctcaagtgatcctcccacttcagtctcccaaagtgctgggattacaggcatgagccactgcggccggtttgttttcttttttttttcgttttttggagacggaatttcacctttgttgcccaggatggagtgcaatggcacgatatcgcctcaccacaacctctgcctcctgggttcaaaccattttcctgcctcagccttcttagtagctgggattacaagcatgtgccaccacgcccggctgattttgtatttttagtagagatggggtttctccatgttggccaggctggtctcgaactcctgacctcaggtcattcgcccacctctgcctcccaaagtgctgggattacaggcgtgagccaccgtgcccggtggtttgtattctttttactgagagtcgtgaaaggcagtgatcctctgtcacatgtgatcttggctctcaggggacatttggcaatttctagagattttttggttgtcacaagtcaatggggaagactgttggcatttagtgggtagaggctggtgacgctgctgaacacccagaacagggaagtagcaggccctagatagagccatcgtggggaaaccctgctctaaggaaatggcgctattttataaccccacgttcctggcatgattaccaacagccaaaagtggagtccccccaagtgtgttcgtccatttgcattgcagtaaaggaatagctgaggccgggtaatttataaagaaaagagatttaaactgggtatggcagtttatgcctataatcccagaactttgggaggctgaggcaggaggatcgcttgagtccaggagtgtgagaccgagaccagcctggccaacatgacgaaactctgtctctacaaaaaatacaaaaagtaggccaggcacggtggttcacgcctgtaatcccagcactttgggaggccgaggcgggcggatcacgaggtcaggagatcgagaccatcctggctaacacggtgaaaccccgtctctactaaaaatacaaaaacaaaattagccgggtgtggtggcaggcgcctgtagtcccagctactcgggaggctgaggcgggagaatggcgtgaacccgggaggcggagcttgcagtgagccaagatcgcgccactgcactccagcctgggtgaccgagttgagactccgtctcaaaaaaaaaaaaaaaaaaaaaaatacaaaaagtagccaggtgtggtggcaggcacctgtaatcctgggttctcgagaccgaggcatgagaattgcctgaccccaggaggtggaggctgcagtgagccaagatcatgccactgcactccagcctgggcgacagagtgggactctgtctcaaaaaacaacaaaaaaaaagttctggaaatggatggtggtgatggtgatacttccacaacagcgtgaatctgcttaaggccaccgaactgtgcactcacaaatagtcgagatggtacattttatgttatgtgtatttcaccacaattaaaaactagttgtgggccaggtgtggtggttcatgcctgtaatcccagcactttgggaggtcagagggaggtggatcatgaggtcagcagttcgagaccagccaggccaacatggtgaaaccccatctctactaaaaatacaaaaattagccaggcgtggtggcacatgcctgtagtcccagctacttgagaggctgaagcaggagaatcgcttgaacctgggaggctaagattgcagtgagccgagatcgtgccactgcactccagcctggacgacagagtgagacttcgtctcaaaaaaaaaaccaaaaaaaaaattagctgtgggtcaggcactgtggctcacgcctgtaatcccagcactttgggagaccgaggtaggtggatggcctgaggtcaggagttcgaatccagcctggccaacatggtgaaagcccgtctctactaaaaatacaaaaaattagtcaggtatgttggcacacctgtaatcccagctactcgggaggctgaagcaagagaatcgtttgaacccaggaggtggacgttgcagtgagccgagattgggccactgtactccagcctgggcaacaaaagtgaaactctgtctgaaacaaacaaacaaacaaacaaacagacaaacaaaaaaactagttgtggagagagggtggcctgtgtctcatcccagtgtttaacgggatttgtcatcttccttgctgcctgtttaggacaaagtattttggacagatatcatcaacgaagccattttcagtgccaaccgcctcacaggttccgatgtcaacttgttggctgaaaacctactgtccccagaggatatggttctcttccacaacctcacccagccaagaggtaagggtgggtcagccccacccccccaaccttgaaacctccttgtggaaactctggaatgttctggaaatttctggaatcttctggtatagctgatgatctcgttcctgccctgactccgcttcttctgccccaggagtgaactggtgtgagaggaccaccctgagcaatggcggctgccagtatctgtgcctccctgccccgcagatcaacccccactcgcccaagtttacctgcgcctgcccggacggcatgctgctggccagggacatgaggagctgcctcacaggtgtggcacacgccttgtttctgcgtcctgtgtcctccaactgccccctcctgagcctctctctgctcatctgtcaaatgggtacctcaaggtcgttgtaaggactcatgagtcgggataaccatacttttcttggatggacacatcagcaccgggcttgacatttacccagttcccctttgatgcctggtttcctctttcccggccccctgaagaggtgatctgatttctgacaggagccctgagggaggaaatggtcccctttgttgacttttctttttctttatttttttcttttgagatttgctgtcacccagcctggaatgcagtggtgccatcttggctcactgctacctctcccactgggttcaagcaattctcctgcctcagcctcccaagtagctgggattacaagcatgcgccaccatgcctggctaagttttgtatttttagtacagacagggtttctccatggtggccaggctggtcttgaactcctgacctcaggtgatcctcccacctctgcctcccgaagtgctacgattacaggcatgagccaccgcgcccatccccctttgttgacttttctcatcctctgagaaagtctcagttgaggccagcacctccctcaagtgaattgaatctcccttttgaacaacaacaaataacaatatgacccagacgtggtggctcacacctgtggtcccagctactcgggaggctgaggtgtgaggattgcttgagcccaggaggtcaaggctacagagagctataatcacaccacttcactccagcctgggggacaaagtgaaaccctgtctgaaaaaaacaaaaaaagaaaaaggaaaaagaaacaatacgatcacaaagtagatattcatagtgtttattttcagtactcttttttttttttttttttttttttgagacggagtcttgctctgttgcccaggctggagtgcagtggcacgatcttggctcactgcagcctctgcctcccaggttcaagcgcttggctcactgcaacctccgcctcctgggttcaagcgcttcttctgcctcagcctccccagtagctgggactataggcacgtcccactacgcccagctaattttttgtattttttagtagagatggggtttcactatgttagccaggatggtctcgatctcctgacctcgtgatctgcctgccttgggctcccaaagtgttgggattatgggcatgagccactgcacctggccttttttttttttttttttgagatggagtttcgctcttgttgcccaggctggagtgcaatggtgtgatctcggctcactgcaacctctgcctcctgggttcaagcaattctcctgcctcagcctcccgagtagctgggattacaggcacctgccaccacgcctggctaatttttgtacttttagtagagacggggtttctccatgttggtcaggctggtctcaaactcctgacctcaggtgatccacccacctcggcctcccaaagttctgggattacagacatgagccaccgcgcctggccgtgtctggccttttttagttatttcttttttttttttttttttttttgagacagagtcttactccgtcgcccaggctggagtgcagcggtgcgatgtctgcgcactgcaagctccgccccctgggttcatgccattctcctgcctcagccttctgagtagctgggactgcaggcgcctgccactacgcccggctacttttttgtatatttagtagagatggagtttcactgtgttagccaggatggtctcgatctcctgactttgtgatccgcccgcctcggcctcccaaagtgctgggattacaggcgtgagccaccatgccaggcttttttttttttttttttttttgagacggagtcttgctctgtcgcccaggctggagtgcagtgccatgatctcagctcactgcaagctccacttcccaggctcacgccattctccagcctcagcctcccaagtagctgagactacaggggcccgccaccacactcggctaatttttttgtatttttagtagagacggggtttcaccatgttagccaggctggtcttgaactcctaacctcaggcgattcacctgcctcggcctcccaaagtgctgggattaaaggtatgagccacctcgcctggtgtgagccacctcgcccagcctgagccacctcacccagcctaagccactgtgcctggcctgattttggactttttaaaaattttattaataattatttttgggtttcttttttttgagacagggtcttactctgtcatccaggccatcctgtctgtctgtcatcccagtgatgggatcataccttgctgcagcctctacctcctgggctcaagcgatcctcccccctcagcctcctgagtagctgggagtacaggtgtgcaccaccacacctggctaatttttttttttttttttgtatatagagatggtattttgccatgttgaccaggctagtcttaaactcctggactcactcaagagatcctcctgccttggcctcccaaggtcatttgagactttcgtcattaggcgcacacctatgagaagggcctgcaggcacgtggcactcagaagacgtttatttattctttcagaggctgaggctgcagtggccacccaggagacatccaccgtcaggctaaaggtcagctccacagccgtaaggacacagcacacaaccacccgacctgttcccgacacctcccggctgcctggggccacccctgggctcaccacggtggagatagtgacaatgtctcaccaaggtaaagactgggccctccctaggcccctcttcacccagagacgggtcccttcagtggccacgaacattttggtcacgagatggagtccaggtgtcgtcctcactcccttgctgaccttctctcacttgggccgtgtgtctctgggccctcagtttccctatctgtaaagtgggtctaataacagttcttgccctctttgcaaggattaaatgggccaaatcatatgaggggccaggtccttcaggctcctggttcccaaagtcagccacgcaccgtgtgggtcccaaaattttatcaaggcacattcgttgcctcagcttcaggcatctgcccaaaaaggccaggactaaggcaaggagagggagggattcctcagtactcagcttttcacagaggctccaaaaggctaaggaatccagtaacgttttaacacaattttacaatttttttttttgagacggagttttgctcttgttgcccaggctggagtgcagtggcacgatctcggctcactgcaacctctggctcccgggttcaagcgattctcctgcctcagtctcccgagtagctgggattacaggcatgcgccaccacgctcggctaattttgtatttttagtacagaaggggcttctctgttggtcaggctggtcgtgaactctcaacctcaggtgagccacccgcctgagcctcccaaagtgctgggattacaggtgtgagccaccacgcctggccttttttttgagacagagtctcgctctcgcccatgctgtactgcagtgacgcagtctgggctcactgtaacctccgcttcccaggttcaagtgattcttctgccgcagcctcccatgtagagtagctgggattacaggcacccgccaccatgcctggctaattcttgcatttttagtagagatggggtttcacagtgttggccaggctggtctcaaacttctgacctcaagtcatctgcctgccttggccctgccaaagtgctgggattatagatgtgagccaccgcgcctggcctacagtttattctttggtggctcacacctgtaatctcagcactttgggaggccaaggtgggagaatggcttgagcccaggagttcaagtccagcctgggcaacatagcaagaccctatctctactacaaaataaataataaataaactaattttttttcttttaaaacccaactattcaacatggcaatgcaatatattaaaaaaattttttttttctttgaaacggagtctctcactgtcacccgggctggagtgcagtgtcgccatcttggctcactgcaacctccgcctcccaggtccaagtgattctcctgcttcagcctcccgagtagctgggattacaggcacccaccaccatacccagctaatatttttgtatttttagtagagatggggtttcactatgttgggcaggctggtctggaactcctgacctcgtgatctgcccgaggatcggcggcctcccaaagtgctggggattgcaggcatgagccaccgtgcccagccaaaacttttttatttttatttttttgggacacggtctcactgtgtaccccagactggagtgatagagtgctgtcatggctcactgcagcctcaacctccctgggctcaggtgatcttcctgcttcagtctcccaggtagctgggactacaggcatgagccaccacacccagctaatttttgaatttttttgtagagacagggtttcaccttgtggcccagacttgtctctaactccagggctcaagcgatctgcccaccttggcctcccaaagtgctgagattaatgcaatttaaaaaattttttggccaggcctggtggctcatgcctgtattcacaacaccttgggaggcaaaggtgggcagatcacttgaggtcaggagttcgagactagcctggccaacatggtgaaaccccctgtctactaaaaaaatacaaaaattacctgggcacagtggtgggtgcctgtaatcccagctacttgggatgctgagggtggagaattgcttgaacctgggaggcagaagttgcagtaagccaagatcatgccactggactccagcctcagtgacagagcaaaactctgtctccaaaaaaattgttttttttttttttttttcaaatcatcacactacagccaaggcctggccacttacttttgtaaataaagttttattggagccagtggaccagtgaggccgaatcttgcaggtgtaagatcacagtctatccttgaaaattttgatattttgttcattgggtggtttttcattaatttaaattttaaaaaataacatattaaaggctggtgtggaggtgcacgcctgcagtcctagctactcccagaggctgaggcgggagacttgcttgagcccaagagttgaagtccagcctgggcaacatagcgagacccccatctctaaaaataaaaataatgcattagaatattattggattcctgggcagggcacagtggctcacacctgtaatcccagcactttgggaggctgaggtgggtggatcacctgaggtcaggagtttgagaccagcctggccaacatggtgaaaccccgtctctactaaaaatacaaaaattagccaggcgtggtggcaggtgcctgtaatcccagctactcgggaggctgaagcacgagaatcgcttgaatccaggaggcggaggttgcagtgagctgagattgcgccattgcactccagcctggaggacaagagtgaaactccattcccctctgcaaagaaaaggaatattatcagattcctaagctttttggctccccctttagtttgggggctggggtggtgagtgtctgacctggcctcactgtcctccctggatgtgatgagacccaggtgtgggtcaggatgtcattcgtttgtccaccagagggcgcccaaactgctttgagctgctgggaaatggtgctcctagacttttagcaaacaaacaaaaaaaaatggcacatcggcaaatttcagaccattctttttttttttttttttggttccagagtagctgaaatctttgttcagttacaagcaggataaaatggaaactgcctgggagaggctgagaaaccttcttgcttgggggaggtggggcactgctagaattaatcgcttcacagaccagcccatccaggactcctcaaatttggcaaaaaagccattcattcattcattcatttatgtagagacgagggggatctggctatattgcctagattggtctcaaattcctggcctcaagtgatcctcctgccttggtctactaatgtgctgcgattacaggcatgagccaccgtgcctagctctagtggacttgaaatgttgccttgcccagggcccttatgttgaatggcccaggtccacttgtatggttctgtaccaaggttaaccccatcccataatgcctgggacagttgatgcaggacaatcagcttctgtgccattcaacctcaggactgagcatgctgggcattgtggggtccgaaggtggctcccctgtccccttcaaaataccctctttttcttttcttcttttttttttttttttttttttgagacgaagtcttgctctgttgccccagctagagtgcagtggtgcgatctcagctccccgcaacctctgcttcccgggttcaggcgattctcctgcctcagcctcctgagtagctgggattacaggtgcccaccgccacagctggctaatttttgtatttttagtagagacagggtttcaccgtgttggccaggctggtcttgaactcctgacctcaggcaacctgcccacctcagcctcccaaagtgctgggattacaggtttgagccactgggcctggccttttttttttttttttgagagggagtctcactctgttgcccaggctggagtgcaatggcgcgatcttgactcactgcaactccatttcccgggttcaagtgattctcctccctcagcctcccaagtagctgggattacaggtgcatgccaccacggccagctaattttgtatttttagtagagacagggtttcactatgttgatcatgctggtctcaaactcctgaccttaggtgatctgcccgccttagcctcccaaagtgttgggattacaggtgtgagccaccgcgcccagaccaaaatatgctcattttaataaaatgcacaagtaggttgacaagaatttcacctgcaaccttgtcaaccacctagaataaaagcctctgcagccctcccctaaagactcatcaatgtgaggctcaagaaccttcttaggctgggctcggtggctcatttctgtaatccctgcactttggaaggctgaggcaggaggatctcttgaggccaggagttcaagacaagcctgggcaacatagccagacctctgtttctatcccccacaaaaagaaccttcttaaaccggaattgagtcctacaacctcgataactcacaaataagcccgtgtggcctctcacagacttgggaagttctccaagtgtccagggagatgtgccaggcgctttcctgccgtgaccaccgtcctctgcctgctccatttcttggtggccttcctttagacctgggcctcactcttgcttctctcctgcagctctgggcgacgttgctggcagaggaaatgagaagaagcccagtagcgtgagggctctgtccattgtcctccccatcggtaagcgcgggccggtcccccagcgtcccccaggtcacagcctcccgctatgtgacctcgtgcctggctggttgggcctgttcactttttctcctggacagggaacagccccactggtgtcctttatcacccccacggcctctcctggcttggggctgacagtgacaagatcagacagctaaggggtcagatggaggatgtggagctgggtcccgtgctgtggaatagcctcaccgagatttgagtgccttctggggaactggttcccttgcagggggctgtgtggagaggcgcgctctccctgcctcacccatgctcatcctaactcggttaccatcacatctcttttttctttttttcttaaattttaagaaaaaagaaatttaatttttttgagagacagagtcttgctctgtcacccaggctggagtgcagtggcaccatcatgcctcgctgcagcctcaatgtctgggctcaagcgatcctcccacctcagcctcctgagtagctggtgcaagccactataccccacttcctatttcttaaaaagtcacagccctgtgtgtggctaatcctggacagaaatctagaagaagtcagctacttctggggcgtggctcacccagtgggcttcaggttagatatttcttatacttatgaggctgggtgtggtggcttatgcctgtaatcccagcactttgggaggctgaagtgggtggattgcttgggctcaggagttcgagaccaacctgggcaacatggcgaaaccctgtttctagaaaaggtacaaaaattagctgggcaggtggcacgtgcctgtggtaccagctacttgagggcctgaggcaggaggatcgcttgaacctgggaggtcgaggttgcagtgaactgagatcatgtcactgcactccagcctggtgacagagcaagaccccgtctcaaaaaaaaaaaaagaaagaaaaaaattcttatgcatagatttgcctcttttctgtttgtttgttttgagatggagtctcgctctgtcgcccaggctggagtacagtggctcaacctcggctcactgcaacctctgcctcccgggttcaagcaattctcctgcctcagcctcctgagtagctgggactacaggcgcccgccaccatgcccagctaatttttgtatttttagtagagactgactgggtttcatcatgttggccaggctggtctcgaactcttgacctcatgatccgcccgcctcagcctcccaaaatgctgggattacaggcgtgagccaccaggcccaggccgcaaggcgatctctaaacaaacataaaagaccaggagtcaaggttatggtacgatgcccgtgttttcactccagccacggagctgggtctctggtctcgggggcagctgtgtgacagagcgtgcctctccctacagtgctcctcgtcttcctttgcctgggggtcttccttctatggaagaactggcggcttaagaacatcaacagcatcaactttgacaaccccgtctatcagaagaccacagaggatgaggtccacatttgccacaaccaggacggctacagctacccctcggtgagtgaccctctctagaaagccagagcccatggcggccccctcccagctggaggcatatgatcctcaagggaccaggccgaggcttccccagccctccagatcgaggacagcattaggtgaatgcttctgtgcgctcattcagaatgtcagcggacaatggccttggtggtgtagaggaatgttggataagcaaatagagagctccatcagatggtgacagggcaaagaaagtcaaaaggagttcagaggccgggcgcggtggctcatgcctgtaatcccaggactttgggaggccgaggctggcggatcacctgaagtcaggagtttgagaccagcttggccatcatgacaaaaccccgtctctattaaaaatacaaaaaattagccaggcgtgggagtgggcgcctgtaatcccagctactcgggaggccgaggtagaaaaatcgcttgaacctaggaggcagaggttgcagtgagccgagatcgcgccactgcattccagcccgggaggcaagagcaaaactccatctcaaaaaaaaaaaaaaaaggagttcagaggcccggcatggtggttcacacatgtgatcccagaacttggggaggttgaggcaggagaatcacctgagctcagagttcaagaccagcctgggcagcacagcaagaccccatctctgcaaaaaataaaaatttagcccagtgtggtgatgagcgcctagttccagctactagggaggctaaggcaggaggattgcttgaggctaaggtaggagattgagactgcagtgacttgtgattgcgtcactgcgctccagcctgggtgacagagcaagcccttgtctcttaaaaaaaaaaaaaaattcaaagaagggtttccagagggccaggagggaggaagggagaggaggtgttttatttttttgcttttattttttattttgagacagagtctctctctgtcacccaggttggagtgcagtgctgtgatcttggctcactgcaacttctgcctcctgggttcaagcaattcttatgcctcagcctcagcctcctgagtagctgggattacaacactatgcccgggtaatttttgtatttttagtagagacgaggtttcgccatgttgcccagactggtctcgaactcctgacctcaagtgatccacccgccttggcctccccacgtgctgggattgcaggcgtgagccactgcgcccgccttgatctttacacaaggggtttagggtaggtagccttctctgaaccaggagaacagcctgtgcgaaggccctgaggctggaccgtgcctgttgggtttgaggccgttgtagctggagcaaacagagagaggggtaaaaaggcaggaggctaccaggcaggttgtgcagagccttgtgggccactggggaggactttggcttttgccctgagagcggtgggaagtgactgaatccggtactcaccgtctccctctggcggctcctgggggaacatgcttggggatcaggctgggggaggctgccaggcccaggaggtgagaagtaggtggcctccagccgtgtttcctgaatgctggactgatagtttccgctgtttaccatttgttggcagagacagatggtcagtctggaggatgacgtggcgtgaacatctgcctggagtcccgtccctgcccagaacccttcctgagacctcgccggccttgttttattcaaagacagagaagaccaaagcattgcctgccagagctttgttttatatatttattcatctgggaggcagaacaggcttcggacagtgcccatgcaatggcttgggttgggattttggtttcttcctttcctcgtgaaggataagagaaacaggcccggggggaccaggatgacacctccatttctctccaggaagttttgagtttctctccaccgtgacacaatcctcaaacatggaagatgaaaggggaggggatgtcaggcccagagaagcaagtggctttcaacacacaacagcagatggcaccaacgggaccccctggccctgcctcatccaccaatctctaagccaaacccctaaactcaggagtcaacgtgtttacctcttctatgcaagccttgctagacagccaggttagcctttgccctgtcacccccgaatcatgacccacccagtgtctttcgaggtgggtttgtaccttccttaagccaggaaagggattcatggcgtcggaaatgatctggctgaatccgtggtggcaccgagaccaaactcattcaccaaatgatgccacttcccagaggcagagcctgagtcactggtcacccttaatatttattaagtgcctgagacacccggttaccttggccgtgaggacacgtggcctgcacccaggtgtggctgtcaggacaccagcctggtgcccatcctcccgacccctacccacttccattcccgtggtctccttgcactttctcagttcagagttgtacactgtgtacatttggcatttgtgttattattttgcactgttttctgtcgtgtgtgttgggatgggatcccaggccagggaaagcccgtgtcaatgaatgccggggacagagaggggcaggttgaccgggacttcaaagccgtgatcgtgaatatcgagaactgccattgtcgtctttatgtccgcccacctagtgcttccacttctatgcaaatgcctccaagccattcacttccccaatcttgtcgttgatgggtatgtgtttaaaacatgcacggtgaggccgggcgcagtggctcacgcctgtaatcccagcactttgggaggccgaggcgggtggatcatgaggtcaggagatcgagaccatcctggctaacacgtgaaaccccgtctctactaaaaatacaaaaaattagccgggcgtggtggcgggcacctgtagtcccagctactcgggaggctgaggcaggagaatggtgtgaacccgggaagcggagcttgcagtgagccgagattgcgccactgcagtccgcagtctggcctgggcgacagagcgagactccgtctcaaaaaaaaaaaacaaaaaaaaaccatgcatggtgcatcagcagcccatggcctctggccaggcatggcgaggctgaggtgggaggatggtttgagctcaggcatttgaggctgtcgtgagctatgattatgccactgctttccagcctgggcaacatagtaagaccccatctcttaaaaaatgaatttggccagacacaggtgcctcacgcctgtaatcccagcactttgggaggctgagctggatcacttgagttcaggagttggagaccaggcctgagcaacaaagcgagatcccatctctacaaaaaccaaaaagttaaaaatcagctgggtacggtggcacgtgcctgtgatcccagctacttgggaggctgaggcaggaggatcgcctgagcccaggaggtggaggttgcagtgagccatgatcgagccactgcactccagcctgggcaacagatgaagaccctatttcagaaatacaactataaaaaaataaataaatcctccagtctggatcgtttgacgggacttcaggttctttctgaaatcgccgtgttactgttgcactgatgtccggagagacagtgacagcctccgtcagactcccgcgtgaagatgtcacaagggattggcaattgtccccagggacaaaacactgtgtcccccccagtgcagggaaccgtgataagcctttctggtttcggagcacgtaaatgcgtccctgtacagatagtggggattttttgttatgtttgcactttgtatattggttgaaactgttatcacttatatatatatatatacacacatatatataaaatctatttatttttgcaaaccctggttgctgtatttgttcagtgactattctcggggccctgtgtagggggttattgcctctgaaatgcctcttctttatgtacaaagattatttgcacgaactggactgtgtgcaacgctttttgggagaatgatgtccccgttgtatgtatgagtggcttctgggagatgggtgtcactttttaaaccactgtatagaaggtttttgtagcctgaatgtcttactgtgatcaattaaatttcttaaatgaaccaatttgtctaa

SEQ ID NO: 4 - DNA, 5265 bp, Homo sapiens
acatttgaaaatcaccccactgcaaactcctccccctgctagaaacctcacattgaaatgctgtaaatgacgtgggccccgagtgcaatcgcgggaagccagggtttccagctaggacacagcaggtcgtgatccgggtcgggacactgcctggcagaggctgcgagcatggggccctggggctggaaattgcgctggaccgtcgccttgctcctcgccgcggcggggactgcagtgggcgacagatgcgaaagaaacgagttccagtgccaagacgggaaatgcatctcctacaagtgggtctgcgatggcagcgctgagtgccaggatggctctgatgagtcccaggagacgtgcttgtctgtcacctgcaaatccggggacttcagctgtgggggccgtgtcaaccgctgcattcctcagttctggaggtgcgatggccaagtggactgcgacaacggctcagacgagcaaggctgtccccccaagacgtgctcccaggacgagtttcgctgccacgatgggaagtgcatctctcggcagttcgtctgtgactcagaccgggactgcttggacggctcagacgaggcctcctgcccggtgctcacctgtggtcccgccagcttccagtgcaacagctccacctgcatcccccagctgtgggcctgcgacaacgaccccgactgcgaagatggctcggatgagtggccgcagcgctgtaggggtctttacgtgttccaaggggacagtagcccctgctcggccttcgagttccactgcctaagtggcgagtgcatccactccagctggcgctgtgatggtggccccgactgcaaggacaaatctgacgaggaaaactgcgctgtggccacctgtcgccctgacgaattccagtgctctgatggaaactgcatccatggcagccggcagtgtgaccgggaatatgactgcaaggacatgagcgatgaagttggctgcgttaatgtgacactctgcgagggacccaacaagttcaagtgtcacagcggcgaatgcatcaccctggacaaagtctgcaacatggctagagactgccgggactggtcagatgaacccatcaaagagtgcgggaccaacgaatgcttggacaacaacggcggctgttcccacgtctgcaatgaccttaagatcggctacgagtgcctgtgccccgacggcttccagctggtggcccagcgaagatgcgaagatatcgatgagtgtcaggatcccgacacctgcagccagctctgcgtgaacctggagggtggctacaagtgccagtgtgaggaaggcttccagctggacccccacacgaaggcctgcaaggctgtgggctccatcgcctacctcttcttcaccaaccggcacgaggtcaggaagatgacgctggaccggagcgagtacaccagcctcatccccaacctgaggaacgtggtcgctctggacacggaggtggccagcaatagaatctactggtctgacctgtcccagagaatgatctgcagcacccagcttgacagagcccacggcgtctcttcctatgacaccgtcatcagcagagacatccaggcccccgacgggctggctgtggactggatccacagcaacatctactggaccgactctgtcctgggcactgtctctgttgcggataccaagggcgtgaagaggaaaacgttattcagggagaacggctccaagccaagggccatcgtggtggatcctgttcatggcttcatgtactggactgactggggaactcccgccaagatcaagaaagggggcctgaatggtgtggacatctactcgctggtgactgaaaacattcagtggcccaatggcatcaccctagatctcctcagtggccgcctctactgggttgactccaaacttcactccatctcaagcatcgatgtcaacgggggcaaccggaagaccatcttggaggatgaaaagaggctggcccaccccttctccttggccgtctttgaggacaaagtattttggacagatatcatcaacgaagccattttcagtgccaaccgcctcacaggttccgatgtcaacttgttggctgaaaacctactgtccccagaggatatggttctcttccacaacctcacccagccaagaggagtgaactggtgtgagaggaccaccctgagcaatggcggctgccagtatctgtgcctccctgccccgcagatcaacccccactcgcccaagtttacctgcgcctgcccggacggcatgctgctggccagggacatgaggagctgcctcacagaggctgaggctgcagtggccacccaggagacatccaccgtcaggctaaaggtcagctccacagccgtaaggacacagcacacaaccacccgacctgttcccgacacctcccggctgcctggggccacccctgggctcaccacggtggagatagtgacaatgtctcaccaagctctgggcgacgttgctggcagaggaaatgagaagaagcccagtagcgtgagggctctgtccattgtcctccccatcgtgctcctcgtcttcctttgcctgggggtcttccttctatggaagaactggcggcttaagaacatcaacagcatcaactttgacaaccccgtctatcagaagaccacagaggatgaggtccacatttgccacaaccaggacggctacagctacccctcgagacagatggtcagtctggaggatgacgtggcgtgaacatctgcctggagtcccgtccctgcccagaacccttcctgagacctcgccggccttgttttattcaaagacagagaagaccaaagcattgcctgccagagctttgttttatatatttattcatctgggaggcagaacaggcttcggacagtgcccatgcaatggcttgggttgggattttggtttcttcctttcctcgtgaaggataagagaaacaggcccggggggaccaggatgacacctccatttctctccaggaagttttgagtttctctccaccgtgacacaatcctcaaacatggaagatgaaaggggaggggatgtcaggcccagagaagcaagtggctttcaacacacaacagcagatggcaccaacgggaccccctggccctgcctcatccaccaatctctaagccaaacccctaaactcaggagtcaacgtgtttacctcttctatgcaagccttgctagacagccaggttagcctttgccctgtcacccccgaatcatgacccacccagtgtctttcgaggtgggtttgtaccttccttaagccaggaaagggattcatggcgtcggaaatgatctggctgaatccgtggtggcaccgagaccaaactcattcaccaaatgatgccacttcccagaggcagagcctgagtcactggtcacccttaatatttattaagtgcctgagacacccggttaccttggccgtgaggacacgtggcctgcacccaggtgtggctgtcaggacaccagcctggtgcccatcctcccgacccctacccacttccattcccgtggtctccttgcactttctcagttcagagttgtacactgtgtacatttggcatttgtgttattattttgcactgttttctgtcgtgtgtgttgggatgggatcccaggccagggaaagcccgtgtcaatgaatgccggggacagagaggggcaggttgaccgggacttcaaagccgtgatcgtgaatatcgagaactgccattgtcgtctttatgtccgcccacctagtgcttccacttctatgcaaatgcctccaagccattcacttccccaatcttgtcgttgatgggtatgtgtttaaaacatgcacggtgaggccgggcgcagtggctcacgcctgtaatcccagcactttgggaggccgaggcgggtggatcatgaggtcaggagatcgagaccatcctggctaacacgtgaaaccccgtctctactaaaaatacaaaaaattagccgggcgtggtggcgggcacctgtagtcccagctactcgggaggctgaggcaggagaatggtgtgaacccgggaagcggagcttgcagtgagccgagattgcgccactgcagtccgcagtctggcctgggcgacagagcgagactccgtctcaaaaaaaaaaaacaaaaaaaaaccatgcatggtgcatcagcagcccatggcctctggccaggcatggcgaggctgaggtgggaggatggtttgagctcaggcatttgaggctgtcgtgagctatgattatgccactgctttccagcctgggcaacatagtaagaccccatctcttaaaaaatgaatttggccagacacaggtgcctcacgcctgtaatcccagcactttgggaggctgagctggatcacttgagttcaggagttggagaccaggcctgagcaacaaagcgagatcccatctctacaaaaaccaaaaagttaaaaatcagctgggtacggtggcacgtgcctgtgatcccagctacttgggaggctgaggcaggaggatcgcctgagcccaggaggtggaggttgcagtgagccatgatcgagccactgcactccagcctgggcaacagatgaagaccctatttcagaaatacaactataaaaaaataaataaatcctccagtctggatcgtttgacgggacttcaggttctttctgaaatcgccgtgttactgttgcactgatgtccggagagacagtgacagcctccgtcagactcccgcgtgaagatgtcacaagggattggcaattgtccccagggacaaaacactgtgtcccccccagtgcagggaaccgtgataagcctttctggtttcggagcacgtaaatgcgtccctgtacagatagtggggattttttgttatgtttgcactttgtatattggttgaaactgttatcacttatatatatatatatacacacatatatataaaatctatttatttttgcaaaccctggttgctgtatttgttcagtgactattctcggggccctgtgtagggggttattgcctctgaaatgcctcttctttatgtacaaagattatttgcacgaactggactgtgtgcaacgctttttgggagaatgatgtccccgttgtatgtatgagtggcttctgggagatgggtgtcactttttaaaccactgtatagaaggtttttgtagcctgaatgtcttactgtgatcaattaaatttcttaaatgaaccaatttgtctaaa

SEQ ID NO: 5 - DNA, 7509 bp, Homo sapiens
ggtaggggccccctttgcttccctggtggccactggattgtgtttctttggggtggcactgttctgtggctgtggacatgaagccctcactggcacagaaaagctaattgagacctatttctccaaaaactaccaagactatgagtatctcatcaatgtgtaagtacctgccctcccacacagacccatcttttttttccctctctccatcctggagatagagaactcttcagtaccttagtaactagcaggggactggggtggagccagaccggattcccgagtcttccctctgtgcagatctctcctgctccacattcgaagcccattcagaaaggaggggtctgcctgcctgcctgtcagcccctcccacccccgcccccttgttttcttacacgtgttctgacttctgctaggtgtggttcatattgcccaagttggagcctccagcgtagtaggtatggagaagccaagggaggcactaagcctctcctgttcctagaacaagttaggctcctgttccttcacccacctttcttcttgtctagctccctactcctgtgagttagcatgtctgaagggtggggcagggagagtaggtccctggttctccaggtcccagggtaagcaaggtgtggcgggaggggcatatgtttctggtcacatacaccctgtcttcacttatttcaacaaagataaggtgaaagcatgcaggaggaacctggtgattcctctagaaaatccctagccttgttaaggtgctcgctctggtgtatacctcacttatgtcgggaaagaagccaggtcttcaattaataagattccctggtctcgtttgtctacctgttaatgcaggatccatgccttccagtatgtcatctatggaactgcctctttcttcttcctttatggggccctcctgctggctgagggcttctacaccaccggcgcagtcaggcagatctttggcgactacaagaccaccatctgcggcaagggcctgagcgcaacggtaacagggggccagaaggggaggggttccagaggccaacatcaagctcattctttggagcgggtgtgtcattgtttgggaaaatggctaggacatcccgacaaggtgatcatcctcaggattttgtggcaataacaaggggtgggggaaaattgggcgcgagtctgtggcctcgtccccacccaaggctgggtcctctctaggggcctggcatttgagtgaggaagcgatggctgcagccgaacgagaaggtcaggaagaacgtggtgcccagctggcttagcctcacctttcaaaggttccctaagcaaatttcttctcaaaacagaaagcatgagttttgtgggatgctttgtacaatcagaccatttctaagccatctgttggtatccctttgttcccttcctagtaggtaccacaagagtggatctaactggacaagagtctaaaatgctgctcatgtgattgagacttgggcacctgatctgagagggaggatggataataaaaattaaataattaactccaaggtgaaatttacaatgttctgggatcctgcacagttcgaggtcccagagggaattggagtagatctgcatgttgaatgttttattgcctgagggttatccatgctttgagtgaggtgcacatttgttttcagtctctggagttaaagatcctttggcggctgaacatgtgtgggttccagcaatgtctttttgtggccagcagttagcttagaaaggttttgtatctgaaattttaatctcctattggctttgttcaatggctagggaacaaaaatgttcctatggcaaggaacatgttctaagctcagcctaaggcacaaaatggcacgactttctttcaagatctgttttgatttctttacaccttatctgcccaaaaacatcctctgaagcctctctaacccagggatcctcctcactcttcccctacccattccccccaccctccgttatactggggccagttatctagtagatactgccaattacccttggcagaggtgccctgctcactaatttcatttgaaggagagccctggaacctggttttaatgtctggcacacgccactccaggatctcccagtttgtgtttctacatctgcaggctgatgctgatttctaaccaccccatgtcaatcattttagtttgtgggcatcacctatgccctgaccgttgtgtggctcctggtgtttgcctgctctgctgtgcctgtgtacatttacttcaacacctggaccacctgccagtctattgccttccccagcaagacctctgccagtataggcagtctctgtgctgatgccagaatgtatggtgagttagggtacgggtgctttggctctcctacccactatggaagcactatatatttggttattttcttagtgtaaggagggtggtgattatgagaaaaatataagatgatgaatgattgggtcttagtttattaatccttccctactgaaaccagagaggtttcttccccgggaagggaacttggaagtggtgggagttttcttggccattcacattggcctactctagttgactgctgttcacaaccccaaagcagcacatttcaataacaaacacaaggtttcaccactgttcaataccaccttctcttttttgtaaacctgtagaaaagaggatcctgattgttggtagaatccaactttacagccaggataattagagatggaagaagggctctgggggaaagtctccatgtggccccgtaactccataaagcttaccctgcttgctttttgtgtcttacttaggtgttctcccatggaatgctttccctggcaaggtttgtggctccaaccttctgtccatctgcaaaacagctgaggtgagtgggttatttgggttattttacaagggagtagctaataccatacaaattacacccatggccttcaattttaaggactgaaagtttccctttgctggattttgaattagccgattgccttctacaacatgttggctaagtgtgcctgagccaatgagcatagaaggtaaaacacctgttttctctagagttgcatagaaagacttcctttccaacccttcccctcttaaaagagaagtttgtagctttaggtaaagatagagcctaatggcaaaatcccccacatgaaaattttcattcctttagttaaaaaccatatcaagaaaatgggctgtgcacagaggcattcataggttttatgaaaacattttcaatttggaacttctttatctcaaatgagaggtaaaataagtacatttgaaagggaaagcactgtattgagaacagatattatatacaaatgaggcaggggaataaaagtaaatccgggggagacaggcagtaaattatttctttgacagcaaaatgttgactttaaattttgggcccctgggcacaactgtagggaaccagttaattattttggagtactgtactatttcatgactattctgtgatctgggtgttaatgggccaggtgctatggtgtacactgaagactgggaggcccacatttagggaagtgaaaacttagttagagatgtggaattagcacacaagaaagatatcaacacattcagaaagctgtattcatgatttacagtggagcatattactgctgttgcaagaaacagttcttcctctttcattttcctgcagttccaaatgaccttccacctgtttattgctgcatttgtgggggctgcagctacactggtttccctggtgagttgactttgaatgatcttggcaagtaaataggcctgagatagtgtgggtacagctattctgaaaggcaagaaggtagactgcttccatccttgaaatgctggagggaagcttctgggaagatagcaaagggtggaggctccgtacttctacttgcattggcaaggcagaaagacatcacaaattagatgggaacaagaaaagtggtatgaggaaagaggtaagagattcatagacacgaatgataatatttagtatttatagaacatgtaatgttgccaagtactttgcagtcataaattacggttaattctcaatacattttgatcagatcagtgacaaaacactgaaacatcacgaaacatgacttgctatagcctggaattctatatactatcaatatgaatccactttggatactctccagtggatttagttactcatatggaaatactgggaggacctcctaacattattagaattgttatgattataatacaatgctatgtcccaggtcttgctgatagtgctacagtgccctgtgaatgtagtgtgctcattgtgcagattaaaaacctaaggcactgaagggtgaagtgatttatctgaagttattttataagcagtgatcagacaagatgagctcacagaactcctggcccctactgctgaggtttccatacagagtcaagtaatttctcaccttgtaaaacgaattgattcattaaccaggggagagctctactgcatgatgtggctgtgtgtctacagcaagcaccctatgactctaagtcactcggacatattgatgtggcaaagccaaatattgttcacttccctgaggaaaactcagtgctagatcaaacagaggtgtggaataaatctttatgatttgattctctgggcctgggccatgagacccatgatgcctcagagacatcggacttccagtcaagtgtatatggagaaagccaagcctgggatgtactgctttttgcagagcatgggtttttcccttatttagttatgattttatttctacccttcctcattcccaaagggatttgaggagggagtgctttcttttctactctcattcacattctctcttctgttccctacagctcaccttcatgattgctgccacttacaactttgccgtccttaaactcatgggccgaggcaccaagttctgatcccccgtagaaatccccctttctctaatagcgaggctctaaccacacagcctacaatgctgcgtctcccatcttaactctttgcctttgccaccaactggccctcttcttacttgatgagtgtaacaagaaaggagagtcttgcagtgattaaggtctctctttggactctcccctcttatgtacctcttttagtcattttgcttcatagctggttcctgctagaaatgggaaatgcctaagaagatgacttcccaactgcaagtcacaaaggaatggaggctctaattgaattttcaagcatctcctgaggatcagaaagtaatttcttctcaaagggtacttccactgatggaaacaaagtggaaggaaagatgctcaggtacagagaaggaatgtctttggtcctcttgccatctataggggccaaatatattctctttggtgtacaaaatggaattcattctggtctctctattaccactgaagatagaagaaaaaagaatgtcagaaaaacaataagagcgtttgcccaaatctgcctattgcagctgggagaagggggtcaaagcaaggatctttcacccacagaaagagagcactgaccccgatggcgatggactactgaagccctaactcagccaaccttacttacagcataagggagcgtagaatctgtgtagacgaagggggcatctggccttacacctcgttagggaagagaaacagggtgttgtcagcatcttctcactcccttctccttgataacagctaccatgacaaccctgtggtttccaaggagctgagaatagaaggaaactagcttacatgagaacagactggcctgaggagcagcagttgctggtggctaatggtgtaacctgagatggccctctggtagacacaggatagataactctttggatagcatgtctttttttctgttaattagttgtgtactctggcctctgtcatatcttcacaatggtgctcatttcatgggggtattatccattcagtcatcgtaggtgatttgaaggtcttgatttgttttagaatgatgcacatttcatgtattccagtttgtttattacttatttggggttgcatcagaaatgtctggagaataattctttgattatgactgttttttaaactaggaaaattggacattaagcatcacaaatgatattaaaaattggctagttgaatctattgggattttctacaagtattctgcctttgcagaaacagatttggtgaatttgaatctcaatttgagtaatctgatcgttctttctagctaatggaaaatgattttacttagcaatgttatcttggtgtgttaagagttaggtttaacataaaggttattttctcctgatatagatcacataacagaatgcaccagtcatcagctattcagttggtaagcttccaggaaaaaggacaggcagaaagagtttgagacctgaatagctcccagatttcagtcttttcctgtttttgttaactttgggttaaaaaaaaaaaaagtctgattggttttaattgaaggaaagatttgtactacagttcttttgttgtaaagagttgtgttgttcttttcccccaaagtggtttcagcaatatttaaggagatgtaagagctttacaaaaagacacttgatacttgttttcaaaccagtatacaagataagcttccaggctgcatagaaggaggagagggaaaatgttttgtaagaaaccaatcaagataaaggacagtgaagtaatccgtaccttgtgttttgttttgatttaataacataacaaataaccaacccttccctgaaaacctcacatgcatacatacacatatatacacacacaaagagagttaatcaactgaaagtgtttccttcatttctgatatagaattgcaattttaacacacataaaggataaacttttagaaacttatcttacaaagtgtattttataaaattaaagaaaataaaattaagaatgttctcaatcaaacatcgtgtcctttgagtgaattgttctatttgacttcacaatagaaacttaataatcgtaccttgttcaaggagatcattcatttttcagctcatccaagtcattctcataacatttctctgaaataaatagtatatgaatagattacttctacttttatagttgaagacactaagaaatagaagcaaagtaatttgcccaaagaaatccagtaagtacatgtctgagcttgtgttaaaacgcagatattgaaaccaatttattgcctacttaaaggtttcttttctcttcgaagttgggtttcagaatgttcagagtcaactatggttactttttcaataccttagtggtgccccagtccccggtgcatttagatttaagttattgttaccttctctttaaattgtttggatattccagtaatgatcccttagtaattcatacgtgactaatatttagttttatttggatagtactggatggaaggtttagtacttaa

SEQ ID NO: 6 - DNA, 3038 bp, Homo sapiens
tcaatcagaaagcccttttcattgcaggagaagaggacaaagatactcagagagaaaaagtaaaagaccgaagaaggaggctggagagaccaggatccttccagctgaacaaagtcagccacaaagcagactagccagccggctacaattggagtcagagtcccaaagacatgggcttgttagagtgctgtgcaagatgtctggtaggggccccctttgcttccctggtggccactggattgtgtttctttggggtggcactgttctgtggctgtggacatgaagccctcactggcacagaaaagctaattgagacctatttctccaaaaactaccaagactatgagtatctcatcaatgtgatccatgccttccagtatgtcatctatggaactgcctctttcttcttcctttatggggccctcctgctggctgagggcttctacaccaccggcgcagtcaggcagatctttggcgactacaagaccaccatctgcggcaagggcctgagcgcaacggtaacagggggccagaaggggaggggttccagaggccaacatcaagctcattctttggagcgggtgtgtcattgtttgggaaaatggctaggacatcccgacaagtttgtgggcatcacctatgccctgaccgttgtgtggctcctggtgtttgcctgctctgctgtgcctgtgtacatttacttcaacacctggaccacctgccagtctattgccttccccagcaagacctctgccagtataggcagtctctgtgctgatgccagaatgtatggtgttctcccatggaatgctttccctggcaaggtttgtggctccaaccttctgtccatctgcaaaacagctgagttccaaatgaccttccacctgtttattgctgcatttgtgggggctgcagctacactggtttccctgctcaccttcatgattgctgccacttacaactttgccgtccttaaactcatgggccgaggcaccaagttctgatcccccgtagaaatccccctttctctaatagcgaggctctaaccacacagcctacaatgctgcgtctcccatcttaactctttgcctttgccaccaactggccctcttcttacttgatgagtgtaacaagaaaggagagtcttgcagtgattaaggtctctctttggactctcccctcttatgtacctcttttagtcattttgcttcatagctggttcctgctagaaatgggaaatgcctaagaagatgacttcccaactgcaagtcacaaaggaatggaggctctaattgaattttcaagcatctcctgaggatcagaaagtaatttcttctcaaagggtacttccactgatggaaacaaagtggaaggaaagatgctcaggtacagagaaggaatgtctttggtcctcttgccatctataggggccaaatatattctctttggtgtacaaaatggaattcattctggtctctctattaccactgaagatagaagaaaaaagaatgtcagaaaaacaataagagcgtttgcccaaatctgcctattgcagctgggagaagggggtcaaagcaaggatctttcacccacagaaagagagcactgaccccgatggcgatggactactgaagccctaactcagccaaccttacttacagcataagggagcgtagaatctgtgtagacgaagggggcatctggccttacacctcgttagggaagagaaacagggtgttgtcagcatcttctcactcccttctccttgataacagctaccatgacaaccctgtggtttccaaggagctgagaatagaaggaaactagcttacatgagaacagactggcctgaggagcagcagttgctggtggctaatggtgtaacctgagatggccctctggtagacacaggatagataactctttggatagcatgtctttttttctgttaattagttgtgtactctggcctctgtcatatcttcacaatggtgctcatttcatgggggtattatccattcagtcatcgtaggtgatttgaaggtcttgatttgttttagaatgatgcacatttcatgtattccagtttgtttattacttatttggggttgcatcagaaatgtctggagaataattctttgattatgactgttttttaaactaggaaaattggacattaagcatcacaaatgatattaaaaattggctagttgaatctattgggattttctacaagtattctgcctttgcagaaacagatttggtgaatttgaatctcaatttgagtaatctgatcgttctttctagctaatggaaaatgattttacttagcaatgttatcttggtgtgttaagagttaggtttaacataaaggttattttctcctgatatagatcacataacagaatgcaccagtcatcagctattcagttggtaagcttccaggaaaaaggacaggcagaaagagtttgagacctgaatagctcccagatttcagtcttttcctgtttttgttaactttgggttaaaaaaaaaaaaagtctgattggttttaattgaaggaaagatttgtactacagttcttttgttgtaaagagttgtgttgttcttttcccccaaagtggtttcagcaatatttaaggagatgtaagagctttacaaaaagacacttgatacttgttttcaaaccagtatacaagataagcttccaggctgcatagaaggaggagagggaaaatgttttgtaagaaaccaatcaagataaaggacagtgaagtaatccgtaccttgtgttttgttttgatttaataacataacaaataaccaacccttccctgaaaacctcacatgcatacatacacatatatacacacacaaagagagttaatcaactgaaagtgtttccttcatttctgatatagaattgcaattttaacacacataaaggataaacttttagaaacttatcttacaaagtgtattttataaaattaaagaaaataaaattaagaatgttctcaatcaaaaaaaaaaaaaaa

SEQ ID NO: 7 - DNA, 33723 bp, Homo sapiens
gaaagacctaattaagaggacaaaagacaagctacaggctggagacaatatatttaatccacgtatctatgaaaggactcatatctagaatatataaacaaccttaagaatctgacagtaaaaaaaaaaaatcagactaactggaccactcatacattgctgatggaaatgtaaagtggtacagccattttggtaaacatcattgctctctgacaaagatacggtgggtcccactgatgaactgtgctgccacagtaaatgtagccactatgcctatctccattctgaagatgtgtcacttcctgtttcagactcaaatcagccacagtggcagaagcccacgaaatcagaggtgaaatttaataatgaccactgcccattctcttcacttgtcccaagaggccattggaaatagtccaaagacccattgagggagatggacattatttcccagaagtaaatacagctcagcttgtactttggtacaactaatcgaccttaccactttcacaatctgctagcaaaggttatgcagcgcgtgaacatgatcatggcagaatcaccaggcctcatcaccatctgccttttaggatatctactcagtgctgaatgtacaggtttgtttccttttttaaaatacattgagtatgcttgccttttagatatagaaatatctgatgctgtcttcttcactaaattttgattacatgatttgacagcaatattgaagagtctaacagccagcacgcaggttggtaagtactggttctttgttagctaggttttcttcttcttcatttttaaaactaaatagatcgacaatgcttatgatgcatttatgtttaataaacactgttcagttcatgatttggtcatgtaattcctgttagaaaacattcatctccttggtttaaaaaaattaaaagtgggaaaacaaagaaatagcagaatatagtgaaaaaaaataaccacattatttttgtttggacttaccactttgaaatcaaaatgggaaacaaaagcacaaacaatggccttatttacacaaaaagtctgattttaagatatatgacatttcaaggtttcagaagtatgtaatgaggtgtgtctctaattttttaaattatatatcttcaatttaaagttttagttaaaacataaagattaacctttcattagcaagctgttagttatcaccaaagcttttcatggattaggaaaaaatcattttgtctctatgtcaaacatcttggagttgatatttggggaaacacaatactcagttgagttccctaggggagaaaagcaagcttaagaattgacataaagagtaggaagttagctaatgcaacatatatcactttgttttttcacaactacagtgactttatgtatttcccagaggaaggcatacagggaagaaattatcccatttggacaaacagcatgttctcacaggaagcatttatcacacttacttgtcaactttctagaatcaaatctagtagctgacagtaccaggatcaggggtgccaaccctaagcacccccagaaagctgactggccctgtggttcccactccagacatgatgtcagctgtgaaatcagactgaaatgctgaaataacgataaaaaaaaatacagaggttaaactagcaaagtgagtaaagtcaagggataaagaaaatttgttggaaaactcacaaagcaggacataaagcaaggccattagatatatctcattagtgtgacatctgggaggacaaagcatccaaaccctttcttctatataagtggtgagatgatgaaggttgtaagagggcttctgcccccttgaagacttcagatgctggggaaaggatagataagaataaggatgaaccaggcttttggagcctgggaaataatgactagcgataaacctgaagggaagttaagtatacgatccccagataatactaaggagaaaggcaatgtgattctgcagccattgtagccagagataataagcccttgaggaaggggccaggggaatttttctaaggatagacagtattaatgcagcactctcttctgctattaaactctcattggcttctaaaaggagtttcggtgagtgatttgctgagatgttgcattttcatggctgctgcctttaggtattattgcaacagtttggaattttgaaattaaaacagttctgtaaaaccagtttagttttgtaaagtgtatgcatcaaagatgtccttcattcagacattactgagttacaactatggtgccaggtactgtgtcagggtactaggggtatggggataaaccagactccctctttgatctaaagcagcatgaggccaggtgagaggtttcaatataatgtgataaaatgtgcactaggtactaagggatcatagagaaaggaacacattaaatggggaaacaattgatagagagagaatattttcatctgggtcttaaaagatgagtaggcgttctctctctttaaatgtctgatataagggcattttatgcaaagaggatcactcgtgcaaagactcagatttgcaagaacgtgaggtatttcaggagttttgtatggttccatatggactatgacaagtgagacaggtaaactaggcagagctggtcatcagataatgaagtcattaacctaaggagattggacaataaaatgcaatatggaggtatcgaagtataaacataaggagtaccactgatggctgatttaggatgcccagtctggcaacacgctaatgaaatgatagtgggggagggggccgtaccaagactaggagagagcagtcctgagactattgcaattatctgcgggagacataaaggctagaacctgaacagtagcagtacaaaaaaagaggggagttcaaatgatattaaggaagtagaagtggtatgacttaaccatctgggtatggaaggggaaatggctagagtcttggggactttgtgtttgatgtgattatggaccacagaataatgtctaagagaactggctctttagtctgactgccagagtctgaatcctgaatgttttagtatgttaccttgggcaaagcccttagcctctatgaatctatcttcctcattcataaaaataagatgacagtgcctatctcgtgggacttttgtgaggatgaagtgagataatggatgcaaagttactgagcacagtgtccaacacagcagaagcattacatatacattagctattactggctacattatgatatacagttagggagttggaaagataatctgaaattcaggagacgtatctgactataggtgagtatttggaactcattgttctgtaaacagtagttacagccacgtgtgtgggcatctggagagtgagcatggatattgtgatacctagtacagtgcctggcagtagtggttgtatgctcagtaaattttgttgacagggtcagggccggactagactgtggtaagcaaggcctgtagggcataaatatacttgtatgccccgagaagtgaggacctcttaaatattgtgccctacatgccttgtttggttcactcttgtcccagccctagcaagtatatataaggtgaaaaaggaaaaagctgaggctggagcctgggagaaccctggacatttaagggccatggagaggaacaggagttaatcaattcaagtgctggatggataacaggagttagagcaaagcggggaaccagaatagagtgattattataaaaagagtttcctaaaaagggagagatcaacaattagaaattatttagagcagccagtaaatacataaactcaaaattattctttaggtcattcctgattgtgacaatagtcatttcattatataaatgtgattaaggaaggaaaagagctacacagaagttattaaagagctaaagagaattgagaaatttaaaacagaagaaagtagggccaacatgaaaggagtagggagaaaaagagataaccagcatattgtctcactgatcctgccaacacctgtgagatagatattcttattatactactgttaaacctaatttacatttgacaaagttaaggttcagagcttgtgtgacttgtccaaggtcacaggtctagaggaggcagatacttgattcaaacctatttctgtctgatctgattctaaagtctgttttttcactcaaccacactgtacagtcagctctccttgtgagttccacagccacagattcaattaactgcagatcaaaaatattcaagaaaaaaatggatggttgcatctctactgaacatgtacagactcttttatctttcattattccctaaacaatacagcataacaactatttacatagcatttacattgtattagctattaagagaaacctagagatgatttaaagtacaaaggaggatgtgtttaggttatatgcaaatagtaagccatttttatatcggagacttgagcatccacagatcttgatatttgcagggggtcttgccaccaattttccatggatactgaggaacgactgtaaatggatgcaggcatggatgctatttaggagtgtccagggccaagtaaatgagttgctgagcagagaggtgggtggaggctgtgaggcatcaatatgtggtggcatccatctgcattttggtgatttttttccttcacagtcctcggctgtctgggaagagaaggatgaaggcagatggctgctccaatttaggggctaggattgcagggtgggcacagcattgcaaacgagtgaaggaaattgagaaatatggccaatgaagagttgaagagaggcctggcatggtggctcacacctataatcccagcactttcagaggcccaggcaggcagatcacttgaggtcaggagttcgacaccagcctggccaacaaggtgaaatggtgaaaccccggctttactaaaaatacaaaaattagctgggcatggtggcgggtgcctgtaatcccagctacttgggaggctgaggcaggagaatagcttgaacctgggagatggaggttgcagtgagctgagatcgcaccactgcactccagcctgggcgacagagcaagactctgtcaaaaaaaaaagagttgaagagaaaaagtctaggctaaattcaaagaaaaaaagtgagcccaaaaggaacttgcagagcaagggaaaagcagggatgtcaagggactagaacactccataaagtgaacagctgcaatgaaaataagggaagaaagtttagttcatctccgtttctttcctttcctttttactttcctttctcttcctttttggagttaatcaggaagtagtcccaaataccccagaaagttcatcttataagcccttggtcctcttgagatggtatcagatatattgctagacccttgaagaaaggaacaactccaggcaacttcttgagtccctgttattaattttatacatacacacacatatatgtatatacatgaaaacacacaaacacatgtgtgtgtatacagccatgcattccttaacaatggggatatattctgagaaatgtgtcattaagcaatttcatcattgtgcgaacataatagagtgtacttacctaaacctaaatggtatagcttactacatacctaggttgtattgatgtggcctattgctcctaggctcctgggctgcaaacctgtacagcatgtgactgtactgaacactgtaggcaatggtaacagtggtatttgtgtatctaaacatagaaaaggtacagtgaaaatacagtattataaccttatgggaccactgtcgtataatgtggtccatcattgaccaaaatgtcattgtgcagcaaatgattatctcatatatatatatatatgatatgatatatatgatatatatgtgtgtgtatatatgtatacatatatatgtgtacatatatgtatacatatatacacacacatatatatgtacacacatatatgtatatatatgtacacacatatatgtatatatatatgtacacacacacacatagagagagagagagaggagaggagaggaaggagggagggaaggagaaatatgattcagatagagacatctatcctccagagttcaggagtgtctcttcagactaggtagatgtagcttaaaaaaaacatatcctgaattctagagagatgcttaaatcactgcaattcctataacacttgccaaccaaaggtgctgttgatctgaaattgcttttttaaattaatgcagtgatttttctttaacatctagtgacagacactggggtcacatttgcagctggaccataattaggcttctgttcttcaggagacatttgttcaaagtcatttgggcaaccatattctgaaaacagcccagccagggtgatggatcactttgcaaagatcctcaatgagctattttcaagtgatgacaaagtgtgaagttaaccgctcatttgagaactttctttttcatccaaagtaaattcaaatatgattagaaatctgaccttttattactggaattctcttgactaaaagtaaaattgaattttaattcctaaatctccatgtgtatacagtactgtgggaacatcacagattttggctccatgccctaaagagaaattggctttcagattatttggattaaaaacaaagactttcttaagagatgtaaaattttcatgatgttttcttttttgctaaaactaaagaattattcttttacatttcagtttttcttgatcatgaaaacgccaacaaaattctgaatcggccaaagaggtataattcaggtaaattggaagagtttgttcaagggaaccttgagagagaatgtatggaagaaaagtgtagttttgaagaagcacgagaagtttttgaaaacactgaaagaacagtgagtatttccacataatacccttcagatgcagagcatagaatagaaaatctttaaaaagacacttctctttaaaattttaaagcatccatatatatttatgtatgttaaatgttataaaagataggaaatcaataccaaaacactttagatattaccgttaatttgtcttcttttattctttatagactgaattttggaagcagtatgttggtaagcaattcattttatcctctagctaatatatgaaacatatgagaattatgtgggttttttctctgcataaatagataatatattaaactttgtcaaaaggactcagaaagatcagtccaaccctctaacccatattgaatggtgatatactacagggttatgccagtgtgggaactatcgctggtaaataagtttaatcctccctagggcttcacaaagaacattgttccaccccaggagggtggaaggaagaaactgaaatgattgtgtcttagaacctaatgaaagtttgcattcctcagtaaaatcagagactgctgattgacttaaatgtttatagcttcaaagtcctcctcattatcatggcccacaagcccttccatgattgtccttccccaccctccccattacccttcttgcctcctctgctacttctctcctcgcacactgggctccagccaccctggccttcctgtcacttcttgcacactctaggaatgctcccactttggaggctttatctggctgtttctcttatttggctgttcccaacttcctgtgggctgactccctcacctccttcgggtctttgcccaaatgttaccatcttaatgaggcctaccttcaccatctattaatacttcaacctgccccagtagccttaccactctagacacctgtacagaactccactctactttttaacagagcttttcaccatctaatgtatcatataatttcttactcatactatttatcatttattttctcctactccactaaaatgcaagtttcatgttggcagggatattcaattgttttgtttattgatatattcctagcacctagaacagtatctggaaaagaggtactcagtaaatatttatcaaatgaattgaccaaaagaaggaaaactcaaaactttaatgacaactaactttaaagctacaataacttaaaattcagcagtaggattttgagggagggtaagtttcaaagattgacttacctaagactatctgcataaataaaaagaaattaatccagacaacaaattcaccaacttccatcaattggaaatccaattctattttctacagtttatgttctggagacactactggacactcttttactctcataactcataactcctccacttttgtttttaaatcatgagagaaaaagagttgactctgttatattgttttatctacctttccttgatcttagaaacgaatactaccataccagcttctactgaggtgccccctaaagttagtccaaataggtctttgcaatctccattcccgcagaatttagaactttgaatcacatgatttatttctaaaagtaaatccatgccgattttccccaccaaaaaattcctgactattaaactcctacaatcccttcattgctcactccccacccccaggatcatattttaaagttgggcccttgccttttgggtcacataggtacactgtttgctataccacaggtatagctatctggaaaacatggagggtattattctgttactactgcttcgtcaaccaaaaaataaaacaaaacaagaacaaaaaagaaacaaactccctgcctcttttcacttgcagtcaaggttcctaaccactacaaaattagcctatgtttcttcttgcacatagtagaaacccaagcttctcactgctgtgctattctgtaccatcaactcatcacataaagagcctggttgaagaatgattgtccaaccacattactagcatctgtcaagactttccagtttacaaaaggcctatcacatttaaccctcacaccatccttgtgaccaaagcattattaactccattttacaggagagtaaactgaagcttagggaagttaaaagaactgccaaaggtctcccagttggggagtcatgaagcccagaagagaagccaaattctctgctgctcaaccccttgctttcactattacacctcagggccttcaaatctaaatgcagttattcattaaacaggaacctggtagtcttaaacaggaatctctcacttggtaagatcttgtctcttgttgtatttgaccccaactgtctatggctttgcctgaacccaaagtacacacagcctagaaaccaaaggagaaccaaatgtgggataaaatgacactcattttaacgacatgtctcagcaaatgagttcctgtgtagctggctgaaagcccagaccctttcagtaaaacatcctgaataattcacatttgttggtctataatataaagggcaaatgtagctcatttttagaccagttctgaacatcaatagtaacaaaccagagataaccgattttgttttcatagaattggaacaaattagagtatctgtgcaaaagcatatcagatctaggagcagaggggacaaggtctaatttttaaataagcaaattttccagggagggactacttatgataaagggatattagtctcttagtcaacggaacctggatacacgcttctgacagagaagagggagaataggcaggaatctacacaccagatgtcaaggagatttgctttaaaatacgactgataattagaaatttctcagtttcccccttttccctcattctttgattcttattgttatctttatctcttactcctttgtttctcatatattgagtcttacagatcaagctcctatttttttcttcaggggtatttttctagttcaaagtgcctaccatctcccttctggttctattcatccttctctcccaaagctcctttagaagtgtggattaaggcagagcactaagaaaccagacttaaagattcccttctcattctgacttttctcctttcacctattccttcctcctgttttcttaccatcagtgtcttcaaaggctttcaagtacacggtaaatgcagaaacttcaagaaaggcagaatggaaacataaccaatgcatacataaataaagcacactgtagaatctttttaaattctgtatgatatatcgaatgctgtctctcacattacctagaccatttgaaaccgaatttgtaaaacatagactatctttaagtagtaacagatgcttctgacatgttttctattgtcttgaaccattactgcatatgatacatcaaagttaagtgacaatacaagaaagcagattcatttgctccctgcctaggccgtcagttcctaaagtggaaacgccatatattatctagctcagtttgctctacaagacctgcaatagagccttgtgtgacatagagataatatttgttgaagcaattaaatttgacttggaattaactctgccatcattctataaggaaggattgaaaatccttctcaccctgtgctgatatagtacctttctatacaaaaacgtccttctccctcttcccttggattgcataaactatgtacatgccttcctcagggcacttttctaggacagtgtcagcctaaggatctttgtttgggtggcttttagaaactcaggaagacaggagcatcatatgcctataggcagctggcttccaggtcagtagttttgctctgaccctaaaatcagactcccatcccaatgagtatctacaggggaggaccgggcattctaagcagtttacgtgccaattcaatttcttaacctatctcaaagatggagatcagtgtgagtccaatccatgtttaaatggcggcagttgcaaggatgacattaattcctatgaatgttggtgtccctttggatttgaaggaaagaactgtgaattaggtaagtaactattttttgaatactcatggttcaaagtttccctctgaaacaagttgaaactggaaaatgcaatattggtgtatcataatttttcttaaaaacatacctttgatgcttataaacatttcatttgtagtgatagttttcaggatatgagttcaagaagctacattaaaatcaataacaatatttggtaactaatattaagtaataatgatgttccactcacttattaatctttaatacaaccgtatgtggttagtactatcattatgcgcattctatgcagatgagaaaaccgcaactccaacggccaaaaattacagaggcataaatggtttagacaggacttaaacttcagtgtgaccaaaacccatgcttctaactactatattcaaaactcagagaaaactgaacccagaaaattgaaatcatgactaaattgctatcaacataggtagtgaaagtcaattaagtacagaactggagtatgactggccaattatcccatataatgggaattctccacatgtacaaaccacttcatatgctaaacttgttgacaacattcaaagctcatccctgaatttgactatattgattacatcaaaaatgttacatagcaaccttagaatccttgtgtaccttttcttctcaaagcctagattatttctttttccgacgtttcagtaattggagcagtaaaccccagtgtcccttacctacttgtttattacctccagatgcaatattactggtactgtgattgagaaacgcacacagtgctaatgaggaattcactttctactctgacactctggaagaatagagatgcaatcctaaggaagaatttaacaccacaggctacatgactaaggataaagagtagaaaattagcaggactctattaaggcattacagcaatccacctgacagatgaaaaaggcatgaaatgaaatgaaatgtagcagctacactcgtcctattgagaaaggaaaaaagtcacctgtaatgttgttcagaaatcctttcagtactaaaaaattcattgaccatcttcctttagtctcgaaaatttcttagaaggtaaaaaaaggaaaaggtgacagggcaaagacatttgaaaagaaagaaaagagtgaatgaacttgcacacctggcttggactcccattcccttaggtttccattgtgggggacaaactaatgcctgggttacctttcttgagagtgtgttaattgattcaatatctctgaagtgctactttcatctgaaaggttataatttgaaattcagatttacctggataaatttgatcttgctattatggaaacctctagaaatccttggagtagttactcattatcagcttaaataatatagccggtggagctgagggaatgagtaactcaattagtctcagttacaactgaagggcacattgttgtaaactataattgaaaacataaatatctttacctagtttaaaaataaagatgctttaaaaggaggaagggaatagccctgaggaatgtaaatataagcacaaaacttctacaacagagtttgctacgtgtgtggctgtgttccacccagcaaaaatgctaagtctacaactgacacaacttggatactctcatgttcccacattttggtttggtcaaggctgtgcagttgtactgcagccaccaccactcctggcctctacagtatattgatctgacccaccaatctgatcaaggtttagaaaaatattttcagcccagttagctcacaaacaaaatgagaattcccacaaattgctctttatctcagacaacagaggaaagctacagcaaaagcataaacaaattaccatttaagtttgttgcttcaaattaaagactaattgcaacagctactagatagcacagtttatggggcatctcggccccaagtcttttgtcttataaggtcttgaaaaaaagaaaggagattttcatcaataagagttttttgttatctttttcccttgttcatcaggcccttcactgcgagagagaggtgtaaacgttcagggcatgcattctagttaaagaatattaattggctattgggtccctttggttagaataaagacctctgtatgatgtccctagctgtacatcaaacccaaatatctctcagataaatgaaggtctgtaagaatttggtcattcctgtctcttctaaagagtaacagaggcattttcccgcagtaaagtagaatggaaagaaaacaaaaatcacaagcctataaacaccttcttcaattttcccagcatgtcacagacactactgtcttatttactacgtatttctgaggagtaaaaaaaggaaatatgttgagtttagctgaagcacagcatattttgtggtaaacttgttaaataaaacatcttttgtccaagctttggttgtcacacaagtggatatatcaggaaatataaaggcagaataaactaaagcagaacatactaacatttgtagtaggcatgaagggaattagaaagtgtttgtgttaacatggagggagggagaacagatgctttgagatgttcttcaacagatattctaggcactgagacccccttcgggaccagagagagcccatatccaccacagtacctgacacataaatgctcagtaattgataaatgagtcccattctaactgttccttagccctgctctatggaactctcccctggaattccttgtgccattattttatttctggaatcttcagccttttagctgagggcaaaagattgctgattaggaagcaatatttcccacctcctgcgcaaaacaagccaaagatcaacagcagcagcaacatactgagccctaaagggcaatgacaaatgtggagaatgatacagaggtctggttacttcttagccaatgacacagaatcacaattgagaaaacacagagtttattcattcccattgtgcatgccctggacaaaccaagctgcacctttcgtaacttatcacaatctcatattgacggaacactttctacaggtaatgtttgatttggctgaacactttagcattgcttcgtagcaacaaaatgatagctagtaacagaaaaagatccagggatattaccactgttagtgaggagaaaggccttttaattaattaattaattaattaataggaccaagtgccatctttttggatcatgcccttagtggattattggtagcaaaggttaaagctcaagctggttcctttgtccccctggcaacagttgatttgcctccctttatctcctgaagtatccgtaaggactaagagccaattattacatttggctatgctagcatatgtaaaatagagtttaaaagtttagattcatcactcaaaaattcatattctccaaaaccatacagtcactctgttagcctgtgttcccccagaaaaaaagtcacaagcttatttattaacatgtgcaatcccagggggcaagagaaaggaactgaagagtgaggcagaaaggaaaagaaagccaataagaggatgagttatcaaactactcgtttctaacagcaactgattgcttaacttcctgggactgtctccaataagtcaaattggcctcaggttagtccacctgagtgggaagaagcggtgaaagaatttgtctgtcagtatctgtctctcattggttagaagttcgacttatggggaattaactccctcacatttcctagttggatatgcttgggtacccagagggtcatatggcatccatgcctcagcatgaacagggaagcttcaaggcaaaagacacatagtgcagctatgagccaaggcaattcaaggatacacccataggaggctggttgacatccacccagagctaatcaccaccatgctggaaaaagacacaggtgaagctgagaagaatgaaggtggtgcataggaggtatctaatacagtcactcattttcaaactttccatgttatgattgcactgaccactgaggatttctattgaaagttttactgttgtcaaacacgtacacaaggggaaaggtgtcttacattgtttatgttcctgtgctgctctagaaacagaaataggctcaagagcagagcctgtttttcttaattcagcaggtctaagctaacaagtcctgaaacatggtacttcctgttattggtattgcataggagaaacaaagggaaagcacagtaattagaaaatacaaaacaagatggcaggaataagccaaaaatatcaggaaacacaattattgtgaattgggattaaactaatctattaataatgacaactttcagcttggagttaaaaatttaattgtatactgttaacgaaagtgatacctaaaataaaattacactgggaggccaaaatgaagggatgtgaaaagaactatcaggtaaaaactaacaaaaagaaactagcaaagcaatcttaatatcagacaaaatagaatccaagaggaaaatcatttcaaaagacaagagattttttttattaataaggggaattgcataggagagtaaagaaaatgtgggccactggaatgcttagcactaatgacatattggtctttggtcttcagttaccttacaggaccctatttcattctcttatgtttgatatgtaaccacctcagccagcttcaagttgctttttggccctaatggacttcctagcactataatttcttttttttaaatgttttattttaggtttaggggtacatgtgaaggtttgttacatagataaacatgtgtcacaggggtttgttgtacatattattacatgacgcagatattcagctcagtaccaaatagtgatcttttctgctcctctgcctcatcccaccctcctccctcaagtagactccagtatctgttgtttccttctttgtgtttataagttcttaacacttagctcccgcttacaagtgagaacctgcagtatttgatttttgttcctacgctagtttcctaaggatgatagcctccagctccattcatattcccacaaaagacataatctccttcttttctatggctgcataatattccatggtatatatgaaccacattttctttatccggtctgtcattgatgggcatttaggttgattccatgtctgctattctaacactgtaatttctaaagacttccagattctacttttataggtaacctgttaaacagtctagctctggaagccaagcaatttctagaataactaagcaatagaaattacacttcaatgcagaaaggcagtatctacatgagattatgaaattgcggttgctttttgtgttcactgaaaaaaataagtaaaactgtaactttcagaaaaaatgattgtacatatagaaaacccaaagcatctaaacaattaaaataaataagtatagaaagattactggatacagagtcaacatacaaatatcaattgtatgtctatataccagcaacgattcaaaaatgatttttataatagcattaaaaattagacgcttagtaataaatgtgagaaagatgtgcaagaactctacataaaaaattatgagacgttattgagaaaaattaaggaaaacctaaataaatgaatgaataggcaatgtttatcaattaaaggatacaatatagtaaatatatcaaatgtttactaatggattcaatgcaataccaaagtgcccagcaggctttttttggtggtgggaggtcgggcaggattcataagctaattataaaatgcatatggaaatgcaaagagccaaggatagccaagacagttttgaggaagaataaacttgtactacttacactaccagatgtcaagacttattatcgagttacatttattaagacagtgtggtactgacacaaggatagacaaatagatcagtgaaacacactagagtgctcagaagcacacctgtacatatataaaggcttgatttatgatagaggtgccagtgcagtagagaaggaaattattggtgttttcaataaaaagtgataggtcaattagatattcatatggcatgaagtatgaaacaataacaatttatattcataacttgcagaaagcaaaaatttcttaaaatacaaaaagtgatcaccataaaggaaaagattgataaactggactatattaaaactaaggactcctgttcagcaaaagacactacttcgactgaaaagacaagtcacagagtgagacaagatatctgcaatacagatacctaataactgaaccccatacagtgatggtgggaatttaagttcgtacaatcattttagaaaattgcttggcagtatctactagatctgaacatgtgatccagtaattacactcataattataagccagtaaaaaggcatgtttatgtcaccaaaagatatatacaagaatgttcattacactattatacataagagccaaaaactggaaacaaaccaaatatccattaacagtagaatgaataaataaaagctgtaatagtaatacagtggaatactacacagcaatgtaaatgaactactgctgtacaaaacaacatggtttaatctcacagacaaaatgttaaatgaaagacacagacgagtacatattgcgaacttctgtttataattcaagaactggcaagaactgtttactgtgttagaagtccaggtaatggtaacctataaaaaggaaaaagggtggaatgattgggagggggcatcttctggggtattgataatgtgctatgtattggtcagtttagtgtttaaacaggctcatttactttgtgaaaacttacactaaaattgtgtgtattttttgaatatatgttatacattaataaatagggtttttaaacctgtagttcataatttagtgaaagtagaatatccaaacatttagttttaaaccaatcaattatagtgctaccatcatttttatgcattattgagaagtttattttacctttctttccactcttatttcaaggctccaaaatttctctccccaacgtatattgggggcaacatgaatgcccccaatgtatatttgacccatacatgagtcagtagttccatgtactttttagaaatgcatgttaaatgatgctgttactgtctattttgcttcttttagatgtaacatgtaacattaagaatggcagatgcgagcagttttgtaaaaatagtgctgataacaaggtggtttgctcctgtactgagggatatcgacttgcagaaaaccagaagtcctgtgaaccagcaggtcataatctgaataagattttttaaagaaaatctgtatctgaaacttcagcattttaacaaacctacataattttaattcctacttgaatctgcttccttttgaaatcatagaaaatatcagtagcttgaattagaccaattaattttctagattgcatcatattttaaatataaactatgtaatcatctacaacctgaattctttctgtgtccaatttgtccaatttttttctctaacatttatatcacaaagcaattaatttgtgtgatttctgcatatgtatttgtaattcatcaagtcaaatcaatgtagtaatactatatcataaaatatacacaaataattgagtgataggcttctagtataaggacggtaagtttgaagcatgattctatctgggctggctagtttactctgagaaagttattttttattgttgggtcttaagctgagtttacacacttggtgtcagaatgattccggcaatgaactgttttatgttctgctaggctgatcagcacaatctatatggctgtgaacaaaacaatgtttcccagtcatgccaaccatgccaccattttaacagctgattagtgtattcagaacatctccactccatgttcgtatggctgttatctaaagatgaaagcagtagacacttttattttttgaaaaatttaggctctgcagggtcaattatatttgataaatgaggggcttttttgaagcaaactagatataatttcttttgcatttctaaagcctgatatcttattaattggtacattaaattgtgcaccatttctctgtaactgtttcagtacctgtctcagcactataccaggcagaagaaattaaagaaagaaccagtgccgagatcagcttggtcagggagaccctaatcctgcggcactagaggaattaaagacacacacacagaaatatagagtatggagtgggaaatcaggggtctcacagccttcagagctgagagccccgaacagagatttacccacatatttattgacagcaagccagtcataagatttactgaaagtattccttatgggaaataaagggatgagtctggctagttatctgcagcaggaacatgtccttaaggcacaaatcacttatgcaattgtctgtggtttaagaacacctttaagcagttttccgccctgggtgggccaggtgttccttgccctcattctggtaaacccacaaccttccagtgtggatatcaaggccatcacgagcatatcacagtgctgcagagattttgtttatggccagttttggggccagtttatggccagatttggaggcctgttcccaacaaaccagaagctaggaatatatatcctgcaaataaaatgaagaatctctaaggcttcagggcctgcccacttgttcttctgcctggttcttcacatacactgtctcaaagctagtctaccttgagaggagcatgaatatgtgtgtgggtgtgtgtctgtgtattttaaccttaaaaacctaacttccagtatagacagatggcatactagctaaacccttacaagttcttctatgctataaaagagaaacagaattgagaaccacctccaactattaagtgttatatttgaatatagccttagctttagcagaataagtaggccaaacttaaaataagcttttctgccttttcaatgataaaggtcccttttctgtagccattgttgattgtgtacacttatacataagtattttgaactaatttcctgttttctcaaccacttgctgtcttcatgatactttgtcgcagctggttgctatagaaatgtctgttacaaggaatgtggcttgaaggaaagtgataaatgaaaatgaaatgtgaagtgactttgtttgactacaaattcccattctggtagtccccagtgtatcaatacattatttttctttagaaaataaaccaacccaaggaaaaatggtgggcaggtcctggtgaatatggctgtgataattatattagcaatctctttggctaatatttgaagcccaaataattgaatcacaatgatctctccccagaaaatatataaaatgcaccttggaatctagaaggccttttagtctgcaaaagaaaccttcttaatcataagcagcagaagtcccatttaccaaattggaaagttaaagttacaaagcatcaatcataagacttccattcagggatggcaattgggagtaagactttttagtaaagaaactaaacacaaagtcattagactctgtaaaagtcttaccaaatttgattctggaacacctattctatttccgtaaagatgatgaattccggagccaaatgttcttttcatgaaggatttgaaaactgtccatgaaaataacgcaatcaaccttttagcttgagactctattcactgattagatttttttaaatactgatgggcctgcttctcagaagtgacaaggatgggcctcaatctcaatttttgtaatacatgttccatttgccaatgagaaatatcaggttactaatttttcttctatttttctagtgccatttccatgtggaagagtttctgtttcacaaacttctaagctcacccgtgctgagactgtttttcctgatgtggactatgtaaattctactgaagctgaaaccattttggataacatcactcaaagcacccaatcatttaatgacttcactcgggttgttggtggagaagatgccaaaccaggtcaattcccttggcaggtactttatactgatggtgtgtcaaaactggagctcagctggcaagacacaggccaggtgggagactgaggctattttactagacagacctattgggatgtgagaagtatttaggcaagtttcagcactaaccaatgtgagaaggcctccagagatgagcagttggtgaaagagaggctcaaaaccagctaccatacaggtcaagaagaatttggcattaaggaaacagcatagcaggattccagacaggcaactggtcaacaacatgaaggtctggaagaaaggtcgcaggtactcaggttcagggcactacttcagcttcagcccttgcaaaaactggtgagagttggaaagtctttaggctaagaaaaattggattatttaaaagggggtaaagaaagggactcaaggaggaaggattaaggcaagaactaggttccaagaaacagggcatgagagagagtcttgatctaccactatagttctcgtggtagcatcagaatcacctgggaacgtagaaatgcaaattctcctgctctacactagacctaccaaatcagaatatctagggggtggggcccagcagtctgtgcgcaaacaagcactgcaggtgattttgatgcacattatagtttgaaaactaggccaggtgcagtggctcatgccaataatcccagcactttgggagactgagacgggaggattgcttaaacccaggagtttgagaccagcctgggcaacacggcgaaaccccacctctaattaaaaaaaatacaaaaattagctaggtgtgatggctcccacctgtgctcccagctattcaggaggctgaggtgggagaatcacctgagcctggaaagtcgaggctgcagtgaattgtgatcacaccactgcacttcagcctgagtgacagagtaagaccctatctcaaaaaacagaaaaagaaaaacactggcccaaaggaaatgaacttgttacagaagccggggttcaaaacaccaaataatgcacttgtacctagtccttcccgggtgctctgcagacatttctccaagcgtagtctgcaaacaacctacatatgtagaattacctatgcacatttttcatttaacaaccaagagctacatttgtagcaaaatctgggttgtaacttagcctacagctgaagcctaagagattccgtctgtgagaagaaataacccacctctttggcccccctccccaggcaggaagccaggatggtccttatataaagttgtgctgtccaataggtaaccactagccacatatggctatttaaatttaaattaactacaattaagagaaattaaaaattcaattcctcaattgcacctgccaaattttaagcacataacaaccacatgtggctagtaactactgtattggagagtgcaagcggagatagaacactctattactgcagaaatttctattggatagcacttataatagtttagtgtaacttaaaactccctagttgccacagtcatgatttagtagtaatttcatggatttctctactgaggttagaatctctgccattagagactgataaatttaaagtttgcaattatcaaactggtgacaatttaagccagaatcaggtaaatgtcctcagttttaacagcattggaattttctgggactagctgtgtatctatccaggattcttgagaatgcctgccatttttcaacataatggatgtaaggtattacacatatacctggggatggggtggtaggtataattgcacaagcattgtggagaatggtatcaaagagtggcagaacatcacaatcaaggttttccctttcttttacctttgctttttaaaaagacaatatttgctggacctgatcttataactcataaatgggacactgtatgttcctttttacctcctctgtttctacttaattgcaccctatgaggactgcttcccttacctaccataaccccttccttcactcatccatatctttactcttcttcacaactctgtaatattgaccttctttatgaacctttcctggaacaatccctcttaagtgcaagcactgttattatgccttcaatgtatttaatatccatgtatctattctctctaattttgtcattttgtgttctcatgtattttcattcattatgtgtccaacttccatggataacatggttacaacaaaagatcctactttatgacaattatcttccttgggtttgtgggacatagaacagtgctcagagtaggggatccaagaacccaggagaatatattagctaagaagataacttccgtttttaaaagtccaagattcaggagatcaaaaccatcctggctaacatagtgaaaccccgtctcttccaaaaatacaaaaaattagcccggcgtggtggcaggcgcctatagtcccagctacacgggaggctgaggcaggagaatggcgtgaaccggggaggcggagctggcagtgagccgagatcccgccactgcactccagcctgggcgacagagcgagactccgtctcaaaaaaaaaaaaaaaaaaaaagtccaagattaaaaaaaaaaaaaaaaaaggatgtctgctttgtgagtttagcattgtctccttgtcattccagaaatgaaatggcaaatacatttaaatcagaactaaaaaggggaacagggtataaaggctcaatttagtcacatcatttccgtttctcacccaccccctttaaaccagatgtttgccaatgcattaacaatgcagatgtttcctgaaagaaagtttagtaactcaagcagacaccttattttcttttcaagcagaaaagactatgagatggtggttgtggttgttccgggagggagaagatataaatgatacacattatttcaaatcatttcatgacctcactgcacacttatagttattgtacctgttgtctttttgctgtcaagcctagctaagatcatttggaatgttcaagatcactcatacatgcatgtgcacacatacacatgcacatatgttcactccctatttcatccacatgaactaagattactgatgtgtacagattcaaagcacttttattcttttccaaaggcaagaagctgagctactttccagaatagttgtgaaagaccctgtcatacttctgcattgtttcctccacaccacctccatccagttccttatgaatggttactggttttcaaaaatatgagataaattgagtgtataaaagtcatttttagacaaaatgaaacaggaaatgaaagaaaccagaatctctcctcatttgtggatgggccagctccaccatgtcatggttaatctgcagggaggaaatactagatttgattgcagatcagactgcagcaaacctgctgtgactaaggcatcaagagaaagcaagcaacagctggggcttcagtggtgaaaacattatatatctagctttgaaatatgaaatactgtttagcagtgtcacctagaaaagagtgtttcaaaatgctgatgcttcataagaacctttctcttcagagttgtttcttttatctttcaaattagccagggtgggaaataaagtgatcacttggtgaagaaatctcacaaagaagaacatagagagttcactttcatctggagtaatgaacagattgaacaaactagaaatggttagtctgttaaagaaaaggtgtaggtgagctgtttgcaagagccacaagggaaaggggaagacaacttctttgtggacttaagggtgaaagttgcaagcaggcaagacgattctgacctccattaagaaagccctttccaaccaacaaccactgggttggttacgcaggttgggcagcattgggagcaaatgttgattgaacaaatgtttgtcggaattgttgacttaaagagctgttctgtcactggggacagcagcggctagatagccccattcagggagagggcatttgttcacctggccagagatcagagcaggctaagggactgctgggatcctgtccagctttgagaccctacagagccatgttcacctagcacgtatcccgtctgcggtcacgctcatttcttaccttattccagggctttcacctcagcttgccaggctggagccaagggccaacgcagccgcgccttgttcgcgatggtagcttcccaggagccccctatggttccggaacggcgctgccggccccatcctgtttgctacctcctaaagccaaaggcactggcgggccgggccagcttctaaagtcgcgcaaggttagaaggttccggacaggaacggcgtgaggccaatggaaggaggtacttcagtttccctccagatgcccagcgatgggctcagagctccttgagaactcgggaaaggaagcagggtctctgaagaaatacttcaggagtagaaagaggaagctagagggttaaatgcactacacaggaacagaaatgagtttttcttagagttagtatatgtctagaggtgtagtaaactaaaacaagtcttgaattgcataccgccacgtagggaagaaatgaaaacctttgaatattagtgaaaaaagggaaactgcaacgcctgtattactagatagctttcatcaacagctcaaaaccgacagatttaaagaagcaacaccgcattttggctttctaaagctttaatttggtttggatcccatgcccatgaccctgccagctgacaattctaagcatgcgcaaactggccccaaaaattcctcccacatttccgaagaactatttggccctttatgtgaagtacctggtttttccattttctgttttaccataggcctcagttcggtgtgtggcgtatttattctacatttaacaatttgaagatcattctattagattaaaaaaaaagaatacaatggaagccaagtgattaagctttccttatgcttatattaagttgtagcatatgcatttaccgatagttaaccgtattaacctacagaaaatgtccagggaaatggtctatttcttattctatttttgacctaaagaaaatctttaaaatgtcttagcattttccccagtctccatccactttcctcagctttggcctgaagctatctttaaaggtaccctgtacagctcttgccctgtacagctagctacagagattcaatcctttctgttcgattaggacacatctcagtggcagataacatgcaaagttattatatgtatgaaccagaacttgtttttccttaggggccaggatgttacactaaggtcttaagactatagtaatatcttcacttgaaaaagccctctattattcctatctcagatgataaaaattcaattaagagaaataagaacgtgacatgtgtaatcgcacctggctctacaaagctagtctggacagacatttaaacaattatcctctaagattatttgatgaaatgcatttcaatgactagttaaccattaaaaaccaaagtgagcatcccatctgttcccagtcaaatgacctagagcaaaggactaggcaaaccacatctgtgggcatagcaagctgtacatcacaaacaaatgaatttgctttgtatatgagtgagagcaaacactctttattgtacaacttgggtgggtaagtagggagaataatggttttactgaaatcgcaggtaacggttacgttggagttaaaggttaggaagaaaaccaaagggtaagagctgttgttctgggctggcattgtcaatgaagagcataaattcagatgtgaatgtatattttgtagaagcatgtgtgttgttggtttttgtgtatgtgtgagtctgaaagagggaaaacaggctcccattagactatgactaacaaaaatgtttgacagattataactcagatgtcttactcagagcatatgccttcccattttccccattattccccaacatgatgtctttaagaacttgtccttgaccgagcagacatctcataccccaaatagctaatattttgatagctatgatcctgaacggccaaacattccaaaaccaagtagtttgtaatatctttaaatgcaaatatattttaggccttttccttggcaaggatgtttggtcaggggttggcaaaaataatgctcttcagacttaaaagaacacaaccatatttcttagccatccaccagaaagtagtagaagctccaggaagcaagtctttgtcaggagtcagactagctacatcataatctctctgcccaggggctgtggatgtcatccatcctggcctaactagcctactgagctgagagatgtccaatttccccccaatacactaaccagaggagaaggaccgtgatatcattgcatgtgaattcttaattccaattgcttaaacaaatatgttcagttgtaactatcaataccagtatataacagtgttggccaagttttattgatgctgacaatcaattggagttacagccagacacatggtcttatgaccggcgtacttacgcagggctttgcactgagacaggtcgtgcatctgaggtttactgctttgcatttttgttttgtaactgaagtctgatgagacagccagagcatgtgctacctagggacttgaatccctgcagccccatttcacttctcaccaccttccggggtggtttctcgacctcccactcccctaccacctggtgccttagccagccctggctctccctccaaacacctgcccaatgagcactgccaccccatggtgcccagacatgctctccctcctcatccctacctagctaccattgccactcccctcccccagcggggacatgggcataggagcagggagagttaaggttggtcaggtgcacgtgccctatgctatcttggaagggggcttggccatgtggcatctctggaccaagaatgcgccacagcacatttggagggtgaatggtgggggcacaccccttgtccacctctatttcaggcatggaacacatcctggcatgaaagttgcagtcccttgggaatcacctctccaccttgattgccacagtaggccagtgacaagggaagattgacacatcatcccctgctggggcccagtgtcctgtggctggcaggcaggggatcctaaggacatgtgggtgttaaattgtagggtgcacttcctgggcacctttgagggtctgcactgccccagcaaatatccccatgctagaaggagcaaaatattaaatggcaaattttaaaaatgtaacaagatgggttgcaaaagagactacagaggaaagcaaaagttttgtattttagtatcttccatggcacttttcttcctagcttttgaacaaggggccccacatttttatttctcactgagccccacaaagtatgtagccattcctgcccggagtgaggacttttaaaacataaagattatcaagtcttggaaattctgattcagtagatatataacaggtctcaaacttaattatgtaaagaatattctggagagcttccttttacccagtcccacccaccaaatattctgataaattaagcttcgattagcccccagatctgcattttataaggatccccagatgattctactgcaattggtccacagaccatgcctggaccgaatttgggtgcttaggagcacaaattctggagccgggcagacttgagtttgcttcctagctttaccaactgatctcaggggagttaatgtttacctctaaactttagctcatgcatctataaataaatatattaatatcatgtcataaggatattatgttgtattaaatgtctttaaaacaccacaatgattagcccaaagtaaacactcaataaatgttcaaaaatttaggaaaattgttaagactgggttgtatgcacactggtgtttattatattatgtagttttttctgtatttttacaacatttcagaattaaaagcaacagctagaaaaagagggaaatggccgggtgcagtggctcacgcctgtaatcccagcactttgggaggccaaggcgggcggatcacgaggttgagagatcgagaccatcctggccaacatggtgaaaccccatctctactaaaaatacaaaaattaactgggcatggtggcatgcgcctgtagtcccaggagaattgcttgaacctgggaggcggaggttgcagtgagccaagatctcaccactgctctccagcctggtgacagggcaagactccgtcaaaaaaaaaaaagagagggagagccagagtatgaaaaaggaagtcagagccctttaatgagtcagctttgtaggtctccaggtaggaggctagtgcttcagtgtctaggacatagtaggtgttcagtaaattaaattcaggacaaaaagaacatgccccaaggaccatctgatatccacttaaagtgatggactacctcgtttcccttgtttatgaatgggttcatgcctaagactgtgtgcactttaatacaagggcagtcgttcagaactagtcaggtcctgaaaaggatttaccaaatgttgagtgtgccctctagtgttcacacttcccagctttcttcctataaaggtggatcaaggcacttgcttacaactggaactgaaatcctccaagtcgatctagacattgagatggagaaaatattcattgtcgactgtaattatgcaacgaatatccagttgagataatggacttgcctcttatctaataatacccaggctcaatgcgtcactgctttgtccactttgcccaaaattcaagcacagctaagttgatattttaggacaaaggcagcttactatccagccagaggggagtagaatatggttaagagagagtggaaagaatgaatgagccctgctattcctcactgcctggatggctataagcacagcccttatggaggccttaggtcttgcttcataatattccagtttgaaaagggtttgaaaagacctcctagaaaaatcagtagtttttctcttttgagtaacatgtagcaaaaaaaatttcatcatgtaggtacagggaacaccctaataactattaatctcaaggagtcaagccagtgtgtttcctaatgtatctgctgtatccccatgaagcaaattttgccatcagagaaactgactcatggggaaaaaatccaaggacctcaaatcaccaaaagaagccattcctcagatttgcctaagcttaagcttccctgtctctcattgtgtgttgctttcaatgcagttacataaatggcttttttgtttatgcaccaaaaacactaattcatctgcaaagctcacatttccagaaacattccatttctgccagcacctagaagccaatattttgcctattcctgtaaccagcacacatatttatttttttctagatcaaatgtattatgcagtaagagtcttaattttgttttcacaggttgttttgaatggtaaagttgatgcattctgtggaggctctatcgttaatgaaaaatggattgtaactgctgcccactgtgttgaaactggtgttaaaattacagttgtcgcaggtaaatacacagaaagaataataatctgcagcaccactagctctttaatatgattggtacaccatattttactaaggtctaataaaattgttgttgaataaattgggctaaaggcagaagggtcataatttcagaacccacgtcgcaccgtcctccaagcatccatagttcttttgatatacccctattatcactcatttcagtgaggtacaattagttcttgatgtagccatttccataccagaaggccttcccaaaaatcagtgtcatgtcaccgatccttttatctctggtgcttggcacaacctgtagcaggtcctcagaaaacaaacatttgaattaatggccaaatgagtttgtgctcaaaaaaggggtgaggatacttgaaatttggaaaatctaggataattcatgactagtggattcattatcaccaatgaaaggcttataacagcatgagtgaacagaaccatctctatgatagtcctgaatggctttttggtctgaaaaatatgcattggctctcattacatttaaccaaaattatcacaatataagaatgagatctttaacattgccaattaggtcagtggtcccaagtagtcacttagaaaatctgtgtatgtgaaatactgtttgtgacttaaaatgaaatttatttttaataggtgaacataatattgaggagacagaacatacagagcaaaagcgaaatgtgattcgaattattcctcaccacaactacaatgcagctattaataagtacaaccatgacattgcccttctggaactggacgaacccttagtgctaaacagctacgttacacctatttgcattgctgacaaggaatacacgaacatcttcctcaaatttggatctggctatgtaagtggctggggaagagtcttccacaaagggagatcagctttagttcttcagtaccttagagttccacttgttgaccgagccacatgtcttcgatctacaaagttcaccatctataacaacatgttctgtgctggcttccatgaaggaggtagagattcatgtcaaggagatagtgggggaccccatgttactgaagtggaagggaccagtttcttaactggaattattagctggggtgaagagtgtgcaatgaaaggcaaatatggaatatataccaaggtatcccggtatgtcaactggattaaggaaaaaacaaagctcacttaatgaaagatggatttccaaggttaattcattggaattgaaaattaacagggcctctcactaactaatcactttcccatcttttgttagatttgaatatatacattctatgatcattgctttttctctttacaggggagaatttcatattttacctgagcaaattgattagaaaatggaaccactagaggaatataatgtgttaggaaattacagtcatttctaagggcccagcccttgacaaaattgtgaagttaaattctccactctgtccatcagatactatggttctccactatggcaactaactcactcaattttccctccttagcagcattccatcttcccgatcttctttgcttctccaaccaaaacatcaatgtttattagttctgtatacagtacaggatctttggtctactctatcacaaggccagtaccacactcatgaagaaagaacacaggagtagctgagaggctaaaactcatcaaaaacactactccttttcctctaccctattcctcaatcttttaccttttccaaatcccaatccccaaatcagtttttctctttcttactccctctctcccttttaccctccatggtcgttaaaggagagatggggagcatcattctgttatacttctgtacacagttatacatgtctatcaaacccagacttgcttccgtagtggagacttgcttttcagaacatagggatgaagtaaggtgcctgaaaagtttgggggaaaagtttctttcagagagttaagttattttatatatataatatatatataaaatatataatatacaatataaatatatagtgtgtgtgtatgcgtgtgtgtagacacacacgcatacacacatataatggaagcaataagccattctaagagcttgtatggttatggaggtctgactaggcatgatttcacgaaggcaagattggcatatcattgtaactaaaaaagctgacattgacccagacatattgtactctttctaaaaataataataataatgctaacagaaagaagagaaccgttcgtttgcaatctacagctagtagagactttgaggaagaattcaacagtgtgtcttcagcagtgttcagagccaagcaagaagttgaagttgcctagaccagaggacataagtatcatgtctcctttaactagcataccccgaagtggagaagggtgcagcaggctcaaaggcataagtcattccaatcagccaactaagttgtccttttctggtttcgtgttcaccatggaacattttgattatagttaatccttctatcttgaatcttctagagagttgctgaccaactgacgtatgtttccctttgtgaattaataaactggtgttctggttcataccttggctttttgtggattccattgatgtgaatcagtcaccctgtatttgatgatgcatgggactactgacaaaatcactctgaccccgccaagctgctgccttctcctgccccaacctcacccccagccaggcctcactcttgctagttcctttagttcttttagtcaatatatttttgtcttcgcatataagtataaataaacatatttttaaatttcttggctgggcccagtggctcacgcctataatcccagcacttctggaggccaaggtgggcggatcacctgaggttaggagtttcaggccagcctggccaacatggtgaaaccctgtctctactaaaaatagaacaattagctgggcttggtaatgtgcacctataatcccagctactggggaggctgaggcaggagaatcacttgagcctggggagcagggggtgcgggaggttgcagtgagacaagatcgcaccagtgcactccccatcctgggtgaca

SEQ ID NO: 8 - DNA, 2802 bp, Homo sapiens
accactttcacaatctgctagcaaaggttatgcagcgcgtgaacatgatcatggcagaatcaccaggcctcatcaccatctgccttttaggatatctactcagtgctgaatgtacagtttttcttgatcatgaaaacgccaacaaaattctgaatcggccaaagaggtataattcaggtaaattggaagagtttgttcaagggaaccttgagagagaatgtatggaagaaaagtgtagttttgaagaagcacgagaagtttttgaaaacactgaaagaacaactgaattttggaagcagtatgttgatggagatcagtgtgagtccaatccatgtttaaatggcggcagttgcaaggatgacattaattcctatgaatgttggtgtccctttggatttgaaggaaagaactgtgaattagatgtaacatgtaacattaagaatggcagatgcgagcagttttgtaaaaatagtgctgataacaaggtggtttgctcctgtactgagggatatcgacttgcagaaaaccagaagtcctgtgaaccagcagtgccatttccatgtggaagagtttctgtttcacaaacttctaagctcacccgtgctgagactgtttttcctgatgtggactatgtaaattctactgaagctgaaaccattttggataacatcactcaaagcacccaatcatttaatgacttcactcgggttgttggtggagaagatgccaaaccaggtcaattcccttggcaggttgttttgaatggtaaagttgatgcattctgtggaggctctatcgttaatgaaaaatggattgtaactgctgcccactgtgttgaaactggtgttaaaattacagttgtcgcaggtgaacataatattgaggagacagaacatacagagcaaaagcgaaatgtgattcgaattattcctcaccacaactacaatgcagctattaataagtacaaccatgacattgcccttctggaactggacgaacccttagtgctaaacagctacgttacacctatttgcattgctgacaaggaatacacgaacatcttcctcaaatttggatctggctatgtaagtggctggggaagagtcttccacaaagggagatcagctttagttcttcagtaccttagagttccacttgttgaccgagccacatgtcttcgatctacaaagttcaccatctataacaacatgttctgtgctggcttccatgaaggaggtagagattcatgtcaaggagatagtgggggaccccatgttactgaagtggaagggaccagtttcttaactggaattattagctggggtgaagagtgtgcaatgaaaggcaaatatggaatatataccaaggtatcccggtatgtcaactggattaaggaaaaaacaaagctcacttaatgaaagatggatttccaaggttaattcattggaattgaaaattaacagggcctctcactaactaatcactttcccatcttttgttagatttgaatatatacattctatgatcattgctttttctctttacaggggagaatttcatattttacctgagcaaattgattagaaaatggaaccactagaggaatataatgtgttaggaaattacagtcatttctaagggcccagcccttgacaaaattgtgaagttaaattctccactctgtccatcagatactatggttctccactatggcaactaactcactcaattttccctccttagcagcattccatcttcccgatcttctttgcttctccaaccaaaacatcaatgtttattagttctgtatacagtacaggatctttggtctactctatcacaaggccagtaccacactcatgaagaaagaacacaggagtagctgagaggctaaaactcatcaaaaacactactccttttcctctaccctattcctcaatcttttaccttttccaaatcccaatccccaaatcagtttttctctttcttactccctctctcccttttaccctccatggtcgttaaaggagagatggggagcatcattctgttatacttctgtacacagttatacatgtctatcaaacccagacttgcttccgtagtggagacttgcttttcagaacatagggatgaagtaaggtgcctgaaaagtttgggggaaaagtttctttcagagagttaagttattttatatatataatatatatataaaatatataatatacaatataaatatatagtgtgtgtgtatgcgtgtgtgtagacacacacgcatacacacatataatggaagcaataagccattctaagagcttgtatggttatggaggtctgactaggcatgatttcacgaaggcaagattggcatatcattgtaactaaaaaagctgacattgacccagacatattgtactctttctaaaaataataataataatgctaacagaaagaagagaaccgttcgtttgcaatctacagctagtagagactttgaggaagaattcaacagtgtgtcttcagcagtgttcagagccaagcaagaagttgaagttgcctagaccagaggacataagtatcatgtctcctttaactagcataccccgaagtggagaagggtgcagcaggctcaaaggcataagtcattccaatcagccaactaagttgtccttttctggtttcgtgttcaccatggaacattttgattatagttaatccttctatcttgaatcttctagagagttgctgaccaactgacgtatgtttccctttgtgaattaataaactggtgttctggttcat

SEQ ID NO: 9 - DNA, 14121 bp, Homo sapiens
attcccaccgggacctgcggggctgagtgcccttctcggttgctgccgctgaggagcccgcccagccagccagggccgcgaggccgaggccaggccgcagcccaggagccgccccaccgcagctggcgatggacccgccgaggcccgcgctgctggcgctgctggcgctgcctgcgctgctgctgctgctgctggcgggcgccagggccgaagaggaaatgctggaaaatgtcagcctggtctgtccaaaagatgcgacccgattcaagcacctccggaagtacacatacaactatgaggctgagagttccagtggagtccctgggactgctgattcaagaagtgccaccaggatcaactgcaaggttgagctggaggttccccagctctgcagcttcatcctgaagaccagccagtgcaccctgaaagaggtgtatggcttcaaccctgagggcaaagccttgctgaagaaaaccaagaactctgaggagtttgctgcagccatgtccaggtatgagctcaagctggccattccagaagggaagcaggttttcctttacccggagaaagatgaacctacttacatcctgaacatcaagaggggcatcatttctgccctcctggttcccccagagacagaagaagccaagcaagtgttgtttctggataccgtgtatggaaactgctccactcactttaccgtcaagacgaggaagggcaatgtggcaacagaaatatccactgaaagagacctggggcagtgtgatcgcttcaagcccatccgcacaggcatcagcccacttgctctcatcaaaggcatgacccgccccttgtcaactctgatcagcagcagccagtcctgtcagtacacactggacgctaagaggaagcatgtggcagaagccatctgcaaggagcaacacctcttcctgcctttctcctacaagaataagtatgggatggtagcacaagtgacacagactttgaaacttgaagacacaccaaagatcaacagccgcttctttggtgaaggtactaagaagatgggcctcgcatttgagagcaccaaatccacatcacctccaaagcaggccgaagctgttttgaagactctccaggaactgaaaaaactaaccatctctgagcaaaatatccagagagctaatctcttcaataagctggttactgagctgagaggcctcagtgatgaagcagtcacatctctcttgccacagctgattgaggtgtccagccccatcactttacaagccttggttcagtgtggacagcctcagtgctccactcacatcctccagtggctgaaacgtgtgcatgccaacccccttctgatagatgtggtcacctacctggtggccctgatccccgagccctcagcacagcagctgcgagagatcttcaacatggcgagggatcagcgcagccgagccaccttgtatgcgctgagccacgcggtcaacaactatcataagacaaaccctacagggacccaggagctgctggacattgctaattacctgatggaacagattcaagatgactgcactggggatgaagattacacctatttgattctgcgggtcattggaaatatgggccaaaccatggagcagttaactccagaactcaagtcttcaatcctgaaatgtgtccaaagtacaaagccatcactgatgatccagaaagctgccatccaggctctgcggaaaatggagcctaaagacaaggaccaggaggttcttcttcagactttccttgatgatgcttctccgggagataagcgactggctgcctatcttatgttgatgaggagtccttcacaggcagatattaacaaaattgtccaaattctaccatgggaacagaatgagcaagtgaagaactttgtggcttcccatattgccaatatcttgaactcagaagaattggatatccaagatctgaaaaagttagtgaaagaagctctgaaagaatctcaacttccaactgtcatggacttcagaaaattctctcggaactatcaactctacaaatctgtttctcttccatcacttgacccagcctcagccaaaatagaagggaatcttatatttgatccaaataactaccttcctaaagaaagcatgctgaaaactaccctcactgcctttggatttgcttcagctgacctcatcgagattggcttggaaggaaaaggctttgagccaacattggaagctctttttgggaagcaaggatttttcccagacagtgtcaacaaagctttgtactgggttaatggtcaagttcctgatggtgtctctaaggtcttagtggaccactttggctataccaaagatgataaacatgagcaggatatggtaaatggaataatgctcagtgttgagaagctgattaaagatttgaaatccaaagaagtcccggaagccagagcctacctccgcatcttgggagaggagcttggttttgccagtctccatgacctccagctcctgggaaagctgcttctgatgggtgcccgcactctgcaggggatcccccagatgattggagaggtcatcaggaagggctcaaagaatgacttttttcttcactacatcttcatggagaatgcctttgaactccccactggagctggattacagttgcaaatatcttcatctggagtcattgctcccggagccaaggctggagtaaaactggaagtagccaacatgcaggctgaactggtggcaaaaccctccgtgtctgtggagtttgtgacaaatatgggcatcatcattccggacttcgctaggagtggggtccagatgaacaccaacttcttccacgagtcgggtctggaggctcatgttgccctaaaagctgggaagctgaagtttatcattccttccccaaagagaccagtcaagctgctcagtggaggcaacacattacatttggtctctaccaccaaaacggaggtgatcccacctctcattgagaacaggcagtcctggtcagtttgcaagcaagtctttcctggcctgaattactgcacctcaggcgcttactccaacgccagctccacagactccgcctcctactatccgctgaccggggacaccagattagagctggaactgaggcctacaggagagattgagcagtattctgtcagcgcaacctatgagctccagagagaggacagagccttggtggataccctgaagtttgtaactcaagcagaaggtgcgaagcagactgaggctaccatgacattcaaatataatcggcagagtatgaccttgtccagtgaagtccaaattccggattttgatgttgacctcggaacaatcctcagagttaatgatgaatctactgagggcaaaacgtcttacagactcaccctggacattcagaacaagaaaattactgaggtcgccctcatgggccacctaagttgtgacacaaaggaagaaagaaaaatcaagggtgttatttccataccccgtttgcaagcagaagccagaagtgagatcctcgcccactggtcgcctgccaaactgcttctccaaatggactcatctgctacagcttatggctccacagtttccaagagggtggcatggcattatgatgaagagaagattgaatttgaatggaacacaggcaccaatgtagataccaaaaaaatgacttccaatttccctgtggatctctccgattatcctaagagcttgcatatgtatgctaatagactcctggatcacagagtccctcaaacagacatgactttccggcacgtgggttccaaattaatagttgcaatgagctcatggcttcagaaggcatctgggagtcttccttatacccagactttgcaagaccacctcaatagcctgaaggagttcaacctccagaacatgggattgccagacttccacatcccagaaaacctcttcttaaaaagcgatggccgggtcaaatataccttgaacaagaacagtttgaaaattgagattcctttgccttttggtggcaaatcctccagagatctaaagatgttagagactgttaggacaccagccctccacttcaagtctgtgggattccatctgccatctcgagagttccaagtccctacttttaccattcccaagttgtatcaactgcaagtgcctctcctgggtgttctagacctctccacgaatgtctacagcaacttgtacaactggtccgcctcctacagtggtggcaacaccagcacagaccatttcagccttcgggctcgttaccacatgaaggctgactctgtggttgacctgctttcctacaatgtgcaaggatctggagaaacaacatatgaccacaagaatacgttcacactatcatgtgatgggtctctacgccacaaatttctagattcgaatatcaaattcagtcatgtagaaaaacttggaaacaacccagtctcaaaaggtttactaatattcgatgcatctagttcctggggaccacagatgtctgcttcagttcatttggactccaaaaagaaacagcatttgtttgtcaaagaagtcaagattgatgggcagttcagagtctcttcgttctatgctaaaggcacatatggcctgtcttgtcagagggatcctaacactggccggctcaatggagagtccaacctgaggtttaactcctcctacctccaaggcaccaaccagataacaggaagatatgaagatggaaccctctccctcacctccacctctgatctgcaaagtggcatcattaaaaatactgcttccctaaagtatgagaactacgagctgactttaaaatctgacaccaatgggaagtataagaactttgccacttctaacaagatggatatgaccttctctaagcaaaatgcactgctgcgttctgaatatcaggctgattacgagtcattgaggttcttcagcctgctttctggatcactaaattcccatggtcttgagttaaatgctgacatcttaggcactgacaaaattaatagtggtgctcacaaggcgacactaaggattggccaagatggaatatctaccagtgcaacgaccaacttgaagtgtagtctcctggtgctggagaatgagctgaatgcagagcttggcctctctggggcatctatgaaattaacaacaaatggccgcttcagggaacacaatgcaaaattcagtctggatgggaaagccgccctcacagagctatcactgggaagtgcttatcaggccatgattctgggtgtcgacagcaaaaacattttcaacttcaaggtcagtcaagaaggacttaagctctcaaatgacatgatgggctcatatgctgaaatgaaatttgaccacacaaacagtctgaacattgcaggcttatcactggacttctcttcaaaacttgacaacatttacagctctgacaagttttataagcaaactgttaatttacagctacagccctattctctggtaactactttaaacagtgacctgaaatacaatgctctggatctcaccaacaatgggaaactacggctagaacccctgaagctgcatgtggctggtaacctaaaaggagcctaccaaaataatgaaataaaacacatctatgccatctcttctgctgccttatcagcaagctataaagcagacactgttgctaaggttcagggtgtggagtttagccatcggctcaacacagacatcgctgggctggcttcagccattgacatgagcacaaactataattcagactcactgcatttcagcaatgtcttccgttctgtaatggccccgtttaccatgaccatcgatgcacatacaaatggcaatgggaaactcgctctctggggagaacatactgggcagctgtatagcaaattcctgttgaaagcagaacctctggcatttactttctctcatgattacaaaggctccacaagtcatcatctcgtgtctaggaaaagcatcagtgcagctcttgaacacaaagtcagtgccctgcttactccagctgagcagacaggcacctggaaactcaagacccaatttaacaacaatgaatacagccaggacttggatgcttacaacactaaagataaaattggcgtggagcttactggacgaactctggctgacctaactctactagactccccaattaaagtgccacttttactcagtgagcccatcaatatcattgatgctttagagatgagagatgccgttgagaagccccaagaatttacaattgttgcttttgtaaagtatgataaaaaccaagatgttcactccattaacctcccattttttgagaccttgcaagaatattttgagaggaatcgacaaaccattatagttgtactggaaaacgtacagagaaacctgaagcacatcaatattgatcaatttgtaagaaaatacagagcagccctgggaaaactcccacagcaagctaatgattatctgaattcattcaattgggagagacaagtttcacatgccaaggagaaactgactgctctcacaaaaaagtatagaattacagaaaatgatatacaaattgcattagatgatgccaaaatcaactttaatgaaaaactatctcaactgcagacatatatgatacaatttgatcagtatattaaagatagttatgatttacatgatttgaaaatagctattgctaatattattgatgaaatcattgaaaaattaaaaagtcttgatgagcactatcatatccgtgtaaatttagtaaaaacaatccatgatctacatttgtttattgaaaatattgattttaacaaaagtggaagtagtactgcatcctggattcaaaatgtggatactaagtaccaaatcagaatccagatacaagaaaaactgcagcagcttaagagacacatacagaatatagacatccagcacctagctggaaagttaaaacaacacattgaggctattgatgttagagtgcttttagatcaattgggaactacaatttcatttgaaagaataaatgacgttcttgagcatgtcaaacactttgttataaatcttattggggattttgaagtagctgagaaaatcaatgccttcagagccaaagtccatgagttaatcgagaggtatgaagtagaccaacaaatccaggttttaatggataaattagtagagttggcccaccaatacaagttgaaggagactattcagaagctaagcaatgtcctacaacaagttaagataaaagattactttgagaaattggttggatttattgatgatgctgtcaagaagcttaatgaattatcttttaaaacattcattgaagatgttaacaaattccttgacatgttgataaagaaattaaagtcatttgattaccaccagtttgtagatgaaaccaatgacaaaatccgtgaggtgactcagagactcaatggtgaaattcaggctctggaactaccacaaaaagctgaagcattaaaactgtttttagaggaaaccaaggccacagttgcagtgtatctggaaagcctacaggacaccaaaataaccttaatcatcaattggttacaggaggctttaagttcagcatctttggctcacatgaaggccaaattccgagagaccctagaagatacacgagaccgaatgtatcaaatggacattcagcaggaacttcaacgatacctgtctctggtaggccaggtttatagcacacttgtcacctacatttctgattggtggactcttgctgctaagaaccttactgactttgcagagcaatattctatccaagattgggctaaacgtatgaaagcattggtagagcaagggttcactgttcctgaaatcaagaccatccttgggaccatgcctgcctttgaagtcagtcttcaggctcttcagaaagctaccttccagacacctgattttatagtccccctaacagatttgaggattccatcagttcagataaacttcaaagacttaaaaaatataaaaatcccatccaggttttccacaccagaatttaccatccttaacaccttccacattccttcctttacaattgactttgtagaaatgaaagtaaagatcatcagaaccattgaccagatgctgaacagtgagctgcagtggcccgttccagatatatatctcagggatctgaaggtggaggacattcctctagcgagaatcaccctgccagacttccgtttaccagaaatcgcaattccagaattcataatcccaactctcaaccttaatgattttcaagttcctgaccttcacataccagaattccagcttccccacatctcacacacaattgaagtacctacttttggcaagctatacagtattctgaaaatccaatctcctcttttcacattagatgcaaatgctgacatagggaatggaaccacctcagcaaacgaagcaggtatcgcagcttccatcactgccaaaggagagtccaaattagaagttctcaattttgattttcaagcaaatgcacaactctcaaaccctaagattaatccgctggctctgaaggagtcagtgaagttctccagcaagtacctgagaacggagcatgggagtgaaatgctgttttttggaaatgctattgagggaaaatcaaacacagtggcaagtttacacacagaaaaaaatacactggagcttagtaatggagtgattgtcaagataaacaatcagcttaccctggatagcaacactaaatacttccacaaattgaacatccccaaactggacttctctagtcaggctgacctgcgcaacgagatcaagacactgttgaaagctggccacatagcatggacttcttctggaaaagggtcatggaaatgggcctgccccagattctcagatgagggaacacatgaatcacaaattagtttcaccatagaaggacccctcacttcctttggactgtccaataagatcaatagcaaacacctaagagtaaaccaaaacttggtttatgaatctggctccctcaacttttctaaacttgaaattcaatcacaagtcgattcccagcatgtgggccacagtgttctaactgctaaaggcatggcactgtttggagaagggaaggcagagtttactgggaggcatgatgctcatttaaatggaaaggttattggaactttgaaaaattctcttttcttttcagcccagccatttgagatcacggcatccacaaacaatgaagggaatttgaaagttcgttttccattaaggttaacagggaagatagacttcctgaataactatgcactgtttctgagtcccagtgcccagcaagcaagttggcaagtaagtgctaggttcaatcagtataagtacaaccaaaatttctctgctggaaacaacgagaacattatggaggcccatgtaggaataaatggagaagcaaatctggatttcttaaacattcctttaacaattcctgaaatgcgtctaccttacacaataatcacaactcctccactgaaagatttctctctatgggaaaaaacaggcttgaaggaattcttgaaaacgacaaagcaatcatttgatttaagtgtaaaagctcagtataagaaaaacaaacacaggcattccatcacaaatcctttggctgtgctttgtgagtttatcagtcagagcatcaaatcctttgacaggcattttgaaaaaaacagaaacaatgcattagattttgtcaccaaatcctataatgaaacaaaaattaagtttgataagtacaaagctgaaaaatctcacgacgagctccccaggacctttcaaattcctggatacactgttccagttgtcaatgttgaagtgtctccattcaccatagagatgtcggcattcggctatgtgttcccaaaagcagtcagcatgcctagtttctccatcctaggttctgacgtccgtgtgccttcatacacattaatcctgccatcattagagctgccagtccttcatgtccctagaaatctcaagctttctcttccagatttcaaggaattgtgtaccataagccatatttttattcctgccatgggcaatattacctatgatttctcctttaaatcaagtgtcatcacactgaataccaatgctgaactttttaaccagtcagatattgttgctcatctcctttcttcatcttcatctgtcattgatgcactgcagtacaaattagagggcaccacaagattgacaagaaaaaggggattgaagttagccacagctctgtctctgagcaacaaatttgtggagggtagtcataacagtactgtgagcttaaccacgaaaaatatggaagtgtcagtggcaacaaccacaaaagcccaaattccaattttgagaatgaatttcaagcaagaacttaatggaaataccaagtcaaaacctactgtctcttcctccatggaatttaagtatgatttcaattcttcaatgctgtactctaccgctaaaggagcagttgaccacaagcttagcttggaaagcctcacctcttacttttccattgagtcatctaccaaaggagatgtcaagggttcggttctttctcgggaatattcaggaactattgctagtgaggccaacacttacttgaattccaagagcacacggtcttcagtgaagctgcagggcacttccaaaattgatgatatctggaaccttgaagtaaaagaaaattttgctggagaagccacactccaacgcatatattccctctgggagcacagtacgaaaaaccacttacagctagagggcctctttttcaccaacggagaacatacaagcaaagccaccctggaactctctccatggcaaatgtcagctcttgttcaggtccatgcaagtcagcccagttccttccatgatttccctgaccttggccaggaagtggccctgaatgctaacactaagaaccagaagatcagatggaaaaatgaagtccggattcattctgggtctttccagagccaggtcgagctttccaatgaccaagaaaaggcacaccttgacattgcaggatccttagaaggacacctaaggttcctcaaaaatatcatcctaccagtctatgacaagagcttatgggatttcctaaagctggatgtaaccaccagcattggtaggagacagcatcttcgtgtttcaactgcctttgtgtacaccaaaaaccccaatggctattcattctccatccctgtaaaagttttggctgataaattcattattcctgggctgaaactaaatgatctaaattcagttcttgtcatgcctacgttccatgtcccatttacagatcttcaggttccatcgtgcaaacttgacttcagagaaatacaaatctataagaagctgagaacttcatcatttgccctcaacctaccaacactccccgaggtaaaattccctgaagttgatgtgttaacaaaatattctcaaccagaagactccttgattcccttttttgagataaccgtgcctgaatctcagttaactgtgtcccagttcacgcttccaaaaagtgtttcagatggcattgctgctttggatctaaatgcagtagccaacaagatcgcagactttgagttgcccaccatcatcgtgcctgagcagaccattgagattccctccattaagttctctgtacctgctggaattgtcattccttcctttcaagcactgactgcacgctttgaggtagactctcccgtgtataatgccacttggagtgccagtttgaaaaacaaagcagattatgttgaaacagtcctggattccacatgcagctcaaccgtacagttcctagaatatgaactaaatgttttgggaacacacaaaatcgaagatggtacgttagcctctaagactaaaggaacatttgcacaccgtgacttcagtgcagaatatgaagaagatggcaaatatgaaggacttcaggaatgggaaggaaaagcgcacctcaatatcaaaagcccagcgttcaccgatctccatctgcgctaccagaaagacaagaaaggcatctccacctcagcagcctccccagccgtaggcaccgtgggcatggatatggatgaagatgacgacttttctaaatggaacttctactacagccctcagtcctctccagataaaaaactcaccatattcaaaactgagttgagggtccgggaatctgatgaggaaactcagatcaaagttaattgggaagaagaggcagcttctggcttgctaacctctctgaaagacaacgtgcccaaggccacaggggtcctttatgattatgtcaacaagtaccactgggaacacacagggctcaccctgagagaagtgtcttcaaagctgagaagaaatctgcagaacaatgctgagtgggtttatcaaggggccattaggcaaattgatgatatcgacgtgaggttccagaaagcagccagtggcaccactgggacctaccaagagtggaaggacaaggcccagaatctgtaccaggaactgttgactcaggaaggccaagccagtttccagggactcaaggataacgtgtttgatggcttggtacgagttactcaagaattccatatgaaagtcaagcatctgattgactcactcattgattttctgaacttccccagattccagtttccggggaaacctgggatatacactagggaggaactttgcactatgttcataagggaggtagggacggtactgtcccaggtatattcgaaagtccataatggttcagaaatactgttttcctatttccaagacctagtgattacacttcctttcgagttaaggaaacataaactaatagatgtaatctcgatgtatagggaactgttgaaagatttatcaaaagaagcccaagaggtatttaaagccattcagtctctcaagaccacagaggtgctacgtaatcttcaggaccttttacaattcattttccaactaatagaagataacattaaacagctgaaagagatgaaatttacttatcttattaattatatccaagatgagatcaacacaatcttcagtgattatatcccatatgtttttaaattgttgaaagaaaacctatgccttaatcttcataagttcaatgaatttattcaaaacgagcttcaggaagcttctcaagagttacagcagatccatcaatacattatggcccttcgtgaagaatattttgatccaagtatagttggctggacagtgaaatattatgaacttgaagaaaagatagtcagtctgatcaagaacctgttagttgctcttaaggacttccattctgaatatattgtcagtgcctctaactttacttcccaactctcaagtcaagttgagcaatttctgcacagaaatattcaggaatatcttagcatccttaccgatccagatggaaaagggaaagagaagattgcagagctttctgccactgctcaggaaataattaaaagccaggccattgcgacgaagaaaataatttctgattaccaccagcagtttagatataaactgcaagatttttcagaccaactctctgattactatgaaaaatttattgctgaatccaaaagattgattgacctgtccattcaaaactaccacacatttctgatatacatcacggagttactgaaaaagctgcaatcaaccacagtcatgaacccctacatgaagcttgctccaggagaacttactatcatcctctaattttttaaaagaaatcttcatttattcttcttttccaattgaactttcacatagcacagaaaaaattcaaactgcctatattgataaaaccatacagtgagccagccttgcagtaggcagtagactataagcagaagcacatatgaactggacctgcaccaaagctggcaccagggctcggaaggtctctgaactcagaaggatggcattttttgcaagttaaagaaaatcaggatctgagttattttgctaaacttgggggaggaggaacaaataaatggagtctttattgtgtatcata

SEQ ID NO: 10 - DNA, 550 bp, Homo sapiens
catcgagaaatttcaggaggatctttcagaagatgcgtttccaattttgagggggcgtcagctcttcaccggagacccaaatacaacaaatcaagtcgcctgccctggcgacactttcgaaggactggagtgggaatcagagcttcacgggttaaaaagccgatgtcacatcggccgttcgaaactcctcctcttgcagtgaggtgaagacatttgaaaatcaccccactgcaaactcctccccctgctagaaacctcacattgaaatgctgtaaatgacgtgggccccgagtgcaatcgcgggaagccagggtttccagctaggacacagcaggtcgtgatccgggtcgggacactgcctggcagaggctgcgagcatggggccctggggctggaaattgcgctggaccgtcgccttgctcctcgccgcggcggggactgcaggtaaggcttgctccaggcgccagaataggttgagagggagcccccggggggcccttgggaatttatttttttgggtacaaataatcactccatccctgggagactt

SEQ ID NO: 11 - DNA, 346 bp, Homo sapiens
ctgttcctgatcggatgacatttctggttaattctttagttggcaggaaatagacacaggaaacgtggtcagtttctgattctggcgttgagagaccctttctccttttcctctctctcagtgggcgacagatgygaaagaaacgagttccagtgccaagacgggaaatgcatctcctacaagtgggtctgcgatggcagcgctgagtgccaggatggctctgatgagtcccaggagacgtgctgtgagtcccctttgggcatgatatgcatttatttttgtaatagagacagggtctcrccatgttggccaggctggtcttgaatttctggtctcaagtgatccg

SEQ ID NO: 12 - DNA, 368 bp, Homo sapiens
cctgacctcacgtgatccacccgccttggcctcccaaagtgctgggattacaggcgtgagccactgtgctcggcctcagtgggtctttcctttgagtgacagttcaatcctgtctcttctgtagtgtctgtcacctgcaaatccggggacttcagctgtgggggccgtgtcaaccgctgcattcctcagttctggaggtgcgatggccaagtggactgcgacaacggctcagacgagcaaggctgtcgtaagtgtggccctgcctttgctattgagcctatctgagtcctggggagtggtctgactttgtctctacggggtcctgctcgagctgcaaggcagctgccccgaactgggctccatctctt

SEQ ID NO: 13 - DNA, 539 bp, Homo sapiens
cgtccccggctatagaatgggctggtgytgggagacttcacacggtgatggtggtctcggcccatccatccctgcagcccccaagacgtgctcccaggacgagtttcgctgccacgatgggaagtgcatctctcggcagttcgtctgtgactcagaccgggactgcttggacggctcagacgaggcctcctgcccggtgctcacctgtggtcccgccagcttccagtgcaacagctccacctgcatcccccagctgtgggcctgcgacaacgaccccgactgcgaagatggctcggatgagtggccgcagcgctgtaggggtctttacgtgttccaaggggacagtagcccctgctcggccttcgagttccactgcctaagtggcgagtgcatccactccagctggcgctgtgatggtggccccgactgcaaggacaaatctgacgaggaaaactgcggtatgggcggggccagggtgggggcggggcgtcctatcacctgtccctgggctcccccaggtgtgggacatgcagtgattt

SEQ ID NO: 14 - DNA, 272 bp, Homo sapiens
aaaaggccctgcttctttttctctggttgtctcttcttgagaaaatcaacacactctgtcctgttttccagctgtggccacctgtcgccctgacgaattccagtgctctgatggaaactgcatccatggcagccggcagtgtgaccgggaatatgactgcaaggacatgagcgatgaagttggctgcgttaatggtgagcgctggccatctggttttccatcccccattctctgtgccttgctgcttgcaaatgatttgtgaagccagaggg

SEQ ID NO: 15 - DNA, 277 bp, Homo sapiens
tgaatgagtgccaagcaaactgaggctcagacacacctgaccttcctccttcctctctctggctctcacagtgacactctgcgagggacccaacaagttcaagtgtcacagcggcgaatgcatcaccctggacaaagtctgcaacatggctagagactgccgggactggtcagatgaacccatcaaagagtgcggtgagtctcggtgcaggcggcttgcagagtttgtgrggagccaggaaagggactgagacatgagtgctgtagggttttgggaa

SEQ ID NO: 16 - DNA, 350 bp, Homo sapiens
gaggttgtaatgagccaaggttggcggcgaagggatgggtaggggcccgagagtgaccagtctgcatcccctggccctgcgcagggaccaacgaatgcttggacaacaacggcggctgttcccacgtctgcaatgaccttaagatcggctacgagtgcctgtgccccgacggcttccagctggtggcccagcgaagatgcgaaggtgattyccsggtgggactgagccctgggccccctctgcgcttcctgacatggcaaccaaacccctcatgcctcagtttccccatctgttaagtgtgcttgaaagcagttaggagggtttcatgagattccacctgcatggaaaac

SEQ ID NO: 17 - DNA, 326 bp, Homo sapiens
cttcgaaggtgtgggttttggcctgggccccatcgctccgtctctagccattggggaagagcctccccaccaagcctctttctctctcttccagatatcgatgagtgtcaggatcccgacacctgcagccagctctgcgtgaacctggagggtggctacaagtgccagtgtgaggaaggcttccagctggacccccacacgaagrcctgcaaggctgtgggtgagcacgggaaggcggcgggtgggggcggcctcaccccttgcaggcagcagtggtgggggagtttcatcctctgaactttgcacagactcatatcccctgaccg

SEQ ID NO: 18 - DNA, 689 bp, Homo sapiens
accctgcaggatgacacaaggggatggggaggcactcttggttccatcgacgggtcccctctgaccccctgacctcgctccccggacccccaggctccatcgcctacctcttcttcaccaaccggcacgaggtcaggaagatgacgctggaccggagcgagtacaccagcctcatccccaacctgaggaacgtggtcgctctggacacggaggtggccagcaatagaatctactggtctgacctgtcccagagaatgatctgcaggtgagcgtcgcccctgcctgcagccttggccygcaggtgagatgagggctcctggygctgatgcccttctctcctcctgcctcagcacccagcttgacagagcccacggcgtctcttcctatgacaccrtcatcagcagrgacatccaggcccccgacgggctggctgtggactggatccacagcaacatctactggaccgactctgtcctgggcactgtctctgttgcggataccaagggcgtgaagaggaaaacgttattcagggagaacggctccaagccaagggccatcgtggtggatcctgttcatgggtgcgtatccacgacgctgagggctgcagagggaatggagggagcaggaaggrgcttcaggaactggttagtgggctgggcatggtggctcaaagcacctgtaatcccagc

SEQ ID NO: 19 - DNA, 322 bp, Homo sapiens
ctgagcctggctgtttcttccagaattcgttgcacgcattggctgggatcctcccccgccctccagcctcacagctattctctgtcctcccaccagcttcatgtactggactgactggggaactccygccaagatcaagaaagggggcctgaatggtgtggacatctactcgctggtgactgaaaacattcagtggcccaatggcatcaccctaggtatgttcgcaggacagccgtcccagccagggccgggcacaggctggaggacagaygggggttgccaggtggctctgggacaagcccaagctgctccctgaaggttt

SEQ ID NO: 20 - DNA, 349 bp, Homo sapiens
cctctccaggtgcttttctgctaggtccctggcagggggtcttcctgcccggagcagcgtgkccaggccctcaggmccctctgggactggcatcagcacgtgacctctccttatccacttgtgtgtctagatctcctcagtggccgcctytactgggttgactccaaacttcactccatctcaagcatcgatgtcaaygggggcaaccggaagaccatcttggaggatgaaaagaggctggcccaccccttctccttggccgtctttgaggtgtggcttacgtacgagatgcaagcacttaggtggcggatagacacagactatagatcactcaagccaagatgaacgc

SEQ ID NO: 21 - DNA, 659 bp, Homo sapiens
ctagttgtggagagagggtggcctgtgtctcatcccagtgtttaacgggatttgtcatcttccttgctgcctgtttaggacaaagtattttggacagatatcatcaacgaagccattttcagtgccaaccgcctcacaggttccgatgtcaacttgttggctgaaaacctactgtccccagaggatatggtyctcttccacaacctcacccagccaagaggtaagggtgggtcagccccacccccccaaccttgaaacctccttgtggaaactctggaatgttctggaaatttctggaatcttctggtatagctgatgatctcgttcctgccctgactccgcttcttctgccccaggagtgaactggtgtgagaggaccaccctgagcaatggcggctgccagtatctgtgcctccctgccccgcagatcaacccccactcgcccaagtttacctgcgcctgcccggacggcatgctgctggccagggacatgaggagctgcctcacaggtgtggcacacgccttgtttctgcgtcctgtgtcctccaactgccccctcctgagcctctctctgctcatctgtcaaatgggtacctcaaggtcgttgtaaggactcatgagtcgggataaccatacttttcttggatggacacatcagc

SEQ ID NO: 22 - DNA, 326 bp, Homo sapiens
cattaggcgcacacctatgagaagggcctgcaggcacgtggcactcagaagacgtttatttattctttcagaggctgaggctgcagtggccacccaggagacatccaccgtcaggctaaaggtcagctccacagccgtaaggacacagcacacaaccacccgrcctgttcccgacacctcccggctgcctggggccacccctgggctcaccacggtggagatagtgacaatgtctcaccaaggtaaagactgggccctccctaggcccctcttcacccagagacgggtcccttcagtggccacgaacattttggtcacgagatgga

SEQ ID NO: 23 - DNA, 299 bp, Homo sapiens
aagtgtccagggagatgtgccaggcgctttcctgccgtgaccaccgtcctctgcctgctccatttcttggtggccttcctttagacctgggcctcactcttgcttctctcctgcagctctgggcgacgttgctggcagaggaaatgagaagaagcccagtagcgtgagggctctgtccattgtcctccccatcggtaagcgcgggccggtcccccagcgtcccccaggtcacagcctccygctatgtgacctcgtgcctggctggttgggcctgttcactttttctcctggacagggaa

SEQ ID NO: 24 - DNA, 343 bp, Homo sapiens
caggagtcaaggttatggtacgatgcccgtgttttcactccagccacggagctgggtctctggtctcgggggcagctgtgtgacagagcgtgcctctccctacagtgctcctcgtcttcctttgcctgggggtcttccttctatggaagaactggcggcttaagaacatcaacagcatcaactttgacaaccccgtctatcagaagaccacagaggatgaggtccacatttgccacaaccaggacggctacagctacccctcggtgagtgaccctctctagaaagccagagcccatggcggccccctcccagctggaggcatatgatcctcaagggaccaggc

SEQ ID NO: 25 - DNA, 275 bp, Homo sapiens
tctccctctggcggctcctgggggaacatgcttggggatcaggctgggggaggctgccaggcccaggaggtgagaagtaggtggcctccagccgtgtttcctgaatgctggactgatagtttccgctgtttaccatttgttggcagagacagatggtcagtctggaggatgacgtggcgtgaacatctgcctggagtcccgtccctgcccagaacccttcctgagacctcgccrgccttgttttattcaaagacagagaagaccaaagcattgcc

SEQ ID NO: 26 - DNA, 289 bp, Homo sapiens
agcctcacctcttacttttccattgagtcatctaccaaaggagatgtcaagggttcggttctttctcgggaatattcaggaactattgctagtgaggccaacacttacttgaattccaagagcacacggtcttcagtgaagctgcagggcacttccaaaattgatgatatctggaaccttgaagtaaaagaaaattttgctggagaagccacactccaacgcatatattccctctgggagcacagtacgaaaaaccacttacagctagagggcctctttttcaccaacg

SEQ ID NO: 27 - DNA, 372 bp, Homo sapiens
tgttgtaatttgtaagtaggggtgagataaagtacacctagggtttgctgggtttcttccatgtcatcatgttcctccttgcatggggccaggatccgtggaggttgcctggcacctacgtggtggtgctgaaggaggagacccacctctcgcagtcagagcgcactgcccgccgcctgcaggcccaggctgcccgccggggatacctcaccaagatcctgcatgtcttccatggccttcttcctggcttcctggtgaagatgagtggcgacctgctggagctggtgagccaccctttttgggaatggcacttcctgatagggctgggccactgcatatacactggggactgtgcttagtaggcccattgct

SEQ ID NO: 28 - DNA, 250 bp, Homo sapiens
aactataaggttgactttatgctcattccctcctctcccacaaatgtcgccttggaaagacggaggcagcctggtggaggtgtatctcctagacaccagcatacagagtgaccaccgggaaatcgagggcagggtcatggtcaccgacttcgagaatgtgcccgaggaggacgggacccgcttccacagacaggtaagcacggccgtctgatgggagggctgcctctgcccatatccccatcctggaggt

SEQ ID NO: 29 - DNA, 333 bp, Homo sapiens
agctggcaaggcctgagtctgcctctgcaacccctctcttgggctcctttctctgccacccacctcctcacctttccaggtcatcacagttggggccaccaatgcccaagaccagccggtgaccctggggactttggggaccaactttggccgctgtgtggacctctttgccccaggggaggacatcattggtgcctccagcgactgcagcacctgctttgtgtcacagagtgggacatcacaggctgctgcccacgtggctggtaagtcaccaccccactgcctcggccaccgtgatgctaacagcccctttggcagtcagggtctgtgccg

SEQ ID NO: 30 - DNA, 342 bp, Homo sapiens
tgatcctgtctagtccctttctgtgttttcaaagcccattctaaagcagattcccatttccgtctttgactctaaggcccaagggggcaagctggtctgccgggcccacaacgcttttgggggtgagggtgtctacgccattgccaggtgctgcctgctaccccaggccaactgcagcgtccacacagctccaccagctgaggccagcatggggacccgtgtccactgccaccaacagggccacgtcctcacaggtaggaggctgggcttgccctggggtgaggaggggtctctttctccttatgcacccactgcccgcgaggcttggtcctcacaagtgtg

SEQ ID NO: 31 - DNA, 188902 bp, Homo sapiens
ggggccggaccaggcagcactcggcttttaacctgggcagtgaaggcgggggaaagagcaaaaggaaggggtggtgtgcggagtaggggtgggtggggggaattggaagcaaatgacatcacagcaggtcagagaaaaagggttgagcggcaggcacccagagtagtaggtctttggcattaggagcttgagcccagacggccctagcagggaccccagcgcccgagagaccatgcagaggtcgcctctggaaaaggccagcgttgtctccaaactttttttcaggtgagaaggtggccaaccgagcttcggaaagacacgtgcccacgaaagaggagggcgtgtgtatgggttgggtttggggtaaaggaataagcagtttttaaaaagatgcgctatcattcattgttttgaaagaaaatgtgggtattgtagaataaaacagaaagcattaagaagagatggaagaatgaactgaagctgattgaatagagagccacatctacttgcaactgaaaagttagaatctcaagactcaagtacgctactatgcacttgttttatttcatttttctaagaaactaaaaatacttgttaataagtacctaagtatggtttattggttttcccccttcatgccttggacacttgattgtcttcttggcacatacaggtgccatgcctgcatatagtaagtgctcagaaaacatttcttgactgaattcagccaacaaaaattttggggtaggtagaaaatatatgcttaaagtatttattgttatgagactggatatatctagtatttgtcacaggtaaatgattcttcaaaaattgaaagcaaatttgttgaaatatttattttgaaaaaagttacttcacaagctataaattttaaaagccataggaatagataccgaagttatatccaactgacatttaataaattgtattcatagcctaatgtgatgagccacagaagcttgcaaactttaatgagattttttaaaatagcatctaagttcggaatcttaggcaaagtgttgttagatgtagcacttcatatttgaagtgttctttggatattgcatctactttgttcctgttattatactggtgtgaatgaatgaataggtactgctctctcttgggacattacttgacacataattacccaatgaataagcatactgaggtatcaaaaaagtcaaatatgttataaatagctcatatatgtgtgtaggggggaaggaatttagctttcacatctctcttatgtttagttctctgcatgtgcagttaatcctggaactccggtgctaaggagagactgttggcccttgaaggagagctcctccctgtggatgagagagaaggactttactctttggaattatctttttgtgttgatgttatccaccttttgttactccacctataaaatcggcttatctattgatctgttttcctagtccttataaagtcaaaatgttaattggcataaattatagactttttttagcagagaactttgaggaacctaaatgccaaccagtctaaaaatgcagttttcagaagaatgaatatttcatggatagttctaaatactaatgaactttaaaatagcttactattgatctgtcaaagtgggtttttatataattttctttttacaaatcacctgacacatttaatataggttaaaaaatgctatcaggctggtttgcaaagaaaatgtattacaaaggctgctaagtgtgttaagagcatactcatttctgttctccaaaatatttcataaggtgctttaagaataggtatgtttttaaaagttaagttcctactatttataggaactgacaatcacctaaaataccaatgattacaaacttccttctggccttctggactgcaattctaaaagtgtaaaaaacatattttctgcattaagttaggcagtattgcttagttttcaaagtggtaggctttggagtcagattattttgattcagatcctacatctactgtttagtagctctgttgcctgaggcaggtcccttaacatctctgtgtgtgacttgacctttaaaatttggagactgtcataggggttaatcccttgagaaaatgaatgtgaaaagttagcctaatgttaactgctattattatggattaccatattttcacattcatcacagtacatgcaccttgttaatataagatgctcaattcatctttgagtataattttgtgactctcaatctggatatgcaatgagtgggcctgtatgagaatttaatttatgaaaaattgtgtttcacatggccttaccagatatacaggaaacacgtcacatgtttctattgtatgttgttaaatgccttagaatttaactttctgaataggatcccttcagtttgagagtcataaaagagtaaaattattatggtatgagttatagattgtattgaatatctctttatatgtctaggttttgtcattggaaaaccaaaaagtttggaaaaaaaatctaagttatttcttactttcttaattttgtgtggatttcacatcaagtataaaatttgaagaacatctgaactatcataatccatatatatatataaaataaacataatctaagagagaatttcaccatgaaaaattcaggtagttcatgactatcagagcaaacaagtacattaaattgaaacttttatgaaaataacatttatgaaataggaagctatttttaaactagaagtgatatattagcatataatttataattcatatacaagtgggattgatttataaatggtcaccaacagagattgtgctatttaatttgggaaaattttttaaatttacattttctcacaacttttaaggtagttattcagtttgttcctctctgtctcttctctcatgccctgaatttttcatatttcgtttagttgtaagagtgtatatcaaaccgtgtgtcacatgacataacttgaattttcgtcgtgatatctgtgctatgtctaggtctatactgaggaactgtgggaaccccacagaatccaagtatacagtgccactgatttcttacaagggatgtggggtctcctgtaaactctgcagttagtctcaagtaagaccaaagagtaaaatattgttaggatctaaggtggaaattcagcaaagaatcacatagtctaagtctcgagtttaacagtaagataatttgagatacttttgtaattattaaacacaaagtaatgagagattttaaaacaaacaaatacacctgaatttatatatcagaataggtatggtggttcaaaatagctatctaataaaaaccacactcctattctaaacatttgcctttgatcaaaataattttgggtctcttattatgaaattgcctttctaaataatacataaatttcttctcataagtatatattagccacattattttattgttattgttttatattcatagcttgctttagattaaaaattatattacccagactggtctcttggacttgcttccaagtgacttttgactgtatcacaaaatcaaattcactctgaaaatataaagatttttcatcataatttcctttgttaacagccaagtgctacctaattttaggtgttttcattaaaaaaaaatgcattgcaaactttaaagacaattcttttgtttgtttgtttttaaaagacagagtctcactctgttgcccaggctagagtgcagtgacacaatcataactcactgcaacctccacctcctgggctcaagtgagccttccatcttgcctcacgagtagctgggtcttcaggtgtacaggtgtgtaccaccatgcctggctaactttttttttttttaagttatatagagacagtatctcactatgttgcccaggctgctcttggagctcctggcctcaagttatcctcccactcagtctcccaaagtgctgggattacaggcgtaagccacctcaccctgtcagcctaaagacagtgcttaatgaagagaaatataagtgctttgagcaatggaagtataattaaaattatactatgaaagatttataaagatgaccattttgaatgggaccacacttatttggttatataaattatgatacactattaaaaattcatcatgatgattttgtatttacattttatttacatgtttgcaatttgtgaggaaagctaaaattatggctaagccataaatatttttgcagtttgttgagggtgtttgtaaaagtgttgccaaggaagaccagttggctacccaaacaagggtttagtctaggtctgatcaatacatacacattatctcaggtttgtctatcagaaaaaccttaggttatccaaatcaaaataaaatagatgcataaaacaaaggccaatatgtgttgaacaattatattgtgatatacaactgccaagcattcccgattaccatgactccatttagtcagtccatgggcaaatgccatcaatgaggacagcccagggtttccatattctctcttggctttacatcctataggaattggaggggcccacctctgggataggagcccttctgtcttgaacaatgttgtctgaacactaacaaatgttgactttctacaccagtccctcaatagtcttttctatttatccttttgctgaccatgttttgttattacacagttgagatttttcagctgggaatctgtgttaattttgtattaattttgattagcttaactctcagagttctaaaagtacctcctgtacctgatatatgacaaaaattataattacatttatttatatataaaatatctttgtatatgtaaaatatctttgtatatataattatataattgtttcttttaattttgcaaattttaaaaagttctcctttgttttgaagtttattcctatagttttttatatgctagttaaattattaatcacttgattcaagtaatattcttatatacttataaggaatagtgtagttttaatatttaattccttgctaaagagagaagtggaatctatttttcttagctacttcatcaatattttatgtttgatgtgacagtcaaaatatccctcagagctaactgttacactagggaaatcacggttttccagttttccatttatgtgttatgggagggagtggaacttagtgtaataatattcaatacataaatgttaacacttgtttaaaggtccttgagtgagtactgctataaaatgcattattattgctagtgtcatttcacaagagcctataatttcagtgtgatagagctacaatataagtatagtattgcaaaaccatcaggaagggtgttaactatttagcatgcagttatgtgttggttgtcaaaacgttaaaaacatctctgactcagcagcaattttggcaattttgatcctgaggcatctgtgtagggcatcttcctggagaaaaacctctgagatgcaatgaggtcaaaaggggaaaacagactatgataaagatcaagttgtttggagatcttgtagaaagattaatttacaaatatgtcaagtgcattatcatggaggaaaacattgctatttctgttggttctcttcagagctctagaatcaatttaccacatagttgtttcagtgtgaaattagcattacagagtggctttacggctttactgtagggcattgtgtcagcaaagagcttaggcttcttttagcaagaagcttgtaaaaatttaatttactcttagattgcttgatgtagagaattacattcctacagagctctgaaaaatcttttttcagagtttttcacagctgtattcaagttgcaaggcttgtcaactttgctatttttctgtgcagctctgttaacttattattatcttttgacataaattatgattccaaattgtaaagctctggatgtcagggccttttctaatttgtttagtatgatattcagaccatttcaagactcttccgtggaacaatttaataaagatttttttgtgatgttaatgagttcatggtgatcaaccctagagacctgtgtctattgtagatcgatgacattcaacagtcctgcagtgctggcatcattttgataaaaaggggtcaaagcaagtgggactgtgggcagatttttaatgcttagaacaattattccatcgaagttttcttgtgtcccttctgccttagcctttgtaggatagcatgcttgctaatttcttgctcatggggtaaggaaatgaagatttttgctaggtccgtaggattattaggactactcaggcctgaagctatgcctggatatagccagaaaactctcccatagcttgctccaaggagctgagatacagcagtacttcctttgtaggtcatgattctgggtaacctggaagatgacctcattcatattctgtattctatgtgagacgttaagaaggtagaggtggccaagaaggaaattgttgctgcctttatggaacaaattatctgaaacccagctttctcgagggcttcattgaagtactcaactggggcacttaacccagtctaaggctggtcaaggaaggcttgctgggggaagtgtcttttgtattcacacctaaaggaggttattcaattagaattatccaaagagggtagggatgggctaggaaaaatttaaacaggtagtgtggaggactgacaggataagtaagcatggcaccttcaaaatatcctgagaagttccctatgacgggaacataaaatatgtgacagagatttgtgggagatgggtctggaaactctagcaggggccagatcgtaagggggctttgtaggctttgtaggctttgtttgggctttatcatactggaagtgaaaagccatggcttttaaacaggagagggacataatcagttcatatactgttgcagttttgtaaaagaaaagatgagctgaaagagtggccatggtggaggtgggtggggtgggggggagggggcggggagagagagagagagagagagatttgaaagacatttaggaggtaaaatcaactggtttggtaatcaattagtagttgaaggtgaaggaaagagaagagttaaggataacatctatatttgttgatttggataatagaggggacagtggtgctgcttattgaatgagaaaatttaatcggagaagaaggcatggagcaggagtgcagacctatgtgactctacttctctcaaaaccagaaacggaaatgatgtatatggctcagggttaggtaatatggttatttgaaaatgtattaaagtgatttagagcttagtcttaggtaagagatataagatgtctgaggtgacagttttataaatatgtagagtgcccacttgtttggccttattgtggcatagtgtgacctgagagtgttaggaagaagcagctgagttctagggacagtactggttaaattctacttagaaattatacttagaactctcctatataacctgctaactgatgtctgaacctcctgataacttcactcctttaggcagtgcttttcacatcacgggacacaacatatgagagatcatagaaattcaatgtggtatgaaaatctgcttgggacttcagatattgtctccagtgattgaataaaaataggagctcacctactatgatgaggtttctgtgtgtgttaaaagaaggttttcattacttttgaaaaggttatgtatccttgttttatgttaaaactttgagctttgttaaatatgcagagttctctttcttagcatggactacagaggtgcaactacctcctacctgacttcacatctactcccaaatgcctagtgaaggcttaataatttcaaaaagggactctagaatttcatttgataccagtcagacaaatgtgtgaaaattaagcataataggcagaatcccaggggtactgacagctgtattaagaggtgattcaagggctaaaccttagagtccagcattggttatgggtgtgacaagaaaatgaagcctatgttggctgggattagcaaccacagttctagaggaagcaaggtggagaaactatatagggggctccctttgtacgttttatttattttaaacatctctataaactctagaaattaaaacaacaataccaacacaaaagcatcactttttcgaccaaagaccattgctatacttttttgtgtaaagggctagatagtaaatattttcagctttgtgggccacataagtctctgcaatagacaatatgcaaacaaataagcatggctgtgtttcaattaaactttattatgaacattaaaatttgaatttcatataacttttacatgttgcaaaatattctttatttaaattctattgcaatatgctttaaaagatacagtttttagtctttcttagtttaaaataaaatctagaaaaaattttaagtcttctataactttttttcggtaactgaataattttaaaagtaagtgaaacatttagacatgcaaaatggacttttcagaagaagaaaatggtagcttaacagttattagattattgtccagaataatttttgacttataagtctctgttgaccatttcattgcctctttttttggaatatgcatcttttaatgtgtccttcaaggcaaaggctctatcttatctatcttgtgtcttgcattttcccagggcaatgtttttcacaatttttttaaaaaacaatactgtaatcaattttcaaataaaattttccatgggaccgcagtgtatacaaatagcagtgacaataaaagataataactctcccataaatacaaagaaacagttaacctagtgctctaaagtaaaggctacagtgattttgtataacatttatatgtaattttcttgatcctacatggttgtgtttttcacagtgttatgtttctgaaatcgagatgccttttataattgatgtcaaaagaaacttgtcagccacaaggcccaggaataagttgtaatatgggaacttagcaatacataaaggtatatatactcctgtgacctcagctgaattatttgcattggttgcatcccacaaggttgactcttaaataaatttagtttgttgcttgaaatttcttgggataaattactttgtgatgtagttttgaaaaaaaaacaggtaatatttagtctgaagtttgtctgacatactaagcaatgtaattaaagtagaagtcgcctaagctcagcactttattatgccttgaaattatactgcctgtcctacaggtgaaggtgttatgaatgcagtttgtcactgtaactctattcatagctctgaaaggctgagagtgactcagaagaatatttttgctctgaatatgaagaacgcttagactaaaactttaattacgatgctgaagaagaaagtggtaggtgattgcatgaataagtatgtaatattgttaatttctaaaaactgtgtatagttaatgtagtgcttctttttggaaaggctattgttaaattgatggtaaattctataaccaatatcaccttaaagcaagtacgcatgataaagtattataaaaccatgataatatcatatgtggcttattattgttccctgagtgttgtacaactctgttatgctgtgatgaaacctcatgcaaacaggtatgtcaaagatatgatgggctgttaactgagcttggcccacatatggtgtagtgacatgctcactaatgcagtgcagagataaccaataacagatcataacaggtttaaatatgtgcaaggagatgtcagcagaagctttcctacatagtgaatactaaacaagcctgacagcccaggatcatgttcggatcaatctagtgtgctaaaattaacatatagtcctacatttgagaatgtgtgattttcttggttcctgtctataaaataatattttaaaatacatacatttcaaatcagaagttggtgaattcactgaaatatttctagagaacactaggtattggggctcatagtgtgaaaaccactgacttaattcttcccccatcttggttgttcctgatcttcccttgtgtccccattccagccatttgtatccttagaaaatgatctcatattctacttcatctttatcttcattgtcaactgtcaggtagcaatatatgatggaagaagcatgtactttggaatcagacagacctggctggaatcctaactctgtcacttattaacaatgtgatcttaggcaatttacttaatctctctgaacctcagctactctcgtcagtacaatgagttatccttatctttacatggcacagtattattatgatatcaaaaattcattgagtatttactctgcatattagtcaaggttctccagagaagtagaaccaatgatacacacacacacacacacacacacacacacacacacacacacaatttattataaggaattgacttacatgattatgatggctaacaagtccaaaatctgcagtatgggtcagctggcaggaaacccaggagagtcaatgttccagtttgagtctgaaggcagtctgttggggaatttcgtccttctctgggaggccagcctttttgttctatacaggccttcaaccgattggatgaagttcacctttattagtgagggcaatctgctttaaccaaagtttactgatttaaatgttaatctcatccaaaaacacccacccagttgacacataaaattaaccatcactctctgtaagcactttctatgcattaagtgatagcaaataatgccagacatagggcgtctttaataaatggtaagcactgttatcagcaacaacaggattattataattagcaccttttcatctttctgtctgggctctgagaaagtacctctcttctctaaatttatccctcctttcctatgaattagacccagtgctttctctgaattatgaaggtcacactcctacaaatgccccttcccaattgcacatctgtcggctttctttgccattgacttttatctctagcttttaaatttacaggcatatgtcagttaacaatgggaatgcgttctgggtaatatgtccttaggcaattttatcgttgtgagaatactatagagtatacctacacaagcctagatgtcgtatagcctactacacacctaggcaatatgacatagtcttttgcttctaggctacaaacctgtacggcttgttactatactgaatactgcaggcagttgtgacacagtggtatttgcatatcggaacatgtctaaacacagaaaaggtgcactaaaaatactatgtagtgatctcatgggaccaccattgtatatgcagtctgctgtagactgaaatgtcatgcagtgcataactgtatcttaaatactcaaagtatcacctttgtttgtttgtccccttgtgtgcatcatcctaacgtggaatttctctgttgattagggccagcgtattagtttgctagggctaccataacaaaataccacaaatttggtggcttaaataacaggaatttattatcttatggttttgaagactagaagtacaagatcaaggtgttggcaggtttttcttctaagggccatgaggaagagtctattccatgcctttcccctaccttctggtggtttgctagaaatccttggcattccttgacttacagaggcatcaccctgatctctgttttcatcttcacatggcattctccctgtgagcctgtctctgtgtccaaacttctttactattaatataaggacaccagtcatattggattagggtctactttagtgacctcattggaatgttattacctctgtaaagatcctatctctaaataaggtcacatccttaggtaccgggggttaggactcaaacatacctttttttggggaaacacaattcaacctataacaattgataacactctttaggagcagaatgcgatatggaagtaatttgagaccataaagtatatacatgtagggagttaatctatgaaacctattgaaagccatatatacctcatgtatagtggtccataaatagcatggagacattgcagaggatgttaagtgatatgatacaggaacaatccaagaaggtcataagaaaaaggaccttttgctcttgagaggactgaagaatgactttccatttatgaaattttggtacatgtccactaaaaataggatgaaggccaaacttaggaagaatattttgataatggagaaggttgcatataaaaacattttattgaggacaattaaataatgttggctggaagttttaggatgatcatctttaggactcagaaaaagagaagaaacattattaaagaattgtccctgaacaagtataggcaccctcacatttgcattgcatttactatagaattgaaaaatgttttgaccttttttttttggcttttaatatatttgaccaagagtaacagctaagcaatacctatttgcaatcagtgtcatcatgtgggctccaaacatatcatgtttgtgtaattaattgattgacccattaatttgttcaatttctgctctgttccaggcactgaacaacatgatggagataaaagataaatattacacctgccttgtcctcaagaagttagtcttctgagggaaagaaattagcaaacaaattgtaatctcagttatgtgccatgttccatgctgggcacaggggatacagtagtttaaaaaaaacacaagatctataaggtgtttcttcttgtggaccttacagtctagggtgcttggaaacatggggcgttggcagacaagtaaatacacattttgtggtaaaggctcaggtagaagaagtacaggatagaatagagcacaccatggggaattaatctagacttcagagaggctcacacatacataatttatgtgtgactatttcaatgcatttgaggtttcttggaaatagaggttaggttttattttaaggaagttaccattttttttttcagtgtgatgtggttgaaccaaagaatgccatgcccagtgatggtaataggataatctttttaaaaattaagagccacctaataaatcaatagtttcattcagcgggagctcctgcagagttcaaaaagaagagaatctggcacagcgtttcctttaaagttcattttcctagagtgtgaatggaagcaagagattataacattttgaggtcaaaaaaattctgaaatgcctataaaaattattttctccaaattatcatcatttgtgcttttaatgacctgattgcaaagatgaacattttgaattcttaaattgcttattaggattggttaatgaatcaattatctattactgtatgttttgctattggaaaaaatagcaacttaagtgttttgcagacctttacttaggtatatgttgcttttatgaaaaaaaagatgtaaatattaagtaaaagggatttaaagcaaggcttttgaggtagagtcttattaattccttggtaaaccttgagccaattgttgtctatgttctctgcctctgtcttgctccttccttctgggattcactgtgggaatgcgggattgttaatctggggatgctgtccaatcctgcctctctcaagctttgctattgatctccctcccagtgataataaagcttgaagaaaatgaaagtagcgttagtattggtcctcaaactcaagaacaggatgaaacttaaatcttgagtcatacaattgtgtctacatactgctccccaaaaagagaagtaaagaagatgctaactttcccttttaatttgcagtacttagcaatttgttttcttgagggttaagtaataacagtggaagaaaaaagggttaaaatgccaccaagaacccaattccatgtttagtttgaaagtgggaaatcagctgccactgggaagtctgaatccaatgccatgatgttctttgaatccttctgagaaataatcatgtgtagccataacatacctgtataacagagcagagaacataaacaaatgaaggtgaagggaagattaagacagaagagaaaaattccagaatcgactgatcatttttatctgtttagatgatttcaggcagaatcctagagaccaactttatcacaactgaattttaaaaatcaccagctttgtcattgtgatgcagcatcagtttcagtattatccttggagtattaattcttaatcatcttcatcttagaacatttttgaggtcacttctagtctctatttcaccagtgaagaaacaaaaatccccaaactatatcaggtggaattacacagtattttttttttaattttggggaaagtcgattcaaggcagtaacttgcaagctagtgttagaaaggatttaataaatagtggtttttctgtacacatagtgagaggtcattacatcatttggttgttgaaagtcataaggatgtctagcatgcgctttgcctgtagtggttcatgccaggcagattcctgactcctataacccagagcttatcagagcatttatgtccccaaagagaaatgtcacctccatctttcaataaacactttagcaaagaaaaatcaagtactttaattccaaatcttgagttaattccagaataacaatgatggctcggaaaaatatgggtatttctgtcaaaggacagagaaacctagtagagagtatttactttgggtcctagtgatggtatctgaacaagctaggtgaacaaagagcctcaataagggattttgaggtctagaaaaagagaggaaataccaaataaatggaataattataaaataaataccagcaaagttaaatcaatatatcatgtgggagatatccttatatcactcatgtgatttctattttgttcctatattaggccaaggagaggtggaacttgttttcctttttccctctcagctacgaatggacatacttaaaactgtttctctgcttctgttctctaaaatgtgattgtctaacagtaaccgtgatgacgttttgacagttgcacaagtttctttctttaagctttaaaaatgccagccagtaacccagtggcatttctactataaaatcttaaggccaatccatttccccttttccttattttcttggtttcaaatatatttttattgccaatggaaataaaaatcctaaattagagagcaatggcatcccttgtcttgtgaataaagagctcctaaatgtgaacttatacaggatgcagcaatttatagggtagttaatcattcttctttctagccagttgttccagctacagttttgtggctcttgttagtggcttcattcccagatagaataaaaatcaaaccaaaatcctggaaaggcactctgaggatgcttctctaaagtagatgggcatcaactataaatcacaatgctttgtttcctctgttatgtttcaagatgggtgggattttttttgtagcattacttattattgcctctcaagtgcttgagtctttgaaatccaagtcatgtgagtgaattagatacagctgttagaagtggcctttcaatgccaatggtacacattccttggtttctttacgatactattgctcttacaacttttatctgaagtcataaattcatagttgtcccagaagttaagttccttgcttctagaggacagaaaacaaacaatttacacaactcatggtgcatgtcaccagtccttagatctcatgaaatatgcatgaaatcttaaatcacttgctgtagccacccagccattgacatatttgaaagactttagtgtatcaaagtcactataatgaaaattttgatttcaccagttctaggagtgaaaaatcaaatgtttagtaaaactttctaaaattaacactgacagttgatttctgtatactgttgttcttaataatagctttattgagatataattcatattcaaaacaacttacccatttaaagcatacaatccaatgattttttagtatcttcaaagagttgcctatcaccataaccaattttagaacactttcatcactgtaaaaagaaactccattcctattagcagtcattccttattccaaatccccctgctcgccctagacaactacaaatgtactttccatctctatagatttgcctgttctggaaattttatgtaaatagaacaaagtgttcttttgtgactggcttatttcacttagcattttttttcaaagattcatccctgttgtagcgtgtatcagtgcatcattcttttttatttttttagagacagggccttgctctgttgcccaggttggaatgtgcagtggcatgatcatgggtcactatagctttgaagtcataggcgaaagcggtcctcccacctcagtctcccgagtagctgagactacaggcttgcaccacatgactgtctaatttataattttctttagagacagggtcttgttatgttgtctaggctgctctcaaactccagggctcaagtggtcctcctcccacagcatcctaaagtgctgggattataggtgtgagccacagcacctggcttgcatcattctttttattgttgaataatatcccacttgtaagaatatgtattttatttatcctttccccagttaatagatatttcgattgttcctaattcttgtctattataaataatggtgctatgaacatttgtgtacaagtttttgtgcagacatccattttcctttcttttgggcatatacctacgagtgtaatggatgggccatatagtaactttatgtttaatattttgaggatttttcaaactgttttccaaagtggctgcatcattttaaattccttccaccattgtgtgagtgtttcaatttctccacatatttgcaacacttactattatctactcttaaaaattacagccatcctactgggcatgaagtggtatttcattgtgagttttttttttctttttctttttttctttttttgctaatgtttgtggattttcttttcattttcttgatggtgtcctttgaagcacaaaagtatttaattttgataatttccaatttattttttgttattgctgtttgtgcttctggtgttgtatctaagtgtatgctactttaaaaaattagttgtaatatggcaaattggatacatgtgtaggctttggtgtcacaatcctaattttaaaattctgactctgcccttgacaaattaactaattaagcttccttagcctcagtttctcaactgtaagttggagatattaccaagacctacctcttgaattgttgtggggatcagatgaaataatgtatgtgaaatatttagaattatgcaagtctgtggtaatgaatactaatgttagctatcattattgttataatcccaataataaattctggtgctttgaaaattaaaccaaagccaagcagttgatatgaagaagcatgtaataatgtacagacataatgctttatagacaacattgaatttggctctcatgaacatcaggaatagtggtcatggtagttattatctccagcaggaactgtagctgagagatcttcagagctttttccaaggcgatatcactgggaaataatagagacaaggttacaagctagggctgtgttttcttcttaaaatctttagttcagtttttttcaataacagatttgtagtaggcatcaggtgactggggattcgtattcttcaagttgaaatattaccttgttgagaaagaaaccatgtgtgagacaaccatgttgagaaagaaaaagtgattttatagaaaattaatattgatagtgagcattatatgaaaatcatgaagttagaacatatttggccagaaaatttacattaatagttacccatagcaattaatgcattataattacacataccttttctttaatgaaaaagaattctttccttccaaagttatgcatgctattgttaaacattagagaatatagagaagcaaaaaagaaaatatcttttttgatattttcttaacatacgtctgttcctaataatgtttatagtttagaagcattgcatgaaatgggtagatcaattttctatttaatgtttggattcattaggtacgaagttagcaaattaatttccattagggtgcctgtatggttgtaaatcctggacctgcagaagatttttcagtattggtttgtagtcttttgtttagcagcaaataattagttctccagagcttctgaaattaattgaccactttaatggtgtttacctacctagagaaagaaaaagaacttctccaagtcccttggtaaaattaagcctcatgaacaattaactcaaatatacacaaggcttgtctttagcgagcatatactccctaaagttgattaagctgaccaagtgattactgcttataaattcaccattttatggagaagaagcaaacactgctaaataccttgtggaatcagaggaggggaaattagtaacttgaccccaatactgcgattttaaattgaattcttgaagcctacaagttttacacaggactttagagagctggatagtatcactttgtcaagtcctacttttactatgattctttgagaaaaatacatctgactaaataactctgaatctaaattggataaaataaatgtgacattcaaaatgttatttatgattttagaaaaatatccttatagacactagatgagttttagtctcaaatcaatcctccctatcatagtcacttatcaaaataactaaagcaaagtggtagagctgtgctctagaagtttgggatttatgatcacaatcttttccaatgagtcccctctttcctctgcctgtcttcaacatttgtttttttttttttttggttaggactatccagattgtgtggcctatttcaaactcatggcaaatacattggatgatcagaaattttctaatgtatttgaatttgtctacacaaactagagtaattgctattaattcctcaagtgttaattatttcatgcaaaaaggaaaaaggctattagtctttaagtgtattagtatgtcaatatttgggagaagtgtcatgcaattagtggtttgaatttcctattttattttattgcattttattttatttgcctagtcaaataaaaagtaatgttaaatacatggaagcatgattgttttctacactaaaaatcattttgacttgaaaagatctgatatccatgaccttcatctgaagttttggcagatgaaaatgtcagatgcgtcttttggattaataaaaggcaaaagtcagatcgaaaaatgagtataagctttaattatatgactttaggaggatatgttatgaaaatcaaagctttaatagtgattataattggcaagttctttttttataaggaattacaagtcactctatacaaaaattggaatttttgtcctaagaaatgaaatttactatagtttcatctgtgtgtgtgtgtgtgtgtgtgtgtgtgtgtgtttaaaaaatcaagtgatagggcttttcctcaataaaatctgaaatctcttatagttaagtgaacagaacagtgtatctaggatgctagacttttttttcaaagttagtttaaaacttatacatagtaaaatctgtatgccttagggatctctgtttgctatcccatagtgaatgattaattagtttctgttagaaatagtcagaactaggctgggtgtggtggtggctcatgcctgtaattccaggactttgggaggccaaggcaggaggatctcttaagcccaggaatttgcaaccagcttgggcaggctggtgagatcctatctctacaaaaacaaacaaacaaacaaaggacaataagaaagaaagaaatagccagagctttgaacaaaatttctaagtagaccaatgtaaaagtctgtcgtcaatatgtagtggctatgaatggaggttatgaatgaaagagaaggataagatgaactagaggtgagaggggaagacagcaggcccaagtgaaaggcagagccgagtttattgctttttggttattccaggtgtgtctgctttgtctcatgaaacacctggatgatcactgatttctagtggaagaaatgctgaaaagtccttactgtgcatttaaacattctaggtttaatatactcagggtttttcaaaagaaagggtggctggagttttgcactaactaatatttcataaagtgtctaagtatagatgtctggtttttttttgtatttctaagactggcttgaggtaggcatggagaattctttgatgggacataattttcttcctttctttttttttttttttttttttttttgagacggagttttgctcttgttgcccaggctggagtgcaatggcacaatctcggctcactgcaacctccgcctcccaggttcaagcaattctcccacctcagcctcccgcgtagctgggattacaggcatgtgcccccatgcctggctaattttttttgtatttttagtagagatggggtttctccatgttggtcaggctggtctcgaactccttacctcaggtgatccacccacctcggcctcccaaagtgctgggattacaggcgtgagccaccgcgcctggcctgatgggacatatttttcattcaattttattgatttaacctcacaaaataaaatatttccttaagatgactctgtggtcattgttgggcagcataagcttaatggattttagttatcataatttaccttaaacccaatttgtatttcaggatataaatagaggtttattgtagtgaatcttccaggaaatactaagtgatactaataattatagatggtgaacttaagtctttatattactgaatttgtttggtttgatgatgctaggctatggcattcttgctaatcaaaacgatgtgtcatggtgtaacataacttattaaaatgggcacagataacacaggaagctttttataaaagcagctcacaaattgtgttactttgaactgaactggccatttatgggaaaggtcactgggttgtaaataaggaccaaaagagttacgtttatattttttaaaagagattgaggagatttatttttacatttcttgaaaatgccttattttggtatggtattgacagatagtgaaattctgctcatttgtaaatatagtgtcatattttaataatttcaaacatattgaaaatgcagaatttattaatagtgggagcacattttcctttttactaaatgttctacaggttcttttctttccatccacacacagtgccattaccctcattctaagcctttcaaacatctggcagtaagtgatctgctgcacttagctctttccagctgagctgatttttaaattttcagaaaatttgtgagctaattgttaaacatggccattattaaaaattaaattatttcaacttataattaaataaattatattaaaacaaaagtattaaaaactcaaaagttggctgggcgcactggctcacgtctgtaatcccagcactttgggagaccgaggcaggtggattgcctgaagtcaggggttcgagaccaacctgaccaacatggagaaaccctgtctctactaaaaatataaaaaaatagccgggcatggtggtgcatgcctgtaatcccagctactcaggaggctgaggcaggagaattgcttgaacccaggaggtggaggttgtggtgagctgagattgcgccattgcgctccagcctgggcaacaagagtgaaactctgtctcaaaaaaaaaaaaaaaaaaaaaaaagaaacaaaaaaaaaaaaaaaacaaaaagcaaacaaacaaaaaaacaaaaattatcacttcctaattattttgcattttactattatctatgctattaacgttatttgccttcattgtatttgaaaggtggactatattctattgcactttcattgtactatattctaatatgcaactgtgtatcccttcccaactctgtgttcaatgactttatatttggttgctttaaaatgatgacgatgagagtatttatatcatagaaattggcaaatgccgtaagtcagtttttgtttttgtttttgttttccggagaggggattgttaaatatttgcctgcatgcaacaccactacatgcagtctgctatcttttgttcttcctgctttcaggctcctctcccagctgtctgtctagcacaacccagcataccaaattttcttaaatagggaaagttgaacatggtaaaagaatgaatgaagtcaaaagaatgtggaaagacctaggctttgccatttagtaaagtttagcatctctaagcctccatctctttatcaataaaattgagcaatgatcccttttagttctacccatttaagaagattttcaaatgaaaaccacaacctgctcatgtttatgaaggcactttggaaagcgctaaatacacgggtttttattagtagtaaacacttacttcacctttttcacttcttgactttagtttacaagggctcataatctaaattatatcataaattgctgtcccagatttttttacagcctaattgccacctgtatgttcgactttccttctgttctttatgttagatactgggatagtatgcaccaggtgggtgtgccatcactttctcagatgatgtccactgaagaccttgcatgatcatggcattcattttcctgctgtattcagactggcctcaactattttctttattgctctccaggaaaaattacaaatgaatcagactgggcaatgaagggtaaacctaattatcgctctttgttaaagacagctcttgttaaaatgcggatattgcaaattaatggaaaaaatatgacatagtaaaccatactcacttattaatatcttagtaaggaataattgatgaagttacttaaccttagagccctaattcagttaagttttaatgaaggacaagttgtagagatatcgagaacccagggcaggtgcctactgaagaagttccagaccaaggaagtataaagaaggacctgggtgggagcagtgagattggatatgagggccactggcaaagttttgccccagaacagtgtcaaaatgtttgcatttggcatagccctttctctttttgttctgaatggctttgctagaatatcttttctataatgaatttatcctgcttctcagatattgctaaagcactcccttttgaattttggtgctttaacatgcattttgatacattaccaaataaggtctgaatgacacaaattttagaactctccagagaaaagaaagatgctgagggaaaaagcataggtttgggactcactaaatcccagttcaattcctttctttaataaatatattcaattttacctgagaaagctctcgtgctctcgaattttatttagaaatttctctttgtacatgattgatttcacaatccttcttctgcctcctcttctactttcttctttctagattttcctatctttatgaagattattctgccttatcctcaacagttagaaacaatatttttgaaaatcactacggtatcctgcatagtgatttcccatgccaactttactaatttccattataaattattatttattgatgcctagagggcagatgagtgtagctgctatggagtgaggagacaaaacataagaaagttatgatcctaccctcaggtaatgattcagacatgataattaagtcaacaaattgatagaaactaatcactaactctctggctatagtcattctttcaatgaatagctcattactgagtatgcatgctacagtaacaaaattatataaggctgttgattaaatgttgattaagtgcatgtcttattcagagtttttttatatttgaaatggaagaggctggacttcagtaatttgctataaactgctagtatatgattatttgggggcagttattttttaaagaataatttaaatatggaatgtttagcagtttgttttttccctgggaaaaaccatactattattccctcccaatccctttgacaaagtgacagtcacattagttcagagatattgatgttttatacaggtgtagcctgtaagagatgaagcctggtatttatagaaattgacttattttattctcatatttacatgtgcataattttccatatgccagaaaagttgaatagtatcagattccaaatctgtatggagaccaaatcaagtgaatatctgttcctcctctctttattttagctggaccagaccaattttgaggaaaggatacagacagcgcctggaattgtcagacatataccaaatcccttctgttgattctgctgacaatctatctgaaaaattggaaaggtatgttcatgtacattgtttagttgaagagagaaattcatattattaattatttagagaagagaaagcaaacatattataagtttaattcttatatttaaaaataggagccaagtatggtggctaatgcctgtaatcccaactatttgggaggccaagatgagaggattgcttgagaccaggagtttgataccagcctgggcaacatagcaagatgttatctctacacaaaataaaaaagttagctgggaatggtagtgcatgcttgtattcccagctactcaggaggctgaagcaggagggttacttgagcccaggagtttgaggttgcagtgagctatgattgtgccactgcactccagcttgggtgacacagcaaaaccctctctctctaaaaaaaaaaaaaaaaaggaacatctcattttcacactgaaatgttgactgaaatcattaaacaataaaatcataaaagaaaaataatcagtttcctaagaaatgattttttttcctgaaaaatacacatttggtttcagagaatttgtcttattagagaccatgagatggattttgtgaaaactaaagtaacaccattatgaagtaaatcgtgtatatttgctttcaaaacctttatatttgaatacaaatgtactccctgggaagtcttaaggtaatggctactggttatcaaacaaatgtaaaaattgtatatttttgagtacctgttacatgccaggtagaatatctcctctcagccactctgagtggaaagcatcattatctctattttacagaaaagcaaactgaggctcagagagataatatactttgccagttaatgaatgatggagccatgattccagctgaggtctgtattgccttgctctctaggaatggtagtcccccccataaagaatctctcagtttcctttccaatcaaaaggttaggatccttttgattgccagtgacagaaacccaatttactagcttaagtaaataaaaggaacgaatttattggctcatgaagcctgaactatgtgaagacctaggtggagaactggccttaggaactcaatgggaccaaggactcaaatgccacctggtggcatttgccttatgctggttttattttctcagaccggaccagctttctacataaagtgggtccctggttagaactctttgctcctatctttaaggaccacgaaagaaggagccctttgtccttggctaaatgtgaaaaatcccagagactcttgagtcatagtgcttaccccttgggccactcatagtctagaatgaactaggctgagtctcgtgccaacagcacaggcctgatgccagataaaagggtgagtgaagggggataaaaaataagacatagctactaaattattgcaccaaagtaaaaacattgagttgacttgcaatttgtttcttttaattaaattcatttcctttttttggcattttgaaggcaaagtaagatattaaactttatttttattgattttattcaaagaattaagctagtgggagtagcagattcacacttctaagatcaagggccagcttctattattgaacacttggtgtgtgcaaatgccatgaggtagggatactttgttttgttttttattttttattgggttcgatctcttttgtttatgatgtatccccaagtgcctagaatagggcctggcatatggtatatactcaataaatatttgttgaatgaatccatgatggaatgtgaaatggctagcattacatagaaacctgtagcattgctggagagataaaatatataaacataatccattgcaggtatattgacaagttcaaaataatataatgggtattgaatatctaaatgtttgttgttgttgttgctgttgtttttgagacagagtcttgctctgttgcccaggctggagtgtaatggtgcaattttggctcactgcaaacttcgtctcctgggttcaagtgattctcctgcctcagcctctcgagtagctgggtttacaggcactcgccacaatgcctggctaatttttgtattttagtagatgtggagtttcgccatgttggccaggctggtcttgaactcctgacctcaagtgatctgcccaccttggcctcccaaaatgctgggattataggtgtgagccactatgcccagctttgaatatctaagttttaattggatgctgagggaatgattaatcagagtagggctgggttaattgaaaaatgtgatacatttgtatttatggccagatagagaacatgaatctgaatttgcagaattatctggcttaacatttttttctttccagttttcactgtatcccccatgttgattcaatttaaaaaatatacctattttacttcaattcaacaatgctatgccagtacaaacccatacgttctattatttttgttttgttttgtttttgtatctccaccctgttacttcttttcttataaaattggtatttgaaatttattgaaatattttggaagagtgacataccatttttggtactttgtacctctgcacccttgggaagtgaccctggcttcacatttcataactgccttgtgaccatggccctcaagtggttgccagatggttgaagaacattaacctatctggctcaattttgtgaccatggattgaatcctctacataactgcagtgtgcaaaccacacatccgttccaagattgtagtcaggatatgaactttttaagaataaaacttcttcccttctgatctgggcctggtatgtggtcctactagaaccacatcacctactcttggtgctaacaatttgtggcaccaagttgttcaagtttcacccattaaagaaattccccgaccttgccttctcctcaggtaactaccccattctattttttctttcatagctaacattctctgctctcctggtctctctacttcactttcatttacatctcagctcctgaagtatggtttccaccatgttcctaaaactacattgcccagggtcactagagacctcttatgaaatataacaacacctttctacattacttccgtgtggaccactttttcacattgaacccattttgttggtttatgtacacaccccttccttggctttcccatctgatccatttctcctttgatggagaaggtgagtctgctccatatttagcttcttactctgagtaaccaaatgttatggatgggaggttagctctgtgtgtgagagaaaggtggagaagcatgtggggagggaaatagatgggaaaaggtaattaggctttatagaagggctctcattagcaagcttctaggggatgccaagatccatgcttagagattgccaggcttgtcttcaaatctcagctgtgtattactcctttatgttttttgtttgtttgtgttgtttgtttttgagacagagtctcgctgtgtcacccaggctggagtgtagtggtgtgatctcagctcactgcaaactctgcctcctgggttcaagcgaatctcagtctcctgagtagctgggactacaggcatgcaccaccaggcctggctaatttttgtagagacggggttttgctatgctggccaggctggtcttgaactcctgacctcaagtgatctgcccgccttggcctcccaaagtgttgggattagtggcgtgagccactgccccggcctattactcctttagagtgatttagagccatgtttacttatggtaacttgacagtaatgggaataaccactgatgaaacgtaaagcctttgtctaattgtttacctagttcttccttgtggttcatgaaatttttcatctctgtacagtttgaaaattaagatgataatatttagagatattttattcctttgtgaagagaaaaaaggctttcattaacagaaatcagtggcaataacttaataaatacaatcagctggtgttcctatagtatttaaaagaaaacagaaagtttactagatttcagccagttttcagactatttaatgtctattcttactataatagaaaatatataatttgatcttgttctcatttttcaaagacctttaatacatgattttagtagttgaaaatgaagtttaatgatagtttatgcctctacttttaaaaacaaagtctaacagatttttctcatgttaaatcacagaaaaagccacctgacattttaacttgtttttgatttgacagtgaaatcttataaatctgccacagttctaaaccaataaagatcaaggtataagggaaaaatgtagaatgtttgtgtgtttattttttccaccttgttctaagcacagcaatgagcattcgtaaaagccttactttatttgtccacccttttcattgttttttagaagcccaacacttttctttaacacatacaatgtggccttttcatgaaatcaattccctgcacagtgatatatggcagagcattgaattctgccaaatatctggctgagtgtttggtgttgtatggtctccatgagattttgtctctataatacttgggttaatctccttggatatacttgtgtgaatcaaactatgttaagggaaataggacaactaaaatatttgcacatgcaacttattggtcccactttttattcttttgcagagaatgggatagagagctggcttcaaagaaaaatcctaaactcattaatgcccttcggcgatgttttttctggagatttatgttctatggaatctttttatatttaggggtaaggatctcatttgtacattcattatgtatcacataactatattcatttttgtgattatgaaaagactacgaaatctggtgaataggtgtaaaaatataaaggatgaatccaactccaaacactaagaaaccacctaaaactctagtaaggataagtaaaaatcctttggaactaaaatgtcctggaacacgggtggcaatttacaatctcaatgggctcagcaaaataaattgcttgcttaaaaaattattttctgttatgattccaaatcacattatcttactagtacatgagattactggtgcctttattttgctgtattcaacaggagagtgtcaggagacaatgtcagcagaattaggtcaaatgcagctaattacatatatgaatgtttgtaatattttgaaatcatatctgcatggtgaattgtttcaaagaaaaacactaaaaatttaaagtatagcagctttaaatactaaataaataatactaaaaatttaaagttctcttgcaatatattttcttaatatcttacatctcatcagtgtgaaaagttgcacatctgaaaatccaggctttgtggtgtttaagtgccttgtatgttccccagttgctgtccaatgtgactctgatttattattttctacatcatgaaagcattatttgaatccttggttgtaacctataaaaggagacagattcaagacttgtttaatcttcttgttaaagctgtgcacaatatttgctttggggcgtttacttatcatatggattgacttgtgtttatattggtctttatgcctcagggagttaaacagtgtctcccagagaaatgccatttgtgttacattgcttgaaaaatttcagttcatacacccccatgaaaaatacatttaaaacttatcttaacaaagatgagtacacttaggcccagaatgttctctaatgctcttgataatttcctagaagaaatttttctgacttttgaaataatagatccataatatatattcttatggaaatctgaaaccatttgggcatttgggggtaaaaagtattttattagtaaatttaaatgaggtagctggataattaaattacttttaagttacctttgagatgatttttctcaatcagagcaccacccagagctttgagaaacaattttattcacagcttctgattctatttgatgtaatttttagaaaataagttttgctggttgctttgaatcagggtatggagtacagttcactctgatcctatcatataaatcatgtaagtatataacattttcaataagtgattgttggattgaagtgaatgatatttcaagtaattgttatgtcatggccaagatttcagtgaaactcaaaatttctcctggttgtgttctccattgcatgctgcttctattgattaacctaagcactactgagtagaagctggaagaggggtctaattagaaggcccctttctatgctctgcttggcttgtaaaataatttatttctctagatcccaccaacatagtagtttcatgtatgcaaaaacacccacctaaatgtcaaagtttgtatgatacatggacatatctatagaattttttttggtctggtgcatgccaaaaaataaacatgatatagaagaatttaatatttattgagtacctaatctgttccagttcaatatgaaggtctttatgcagattattttacttaattttcctagtaactccatggagcaaaaattatctctaatttatataacaggaagttgagcgtgaggcaaattaagtaactttcccaaagttacacatatggtaagtttgagagatatcccagtctctttagctccaaagcctttgaccctttcaccataccagattatgattgctattaatatataattataattataatgattgtatttaggtactcaacagaatggtgactctagtaaccagccttggttctgctgagcttctctgcgtcttctcaggagacacaggctacagagcttgaaggctgaggattcttccagggtcacttcaggggcaaatctgaaactttcttcaggacaggaatcaacgagatcttctcacttacttatacctgggggaggaactgtatgaaatccacccaagaaccagtcatgctaagggccaaacctatagacaaaaaaagggataggagaatggagtatgtatggagaaagactaaattgttcttaaacttctcaagcttaaaaatatcccagcaaaagagatcgtaaaagcccttcatggcgtattaattatccatgcatgggggtgagtggaaaggtactcctgagcccgaggctacagctttggaactagcagcacctttgaaggggaaagcgtgtttccatcatctcaactcctactgataaccaatggaatattggtgagtaaaggatcctgggggaagaagcagctgaaatgtgtaggtgagaaggcagagagaagaatatttatattgggaatggcacaagtgtgatgaggctgcaggtttttcacccttgtcatagagaaaaaaccacgctgacaccatgcagttttaaatagtgagaaatttgcaaattgttagatcttaaataatttagataaacatagtggccatttagattattgcagttttttcaggatatctgatctcttgatttcattctttttgtctcttataagaataaaagggggggagaaaatttagccattatagtatttctctacattttctctgtccttttacataacttacaccagtgccttcctatttatggtattatttatgggtatttcttcttttctttcactgagcaaggataaatgagccagggattcttgaaactactgtaacacttctcttagaaatagatggtcatactttcagaatctctacacattcttagtccctctaaacaatgatagttgtggcataaaaatatttgcttggtttcaggactgatagagaaaagtactataaaatttgctgttaactgtgaaaggttaaaaaaaaggaggtgccatcatgaaggagctaatctttctgaagtactgctgtagttttaaatattattagctatgacttctcaccattaactatgcacttgctttttcttcatctgactcagcagccagatagatgcaacattgtctttaacatttaagactcctagcaagtccgggcacgggggctcacacctgtaatcccagcactttgggaggccgaggtgggcaaatcacaaggtcaggagtttgagaccagcctggccaatatggtgaaaccctgtctctactaaaagtacaaaaatcagccaggtgtggtggcgtggtggcgggcacctgtggtcccagctacttgggaggctgaggcaggagaatagcttgaacctgggaggcagaggttgcagtgagctgagatcgcaccactgcactccagcctgggtgacagagcgagactccatctcaaaaaaaaaaaaaaaaaaaaagactcctagcatggaagagaaactggctgttgaaaacctgaatgtgagagtcagtcaaggatagtttgagggaagccaagtagaggaagctctcacaagcagattggtgagagaatatgattatacaatgcatttattatgataagaaattcacaagcattcattcaaaatactcttgattcctaggcagctctgggcatatttccaccaacaaattgaggcatatgtcagtgcagcctaggtcagactaccttttttcattaaacctcacaaaattaaaggacatacaggagaagtcctggtactcatgttgcagactacagtctatatggcaaaggaggatctctgtcccttatgtttggatgaaaacattgggtaggcatttgaatacaagcctactgctaatatggggctaaggtctttggccccctaaaggtttgctgaaatattactgacaggaggcagattgataagaggaaaagcacataaatgtatttgacatgtatacatgggagccttcaggatgaagacctaccctctcagtgcagtatggaagcttgtataccatcttgaggttacagaaagaatgggggtttggatctttgtaaaacaggtttcagtggcaagacaggttatgagaaggagaaaggaagagacttgggtagcaaagggggtcttgttttgtaggtaaatcgttggcagcccacagagaaaatagatggagaatgtttcttttcagaccttggcaggtgtcagattctcagttaatctctcctagatttgaaaaaaaaaaaaaaggtctagaaagggagagcctggctgcactaacacattttctacagatgcaaatttctcccacaaaatacagctttgcaggtccacttctatctgctgggcctgtggcaaccatttcaaaatatgtgaatgaaatatatgtgggggtaaactatttttatttacttccctaaagaagggatggtgttctctcgggaattctgtgcatagagagcctgtggcttaggcactttgatttatgtatatctcttcctgtgattggctatctagggactgctatctccagcaaatcttctaaatgtctgccatgtagaattcctttctcatctttctgtctcacccccttatctagctgcttctctaaccctagagtgacactgcactccccacaatctcctatgtcctgaatattttaccccatcctaaactccatctctaacacagatgcactttcttgtgctgcctactgcattgtacatcttccccttagttcccatgatgcaactctgccctaccccagaaaatgtaatttaattggtctgggataaaacctgggacactatcattcttgaaatattccccaagcgattctaattatatagccaaagttgagaactatttgtagacaggcatcagcatgatcacttaatgatttgacttttgctagatctaaggtgaggaaattggagagtggtatccataggaagaactgtttagtttaattttttttttattttttcttctaaaaaaaaatccaacaacgagatacatgtgcggaacatgcaggtttgttacataggtataatgtgccatggtagtttgttgcacctattgacccatcctctaagttccctcccctactccttacttcccaacaggccctggtgtatgttgttcccctctctgggtccacctgttctcaatgttcaactcccttttacgagtgagaacacatggtgtttgattttctgttcctgtgttaatttgctgaggatgatagtttccagcttcatccacgtccctgcaaaggacatgatctcattcctttttatggctgcatagtattccatgatgtatatgtaccacattttctttatccagtctgtcattgatgggcatttgggttggttccatgtctttgctattgtaaatagttctgcagtaaacatatatgtccatgtgtctttatagtagaatgatttatattactttgggtatatacccagtaatgagattgctgggtcaaatggcatttctggttctagatacttgaggaatcgccacactgtcttccacaatggttgaactaatttacactcccactaacagtgtaaaagcgttcctatttctccacagcctcaccagcatctattgtttcctaacattttaataactgctattctgactggcatgagatggtatctcattgtggttttgatttgcatttatctgatgatcagtgatgctgagatttttaaaatatgtttgttggccatgtaaatgtcttttgtgaagtgtctgttcatatcctttgcccaccttaatagggttttttttttcttgtgaatttgtttaagtgccttgtaaattctggaaattagatctttgtcagatggatagattgcaaaaattttctcccattttgtaggttgcctgttcactctgatgataggttcttttgctgtgcagaagctctttagtttaattagatccaatttgtcaattttggctttttttgcaattgcttttggcattttcctcgtgaagtctttgcccgtgcctatgtcctgaatggtattgcgtaggttttcttctagggtttttatagttttgggttttacatttaagtctttaatacatcttgagttaatttttgtataaggtataaggaaggggtccagtttcagttttatgcataatggctaggcagttttcccaccaccatttactgaataggagatcttttcctcattgcttgtttttgtcagatttgtcgaagatcagatggttgtagatgtgtggtgttatttctgaggtctctgttctgcaccattggtctatatgtctgttatcgtaccagtcccatgctgttttggttaccgtagccttgtagtatattttgaagtctggtagcgtgatgcctccagctttgttctttttgcttaggattgtcttggctatatggagtcttctttgattccatatgaaatttaaaataatttttttttattctgtgaagaatgtcaatggtagtttgatgggaatagcattgaaattataaattactttgggcagtatagccatgttcacaatattgattctttctatccgtaaggacgacactttttccatttgtttgtgttctctcttatttccttgagcagtggtttgtagttctccttaaagaggtctttcacatcctttgttagctgtgttcctaggtattttgttctctttgtagtgattgtgaatgggaattcattcttgatttgcctctctgctgcctgttgttggtgtaaacaaaattcatttcttgttcttatttgtgaaattttggaaccaaatctattttcaaattagaaattgcttgtgataatggttttgcaacttagactggatatgagacgatgagatattagttctttcattcctttgtaggaatatggtgcatcttgcattattttagctaactagtgtcctttaatgactaatgaatatgacatggtgaaacaaagtaaaatatatatgatgcactaagtatgcattgtttccaaaggttcagcattttttttttgttaactctgctgggatctgctttatgcactgataacataacttattttatgatcttaagcaaataaaaacacttatctggacctcagtttccttaactgtacaactgagggaaactgtatagtatagctatagtacagtataccatctttaccgtcacttccatcttttaaattatgtgtatataagatagggcctagataaatggtatttatcttaaattacagtgatactagcttataacttaatttgctaggtcatgttgaactgataacaatgtgtgaactgatgagcaactgagaagtaaccaggttgtgttataacagtttgtttttgatttagggttatcagtgagggtggcggtggggaggggactttggagtctaactgtctagttcaaatattagtttttgtttatttttatttttaatttttgtgggtacatagtagatgtatatatttatggggtacatgtgatgttttcatataggcatgcaatgtgaaataagcacatcatagagaatggggtatccatcccctcaaacacttatcttttgagttaccaacaatccaatgacactctttaagttatcaaatcacagttttgccagctactagccatgtgattttgggtaggttacttaaattctcttcatctcaatttcattattgtaaagtggagataatgatagcacattttttctttttcttttttcttttattttttattattatactttaagttgtgtgatacatgtgcagaatgtgcaggtttgttacataggtatcaacaactctataaaacatgttctatccaggaaaagaaactatcatcagagtgaacaggcaacttacggaatgggagaaaatgtttgcaatctagatggcgattgcaatggcggttcgctgcatccatcagcccatcatctacattaggtatttctcctaatgctatccctccccttgctccccaccccctcacaggcccctgtgtgtgatgttcccctccctgtgtccatgtgttctcattgttcaactcccacttatgagtgagaacatgtggtgtttggttttctgttcttgtgttagtttgctgagaatgatggtttccagcttcatccatgttcctgcaaggacatgaactcatccttttttatggctgtatagtattccatggtatatatgtgccacattttctttatccagtctatcattggtggacatttgggttggttccaagtctttgctattgtgaacgctgcagcaatgaacatacataagcatatgtctttctagtcaaataagttataatcctttgggtatgtacccagtaatgggattgctgggtcaaatggtatttctggttctagattcttgaggaatcgccacactgtcttccacaatggttgaattaatttacactcccaccaacagtgtagaagcattcctatttctccacatccgctccagcatctgttgtttcctgactttttaatgatcaccattctaactggtgtgagatggtatctcattgtggttttgatttgcatttctctaatgactagtgatgatgagcttcttttcatgtttgttggctgcataaatgtcttcttttgagaagtgtctgttcatatcctttccccactttttgatggggttgtttttttcctgtaaatttgtttaagttccttgtagattttggatattagccctttgtcaggtggatagattgcaaacattttctcccattctgtaagttgcctgttcactctgatgatagtttcttttgctggatagaacatgttttatagagttgttgtgagaattaaatgcattaagcacatagaatagattctggtacatagcaagtgctctctctatatatggaactctatatgtagttggtgcaaaagtaattgtggttttcaccattgaaagtaatggcaaagaccatcattaccttttcaccaatttaaatatatggaaggaatatatatataaaacctatatatatatgtcacatatatgtctctaacccattattataatatataatacaatatatattataattataattgtatataacatatgttatataataatatagtaatatttattctaaataaatatataatactataaataatataataatttatatatatgattataatatataataggctatattatatattattaacatatacatatgtgtatatatatgtctttcatagacttaaatatatagagcaataataggttagaaaatagcaaacatgtatatataaacatatatacatatagaaaacatatataaaaacatatatatatatatatatatgtgtgttttctgcctttcatttttagagacagggtctcatcatgttgcccaggctggtctcaaactcctgggctcaagtgatcctactgctttggactcccgaagtgctgggatttcagacatgagacactgcacccagtccagtccctgtctttttaaatagactctctacctaagtgcacaaatactcattatttacatttagttatttctgtatatatgctataagcaaatcttgtagcaccagtttgatttttataaggcacaagaatatattttactaatgctttaaaatggcagctagattctagtattactttagaaattaaaattaatattttaacacatctttcattattgtgttatctgaaccaaacctattattgctgctatttcagcaaatccaggggctttttcttataaaatatgaagaatatagcttagatttctagtgaagatgttaccagtaataattaataaaatcagtaagcactaaaaggaaaataccaaaactaaagcattttgaattagtcattgaatctaaaagaaaggtagatttttttctgagattctgttctaggtgtggtatatgtgtatttttgcaaaaactataaacaattgtggcaaaatgaaggaaatatttaaaaacaaacctcttaattcttcagtggattaagcgtgaatatgtttttattttctatgatgaatatggaaaaattcatttccttagcaatttgtatgagcccaaaaactattgtcagactctgctgtatcaaaatagacaaaaaattgacactcacttttaccctgccaaaagcaaaatcttaaacttttgctttagtatataagccagcattcattgtatcctatgatgggttctgagtgtaggtgtatttgctttcttccattttttgtatgcatgttttctttttatttattattgtaagttgtatgaaatttttatccaaatttttattttcttctgattaataatcagaataatcagataattactggtaaatttgatgttaatccttccagctttttcccatgggaatttatacttaataaaggggagaagtcatcattacataatgtgcatattaatctgcttctccctttaatgtgttgtgaatgcctttccatgtcattagatgtttttctacctagttactttcatgaatcatatggctgtaccatgatttatttaatcagttcctcatcattgagtatgtaaattgcctccatttttttattactataaaaggtccttcagtacacacccctttaaaagctgactcttagaaggtgttcttgactctctacctaagtgtaaaaatacaaataaattgctttccagaaaaggtgcactactattttactttcctgatactaaactatgaaaattcagtcctaacaatagatatttaaataaagttttaaaaatgccaagtgaaaaagagcatattattattttcatttgcattacttttggttcctggtgagtttaatctgtttttgtatattaattatgcatttatatttctttttgtgtgtgtgaattgcctttcatgttctttgtgtgtttttattttgttgtatttgtctctttcttgatatatgagagaatattttccctagcctgtcaattgccttgtaattttgtttctagtgagtttttttttttttttttacaattaaaagctttaatttttgaaaattttgctggcaaatctatatatctttttctttgttttctgctttgacattattcttttataaaggcccatgccacccaaatattatgtaagcatgcatctatgtttttattacttcatcttttacatttaaatatctactctatttagaattcattgtgatgcatgtatgaggtagaaatctaatttcaaaaagatgagtatccagtttgtccatcatttattgcatgatctctttctccactgaattaaaatgccgtattttataatatattaaagtattacatgtgcttggacatgttcctggacttttgagataaatcagtctatttctttgtcatgtcacatattattatggctttatgatttaatatccagtaatgtaaaccctctgacacattattcttattcctcaaatgtttttgatgagttttcttccaaatgaaatttataatcattttattcattgattcaacaaatatttgttgaatggatattctgtgcttggtattgtgcatggtattaggattgttgcaaaaattgagactgacagtccctactcttacggtgctaaaaattcacttccaaaaaaatctttaaatgttgatgaagattgcactaatcttataaaataacttggaggggaatgtaatctttgcaacattaagttcttcattttagaaagttttaagactctccatttatttgagacttttaaaatatgtcccaataatgttttgtgagatgtatattttaagatatatatcttattgctattacattgtatcttttgttatattgttactatgaatgggatactcatttaattagatgtcatttttggtatatagaaatctattttcttagcatagtcattttttaaacctcgatctattaaattcttgattcatttacatttgttacacaatcatattctatgctgataatacttcttgcttctttccaatatttgtacctcgatcatttttcttgttgagttgtattagctagaagttctagaaaaatgttaaatggtagtaatagctagtattctgttttttcctgactctaaatgtaatgcatctagacttttataattatggcattgattgtaacattttgaggaagaaatcctttttcaggttaataatgtatctttatattcaagtttattaagaacatttattggaaacatattgaaattttatcagattccttttcagttgttactgagataatcataggttcttctgtattcttttaattaatttctcaaaattaaactgtcctattattcttggaataacgacatataaagtactgtatatttaaaagaagttaaaatgataatggtgattttattaagtgacctcacacaatagaaaacagtgtagccttagaagttttccaagtgaccattctacttagaaacaaccctgctttgggatcagaactgtaatttttaaagtaaagttttctgggtttaattcatttagtgtaattacaagcatgagttcaggtttctatttttttcacctgaactttccttcatggtttgaatatctagaaaaagcagactttcctatctctagactaaacatttgatcctatcttaggtatgcattacaattttttaaccataaatggttaaagaatttagactcatctacaataactttgaagctctggtcttgaagaacatgtgagaaatgagatataactcctagaagatataggagacatttttagtcttccaaattttccctgggaggctgatctaaattgagtcacaaaattgttcccaccaggaatgcaatcacttgagctgttttctaatctgagcccctctacccagatgatcttctgaactcatactgttcagactttcatccttctgagtagaaaacagccatagtcatggcaggatgagggctaggacaattacccaaggaattcttggcctctgccatgggactctgcagactcagatcatataatcagagatgttagcactggaggggacatcacaattagctttctccacctcttagtttatcagtgaggaaaactgtccagagcgcggaagagactaaaataacacagccaatgtaggtaatgtgctggataagaatttggaattcacgattttgaattcagtgtttatttcaccatcacgctggcttacacgttggtatcaggcttcttctattattgaagtgagccattaagtgaattccatcttgatttgtgtctgatacagagtaataaactattttattaaatatccaaataattatacattcctccttcttacatgcaagcctaagtttgcttgtactatttcatgtggtagcaaatcaggacgcttcttgtgtctctgaaaatactctgagtaatggagtacagtcagctttcttgtaccaagaatatagggactatgtttctcccagtcattctggggataatttttgtgaaggattgcacttcataggttaagctaggtatcagttaccagtgttttttccaaataaaaaaaaaatcaggtgatatctgtaaatggttccattgtaaatattaaagaacatgatgcttaaaacagattagggaaaactatagaaggggtggggtttcggagtgctaattttgtccttgaatggtaacagctccatgtggtggtgaggtttatgttggtttgctgtttgcagatgatcttattattagaatttttcataccgaaaataaactgcattttagtttgtaaacatgcccttccagagtaatgctaccagttctttgtgaaatagctactgttgttcaaaggatgactatgtcctcttcggttgaggaaagatgacaacaaactcagtaatgacatgtaaaataggtattacaaaccaggtatggtggcatgagcctgtaatcccagctacttgagaggctaaagcaggaggatctgttgatctatggatttgaggctgtagtgtgttgtgatggcacctatgaatagcccttgcactccagcccaagcaacaaagcaagactgtctctgaatttttgttttgttttgttttttgtttttttttttttgagacagagtcttgctctgtcacccaggctgaagtgcagtggcgcgatctccactcactgcaagctccgcctcctgggttcacgccattctcctgcctcagcctcccgagtagctaggactacaggcgcccgcctccacgcccagctaaattttttgtatttttagtagagacgaggtttcactgtgttagccaggacggtcttgatctcctgaccttgtgatcctcctgcctcggcctcccaaagtgctgggattacaggcgtgagccaccgcgcccggcccctgtctctgaattttttaaaaaggcattccactcaaattaatacacattttaattgtgttttgttgtaaattacaactgaataaaaattcagcaaataagtctgttgtggtagggaaaagtctattgtgatctggaaaatataatggagaaatccagtggaagagattttatttcacattactcaaaataaaaaaatcttatacaagtctttacacttgtaacttgaaaaattctgtgctaaaatttagcttggttgctaaaatatttctctttttttctcagaagcttctttttagcatcctatagacacaagttactttttaaaatatttgcatacttgctttgcaatgtattgtttatcagtagttctatattctttgagatagtctatccagtctttctgtatttatcgtatgtctgtatagatatatattagcagataaatgagttctgaaaggggagaaatgtgattatgctaatcatgatataaagaattgactttataagcagtgttcacaggtcatacctttcccgttactgtcttacagtgaacaagaaatgatgctttgtctggtatgcatggtaaataatgccccttgctctctgcttcatgatcacatgtgatacttctaacatagatagcacatgtaaatccagtggccttgactgcaactcaagagagcattttggccaagtacaaacccactagtcatgaaaaaaaaaaaaaaaccaaatcaaagtaaattgatggtattgacatttgtctatgaaaaacaacataatatagaacaattctggggtaaaatattgatctaaaataattttaaggattaaatattgccattgtaagcatactatgagcaattatgtttgtaatgcagatatatttataattttaaatccaagatttaccttaattgtacattttcctaatttaaaaaagttattttgaaaaaaaaatcctcgaatctagagaaaggttggcaaatacatatggaactttgtaaaaaacatccagggcagcactttcactgattgcagtagcttaggagtgaaaaacaacacaactgctccaatgtatggcaatgggcaaatatcccgatttattcacagggtggcatgttaggcagtgcttagaataaatgagttggttatacaagtatcaatagggataaatgtgaaaaacacagtgttaagtttttaaaaagttgtaaaaagcacagtaggatgttatttatataaaatttaaaaacctcaaaaaccattcttctttgatatatattctaaagatgaacatatatgtaatagaagtacaaaacatacataaaataatatacactatgcagtcatttgtgtacttacttttcaaaaatatttcagtagatatagcaaacagttaacatgtaatatttggataggaggttggcaattttctttttagcacctgcctgtctgctatcattcaaactcacatttaaaatgtggctatgtgagatgagagaactataatattccaggtttgtgattagtttggaaactttttaaaagtttgaatgtggtctgagagatagtttgttataatttctgttcttttacatttgctgaggagagctttacttccaactatgtggtcaattttggaataggtgtggtgtggtgctgaaaaaaatgtatattctgttgatttggggtggagagttctgtagatgtctattaggtctgcttggtgcagagctgagttcaattcctgggtatccttgttgactttctgtctcgttgatctgtctaatgttgacagtggggtgttaaagtctcccattattaatgtgtgggagtctaagtctctttgtaggtcactcaggacttgctttatgaatctgggtgctcctgtattgggtgcataaatatttaggatagttagctcctcttgttgaattgatccctttaccattatgtaatggccttctttgtctcttttgatctttgttggtttaaagtctgttttatcagagactaggattgcaacccctgcctttttttgttttccattggcttggtagatcttcctccatccttttattttgagcctatgtgtgtctctgcacgtgagatgggtttcctgaatacagcacactgatgggtcttgactctttatccaatttgccagtctgtgtcttttaattggagcatttagtccatttatatttaaagttaatattgttatgtgtgaatttgatcctgtcattatgatgttagctggtgattttgctcattagttgatgcagtttcttcctagtctcgatggtctttacattttggcatgattttgcagtggctggtactggttgttcctttccaggtttagcgcttccttcaggagctcttttagggcaggcctggtggtgacaaaatctctcagcatttgcttgtctataaagtattttatttctccttcacttatgaagcttagtttggctggatatctctcagaccacagtgcaatcaaactagaactcaggattaagaatctcactcaaagccgctcaactacatggaaactgaacaacctgctcctgaatgactactgggtacataacgaaatgaagacagaaataaagatgttctttgaaaccaacgagaacaaagacaccacataccagaatctctgggatgcattcaaagcagtgtgtagagggaaatttatagcactaaatgcctacaagagaaagcaggaaagatccaaaattgacaccctaacatcacaattaaaagaactagaaaagcaagagcaaacacattcaaaagctagcagaaggcaagaaataactaaaatcagagcagaactgaaggaaatagagacacaaaaaacccttcaaaaaatcaatgaatccaggagctggttttttgaaaggatcaacaaaattgatagaccgctagcaagactaataaagaaaaaaagagagaagaatcaaatagacacaataaaaaatgataaaggggatatcaccaccaatcccacagaaatacaaactaccatcagagaatactacaaacacctctacgcaaataaactagaaaatctagaagaaatggatacattcctcgacacatacactctcccaagactaaaccaggaagaagttgaatctctgaatagaccaataacaggctctgaaattgtggcaataatcaatagtttaccaaccaaaaagagtccaggaccagatggattcacagccgaattctaccagaggtacaaggaggaactggtaccattccttctgaaactattccaatcaatagaaaaagagggaatcctccctaactcattttatgaggccagcatcattctgataccaaagccgggcagagacacaaccaaaaaagagaattttagaccaatatccttgatgaacattgatgcaaaaatcctcaataaaatactggcaaaccgaatccagcagcacatcaaaaagcttatccaccatgatcaagtgggcttcatccctgggatgcaaggctggttcaatatacgcaaatcaataaatgtaatccagcatataaacagagccaaagacaaaaaccacatgattatctcaatagatgcagaaaaagcctttgacaaaattcaacaacccttcatgctaaaaactctcaataaattaggtattgatgggacgtatttcaaaataataagagctatctatgacaaacccacagccaatatcatactgaatgggcaaaaactggaagcattccctttgaaaactggcacaagacagggatgccctctctcaccgctcctattcaacatagtgttggaagttctggccagggcaatcaggcaggagaaggaaataaagggtattcaattaggaaaagaggaagtcaaattgtccctgtttgcagacgacatgattgtttatctagaaaaccccatcgtctcagcccaaaatctccttaagctgataagcaacttcagcaaagtctcaggatacaaaatcaatgtacaaaaatcacaagcattcttatacaccaacaacagacaaacagagagccaaatcatgagtgaactcccattcacaattgcttcaaagagaataaaatacctaggaatccaacttacaagggatgtgaaggacctcttcaaggagaactacaaaccactgctcaaggaaataaaagaggacacaaacaaatggaagaacattccatgctcatgggtaggaagaatcaatatcgtgaaaatggccatactgcccaaggtaatttacagattcaatgccatccccatcaagctaccaatgactttcttcatagaattggaaaaaactactttaaagttcatatggaaccaaaaaagagcccgcatcgccaagtcaatcgtaagccaaaagaacaaagctggaggcatcacgctacctgacttcaaactatactacaaggctacagtaaccaaaacagcatggtactggtaccaaaacagagatatagatcaatggaacagaacagagccctcagaaataacgccgcatatctacaactatctgatctttgacaaacctgagaaaaacaagcaatggggaaaggattccctatttaataaatggtgctgggaaaactggctagccatatgtagaaagctgaaactggatcccttccttacaccttatacaaaaatcaattcaagatggattaaagatttaaacgttagacctaaaaccataaaaaccctagaagaaaacctaggtattaccattcaggacataggcgtgggcaaggacttcatgtccaaaacaccaaaagcaatggcaacaaaagccaaaattgacaaatgggatctaattaaactaaagagcttctgcaaagcaaaagaaactaccatcagagtgaacaggcaacctacaacatgggagaaaattttcgcaacctactcatctgacaaagggctaatatccagaatctacaatgaactcaaacaaatttacaagaaaaaaacaaacaaccccatcaaaaagtgggcgaaggacatgaacagacactactcaaaagaagacatttatgcagccaaaaaacacatgaagaaatgctcatcatcactggccatcagagaaatgcaaatcaaaaccactatgagatatcatctcacaccagttagaatggcaatcattaaaaagtcaggaaacaacaggtgctggagaggatgtggagaaataggaacacttttacactgttggtgggactgtaaactagttcaaccattgtggaagtcagtgtggcgattcctcagggatctagaactagaaataccatttgacccagccatcccattactgggtatatacccaaaggactataaatcatgctgctataaagacacatgcacacgtatgtttattgcggcactattcacaataggaaagacttggaaccaacccaaatgtccaacaatgatagactggattaagaaaatgtggcacatatacaccatggaatactatacagccataaaaaatgatgagttcatgtcctttgtagagacatggatgaaattggaaaccatcattctcagtaaactatcgcaagaacaaaaaaccaaacaccgcatattctcactcataggtgggaattgaacaatgagatcacatggacacaggaaggggaatatcacactctggggactgtggtggggtcgggggaggggggagggatagcattgggagatatacctaatgctagatgacacgttagtgggtgcagcgcaccagcatggcacatgtatacatatgtaactaacctgcacaatgtgcacatgtaccctaaaacttagagtataaaaaaaaaaaaaaaaaaagtttgaatgttttcttgcattcagagccttggttgacatagttaattaaaaataaaacattgtatataaagcacagaatgagcagctacacaaagctgctcaatcaatgacagctctatatgggttagggtttcttgtggggatgacattgatgtagaaagcatggtcatctattgagaatgatggggctggaggtattggatacttgaggtttagaaaatacattgtagaaaatggacaaaaacccctcaaattaagggatgaggcagaataatgcttggcaataccaggggtaggctgcagtctttcttggaaatatatattttaaatggaaccaattatcatagcatcatttcctctcagggttaccctctgatccctattttactaaatcgttataaaacaaaatgaggaattatgtgtccttcccttttgaagccaatgtaacaagatgggtaagaattagacctcctgagttcaaaatccctggattcagatctattcctgtatattcaggagaagtggtaataaattcgatggacaatttggtttagtagtcgattgaggaccctgatgaggtatatttgggaaaacataacttccgctctctctcattgactcacgggcctttgaggagtccaggagtcattggaatctggcctgaggttgaggctgctggcaaaactccttccccaaagtccattcctattgctgactgagaagggactagcattggaagtggctgattttaaataccgctagtgctggtgtgctcctccctcccattcccagctctgctttgtgtagttgccttgagaagctaagttcattctgaaaataatgccattgcacaaaacacttttgaaagttctagtttgaaattacatcaggtcacttggtctgtgtggcctcagtttcttcatctgccatgtgaaaataataatgcctactctgtagcaaagaaagtctctatagtaaacaaaaaaaaagcctactctgatactgaaagttgttatgaaaaataaaaaagggaaatgctttagaaactgttaagtgctatgtagatgttactaattaacaaaccatttcagaaactatactttttattttatggccactattcactgtttaacttaaaatacctcatatgtaaacttgtctcccactgttgctataacaaatcccaagtcttatttcaaagtaccaagatattgaaaatagtgctaagagtttcacatatggtatgaccctctatataaactcattttaagtctcctctaaagatgaaaagtcttgtgttgaaattctcagggtattttatgagaaataaatgaaatttaatttctctgtttttccccttttgtaggaagtcaccaaagcagtacagcctctcttactgggaagaatcatagcttcctatgacccggataacaaggaggaacgctctatcgcgatttatctaggcataggcttatgccttctctttattgtgaggacactgctcctacacccagccatttttggccttcatcacattggaatgcagatgagaatagctatgtttagtttgatttataagaaggtaatacttccttgcacaggccccatggcacatatattctgtatcgtacatgttttaatgtcataaattaggtagtgagctggtacaagtaagggataaatgctgaaattaatttaatatgcctattaaataaatggcaggaataattaatgctcttaattatccttgataatttaattgacttaaactgataattattgagtatcttctgtaaactgcctctgttgtagttttttttttctcctaatcatgttatcatttttttggaatccatggtttcctgttaagatgactcacacagcctacataaaagtaattgacaaaatatcatcttatagtaaaatgccacatatctttatgttcagcaagaagagtataatatatgattgttaatgataacccaaacaacaaaagatttcaccttaactggttgtcataagtagtagtatccaccgccttattttgagttggatttttatcatcctatgagccctacaaatttaaagtttttggaacagcacgtgcattgaacccataagaacctactctgcttttctgcatgtattgtccagacaagagaccaaattgccgaggcatcatttaggtgaattctaattaacatttagctaccttacaaccacaattcaaggttgtttcaaaggcatgtgcttgcatcatcctgattcactaccatgtgttactaacttggatctgcaaagtcattataaaaagctgttttgatggacttatttggatattgctttacccttcttctctcttttcttttatcaatgtaaaaacattatatgttaaatacttggcttttaagagcatagatctgaaatctgcctctagcaaataacccataacacttctaagatatacctgcaaggtcaattgtgttgtaaaaccttgataaccatactttattgttcaaaaaagccttttatgaaggcagaagttaaaaaaaaaaaacaaaaaaaacagagtccacagttatcacctcagctacaatctcatcagttcacaagtaccagcaaaacatgtgataagtcaacaaatgttttatttcaatctgaacattttacgtaagtgaagactttgttagatatcatttggaatgtggaatctacacagttggcatatcagagaaggttgaattcagtttaataaatgtttatagaaagtgcttgttatcataatgataatagctcaggatgtgcatgacaagcttttaagcgattgggtacactatctcatttgatcttctgcacaactattaatggtaggtactattatccctatcttatggataagtaaactaagatttaaaaagtacagaacatggtgtgaacactgcttcaaaatttctaaaataggtaaatcacgatctctaaactggagggttgtccaaccactagggacaatagagtactgatatttagtggtcagactgtaatgcgggaagagacaggcatgggctaaacgggtgtagagatcaaataaggggcaggttagtttgtaaacatgtccatatgtaacatttagcacaaatacaggatataggtgctttcagacccagctgcattgataaaaagttaggtggtattgtatctgtcttcctttctcaatgttgcatatctgtgttcttgcccagtttgcttcatctctctagccacacttattggcctacaatggcatcatcaccaaagaaggcaatcccatctccgtgtggctttggtttgctccctaaagtaaaccttgtgtttacttttcccaggtctcatgctttcccatatctgacctgttttgtcctcatggccaggatatgtgggacctttcctacaatgttccaaagtttgtaatagagctcttctctgctttgttccaaattctgcaacattttactttaaataatgaatttaaatacaaacaaacttgagctttgcctatacttttcaagaatgcagagataactaaattaataaaaatattcattgagtccttactgtgcacacagctctatgttaagccttgtgcagaactcaaagtcactcgagattaagcctgttactaagttatgtgcaatttagctcagtggatttcccccacttcatattgctctgataatgttttggaattaactgccttgattccttcttttctctgcttgtctatacactatttattattctacaccatctcaaattctaactcctcaagaaaatccttccagatgatttttctaaccaggagttttaacttccttttaactaccctattactttctacttccttaactcatctatcatattatatttagttatttatatactaggtcgccttgaagaagggattgtgttttcataaatcttaataatccctgaggcatcaagtacagtgatttgcatttactaaatgctcaacaaatatgtgagggattcacttgaaactaatattagataattcccagtcaaagtgatctaatagcaaatcaattcttcagttttataggcaaagtatgactctggttttccataatcataattaatttgtcaactttataattttaattaagtaaatttaattggtagataaataagtagataaaaaataatttacctgcttaactacgtttcatatagcattgcatttttctttgtaaaatttaagaattttgtattaataaacttttttacaaaagtattaattattcagttattcatcatatacttttattgacttaaaagtaattttattcaaaagagttagtataggactacatgaaaaattcaaggccaaggcttaatttcaaatttcactgcctttggctctatcttttaaaacaaaacaaaaaactcccgcacaatatcaatgggtatttaagtataatatcattctcattgtgaggagaaaaaataattatttctgcctagatgctgggaaataaaacaactagaagcatgccagtataatattgactgttgaaagaaacatttatgaacctgagaagatagtaagctagatgaatagaatataattttcattacctttacttaataatgaatgcataataactgaattagtcatattataattttacttataatatatttgtattttgtttgttgaaattatctaactttccatttttcttttagactttaaagctgtcaagccgtgttctagataaaataagtattggacaacttgttagtctcctttccaacaacctgaacaaatttgatgaagtatgtacctattgatttaatcttttaggcactattgttataaattatacaactggaaaggcggagttttcctgggtcagataatagtaattagtggttaagtcttgctcagctctagcttccctattctggaaactaagaaaggtcaattgtatagcagagcaccattctggggtctggtagaaccacccaactcaaaggcaccttagcctgttgttaataagatttttcaaaacttaattcttatcagaccttgcttctttttaaaactttaaatctgttatgtactttggccagatatgatacctgagcaattcttgttctgggttgtcttatgtgaaaaataaattcaaggtccttgggacagataatgtgttttatttatctttgcatatccattacttaaaacagcattggacccacagctggtacaaaattaattactgttgaattgagcaaatatttattctaaatgtctctgtcaaatgacagagtgtggttgtgtggattaagtccctggagagagttctttgttctctcatgttctatgctgtggttcttgctttatgcaaaaagaagtaagttacttaaaacctggacatgatacttaagatgtccaatcttgattccactgaataaaaatatgcttaaaaatgcactgacttgaaatttgttttttgggaaaaccgattctatgtgtagaatgtttaagcacattgctatgtgctccatgtaatgattacctagattttagtgtgctcagaaccacgaagtgtttgatcatataagctccttttacttgctttctttcatatatgattgttagtttctaggggtggaagatacaatgacacctgtttttgctgtgcttttattttccagggacttgcattggcacatttcgtgtggatcgctcctttgcaagtggcactcctcatggggctaatctgggagttgttacaggcgtctgccttctgtggacttggtttcctgatagtccttgccctttttcaggctgggctagggagaatgatgatgaagtacaggtagcaacctattttcataacttgaaagttttaaaaattatgttttcaaaaagcccactttagtaaaaccaggactgctctatgcatagaacagtgatcttcagtgtcattaaattttttttttttttttttttttgagacagagtctagatctgtcacccaggctggagtgcagtggcacgatcttggctcactgcactgcaacttctgcctcccaggctcaagcaattctcctgcctcagcctccggagtagctgggattagaggcgcatgccaccacacccagctaatttttgtattttagtagagacagggtttcaccaggttgcccaggctggtctcgaatgcctgacctcaggtgatccgcccacctcggcctcccaaagtactgatattacaggcatgagctaccgcgcccggcctaaaaaatactttttaagatggtgtaaatattactttctgtatcaatggtacattttttacttgtcagtctctagaatttctttataaatatgttgattcagttcatttttgtagattataaaacaggtaaaaaaggataaaacatttatgtgaattaaagggaatacctaatttttgtgtagagtttattagcttttactactctggtttatggatcatcacaccagagccttagttactttgtgttacagaataactaatatgagtgaatgaatgacttacacaagtcactgcttaggataaagggcttgagtttgtcagctagagtatgacagaaagtatctaagttttggagtcaaatagcactttgtttgaatcccagattgcatgcttactagttatgtgaccttagtcaagccacttcacctcactgagtctttgcttttttcatctctaaaatagagatacccaccgctcataggctgtcataagggatagagatagcatatggaatgagtctgtacagcgtctggcacataggaggcatttaccaaacagtagttattatttttgttaccatctatttgataataaaataatgcccatctgttgaataaaagaaatatgacttaaaaccttgagcagttcttaatagataatttgacttgtttttactattagattgattgattgattgattgattgatttacagagatcagagagctgggaagatcagtgaaagacttgtgattacctcagaaatgattgaaaatatccaatctgttaaggcatactgctgggaagaagcaatggaaaaaatgattgaaaacttaagacagtaagttgttccaataatttcaatattgttagtaattctgtccttaattttttaaaaatatgtttatcatggtagacttccacctcatatttgatgtttgtgacaatcaaatgattgcatttaagttctgtcaatattcatgcattagttgcacaaattcactttcatgggctgtagttttatgtagttggtccagggtgttattttatgctgcaagtatattatactgatacgttattaaagaatttcctacatatgttcactgctgctcaatacatttatttcgttaaaacaattatcaagatactgaaggctgattggtaactcacatggaactgggagagtatacaattctgaaccaaatagatgattctctattattatatcttaatttatgtgttatggtatattaaacatgaaaaaaattgtatttggttagaatatgtttgctcttccttaactcgggaatgacatagggtaatattcacagattgggttcctataaatcctccacttgaagtgaagtcagttcaagtaatgaaagctacctcctgagatagaatcagtacttggcacctatctctagtgttctttcacctcatataacctttcactgattagtaaagattatatccaacaaagaaagtacagcacagactgagatatgattactgagataaatttgggcaaaatataaactacagcatttctgtagcaatgagaccatttttcttcagttgagctccatgttctacaaacttcaatcaaaaaaggttctaggagactcagtgaaagttgatacactgttcaaggaacaaataatttcagcacatgggaatttcacagggaaaaatatactaaaaagagaggtaccattttggatggtgtcaatatgggttatgaggaattcaggctgctgagtccagtgtacaatggaaactgagctgcaggtgtgtgattgtaacaacaaaagaaatgctgaaatattaagtcctttgccatgtaaatagaaaaagagtatttatttcccaaacattattgctcacctgtttttgttatgcctttcaagataaatccaggaaaggaattgcattttctttccagaaaacaagttcttgggggaattgttcaattggtagatgttgtttttctcattaacaagtgagtgctccatcacacttgctgagtgctccatcacacttgctctctgcattactcctctgcctgcaaacacatatatagcaagggtgatgacaaggatatcagagggtctggttttctcaaactcatgataaactcatggctgggtcattcttggtgctgattttactttgttttttgttgttattgttccctcttcctcaaaagatgaaatctatccctcttacttggaatttctctttgatatatagcgaatgtttggttgtaacctgtataatctggcatgaaattgtcactcgaaaaggctagaagtgttgacataaatatgggacagcaagagttgctcctactcaagagagcaaatataatgttctggaagagattggcagaattcacatcaaaggagtgattacttcagcctgggccactgttgtactggtcaaaaggctgtgcaaagctctctgaaaatccactcttttattgctctttagtaataaagtcactttcaattttaaaaataacaaactgatatatttttatgactcataaaatgttagcaattatattatggagaatctactttctgggtgattcttacaaatgttcttggatctatttttttttcttatagtacctattcttcccatttttctcagctctagttaatatatttcaacaacagttcaacaaatttaacatttttataaaaagtgtttcctatcattttataaataccagcctagtccatgttattccttttcttgttgaggagaaaggacacacattgtaaattcaaatatagacctctactgtgctatttaatcttggtaacaactccacaaaggagatgacatgttttccttctatagaggtagattctgtaaagttagagggaagagtgacttgcttaagatggcataagctgtaactggcagaaccaggattcaaagccaggtgggatgccaaaatcataatctgtcttcagtgtcaagttactgaaattggtaaacattagacctaaatagacggaattgcaatccgggttgggcacattaaactccattttcttcatcaatgtgctcagattacattttacttttcaggctaaaaatggaaaaaaagagtccctcttagttctgcacttgagaatgagaatagcttttctgaattatacaaggaagaagaactaatgcccaaatgccaggtacccacatgcactatgccatggcacagctgttgccccctttcaccagagccctctctctgtatcctggttgacctttccttgggcaagagctgggtggggaggatcacaagtgactccaatttggatggcttcgggaagactgggaccgagctgaaggcagtgttgtcctctgcactccctgttttctgtctgctggagcactgaagcctcacatatgtattaaaaaaataatttccatttgcatttcagactagaagattgaacgtatagtgtaatgtgattgcaaataattatattgaaatgagacagagaggatgtagtatctactgtcataatttttcaaaacccacctgcaacttgaattaaaagaaccacttgggtttttttttttgtttcaaacgcaaatcctggaaacctactgagactcattcagtcagtatctctaagaggcaagcttgagactgtatatttaaaaagcatctcaggtgatttttacacatgctaaggcttaagaaccacttctctgtagcttatatgttattttcaatgttcctcaaagccaagttagaatttccaaagtgttaagaatccattagacaatcacagaattgtctttttcctttataaatcttgcaatgttgttctcatttccatacttaattacttaaaacaccaaccaaccaacaagcaaaaaatgattagtctaactaatattacaagttaataatgaagtaaaggtttaaaaataatgtcataataatgttaataacaaattattaattataatttaaaaataatatttataatttaaaaataatatttacaagtactacaagcaaaacactggtactttcattgttatcttttcatataaggtaactgaggcccagagagattaaataacatgcccaaggtcacacaggtcatatgatgtggagccaggttaaaaatataggcagaaagactctagagaccatgctcagatcttccattccaagatccctgatatttgaaaaataaaataacatcctgaattttattgttattgttttttatagaacagaactgaaactgactcggaaggcagcctatgtgagatacttcaatagctcagccttcttcttctcagggttctttgtggtgtttttatctgtgcttccctatgcactaatcaaaggaatcatcctccggaaaatattcaccaccatctcattctgcattgttctgcgcatggcggtcactcggcaatttccctgggctgtacaaacatggtatgactctcttggagcaataaacaaaatacaggtaatgtaccataatgctgcattatatactatgatttaaataatcagtcaatagatcagttctaatgaactttgcaaaaatgtgcgaaaagatagaaaaagaaatttccttcactaggaagttataaaagttgccagctaatactaggaatgttcaccttaaacttttcctagcatttctctggacagtatgatggatgagagtggcattttatgccaaattaccttaaaatcccaataatactgatgtagctagcagctttgagaaattctaaagttttcaagtgataagactcaatttatacaaagctaattggataaacttgtatatgattaagaagcaaataaatacttattatgcttttttgctgtttatttaaatatttaacccagaaaataagtcactgtgacagaaataaaaatgagagagaagggtgagccactcttaggtagttctggcattatttaatctaggccagaggttgcaaatggtgtcccatagaactaattttggctcctagacctgtcttatttaacctttcatttaaaaaatttgtattggttgccagcaattaaaaattgggagatgtctcacacacacacacacataaacacacacactcatgtgtgcagcctcttttgaagaattggaataactagtcaactgcgtcctccttttccacaagctgtgacagctccctgctcacagagcacctgccctctcctgttcatcatgctctcttctcagtcccattccttcattatatcacctatttggtcctgagactaagtgagtttgagatctgtgatttagacaaagtggtgaatctagctctgaatcatagtaagtagctctgggaatcatcttgtcttctgttagcccattgagagagaaatagagagagagagagagagaaagaaagaagaagaaacagatctggggagagtcactgaatgggagcatagagacagagaaacagatctagaaaaccaaactgggagaaaatgagagaaaccaaaagagaggtagagaggagcagagaagaaaatgaagaagcaaggcaaggaccaggctttttcattatttcttatggccaagacttcagtatgcgtggacttaattcttccttatgctcctaccttccctagggaaactgatttggagtctctaatagagcccttcttttagaatcacagtttgatgccttaaaactagttatataccttcacatgcttccttaacccacagaagtgatgctaatgaggcccttaataaggagcgtgctattaagatgaagacattcattttttttctccgtccaatgttggattaaggcacattagtgggtaattcagggttgctttgtaaattcatcactaaggttagcatgtaatagtacaaggaagaatcagttgtatgttaaatctaatgtataaaaagttttataaaatatcatatgtttagagagtatatttcaaatatgatgaatcctagtgcttggcaaattaactttagaacactaataaaattattttattaagaaataattactatttcattattaaaattcatatataagatgtagcacaatgagagtataaagtagatgtaataatgcattaatgctattctgattctataatatgtttttgctctcttttataaataggatttcttacaaaagcaagaatataagacattggaatataacttaacgactacagaagtagtgatggagaatgtaacagccttctgggaggaggtcagaatttttaaaaaattgtttgctctaaacacctaactgttttcttctttgtgaatatggatttcatcctaatggcgaataaaattagaatgatgatataactggtagaactggaaggaggatcactcacttattttctagattaagaagtagaggaatggccaggtgctcatggttgtaatcccagcactttgggagaccaaggcgggtggatcacctgaggtcaggagttcaagaccagcctggccaacatggtaaaacccggtctctactaaaaatacaaaaaattaactgggcatggtggcagatgctgtagtcccagctgctcgggaggctgaggcaggagaatcacttgaacctgggaggcggaggttgcagtgagctaagatcacgccactgcactccagcctgggcaacaaggcgagactctgtctgaaaaagaaaaaaaaataaaaataaaaataaaaagaagtggaggaatattaaatgcaatataaaagctttttttatttttaagtcatacaatttgtttcacataacagatcaggaaataatacagagatcataagttttggagctgggtttgaatcctggctctgccatttactttctgtgtaatctaagtcaagttactgaactttgtgggccctctggctctccatgtgtaaaatggagaatattaatatttaccttgcaagtttgttgtgaagactgaaggagagaatttaggtaaaacattcatcagagtaccatgcacacagttgttcctcaataaacattagcttctctgattgcaagttccagtctaaagtgctttatatataccagccaataaaaggatgcgagagagatataccagtgtattgttttctaccattttaaacctattttcatccactgttacaaattctatcatactgctccacataaaaaatattatcaatgatttttagtctctgaagtgcaatatttgattattgagcacacctgttgaagttttagtttcttctcacttacatgggttgtgtaaaggtaggaggtataaaaccagtgtcctaggtctaaatctttcttaatgtcatactttggattcattgatataagtaacttgagcaccagcgcttcattttacttcattttttaaagatatagtaagagtaattcccatctgcctagcaaaattgttttgtagaaaagtttgtggatcagatttattttactttgattttaggaatttcaagtgtcttcgtcggcatgaaggaaaaatatgcagtttgacattttctactactttcaggtcattattttcctactctggtgcaaaaaccctcaattcctgtctcactccatctaatcaaataggtagcatgcttgagcccttactatgtgccaggcactaggataagcactttatatgttttgtcccaattaattctcacagcatttctatgacctaaataaaattaatattttcatttcaccaataataaaatggaggcttcaaaaagtttagggacttggctcagctcacacaactggcaaggactgaaaatggattttagtcccaaatgtcataggctagagccctttcactaaactgttgtcttccatctggtggcatcctcttcctccagtctttgtcacctaaactctgggcaccccttgatggcatttacttatgatggtgatgcttgttaaacttcctgtttgcgacttcaacgtccatataaatgagtcttccaatactgtacttagaacttatattttgtagtgacttctttaaaagctttctctcttagtcatatcctgagttttgttagcacctggacttaccttactttggaaatgttgcactctgaaatctctttctcagcttggaatttcctaatcttccaactgtttgagtcttttaattctacatttactgcctttccatttcatcaggatttctagtctctttaattcttccttttgaactcctcctgatttaacctctgcttattcgaagaacaataattttattctctcagctgcactctcaattcccttttccttttggtgatttttctttttcctacagaacacttactttatcagttttggagaaggaagtgctatctgggtaacagtagtgctatctgttgactctagtcaactgtaagttttatacatttattgtttaaaccttatatgggtctataatccttcttgggaaatcctttcatttgtctttaatttcctttaccatttccctaaaggctattccagatttttatcacattcacaaaattcccgtcttttctcaggatctgttcacccccagtagatagccttgtctcccacaatacatggagaaaatagaggccaccgtcatatttgaatgtttccaacttctctcttcacctttggaattatctttttcttcttttgtgtctaagagaaagatgtatacttcttcttacccttgtctgaactactctattttgcttcatcttctcagaacaggggaccagcaattattcttcctccagaagcttcaacatcttttgtcaactgactccttctcatgtttaaatattttcaagttaaacaatttctttcctgactttcgctcacgcaacctcatgcccaaaaccttatcactcttcttccctttgctgtcaaggctgttctcacttcttcactttttgtggacttctccccactacaacatagattctgctatcaccaatctattaaaactgttatactcttgtggaatttatcatttaatttagcttcagtgaaccgttctttccagattattttggcctcagaccatgacttctaagtctgccgtgcttgccacttaagtgatgatgggccagtgggtccccacctaggcctctgtgttagtctgttttcatgttgctgataaagacatacccaagaatgggcaatttacagaagaaaggggtttgagggactcacagttccatgtgactggggaggcctcacaatcatggtggatgatgaaaggcatgtctcacatggaggcagataagagcatagaacttgtgcagggaaacttccctttattaaaccaccaggtcttgtgagacttcttcactatcacgagaataggatgggcaagaccctcccccatgattcaattatctcccactgggtccctcccacaacacatgggaattatgggagctataattcaagatgagatttgggtgaggacatagccaaaccatatcagcctccttctggctttttatgttctccgtgggtgacctctctcaggctcaagtgataaccaatgtgctgatgactctcaaatgcgcatctctggcttcagtttcttccttgaacttcatacatatgtttccaaatttcctgcgtgtacctcaaggttcttgttcatcacttcccaagcttcataaacgcactcattttagtgtattctctgtctcctttgatagcatccctgagaggcaagtccctggtgagttatatacaactcctcccttgctccaaacctgagagtaagtaacattcctattaacatattaggaagctgaggcttagacagtttaagtaactcaagcatggttacacaactagctagggcagagctaaaatgtcaggctaggcttctgtgactccaaagccctttctcacttagcatatcatcacttatttttttttttaatcacatatatgatttttttttctttaagagatagaatcttgctctatcacgtgggctggagtgcagtggcacaatcatagctcactgtaaccttgaacttgggctcaagtgatcctcctgccttagcctactgagtagctagggctacagacacacaccaccatgcctagctaattttattttattttattttattttttgagacagagtctcactctgtcacccaggctggagtgcagtggtgcgatcttggctcactggaacctctgctgcccgggttcaagcgattctcctgcctcagcctcctgagtagctgggattacaggtgcctgccactgtgcccagctaatttttgtatttttagtagagacggggtttcaccatcttggccaggcttgtcttgaactcctgacctcgtgatccactcgcctcggcctcccaaagtgctgggattacaggtgtgagccaccacgcctggccacctacctaatttttaatttttttgtagagacagggtctcactacgttgcccaggctggtcttgaactcctgttctcaaacaatcctcctgcctcggacaccccaagtgcagggattacaggcatgagtcattgcagctgacctgtatatatgatttttagtatatgtaaatatacatatttattaaatgtaaatataaatataaatgtgtggagtgatatccattgaaatgttaaacatagttctcagtggtacaactacaggtgatttctcttttcttatttctggttttctgtgttttccaaatttcttgaaatgtgtcttctgtaatcagaaataaaagttattagtaacaacagtcttccactggtacaagtgcttattggataaaagtcccacttctaagcatgatactcacaacttttaggttaatagcctttgtcaccttgccatatacatctgatccagccactcacaccattcctgagatatattttgttcctttgtgcctaaatcattgtgcatgcagatccatcttcctggaacacctataaccatttcttagtcctgtgaaatcctacttacatccttcatagcctagcatgtatgtcatttatttggtcaagggtgagttggttgttctcttgaatgtactgccatatgacgtggtgtgatttcaattgtagcaccaagctcattgcaatattaattcgtttgtcattctcccatgtaggatgtttgaagtagtttctaacacagagattatactcaataaatatttattagataaataaatgaataagggaataacaaatgcctttgtctcattttaaaatactttcattgttagctacccatataataaaaaactaaaagcagtagttttcaagcatgattgtttatgtatgccttaaaagaattttgaaaacctatgtacccctgacacacttttaagttaacttataaatttttcaacatagttttaagtggtggcaaatgatgtagtttcttgtgtattttaaactgcttaagtatgctatacatggatttcttcaaaaccctgaagctgcagtttcagtgcattcaatttatggaaaagaaattaatttataaaattggttcttattgtcaagtcaatcagctaaatataacttgctttctgtcaggaaaagtctgactttaaaatacagataagtaataactattattaattaattaaattattaaaattaaaataattaaataatttgttaattaaaatgccttattcccctacttatttctgcaatttgactctaagaatagataggacatgtagattgccttaggtttgaaatctgggtgaaataagatactgcctccttcagtatttctgcctttgcttttatgggagcctctttcaagaaaaagtcattctctcatggtccctttgtttgagtcccagaggttttcctactccagaaagtgcaacgtagtgagactagtactatactcccttgcatggtaagtgagaaggctgtctgtataaaatgagggaaggactcatgagagggaagtaggtcaggagaaatgataggttctcaggcaggttaattttaggaaagagtgaatagagtcccttaaaacaaggtgcatctgcttcctcctgatcaatctttaggactgtttactttgatttgaagaccactatgctaaagcttcccacgggggcaatagtgaggcaaggaatttttaaaagggaattacttcttcgtagctacttttgtgaaatgaattcatttgaattatctggcaatctcttcatatttatattcaacaataattacttaaagaaatgctttgagcttctcagaggagggtgctaccagtgtgatggagtagaattcagatttgggtagtgactttaaagctgtgtgactttagtcatttaactgctgagtcacagtctacagctttgaaagaggaggattataaaatctatctcatgttaatgctgaagattaaataatagtgtttatgtaccccgcttataggagaagagggtgtgtgtgtgtgtgtgtgtgtgtgtgtgtgtatgtgtatgtatacatgtatgtattcagtctttactgaaattaaaaaatctttaacttgataatgggcaaatatcttagttttagatcatgtcctctagaaaccgtatgctatataattatgtactataaagtaataatgtatacagtgtaatggatcatgggccatgtgcttttcaaactaattgtacataaaacaagcatctattgaaaatatctgacaaactcatcttttatttttgatgtgtgtgtgtgtgtgtgtgtgtttttttaacagggatttggggaattatttgagaaagcaaaacaaaacaataacaatagaaaaacttctaatggtgatgacagcctcttcttcagtaatttctcacttcttggtactcctgtcctgaaagatattaatttcaagatagaaagaggacagttgttggcggttgctggatccactggagcaggcaaggtagttcttttgttcttcactattaagaacttaatttggtgtccatgtctctttttttttctagtttgtagtgctggaaggtatttttggagaaattcttacatgagcattaggagaatgtatgggtgtagtgtcttgtataatagaaattgttccactgataatttactctagttttttatttcctcatattattttcagtggctttttcttccacatctttatattttgcaccacattcaacactgtatcttgcacatggcgagcattcaataactttattgaataaacaaatcatccattttatccattcttaaccagaacagacattttttcagagctggtccaggaaaatcatgacttacattttgccttagtaaccacataaacaaaaggtctccatttttgttaacattacaattttcagaatagatttagatttgcttatgatatattataaggaaaaattatttagtgggatagttttttgaggaaatacataggaatgttaatttattcagtggtcatcctcttctccatatcccaccctaagaacaacttaacctggcatatttggagatacatctgaaaaaatagtagattagaaagaaaaaacagcaaaaggaccaaaactttattgtcaggagaagactttgtagtgatcttcaagaatataacccattgtgtagataatggtaaaaacttgctctcttttaactattgaggaaataaatttaaagacatgaaagaatcaaattagagatgagaaagagctttctagtattagaatgggctaaagggcaataggtatttgcttcagaagtctataaaatggttccttgttcccatttgattgtcattttagctgtggtactttgtagaaatgtgagaaaaagtttagtggtctcttgaagcttttcaaaatactttctagaattataccgaataatctaagacaaacagaaaaagaaagagaggaaggaagaaagaaggaaatgaggaagaaaggaagtaggaggaaggaaggaaggaaagaaggaaggaagtaagagggaagcagtgctgctgctgtaggtaaaaatgttaatgaaaatagaaattaagaaagactcctgaaaggcaattatttatcaatatctaagatgaggagaaccatattttgaagaattgaatatgagacttgggaaacaaaatgccacaaaaaatttccactcaataaatttggtgtcaggctgggtgcagtggctcacacttgtaatcctagcacttttggaggcagaggcaggtgaattgcttgagtccaggagtttgagaccagcgtgggcaacatggcaaaccccacctctacaaaaaacacaaacaaaagaaaatagctgggtgtggtggtgtgtgcctgtagtcccagctacttgggaggctgaggtgggaggatcacctgagcctgagaagtggaggctgcagtgagccatgattgcaccactgtaccctagcctaggtgataggctcaaaaaaaaaaaaaattggtgtttgcaatgctaataatacaatttggttgtttctctctccagttgttttcctacatacgaaacagcttttaaaacaaaatagctggaattgtgcattttttcttacaaaaacattttctttcttaaaatgttattatttttcttttatatcttgtatattattactagcagtgttcactattaaaaaattatactataggaggggctgatactaaataagttagcaatggtctaaacaaggatgtttatttatgaaaaggtagtaattgtgtttcatagaatttttaaaattaattctgcgtatgtcttcaagatcaattctatgatagatgtgcaaaaatagctttggaattacaaattccaagacttactggcaattaaatttcaggcagttttattaaaattgatgagcagataattactggctgacagtgcagttatagcttatgaaaagcagctatgaaggcagagttagaggaaggcagtggtcccttgggaatatttaaacacttctgagaaacggagtttactaactcaatctaggaggctgccttttagtagtattaggaatggaacactttatagttttttttggacaaaagatctagctaaaatataagattgaataattgaaaatattaacattttaagttaaatcttacccactcaatacaatttggtaatttgtatcagaagcttaaaagataacctaatagttcttctacttctataacttacccaaatatgtttgcagagatcttatgtaaagctcttcattataacactgctttcaggagccaaaaattgggtgggggagccccataaatgttgaataataggggtttgattagataaattttggtgtagttctataatggcgtgttattcagccaataaaaggtttgttaaagaatgactgtgacggatgtatatgatatactcttaagtgaataaagagttacaaaatgttatgtacaagttacaaaatgtatgtacattatgatccatttttcataaaatcatatgtatgtatatatgtgtgtctggaaggataaatttatcaagttgttatctctgaaattttgggtatattttatatttctagattttctgttactttgttactttactgataaagtaataacgttgttgacttttgtcactctcccctattaataatcatctaggctgcaaaaggatcatgtcttctttatttttatattccaaggactgtcaacaagtgcctagcacttgacaggtatattatagaaatttaactgaatatctttaggaaatagatttttgtttgtagttgttctagtctacattaaatgtcttgcgcttatgaaacttccttgaattattttagtgaagcaatattagtatagaattttgcatcactggatgcccttgactgaaagctggcttatggcatctcaccagtgtgtggggagtttcagtccttctgttgtctgcatcacagctgaagcagtgctgttgctgacaattcctgacaccaccttgtctctattattgatcattgcctcactatggtactgagttttagcttattcttgtaataactgggactcatatgtatagaataagctattagctcacgtttttgcttgctttttatacagaatacatgtctgcaaatagttttatcaatattttggaattttgggagatatgaagttaaaaacatcattgaatatatatatatacacacacacatatatatatgacactatacatgatttattttatttaatttttaaaattttattctttttagagattaggtcttactctgtcacccaggctgaacttcagtggtgtgatcatagctcactgtaaccttgaactcctgggctcaattgacctttccgcttcagcctcccaaagtgctgggtttataggcatgagccactgtgtctggtccaatatgcatatatatatttttaacctggattatcagagctatattgtgtttaggtttataaagctgtactatgtgaaaatatcacttctaggtttaattttgtacaaaggaattttatatagaaatgaggtaattcagattttttcccatgtaataagaattgtaaaatttactgaaacaaacatcaaaaagatatctgttacatgaccttcctttcttttgaatatatttcaggtgatattatttattaaaatttaaaaatgaaaattaaaatatataaaaagttgaaaattattcctttctttactgtctctcatctgtccattttccattctcctgcattccctcatccaaccaaggtagccaatccaggtaactttttttagtatcttcccagagatgtttctctctatatatataatcaatatacattttttattattccccacctctctttttatgtaacaatatgcagagttttgcttcttgcttttcccactatcttggacaactttccatattcaaagcacagaggacttgcacatatgttcagactgctgaatatttctgtctctcccctgccattcatatgttgaaatcctaattcccaaggtgatggtattgcagggtggggcctttgggaggtgattagtccatgagggtgaagtctttagtaaatgagattagtgtctttataaaagaaaccttagagagaccctcacaccttagagagaccctcacccctttctgccatgtgagaacacagcaggaagacagctggctatccaggattcaggagtctcttagcagacccaaatctgctggcaccttgatcttggacttcccagcctccagaactgtgagaaataaattcctgttgtttataagccacacagttcatggtattttgttatagcagcctgaacaaggacacacacacacacacacacacatgcacacacatttaaatagatgcatagtattctatcatatggatggatattctatgatataatgaatcactattgattgacatttgggttgtttccaatattttgttaacacaaagaacaacactacaaataactttatatacatatcatttagcacatctgcaattgtatcagtaggcttcctataagtggtcaagcatttgtgtacttgtgattttggtagatgttgtcaaatgtccttccctgaaatttgtaccaattcgtactcatgccatacactctaaatagagtgctgatttccccacagcattactaacagatgatattatctaatttaaaaagtttctcatcttatagggaaaatagtatgtcaatgtattcttaacttgcatttcttttattataagtagtgtaaaatatcatttcaacttatacacaggaggaatttctctctatataaagtgatcctagaatcataatgaaaaatatcaccaactcattaggaaaatgtacaaaggattgaatagatatctcatcaaaaataaaaatataagtggcctttaaacattgaaaggtaacatttgaacaaagacttgcaggaggtgagggattagggaatgcagactctgggaagagtcttccaagtagcaggtgaagcaagtgcaaagctttcagatgggactgactatacctgtctggtttgaagaacagtaaggaggtcactgaggctggcatagagtaagacagggagggtagaatactgtcagagaagtaatcggcggtggaggtagggggtaaaccataaagtgctcgtaaagactaaggcttatttctctgggtgagattagaggccactggagagttttaaacagaagtaacagggccactttggctaatgtttttaggctattctgtagggagacaagggaggaagcaaggagatgagttaggagtctattgtgccagttcaggcaagtgatgatggtggcttgatccaggtagtagtggaagtagtatagtaggaagtgatcagattcaggacatgctttgaaggaagatccaataggattaatggataagttgaacaatggcatatgagaaaagtcacagaggagtcaaagatgattccaagctttctggactgagtaactggaaggataaatgtgccgtttactagaaagataatgggagaaacaggttttggatggagcttggtttgggaatattaagtttgaaatgcctatttgacatccaaatagagatgttagttggatgtacaagtctagtttcaaggaagagggggctggtagtgtgaagatggggctggataagattctaaaggaaagagggttgataagaagagaaaggggtgtaggggttagcctaagggcattctaagtattagaggttaaggaggtgggtgaagaaaacccaataaaataaaagtctgagaagacaaagctagtgaatgaatgtggtatcccggaacccaactgatgtcaagcagaagggtgttatcaactaggtcaaatgctcattcatcaagtaagatgaaactgttataattaaccggtgtcttctgaaatacggagataactcgtgacttaatgaaagcaatagtagagaaggtcaaacttgaccagaatgaaattagaaagaataagaggaaagaaaagaccaaatacagacaaccattgatgccttattcttttgatatactcctggagtccacttgctaatacaattgacccttaaacaatacaggcttgaactgcatgggtccacttatttgtgaattttttttcagttaatacattggaaaatttttggggttttttgacaatttgaaaaaactcacaaactgtctagcctagaaataccgagaaaattaagaaaaagtaagatatgccatgaatgcataaaatatatgtagacactagcctattttatcatttgctactataaaatatacacaatctattataaaaagttaaaatttatcaaaacttaacacacactaacacctaccctacctggcaccattcacagtaaagagaaatgtaaataaacataaaaatgtagtattaaaccataatggcataaaactaattgtagtacatatggtactactgtaataatttggaagccacttcctgttgctattacggtaagctcaagcattgtggatagccatttaaaacaccacgtgatgctaatcatctccgtgtgagcagttctctctccagtaaattgcatattgcagtaaaaagtgatctctagtggttctcgcatatttttcatcatgtttagtgcaatgccataaaccttgaataacatcaagcaatccatacaaagtgccactagtgatgcacggaaaagttgtaacagtacaagaaaaaagttgagttgcttggtatttaccatatattgaggtctgcagctacagttgcctgcaatttcgagataaatgaacccagtataaagactgttgtaacaaaagaaaagaaaatgtgaaaccatcagtgcagctatgccagcaggtgtgaagtcttgcactttttgcaaaatacaaaatatgaaatatgtgttaattgactgtttatgttatctgtaaggtttccactcaacaataggctattagtagttaagtttttgtggagtcaaaaattatacgtggatttttgactatacagtgggttggcacccctaaccttcatgttgataaagggtcaatggtatattatttaatttttttgtatttatattcataaataagattaaatctatatttccaagtaatctctataagattttgttattaatattactattatttttgagacagagtcttactgtcaccaggctggagcacagtggtgcgatctcggctcactgcaacctctgcctcccgggctcaagcaattctcctgcctcaccctcccaagtagctgggactacaggcacgcacaaccacactcagctaatttttgtatttttagtagagacggggtttcaccatgttggccaggatggtattgatctcttgacctcatgatctgcctgcctcggcctcccaaagtgttgggattacaggcatgagccactgtgcacagccattaatattattgttacccaataaaaaaaatttggaaacttgtcttcttttcccctgattctgtttaaatagcactggagttacctgttttgaattttttttccaagcggtcccttatgagttttctctatgttttatttgtttcatttctttttttttttttttttttttttttgagacggagtctcgctctgtcgcccaggctggagtgcagtggcgggatctcggctcactgcaagctccgcctcccgggttcacgccattctcctgcctcagcctcccaagtagctgggactacaggcgcccgccactacgcccggctaattttttgtatttttagtagagacggggtttcaccgttttagccgggatggtctcgatctcctgacctcgtgatccgcccgcctcggcctcccaaagtgctgggattacaggcgtgagccaccgcgcccggcctgtttcatttcttatatcgtatttttgcaactcctttattgatacttttcttcctgattaggtttctactaaaaccaaacaagctttccatgaattagcttttagatttacttattagtttaactgttctgttgtattgtaactcattaatttataattttatctttattaattattctatttttcttcgcttttttgttgtttttctagtttttgagttagatgtttgacgcttttttaaaaagctgtgcattttcctctgggtaatactttagctgtatattatgtattctgatatatagtgtttccattacattgttttctagaaaatctgtagctttgatttatatttgtttcctctttgacctaagatatcctaagggaaaatttaacattttccagaaagaaaacaaattttctttgttttccaagaatgttgttcaaattatttctactgcttggaatttttatcatttttgtgtatccagtaaatagtcaatatttgtacttgctctctgaccacataaaagaatatattcgtgtagtttctattaatagattagagttcaattcagatattaaatgtacatcattattcatgatatttaggtcttctacatcttcacttatcttttttctacttgctttgccattaacagataaagttgaattaaaggcttctactacatacatttctccctgttattccttataggttctgtaatttttgcttcaagaatattgctttttaaatttaatatatagatacttataattacactctagcattataaagagccttttctttttcattgaatgtatttgggcctgcatatgtctaacatgaaaattatagtcctttttttgtttctttgtttgtatttacagttttaagttccattttcaacctttatgcactctttgctttaggtgtgtctcttttagttagcataaagttaggtttgtctttaatttcacctgaagtcttttcctcttaatagatgggttaagccaactgaaaaataaaactgacttatatacttttatttcaagtatgtcctccacaaatattttttgaatagattagcttatatactttggaatttgttaaaaaaagatttttataaaaaataattgtggtgaaatgtacataacataaaatttatcattttgaccatttttaagggcatagctctgtggcataaagtatactcacatagttgtgcaactatcacctccttttgatttttttttactaattttgtaaatttgtttcatctgagctgtcttattatgttttgttttatgtttttctttcctttattatgaagtcactgtattgtctgtaggctatatgtatctgtgagtgtgtgtgtatatgtgtgtattatggtttttaaaaaagtctatatttgttttccagtggctatacttaatactaataactttatgttaaatttttcattctatgtgactctagttcactaatatgagctctgataaaatcagtgctttttcgaggttaggagatcaagaccatcctggctaacacagtgaaactccgtctctactaaaaatacaaaaaattagccagacgtgatggcgggtgcccgtagtcccagctactcgggaggctgaggcaggagaatggcgtgaacccaggaggcagaacttgcagtgagccgagatcgcgccactgcactctagcctgggtgacagagtgagactctgtctctaaataaataaataaataaataaataaataaataaaatcagtgctttttcttcctctgctacctcctttccttctactcagttttagtcagtagtattatcttttttcagatttatctttgtattgttaaatctgcttatgcttctattactttatttattagctttaaatgataccttttgactttcagcttttcttaataaagcaatcagcaaatttcctttacactccacacttataccccatttcctttgtttgtttatttggtttttacttctaacttttcttattgtcaggacatataacatatttaaactttgtttttcaactcgaattctgccattagttttaatttttgttcacagttatataaatctttgttcactgatagtccttttgtactatcatctcttaaatgactttatactccaagaaaggctcatgggaacaatattacctgaatatgtctctattacttaatctgtacctaataatatgaaggtaatctactttgtaggatttctgtgaagattaaataaattaatatagttaaagcacatagaacagcactcgacacagagtgagcacttggcaactgttagctgttactaacctttcccattcttcctccaaacctattccaactatctgaatcatgtgccccttctctgtgaacctctatcataatacttgtcacactgtattgtaattgtctcttttactttcccttgtatcttttgtgcatagcagagtacctgaaacaggaagtattttaaatattttgaatcaaatgagttaatagaatctttacaaataagaatatacacttctgcttaggatgataattggaggcaagtgaatcctgagcgtgatttgataatgacctaataatgatgggttttatttccagacttcacttctaatggtgattatgggagaactggagccttcagagggtaaaattaagcacagtggaagaatttcattctgttctcagttttcctggattatgcctggcaccattaaagaaaatatcatctttggtgtttcctatgatgaatatagatacagaagcgtcatcaaagcatgccaactagaagaggtaagaaactatgtgaaaactttttgattatgcatatgaacccttcacactacccaaattatatatttggctccatattcaatcggttagtctacatatatttatgtttcctctatgggtaagctactgtgaatggatcaattaataaaacacatgacctatgctttaagaagcttgcaaacacatgaaataaatgcaatttattttttaaataatgggttcatttgatcacaataaatgcattttatgaaatggtgagaattttgttcactcattagtgagacaaacgtcctcaatggttatttatatggcatgcatataagtgatatgtggtatctttttaaaagataccacaaaatatgcatctttaaaaatatactccaaaaattattaagattattttaataattttaataatactatagcctaatggaatgagcattgatctgccagcagagaattagaggggtaaaattgtgaagatattgtatccctggctttgaacaaataccatataacttctagtgactgcaattctttgatgcagaggcaaaatgaagatgatgtcattactcatttcacaacaatattggagaatgagctaattatctgaaaattacatgaagtattccaagagaaaccagtatatggatcttgtgctgttcactatgtaaattgtgtgatggtgggttcagtagttattgctgtaaatgttagggcagggaatatgttactatgaagtttattgacagtatactccaaatagtgtttgtgattcaaaagcaatatctttgatagttggcatttgcaattcctttatataatcttttatgaaaaaaattgcagagaaagtaaaatgtagcttaaaatacagtatccaaaaaaatggaaaagggcaaaccgtggattagatagaaatggcaattcttataaaaagggttgcatgcttacatgaatggctttccatgtatatactcagtcattcaacagttttttttttagagccccattcttattttttatacactttgagagcataatgaaaagaaaagctacctgcaaaagttttggacttacctcaaagaggatatacttcattcctcaaaaggccttcttccaggaatagtatttcataacctggaggttggaaaaatctggatttgttacaaaaaaatctgagtgtttctagcggacacagatatttgtctaggaggggactaggttgtagcagtggtagtgccttacaagataaatcatgggctttatttacttacgagtggaaaagttgcggaaggtgccttacagactttttttttgcgttaagtatgtgttttcccataggaattaatttataaatggtggtttgatttcctcaagtcaacctttaaaagtatatttagccaaaatatagcttaaatatattactagtaataaatttagtactgtgggtctctcattctcaaaatgagcatttactaatttctgaacactgtgctaggtcctgggaataccaaattgaataagacatagtctatttttctgaagggtttatagcagagtcccctgtgttaataatgaaggagtgtgtggtatgtgaatcatatatcaatagggttgttaaaaataatgaaaaaaggagaagaggaagaacatcttttttttttctgattgcacgggcagccttaaaattatttttgaagtgtacaattcagtgtttttttagcatattcacagggttgtattatcatcaccatatttttggcctcttgaaaagaaatcctgtgcctattagcatccaattaccgttcctttgtagctaagtctcccccattccagctttaaacaatcacccatctactttctgtctctataaatttgtctcttttggacatttcacataaatgaaataatataatagggttttttgtgcctaaataagcttctaaagaagaataaggtaaggaatcatcattcagcaaatatttattaagacttgctttattttatacagtgtactaggagctggagatgaaaatatgtgtagaacatgaatcatatacttcgggaatttgtggactagtgggaaagattgacatatcaataacaaatcgaattagtgatgtaatagaggcatttttacaggagtaaaatgaggtagcatggactctatctgggtctgaataatgtgaggagtaacctccttacacaaagaggcacaaggctaatgtcctctgatggaatgattcaccatgcaattctaagggtgacaagaatgaaagttagggccttgaagaaatattttgattaagagctgccaataaagtagagtaaagattagattgatgtgaagaagtgggagattaatgagtaaatggtcactggcttgttgagaagattaaatgagatgtacatgtaatgtacctaacacaacgtcttgtacaaagtagccattcagtagagactagcttgtattatctccctttgaggtaaagaaaactgttagaaatagtatttctactactgatagtatttcttctacttatgcctccctttgaggtgaagaatactgttagaaaacatgacataggagaaatacccctgagagacagttcttattagtgactactgtgcagaaaagatggaggttggtgtaattaaggagaaggaaagccatgaagccaaagtattatgaaaaagcatcaatatgaattttcatgttgacaaagtggtataaaagataattataaagatggtcacttataaatacggtagttctgtgtgacacaatttacagaagttggtatatcgtgtggaagaaaacagcataagatcctgaaggtttgaactgtgggcacattggctccatgctcaggaaatggcaatggggttgggaagtgattccactttatgtccctttcagacacataaaaattacttgtgtgagtatcttatgccagacactattcactgtgtagtgagcatggtgggtatgaaatgacaactttattgtctttcctgtcaaagaacttgtaggctggttgggggaaagagaccatttcaatatgaagtgctgagctagaggtacccttagggcactacagaagcctagctgatggcttttagcctggctagacagttcaggatctctaaaagcaggtgccttgaaggctgagtcaaatacaaaaatgtattttggacagaggaaattgtatgaacagaaacacagaacatgaaactacttggttggtgcagggtatcatcagcatagaaccagacagaaccagagtgtaaataagccagaaggccatgtcatggaggccttgtataccagtctcaggaatttggttgtggagagctttcatcaggggaatgatgtaatcagcttggaaatgtagatatatcactgactgtgatagtgaggagcagaattaaggtggacgtgattagaagctttgtgaatagcagaaagaacatagattttgaaagctggcagacgtaggttactgaagaaagttacttaaccttgctatgtctttagttttatcctctgcaatatggggataatactgcctattttgtagagtcttgtggattcttctggcatatataatagaaaataaaacagctattattattattgttgatggtactatttgctatatctgactacaaggagaaagactaataggaaaccatttcaggaatccagatatggtcatgatggacaggaagagacaagagttacatagaggaattctgggaagataagaaatgtcatttttatgtactgtttgcatccatcagacaaggcatcaggaaaaatgatccttcaggaaagagtgattttttttcttcaagaaattagaagaggggagaaattggtttaagattaaggactccatgcataagagaaactgggagggaagacaggtagaaatgctatggggttaggaaggaagaatgcagaggtggattacttagaattgagacatctgatcaagacagagggatcacagcttttgctaacaaagtactagtggaggatgccactaggtgaggtttaataaataattgttgacaataagttccatttaaaaaataaacaatttatgcttcttctttgcctaagtgtcaaataaaacattcagatttttatttcaaagtatccctgagtccctgttcccttttttgtcctgctgacttttggaactgatttaggcttccttagtcatctcataatagaaaaaatcagccaggtatttcctacatttcttgtattttaaaaaaatgtaatggatgtaatgaattttaagcaaatgtaatgaatacaataagtaacttagtatatgctgttttcttctctatgctgaatgtttcatacatgttattttctatacaactacatggtcaattccttgaaaatatcaactccaaaatctttattttggtatactccacgtagcacattgagagagttttaaactcttgttggatgactgtttcaaaagtgttttgaagtaggcatgtcagttgcaaaaagtttgctcagcaaatgttgttctgtctcacagtctcagacattgagcagatgattacatgacagcacgtgattgctgggagtaacagacaaaagtaactgaaagtgctcggttatcttgacagtcaaaatcaaaagtgtcccctattttcagtgacctaagagtttctttttgtgtttttggtattgttgttaaataagtgttctcacctttgaaaaggtcaataagaattcaatacagtataatgtctgtgtgccaaatgaaggtgccccttatttttaagtgtggaggagttttgatcataagaacttgaaatacctacagaatccttgatggttaagcagctggtgccagcacaagaatccctcaatatgttctctatgaagccccgatcaccaaatgcaaacattcatgattcagtatattttcatcttgactgccaaagttgatctgtttcttaatatattacatctagacttggaactggagatgagaacagaatattatcttcctcatttttgtgtttttgttcaactctaatgtctgcaaagcacttgcgtatgtaatgatgctcagtgtcataggagcaggcaggtaagtgtaaatttgtctggataggagaaagcatgcacaacatatttcacatagttttctgatttcagtttgtttttgcaaattattcactcagtgagatagcttaaagacgttatcacagggaaaggcatggagatagttctgtgttgatagaaaacttgtaatgtacagccatgagtgagaagtcaggttcagattcttcaccttcagtcctcctctttcataaacagctccatgtcctattttacatatcctactttaaaacgagattatagaagaatgaatttctaggcaaagtgacacttattttaaaatactattacgtatccctgtgcccattaacttatcctaccatttttcttcccctgtgtccaaaccacctttagaatctcctaaatatttgtagctattgtaaacagcactggagactttgctagtttaaaaggagaaatcaacgcaattaagccctagttaatttacttatcccttatgagattataattgtattttgttattaaaagggggacagagtacactgttctcttgcctttttaatttccagactaccacttctcctgcacttgacaataccgcagtctaccacgtagtcccatggctgacaggaggagaattctaggcaggccagtgtttgagtagtgagtaattggactgtctttacccagcaactcactgttttgtaaatgtacctgagtttggagaagtaattggcttttataaggggtgcggggtggagggttggggtggggagagtgagaaggaggtcagagctttaggatatataattggtctccacaaagttgttgtgatacttttggaaccacgtaatggtcttcattaactaagtgtctgtcatgacagccattacatatgcattataataaaaatttatttacagtgtaagttgaagaaggtaaaatctggatgtagtttctaaactctgcttggcagttttcatatttaagccactagaagaaaaaaattgggagggaagctgagaagaatttactgaaagaaaaaaatacttgggagggaaattggcaagaagtatgaaaaagcttgggagggaagtaagcaaataaatgagttaatgactgttctggaaaataaactctatcatgcagatatcacatgactgattaaatttgaatttgacctcctgctttccaggtctggtaaaaactaacctgtaagaacttgaaacttagcctttgaatggtcaatccaccactgtaggagaatttatgaatgttcagttgagagaactgaaaataaagaagtaccataggaattaacatttgcattcagtagccaagatataatggacatctgaaacaggtatttgaggccaggcgtggtgtctcatgcctgtaataatagcactttgggaggccgaggtgggtggatcacaggaggccaggagttcaagaccagcctactaaaacacacacacacacacacacacacacacacacacacactagccaggcgtggtggtgcacgtttgtagtccaagctacttgggaggctgaggcatgagaatagcttgaacccagaaggcggaggttgctgtgagctgagattgcgccactgcactctagcctgggtgacagagtgagactctgtctcaaaaataaaataaaacatatatttgaaacacattgaattatgtcccttaaacaagaataaacatcactaaatgactgtaccttgaactacctgtaattttctcctgataggtaattaagcttcaaagtactgacacttatttactgtaatatgaagcaataacttaaaaaaaaaaaaaaactattgaaccagaaccaaacaggaatgccatagcattttgtaaactaaactgctatttcatttcatttgagccctggaacttgaaaataaatgctagctaacatctgtgaacagaacatacccatcagtactgtgctaagcacctttcatgaactggtcattaaatcctcactttccatttatttagtgacaacttcacccagagtttgcagtcaaagtgaaaatgtgctgaattccaaaagtgtgagctaggttttagaagttaatcacaattctggaacaaattactagcttaacaaatgagagttcttatgtctctaaaaccaaaatagccctaagtctgtccctcccagtaagatttgggccagtcaatggaacagtaatatacaaatataattacagctgtctaggagcaaactatcctatgaatagataataaaattaagacacttaagccatgttttcatattaaaacacaaagtaaaaaatcattgttttccaaagataaaagccatactgtatcatgacatatatatgcccgatgtttcgaccctcttgaagaattgagattctcgactctacactcttagcgttttctatattgaacagatgtttaatttaaggaggtcaagagaaatcttacacttattttttaatggtaccttagacatagaaggaacctcagaaatctctggctgaatatttccatctgcagatgatcatgtcattaggcttctgactctatagccatagaaaaatattcatgaagacctttcaggaagggaatgttggtatttctaaaaattgagtacaagtattctctagacaaaacagctcttgaaatggcagattgtattcccattattatatttcagaatcaagacattaatacctactttttatttaccaggtttagttatccttgaattagattttataaattaaagaaatagatttcaataaatatttgttgagttcctagtatggaaacatcgtgtttggcaccagggatgttgcctgcaagtataacaggagttcgtatttgtaatgagtttatgatttacagatatttggggggcaaagatatcattcggtaaatacttatgagtgcaaactttgaactagggactgggccaaactctaggaacatatttgatgacagagacacaatccctgtcctcaaggagctttcattctagtagagaagatgaaaaccagtacagtttggtaagttagatgatattggttaatgtagggttcttatgtaagtctagagaagtagcatttaatctgttcttagaaggtcaggaaagatttccctggaggaagtgacatttaagctgagagaggatggataaacaggagtcatctgagtgaacaacagggagaacattccagaaagagaacaaaatgtacgaggcctgatgccaagagagaacattcattgcattggggaactatagtcacttctgtgtggctgggatgtagaatgaaatgagcctggacccaagagagcactttgccctttggggaagctgtaggtattacagtaaggttggagtctggaaagaaaggggtatattgtgagatctgaattgggagaggacagttatatccagacctttatatgctccagtaagaagactgaactttacactgggggccatgggactcactgaatggcattaaatttgagagtggtcatatgaccagatttgcattttacaaagattgtcattgactgcaacatgaagtatggagtattggaggagcggtaaggctggtggcagggagataatttaggaggctttaggtgagggatgataatgacttgccaggtaggaaggagtaaatttcttctcagtggataattagaagattgaatggatggacttggtcactatttggtatagaaggggaaaaaagatgtcaaagatgatgccaatttttaaaaataatttaacatttatttttaaatattttttcagccttattaaggtataatggacaacaattgtaggtatatgtcatttacaacatgatgttttgatttatgtatacattgtgaaatgactgccatagtcaagctcattaacatatccatcactcacataattaacattttgtgtgtatgcagtgagaacatcaggctctactctcttagcaattttcaagtatagattacatttgttaccaactatagtggccacactatacaatagagctccaggacttattcatcctgcctaactaaaactttgtactctttgaccaacatcttcccattcgtctctcctccccatgccaagtttccatcttggtcagttgggtggatagtagtactatctgccgaggcaggttggtagggtgaaaacaatgtgttcccttttggaaatgctgaggtgaccagggaacttccaagggaatctgtctggatctagagcttagaagagatgtttgggctggaaacagacatcaggtattcttcagtatatgggttgtaaatgaagtcacaggagtgggtgatatcaccaatggtgagtgtagtataagaagactggactgaggacagatttccaaggaatttcaatacttaagaggtacgcagagaaaagaggggctgtgaaggacaccaaggaggagactaagagccaggagggaaaactttcaagagagtattgcattatggaagggaagaagagagaacattttaaatgatacgcaatgctcaataatggtatccgctttggagaggccaagtaagattcctaagtacccattggatcaaggtccttaatcttacaaaaacttatgcaaatcaataataaagagatgataacccgataatcaaaaatagacaaggcatataagaagaaaatgaattaaaaatattcaaagcattcaacatatacaaatgcgctcaatctgatatataatgaaagaaaagtaaattaaaacaacaatgggcatgactaaataacagtatgagggagcctgaggagaaggagcatttgaaatttcagtacagaagagaaaaggggtgacttatagaaaaaggagacagaaaccatagaacatgtttggaggataagactcaaacaggtagtggggacccttttctagagtaggatgaaaacaggtaatgtgtgtggatgcaaatatgaggtaggatgtaatgggaagttgagcgaattcatatttagtcattcattcaaaaatacttaattgagttactgctgtgtggcaagcatcattctacaaacagagggcacagtgataagcaagccagtttgtactctcgtgtaacttacattctactttgagaagacagattataaataggttaaaaagtcaataatatgatgtttcagcatcaacaataaaaaattagggtgatatatagagtgccagggaaagtgctttcatggacctcttcattctctcctctcctggtgtcataagctactccttcatccatgctgccatttctcttggtttacggttccagtatagtactcatcacattattactatagagccatccaccttatgaaggtgaaggtgtccatctccttacttaaaaaaaaaaaaaacaaacaaaaaaacaaaaaacccgaaaaacaaaaaaagaggcagaaagacagaaggtcctccactaactttcacgtgccatgtaaccagcgaaatccaattattttacagcattctagctatagaagagtttgggaagcgtagtgcttagtgttctagcctttgtagcacaggaaagggcctggaaggaaaggaattgtgtcttccgcagttgcttttctttatggggaagtgctatagcccaaacaatattttaggaattttcatctattgtcaatatgcaaactggaaggggataatgaaaatgttgtggttagaagtttatgaaatattgttattcacattttaaagtaaaaagagggaatgtttaagagacttgtttaagatcacatgtctcataattggtgggaccagcaatacaatccaaatctaactacttatctttttgctatgccctattagtgttcatattagaaaagaaattctatctcagacactaatgatttgttctttggacaccaatgactttaagttaaaacttcatactagttaatttaattatggtgtagcagtattattaaactatcaagactataaattttctatttgtaaaggagattatgataccaaagattagtgaactaatgatattgagaattctatgacataattttgaaaaatatttgcaggatatttatttttgtgtaaatgatgctttcaagctaccataatcctaagtaagtgtatatttgggaaaaccacctattctaacacacttgaaatttaaataagtcaggaaatttttttccagatcttctcccaaattatcttcatctttttcctctccccttgggaaagaatctcttcatgcctcataatatcaaatttaaactatggaagtccaggtggtggacagtcagcaaaggggaagatgagaagcttgtgttataaagccagctcttgtcagaataaggatctggtaggaacttcagaagtgatgggtaggtaagtatgaaggccaggtcctaagatctaaattacaaagcagaagacttacttaccagggagctggaaaacatgttaggaaatccagagcaggaacagatttcaagatagcacaataatatagcagtgaagtactgagaaaagagtttttttcacgggttggatttattctagcattttaggcagcatttgggcatttctaagtggtcagacttagaggagatagttaaggaattagcagctgctaaatgccaattcttagaccagttgaatcaaaatcatctaaaaagctttcagaaaccagactttttaagggccatttgagagactctcaaatctggaatccagaaatctatagctagatgagtttaaggtagagccagaataagaaaaataaaatagtttgtttgtttcaggtatcttttccaatattatttccgaacctaccccaaacaccttaaatcactgcattctatagccattcttttaaaaatgcttgagttattagttttcaaaaacaaatacaaatctgcacacatacagaaataaacattaaagagacataaagatattaaacagagttacatatacttacaacttcatacatatatattatatataaaactgaatattaagtgtttgatattagtgacaaaatctgtaacatccattatattagtgctttttgtactttttgttgggtgtagtaaaaattgcattcgaatttgagttttctgctatatatttggtcagttcctatcagtgaaggaaaaacctttttttattattttattgtttttttattttttgagacggagtcctgctctgttgtccaggctggagtgcagtggcatgatcttggctcactccaacctctgcctcccgggttcaagcgattctcctgcctcagcctcctgagtagctgggactacaggcacctgccaccaggtccagctaatttttgtatttttagtagaaatggggttttgccatgttggccaagttggtctggaactcctgacctcaggtgatctgcctggcttggcctcccaaagtgctggaattacaggtgtaagtcaccacgcctggcccctttttattttttaagctgattgaagattcttagttctcatgctttctagtggtgattaatctttagccaatatttctatatacagttattagtaatcatgtttgacttaggtcaacaaacaatctttcctaaaaaaacagaaccccaattttaatttctgaattatttagtatctattttctgctgtggaagttgaattatgttgatagatatcatacagggccatgtaacactctcagatacacgttcacatgtatagtagctgtatacaaaaatgttacttcattctctctctctttataatactcttggctctcttacgttctctcacacactctactcttcccttcctctgttctttctacttgttccctctgctcctaccacacttattccccccttgtccattttccttgtgcataaagcacaagtgcttagtaattatcaaatattaataacaatgacactaaccacccaatgatttagtgttaatgacatgctttattgaatggcattacctctaaagttcatgtttcctttacccaaccaagcttcttaccctcctcccttaccacaagcatctatattgtcaaggttgttataaagagtaataagccagccattaaaaaagggtttatggtattttcctatctacaaagtcacaggaagctcaaatgtactcagtaaatattgcaaaattacacaggaccattaaatgtaacactccaccctttctctctctctctctctctcttgctctctctctctctttctgtcaatatagcaacaccctatatcattgccctttgtatgtgcaaatcagagttaataagctttatattagcaattactccttaacaacttctggtttgtttggtccagttgaataatgtaagcacttaaaaaaatgaaattataaacatttatgtgaaaagtgcatatatcacattggatatgttgttatgcactccttaataataaagtaagttaatctttattgcacacttattataatattactttgaccctctctagtactctttatctaagtattctcaagtgctttacaatctcaaacagacccaatgtgttgtatacacagaatcctttgaagctgacatttgcctttctgaccagcttgttgtaaaggaaatcagccaaaaaacaagtatctagatgagtagctcaaacattagtacacatagtaatcacaggtcaaaatgcagatagattaccctgtccaaattctcctgagtaagagtaggtgaaacatttttaaataagctccccaggtgattctgaaattggtccaaggaccacatattaagaactaatgatccaaacaatttgactttttattgtagattaaaccatgctgagaaaattattaaaaattgaaatggcagtggaggatggtttgaaagaaaggtttttcagggccctttcaacaataaaattaattgaacacaatattaaaactctatatttgatttaagactaaggttttcattgtttttaaatctcagtaatttttatgtaacaggtcaattcatacccagcatcttaattccaatgaatgatttcccacaacaatttttgtggataactccaagggaactcgaaggaagttgtagtatgaacaaagagaagtagaatttgtccctgtgtgtaaggcttctctgataagcagcacaggctctcatactgctttttaaaaaaattatgatagcatcaagtggaattaattttttttagattatactttcatggaagggaagatctactgtgaaggctggaaaaccaacacccttaagataaatatattaccagatttgagcgctcttagtaatcagcaaagataaatgtttaacagtgcatacaaaatgaagtgttttatgttaaatcaaatagagaaagccaaacactaataatgtggttacaaatgaacaataaattaggtaatcagaacaggtacagacattaatagcaggatattggtattattaatgtattttgttttaaaataatgaacttaattacaattctcctcatcctaccccactattttattttattccagattcagcagcttcatattatgtctctgaaacacttattattaaagttatccaaatgtacacatttctctttatataaatgtttcagtccagaaaaggaggccaaatacattagctcagaacatcaaatcttctcagatgtgggaatcttttattttcacacttttaaaggtaatctgtatttctagcgtctattatagacagaaaactttcatatgacaacattcctattttcttaactgccttgataggggcgaagacaaattctaagtaggactttttaccccattcttcttaccatcattctttcacaaaacccccagctttagacaatcgctattatgaatttgacatgtactattccaatccattcccataaatttacacccatatatacatatagttatctatgaacaatatttagtagcttttttgtgtgtggctttaaaatttacataaattgtataatttgtgcacattcttctttaatttgccttcttggctacggttatctttttgagatctagctatgctgctggtatgtagaattctatttcattcttttttcattgttgttttgtacccataacgtgtcacattttatttataccttctgttcctgatggacatttagattcttccaggattttactcaatactgcaatgaaaatctttgaatttttctcttttgcacatattcaagagacttttctgacatatatatctataggtgaattgtgtagtcatatgatacatacacacattttaaatttcactagatactgccaatttgccctttgaaatagccatacaatttatagtaccaccagccacttatgaaagttcccatttcctcaaatctttgaaagttcttattataaacagacatattaattcttgccattctgatttgtaaatcagaatctctattgttctacctctagttctaatttggaattccccaattacttgtaagatgctatatattttcatgtttgttagtcattctgatttcatatcctttaccaattatctttttggtaagttattgtggtggccatgagatgtgccttacagaggccttgctagagggaatgtgattgaatgagagccccagatgctgtgtattaaaatcctgcactgagtttgtctcaagatttcttgcacgtgaatgaatgagtacagctgggatactaaagcagatgtgtatttgggagatatgagacttctttagtggctgatttttggctcataaatgactttgccaaaccttccttagactgctcagtgttctaacatcttccatccagccttctacccttctttcctttactaggggattgaatttacattgaggtctcatagccttctctgcctctctccttatttccttttatacaaatatttcccctaataaatccatgcacatttaataccattttgctatttgcaacctgcaggtcctggactaacacagttctatacattgcattaccattctctagagtgggatcttttgttgtagagagttttaaaatttttatgtagtcacttttatccatatttttctttatggtttatatttttgtgtcttctctttaacacatcttttctagcagaattcataaatatattattctatattgccaaaagtttgaaagttgcaatcattagaattaatttttgtatattgtgtaagttaagaatctaattttattgtttttcattggaaagccatttgtcccaagataattttttagtagtccctccttcccctattgtcattctgacatattttttctaggttccgatctatgcatgtgtttctttatggaagagttggccctttgtatctttgagtttcaaatccatggattcaatcaaccacagatagaaaatatttagaaaagcgtcagaattgaacatgtacatacattttgcttgtcattattccctaaacaatatagtataacaactatttatgtaggatttacattgtattaggtattgtaagtaatctagagatgatttaaagtatacaggaagatgtgcatatgttacatgcaaatactaccccatttatataagggtcttgagcattcatggattttggtatccacagagagtcctggaaccaattccccacagatgccaaggcacaactgtatttattctatcatctacttgtttaatctcacatcagtatctacttttgaaataacaataactttattatttaactttttttattacttaggattagagaatttcctctggtgaggcatcatagtgtctcaagctggccataaagacaagtgagggctaggatcggtaagactgggcagaggaagatacaacagatctcctatgcatgaagcaaaagtgcagctcagaagccagctctttcattaagttgtcctctataccctcactagattgtaagctcttgaaatgagaggctataccttaattgtctctgttatctaaaatacttccactcactgcttggaacatattgcctgcaataattaagcttgccctggctcccaaagcatagagcaaatcacactcctccccttgcctttgagaagctcacagtcttcgaaggtagagatatgtgaacagataagaaaatggatgacaggagaacagaaacgcatgactgtcagagaagtcattggagactttacagaggaaattaaatttttattgatcttgaaagagtttgccagatgaagtagaggacaggcattttagacaaagggaacaggaaatgtgaaaacacaaagtgatggaagtcatggtgagtttggagaactataaaacttcaatgtggctgaagggtaaggtggatatagaggagtgctgggaggtgaggctgaagaaataagctaggaaatgtctttttatgccattttttaaagtttggactttattctgaagttcacatggatccaatattttttgttttgtgttgttttaagcagaagcgtgacatgatcagcttgaatgatgaacaacttgaattgtttaaagtggatcacacagtctactgttttacagttattctttgaccaagatattctttattaactgaggaaaaaaagggctttcctgaattttgcagtcatgggatatatgataagcattcttgatttatcatcttcaatcctgttacataacataataaccattgttattacctttagcaatgctttcctcagtattatctaatggcctataaaatgtgactttcatttgcaaatacagtacatctaacaagaacttaccacagctgctatgcaaaataccaatacaattgacccttggacaatgtgggggttaggggtgctgattccccatgcagttgaacatgttacataacataatacataaccattgttattatgtaacaggattgaaaatgataaatctttggaaagtggggcaaatgaattcttatgaattccatatcttccacatgtgttttacttttttgataagaagtagtaacctagttcagaaagaaaataatcatccccttttacttatgcaggataccaagtctatcttagcaccataatagtgaatgataggaatcaagctctatgaatacattcacatgtacatatatatggctatataggacacatgcatgcacatatacatatatacacttgcatatatgtgtatatacatgtacatatatgcatgtatattcaattgtatatgtgtatatagccaagttattgtacagttgacctttgaacaacacgggtttgaactatgcaggtccacttacacgtattttttttttccgtttctgacacccctaaggcaacaaggccaactcctccccttgctcttcctcctcagctgactcaacatgaaaactatgaggacgaagacctttatgaagattcacctccacttaatgaatagtacatacatttctttttccccatggttttcttaataacattttcttttctctagcttgctttattgtaataatatagtatataatacatataacataccaagtatgtgttaattgactgcttatgttatcagtaaggcttctggtcaacagtagactattgctagttaagtttctggtagttacaagttatatgtgggtgttcgactgcatggggagtcagcaccccaaccctcatgttgtccaagggcgttgtccaagggtcagttgtaattggtattttggatagcagctgtggtaaattctggttagatgtactatatttataaatgaaactcacattttataggccattaaatattattgaggagagcatttctaagggtaaaatcttgtctaatgcttgaaacatcttcattttcctgtcagtttagatctttttgaagtaattctgaaaatctctcttttaagctaaatttaacacaaccaaatagccaaatatttaagttccactaatgaagatatctaaatttctgttaaaaatttaagatatatgttaaacccttctaatataactcttctctcagtcaaacttttttttttaacagttgctttgcttcttctttcaaagtcatacttcaacaaagttgctattgaatatgtctgactaaacatgttagctatatgataagatggctggataagagataaatatagaaaatgtagctttttttctacttgcaataaccctttaggaattaaaatggaaaactaataactatttgattcataatagtagcaaaccgtaaaatatttagacataaatctactaagaaatttataagacatatatggagaaaattcaattgaataaaccgttattgaagtatataaaataagatctggatgaatagaaagatcataatttttaataaaattttgcatcttaaaaagtgaaccctctccaaatatatgcacatttaataaaattataaatacatcccaatgaggttggttttgaaattttgttaattggaacttaaatttcacctaagaagaaaaaataaagaatagttaagagtgcatgctttgtagacaaattgccttagttagaatcctggctctatcatctattagctatgttatctttgggataacattcatcttttcttatagatatgcttaaaacagtgcctgacatatagtaagcacaaatatccattagctattcttcttattatttatgttattagtattgttaatatttgttattatatggaagactaaatgaccaaagagagtcaagaaatttatgaataagatttatgcgttgttagatattagagccattaaaaaaaaaaaaaccaaagtgccaaaaaacctagcacagtgttaatacaggaataaaaaaatggatcagaggaaccaaacagaaaagccagaaatggatcttaggaaacatgagaatatgatatatgatagatgctaaatgaattcagtataaaaatattaatgtaataaatcatgcttgctattcaagtaaaagaaaatgaggttagattcatgtctcataccaaatataaccataaattataccttgattaaattttttaattaaaaagcaataatatttgaaaagaaatataggatactcaatgtataacctgaaggttgggtagtacttttcaacaaatataggaatttttcacttgaaatactagaagaaaaaaagatagcaaacaaatacaggaattccaatttcaagcagatataatgatttcatgaaatgttaactgtgcacatgatagatggtctatggatagtgcaaaagaaaaagagaaaagaaaaaatgttttttaacatatgcagcaaaaaaggtttttaacatctattacatacaaataaaaatgaatgtataacacagacttcaataaaaataggcatttcacaggagaacaattcagatggccagtatttacaatttcataggtattaaggaaaatacaaattaaaatggcaaattagcaaaaattgaggtgtgattatattaatatctgttggtggtggtgattatggggaaaagggtactttcaaaacttgctaatataaatataattcttttggttgttttgtaaaggaacctgacaatatcttttaaaaataaagaaaacgcatacttttgacctagccatcccattcatgagggtatgtcttagaaaaataagatcacaaaatcatagagatttatgtgcaatgatattattggtaggtcatttttatgaggaggggtgtggatagtaaatgccagggtaaatcacatagcatctaataaacgtatttatgaactacaaaagcttacactttcagtctagtctagtccagactgcaaataaatgtgagcaagtgaattcaagcacagaagtgcttgaaggcaggtttcataaatctactttcttacagtatcctgatattgacttatcgagacagttactgtggggttgattattaaaatatttatgtatctaggtatttttcattcagtagtatgttattcaattagcaacaagtgtggggatttaaagatattcttgtttgtttttactgctgaaacatattctagtggaaatttcgaataaacgattagtcatcctaaaagcaagatacattttctcagaaaagacaaggtaaagaacttgtatatcctccctcaattcgtttataaggtaataagatgaataaaaatatcatagtacaatttagcattgtaaaataaaattaattggtcatctctagtgtggtcgtgcttggaaggtgaaagaagccaagatcttgtctgggaatatcatgtctaccttgacctcacccttaagaatcctagcctttagtttaaaatcacatggctacatacataccaacttcaacaatagtacatctggcaaggtcatgcaaacctgggacttgagcttctgattctaagtccagtgctttttgtgtacatcatctcttgtacataccttatgatgatatgctaataaaagctacgtgatcaggccttaaaaatctgctttttttttgtaatggtagaatggggcatattatcacatcaggtaaacactctattcaaggataaatggaaatgaatgtcatatatagatcattgataaatatctcattacaaaattatgagagttaccaatgtttgagtgtatattatgggccagccctttatattaaattacttcaaatttttacaactgttaaaggaagatattattatacccattttatagatggacaagttagggccagaaaagacttcctcaaagctgttagtccagtaatggagacagggctagaaaacaggtcattttgctctttgactaatgttactactcatgttttgtattttgtttaaagttttattttattttgctttatttattttttgagacaagatcttactctgtcacccaggctggagtgcaatggagtgatcacggttcattgcagccttgacctcctgggctcaagcgatcctcccacctctcaatctccagagtagctaggactactacaggtgtgtgccaccatacctggctaaattttgcattttttgtggggacagggtttcactatgttgcccaggctggtcttgaactcctgggctccagcgattcacctgccttgacctcccaaagtgccagtatcacaggcttgagccaccatgtccagccaagttttattttagaattaaaaaaaattccacttggattgttacattttatctcattgctttatatttatagaattactttataaatgccactttcttaattttcatagttagcactctttatgaaacataaactattatttgacccaggtttttgttagaggaattgagtcagagagctgttaagtaactgagatttcacaataagccagacagaccagggttcaaattctgggtctcacattatccaattcaatattccagctttgttacttattgagcaaccactacaagcacagtttacatgacatctgatagctctcaaaatgaattttacaaacataattcagatttcaactcagcagtgactcaggagaaaggacacttggatgcatttctttatggcatttttcccagggtacacgcaacctggaagatctcccaagtatgggggaaggtttcaccctgaggaatcccattccctctaatctgggacaagggggaggagagtactgtctcttatcagccatctccccagggaggcctgggccctcctggaatgcataccatggcttactgactcaaagtgttgaaaagaccaggcattgggacacacaacactactcttaaaataaaaaaagaatcagagtagcttgtggttataattgaaatggacagagtaacatggtaccaagaaactattagcaattccttccctaaatccctcattttcttaaagcattttctccttttcctcaacaagctttaagttggatttgaagaatgataagactaaaaggagggctgtttctggtctttggaggaatttgatattccattcgatctgagtgtgcaaagcctgagttcacatgaactcttctgatctctttctctaatattttttcaccttattcatatgggaaagaaggaggggaatactttagttccattctccctcctcctatttccttgacttgtttaaaatataaatgttatagacacctaagatagaaatttgactgaaacagcctcttaattattgtcttaaaaaattggtataatgaaattgcatttgtagtctttggacatttaaatccagaagggatattttctttttcttttttaaaaatttaattcaatagtttttgggctacaggtggtttttggttacatggataagtgctttagtggtgatttctgagattttgatatacccatcacctgagcagtgtgcactgtacccaatatgtagtcttttatcccccccccgctccacccttcctttatcgtccccaaagcacattatataattattatgcctttgcagcctcattggttagctcccacttgtaagtgagaacatgcgatatttggttttccattcctgagttacttcatttagaataaattgtctctagctccattcaagttgctgcaaaggccattatttcattccgttttttggctgaatagtattccatagtgtatatatgccacattttctttatccacttgttgattgataggcatttaggttggacccatattttcgcaattatgaattgtactgctgtaaacatgagtgtgctttttttttttccatataatgacttcttttcctttgggtagatacccagcagtgggactgctggatcgaatggtagttctccttttagttctttaaggaatctccatactgttttccacagtggttgtactagtttacaaccccaccagcagtgtaaaactgttccattttcagcacatccatgccaacatctattattttttgactttttaattgtggctattcttgcaggagtaagatggtatctcattgtggttttaatttgcatttccctgataatcagtgatgttgagcattttttcctgtgtttgttatttgtttgtatatcttgagaattatctattctgtcctttgcccactttttgatggaattatttgtttttttttcttgctgatttgtttgagttccttgtagatcctggatactagtcctttatcggatgcatagtttatgaatattctttcccactctgtaggttgtctgtttaccatgctaattatttattttgctgtgcaaaagcttttcagtttaattatttcccatctatttatttttgtttctgttttatttgcttttgggatcttagtcatgaactttttacctaaaccaatgactataagagtttttccaatgttatcttctagaatgcttatgttttctggtcttagatttaagtctttgattcatcttgagttaatttttgtataaggtgagcattgaggatccagtttcattcttctacgtgtggcttgccagttttcccagcaccatttattagatagggtatcctgtccccactttatgtttttgtatgctttgtcaaagatcagttgactttaagtatttggctttatttctgggttctctattctgttccattgtctacttgcctatttgtgtaccagtaccaggctgttttagtaactatagccttgtagtataatttgaagtcgggtaatatgatgcctccagatttgttctttttgcttagtattcctttagctatgtgggctcttttttagttccctatgaattttaggatttttttctagttctgtgaagaattatgatgatattttgatgggaattgtattgaatttgtagattgcttttggcagtatggtcattttcatagtattgattctacccatccatgagcatgggatgtgtttccatttgtttgtgtcacctgtgatttctttgagcagcattttgtagttttccttgtagagatctttaacctccttggttaagtatattttcatgtattttagttttttttttttgtttgttttgttttgttttgttttgtttttgcagctgttgtaaaagggattgagttcttgatttgattctcagcttggttgttgtcagcagggacattttctaaagtatagactgtagttccttatcttctatctgtttcttactgtccccttcagtattcttgtccttttttcccgctattatctttttgaccttttaatatatagatatctacttctacttctgacaatttttgcttctccaattttctttctttttctcctctgcacacatttatttattttcttctatgtacttctttatttttaacttaatatttgattaacttcccttccctgtctcttttccttctttccataaatcttcattaattgcctgcactgagctaggattctatactctctaaatcaataatctattttctatagtcaactgtgttataatcgtactgtcaagataactacttatttttaatacttaaaaatattttgaaattttaaccaatttaattaatacaatgttgagttcaaatttgaaaaaaacaatggaaaactgtaataattctagcaacctcctgctttttaataatgtattagaaaatttgcctctttttcaaaagcctacagtgaatctattcatacaaggcaaaagcaaaccattctcttcattctctttttttctccaaaagatttaagtgttttttgtttgtttgttttgttttgttttttagatattgagtcttgctctgtcatccaggctgcagtgcagtggtgtgatcatagctcgctatagcctcgaattcctgggttcaagcaatcctcctccctcaccctcctgagtagctggggctacaggtgcatgctaccatgcccagctaatttaaaaggaaaaaaattgtgtagagatgggtcttgctatgttgcccaggctggtctcaaacttccaatctcaagcatttctcccacccagcatcctgaagtgctgagattataagtgagccactatgcccaaccagatttagtttttaaaaagagaatacgatttgaaaaaggaaaaatgtgaggcaggagagaagaaatacacacacgagctgttttgtaattgctgtaaaactgaaatcttcagcctcactaaaggagcacttgcatgaacacctctaaattaccttattaccttctaaattaggtgtgaagtctaacttctaaattatgagtgaaatccactgcaattcttgttatttggatggaatcctaggtatgtggtccagttcatgagttgaacaaaagcatgctcatttaggccaggtagaaagaaataaagacctatgttttacatgtctcataaccactgaaggtccttctcataagcagtgcttatgggtattaacgacctctctatattttacttctccagtgcctaagtagccgagtccactgagtcctgctacatctcctccaacatgtcagcatttttttcacaggccttttgttactctagatcagaaatgttgatagcaacagttccttgagggcagcagctagcatgatgccagccaacaggaaccaccaaatggttcttaatataaattactacttattaatctatttactttgtgcatttggagttttgcatgtaaagtcctatttatgtccatatggtagataaatggaacaaatgaataacagaagtaaccattttgatactttagatatagataatattggattatttctggattgtgaaagaagaaggaagaagcatatggaagagaagttttagtagaggggaggaaggaggaggtggaaacgaatgtacaaggatgggaggagaaaagggagagagacttttttttttttaaggcgagagtttactacctatctaactcttcgcattcttgaagtctcagaccaaatcccatcggtttgaaagcctctagggtattctatctattgtatacttctgttatgtacaaaattaatttgccaattaattgtgaactgttttataaactatcttaaaatggttagttaaatctttgggatagtatttagctttctccaggattatgacttaccttctaaattagacatacaatgcctaggagtcaaggactattttgcataaattccagtcttcttttacaatgcctagaatgattgttaccacagaaatattcattacctgggagaaaggatgacaggaggggcagaatgaatggagagaggtcgtgagaatgaggtgctgaggatggacgaggaagaaagctgttttagttgggaggataggtgacagaagcatggaaaggaattgccttggacccatggaagcccagtgaagatacttagatcctgcaggggtgtgaataatgttcttttagtttctcttcttaggaggtttgttcattttgggagatttcttttgaaaagagtgaacttaaattggagaaaagtacattttagtatgttgataacatttgaatttgtaaaatggacctatggatgatctacacatatttatatacccataaatatacacatattttaatttttggtattttataattattatttaatgatcattcatgacattttaaaaattacagaaaaatttacatctaaaatttcagcaatgttgtttttgaccaactaaataaattgcatttgaaataatggagatgcaatgttcaaaatttcaactgtggttaaagcaatagtgtgatatatgattacattagaaggaagatgtgcctttcaaattcagattgagcatactaaaagtgactctctaattttctatttttggtaataggacatctccaagtttgcagagaaagacaatatagttcttggagaaggtggaatcacactgagtggaggtcaacgagcaagaatttctttagcaaggtgaataactaattattggtctagcaagcatttgctgtaaatgtcattcatgtaaaaaaattacagacatttctctattgctttatattctgtttctggaattgaaaaaatcctggggttttatggctagtgggttaagaatcacatttaagaactataaataatggtatagtatccagatttggtagagattatggttactcagaatctgtgcccgtatcttggtgtcagtgtatttgtttgcctcatagtatagtttactacaaatggaaaactctaggattctgcataatactggacagagaagatgtaaatatctgttagttccatcatagaccctgccactccaatgtacacaccagctttaggcttcttggtatagataaacatacattttcaaaatttttcatcataattttcataacaaaataggaaggcaaatgatgtcacttggcttaaaatctataatatttaaaataaacaggacaaatgcattaacattgttgggggaggaggtcccttagtagaaacactcttggtccaagcattttaaagctgtcaaagagatgtaaatatagataatgtatgtcaaggagagagctttgtggttaaactgtaactttcagtttaaacaattattggtgactctgatgtcaaatgtttctcaagctttatctgaacaaaattcttctcactttgttgccaaagtcgttaacaagaaatcacattgactcattgatgttttggctcctttcccttactttctgttgctttccaaaagctgagacaggaaactaaccctaactgagcacctgcaattgcctggtagtattctagtcatgtgtgtacttttgtgtgtatgtaatccccttacagctctgcaaagtaagaattgttctccctgctttacagaagagatcataagataattgaggctgttagatgttaacttgccaaaagccatacaggaaaatggtagagtcacagtttgaaccaggtccttttgattctttacattaaaccatgctttgatcttggaaatacactgtaaggcaataaatcaatagatacggataattcacaggcttctaaataaatggaagttgattgtttttatctgtgagccaaagtaagacttattctaagaattccacaaatttagataagatagagtatatggcttctagacatccaacatagaactgagtttgtgttatcagtttaagatttggttttgctgtaaggtgcacacactttgaggaactaaaaataattgtctgttcttattctgatcagaatgtgtaatgtgttgtccagttttggatgatgaatttcttatttctaatctcataagaaacttgtcatagatgtgagggagagaattaagaacagagtgtggggaagaaactgtgtacattttgatgggatccattatgtagctcttgcatactgtcttcaaaaataagttacactataaaggttgttttagacttttaaagttttgccattggtttttaaaaaaatttttaaattggctttaaaaatttcttaattgtgtgctgaatacaattttctttattacagaagtaccaacaattacatgtataaacagagaatcctatgtacttgagatataagtaaggttactatcaatcacacctgaaaaatttaaatgttatgaagaaattatctcatttctattaatatgggaactgtgtcttcatctttattactgttctaaggtcaactcaatgtagattttacttgcttatggtttcatattttagctaaatagtaaaataatatggatatacattttgttgtgacttactcatactttccttatttggaacttttatgaatatgatatagagactgaaactacaaggaacaaaatgcaatatcaattatacagttgtggcagcactgctatcaatttgttgatagtggttaacacttagaaaaacattttaaaaataatttcacataagtaatgtaatttattagctgtctctgacattttacagtttggaatagtttattttctttttggtgtcctcaccaaaacccaacatcttcaagggcaggaactgtataatttttgccattgtattttgagcacatagcatggtacttgcctctaaatagatactattgttaaaatattttttaaggtaatattttaaagtgtatgctatggtacagttcagtttgtgacttttgctagtttatgccacttacagttagcaaaatcacttcagcagttcttggaatgttgtgaaaagtgataaaaatcttctgcaacttattcctttattcctcatttaaaataatctaccatagtaaaaacatgtataaaagtgctacttctgcaccacttttgagaatagtgttatttcagtgaatcgatgtggtgaccatattgtaatgcatgtagtgaactgtttaaggcaaatcatctacactagatgaccaggaaatagagaggaaatgtaatttaatttccattttctttttagagcagtatacaaagatgctgatttgtatttattagactctccttttggatacctagatgttttaacagaaaaagaaatatttgaaaggtatgttctttgaataccttacttataatgctcatgctaaaataaaagaaagacagactgtcccatcatagattgcattttacctcttgagaaatatgttcaccattgttggtatggcagaatgtagcatggtattaactcaaatctgatctgccctactgggccaggattcaagattacttccattaaaaccttttctcaccgcctcatgctaaaccagtttctctcattgctatactgttatagcaattgctatctatgtagtttttgcagtatcattgccttgtgatatatattactttaattattattatacttaacatttttatttactttttgtgttagtattttattctgtcttctccttagatagtaaccttcttaagaaaatatatatgctaagtgttttactggtttaatatgcttagactactcatctacctcaatacttccttggagatctcctcctcagtcacacagagctcaggacttatatttccttggaactcctgttagggtccaatgtacatgaaattccctagacagacagacagtcagttatatggcttgatttcaaagtttcaaaatgatttaatggactatcaagtagtttattaggagaacagttattatactcttctaaaaataaagactttaagcaataaagatgtatatgtatataaaatggctgggttattcctagaagtacctttcttagaatttagttaaatttaatatccaagatactatcttttcaaccctgagattgtgaaaagtaacttctatcaatataaactttactacatttgtattgtgttagtgtgttacagtataatctagaacaatgtgtctttctatatgatatatgacattttaatgcctaaaaaaactgatatgtcttagatgattctagtcaggatttacttctagaatagattaaaattctatttgaggagagtcaaattaattatcgaattctcagttgttattattgctgttttatttttagtgaaacagattagtcttaatgtaaacacttgagaaataaattgatggtcaacctaaaatgtaaaaaagaaattaatagaaaatttaaagagcaacaaagctctgacatttaaaagaaatgaagtacaaatctctagggaccttaaagatcatctaataatttcctcattttctagataaataaactgagagaccccgaggataaatgatttgctcaaagtcaaatatctacttaatataggaaatttaatttcattctcagtctgttaacatgcaacttttcaatatagcatgttatttcatgctatcagaattcacaaggtaccaatttaattactacagagtacttatagaatcatttaaaatataataaaattgtatgatagagattatatgcaataaaacattaacaaaatgctaaaatacgagacatattgcaataaagtatttataaaattgatatttatatgtttttatatcttaaagctgtgtctgtaaactgatggctaacaaaactaggattttggtcacttctaaaatggaacatttaaagaaagctgacaaaatattaattttgcatgaaggtagcagctatttttatgggacattttcagaactccaaaatctacagccagactttagctcaaaactcatgggatgtgattctttcgaccaatttagtgcagaaagaagaaattcaatcctaactgagaccttacaccgtttctcattagaaggagatgctcctgtctcctggacagaaacaaaaaaacaatcttttaaacagactggagagtttggggaaaaaaggaagaattctattctcaatccaatcaactctatacgaaaattttccattgtgcaaaagactcccttacaaatgaatggcatcgaagaggattctgatgagcctttagagagaaggctgtccttagtaccagattctgagcagggagaggcgatactgcctcgcatcagcgtgatcagcactggccccacgcttcaggcacgaaggaggcagtctgtcctgaacctgatgacacactcagttaaccaaggtcagaacattcaccgaaagacaacagcatccacacgaaaagtgtcactggcccctcaggcaaacttgactgaactggatatatattcaagaaggttatctcaagaaactggcttggaaataagtgaagaaattaacgaagaagacttaaaggtaggtatacatcgcttgggggtatttcaccccacagaatgcaattgagtagaatgcaatatgtagcatgtaacaaaatttactaaaatcataggattaggataaggtgtatcttaaaactcagaaagtatgaagttcattaattatacaagcaacgttaaaatgtaaaataacaaatgatttctttttgcaatggacatatctcttcccataaaatgggaaaggatttagtttttggtcctctactaagccagtgataactgtgactataagttagaaagcatttgctttattaccatcttgaaccctctgtgggaagaggtgcagtataaataactgtataaataaatagtagctttcattatttatagctcgcaaaataatctgtatggaagtagcatatataaggtatataaacatttagcctcttgataggactaactcacattctggtttgtatatcagtcttgcctgaatttagctagtgtgggcttttttttatcttgtgagtttgctttatacattgggtttctgaaaagatttcttttagagaatgtatataagcttaacatgtactagtgccaatcttcagacagaaattttgttctattaggttttaagaataaaagcattttatttttaaaacaggaaataatataaaaaggagagtttttgttgttttagtagaaaacttaatgccttggatgaaatgagccatgggcagggttgtaatgaattgatatgtttaatagtatagatcatttgtgaataatatgacctttgacaagacacaagccattaacatctgtaggcagaagtttccttctttgtaaaatgagggaataaaatagatccctaaagtgtgtaattttagtatttctaaactttatgaaggtttcctaaatgataattcatctatatagtgtttttttgtgtgtttgtttgtttgtttgtttgagatggagtctcgctctgtcacctaggctggagtgcaatggtgcaacctcggctcactgcaacctctgcctcctgggttcaagctaatctcctgcctcagcctcctgagtagctgagattacaggcatgcaccaccatgccgagctaatttttgtatttttagtagagaaggggtttcatcatgttgaccaggctggtcttgaactcctgaccttgtgatccacccacctcagcctcccaaagtgctggtattacaggcgtgtgccaccacgtccagcctgagccactgcgcccagcccatctatatagtttaatatcaatctaaatgaatttctcagtcctgagcctaaaaatttagttgtaaagaatgatatccttgactaataatagtttctattaatggattgcatctagtgctaggtggcatatatttagtccccacaactaccctggaaggtatttaaaatttttcacatttgcagataaggaaactaaagttcagagttcggcaacatgcttgaattcaagcagctcctaggatgttaatggtggaggttgggttcaaatccagatctgtctgactcaaaaaatgcatactcctaaccagtgcactatatcccaattccataggagcccttctttgtgattcatagcactttcccatgagttttgttgattttgtgagaaacaaaactctttttcctttggactgtctggaatctctctttttcaaatttttgaaatgtatttctatgccaaaagacaaagatttctagaggaatatgcctaggatgagaattatgtaatttaaatcacagctggaaagagagaaagtcctaagttactaagaaatgttcaaacacaaatgagctttcagtctattggaagacctttatagctagaagtatactgaactgtacttgtccatggacccctgaagaaacaggttaaatcaaagagagttctgggaaacttcatttagatggtatcattcatttgataaaaggtatgccactgttaagcctttaatggtaaaattgtccaataataatacagttatataatcagtgatacatttttagaattttgaaaaattacgatgtttctcatttttaataaagctgtgttgctccagtagacattattctggctatagaatgacatcatacatggcatttataatgatttatatttgttaaaatacacttagattcaagtaatactattcttttattttcatatattaaaaataaaaccacaatggtggcatgaaactgtactgtcttattgtaatagccataattcttttattcaggagtgcttttttgatgatatggagagcataccagcagtgactacatggaacacataccttcgatatattactgtccacaagagcttaatttttgtgctaatttggtgcttagtaatttttctggcagaggtaagaatgttctattgtaaagtattactggatttaaagttaaattaagatagtttggggatgtatacatatatatgcacacacataaatatgtatatatacacatgtatacatgtataagtatgcatatatacacacatatatcactatatgtatatatgtatatattacatatatttgtgattttacagtatataatggtatagattcatatagttcttagcttctgaaaaatcaacaagtagaaccactactgatattttattatttcatattacatataaaatatatttaaatacaaatataagaagagtttttaatagatttttaataataaaggttaagagattcgaaagctcaaagtagaaggcttttatttggattgaaattaaacaattagaatcactgttgatattttattatttcatattacatataaaatatatttaaatataaagataagagtttttaatagattttataataaatgttaagagattaaaaaactgaaaatagaaggcttttatttggattgaaattaaaggccaggcatggtggttcatgcctgtaatcccagaattttaggagactgagtggggaggattgcttgagcccaggggtcaagaccagcctgggcaacacagtgagacaccgtatctacaaaataattaaaaaattagctgggcatggtggtgtgtgcctgtatgctaccattaactaaggaggctgaggtgggagaatcgcttgagcctgggaggtcaaggctgccctgaactgtgattgtgccattgcattccagcctgggtgccagagagagaccctatctctaaataaataaataagtaaataaataaacagcaacaacaaaaacactcaaagcaaatctgtactaaattttgaattcattctgagaggtgacagcatgctggcagtcctggcagccctcgctcactctcagggcctccttgaccttgacgcccactctggctgtgcgtgaggagcccttcagccctcccctgcactgtgggagcccctttctgggctggccaaggccagagccggctccctcagcttgcggggaggtgtggagggagaggcgctgggggaactggggctgcgggtgccttgtgggccagcgcgagttctgggtgggtgtgggctgggcaggccccgcactcggagcagccggccggccccgcgagccccaggcagtgaggggcttagcacctgggccagcagctgctgtactcgatttctcactgggccttagctgcctccctgcggggcagggctcgggacctgcagcctgccatgcctgagcctccccccaacctgccgctgcagtgggctcctgcgtggcccaagcctcctgacgagcaccgccccctgctccacggcacccagtcccatagaccgcccaagggctgaggagtgtgggtgcagggcgcagggctggcaggcagctccacctgcagccccagtgcgggatccactgggtgaagccagctgggcttctgagtctggtggggacttggaggatctttatgtctagctaagggattgtaaatacaccaatcagcactctgtatctagctcaaggtttgtaaacacaccaatcagcaccctgtgtctagctcagggtttgtgaatgcaccaatcagcactctgtatctagttaatctggtggagacttggagaacctttatgtctagctaagggattgtaaatataccaatgtgcactctgtatctagctcaaggtttgtaaatacaccaatcagcactctctgtctagctcagggtttgtaaatacaccaatggacactttgtatctagctaatctagtgaggaggtggagaacttttgtgtctagctcagggattgtaaacgcaccaatcagcaccctgtcaaaacggaccaatcagctctctgtaaaaccaatctgctgtctgtaaaatggaccaatcagcaggatgtgggtggggccagataagagaataaaagcaggctgcctgagccagaagtggcaacctgctggggtctgtagaagctttgttcttttgttctttgcaataaattttgctactgctcactttttgggtccgcattgcgtttatgagctgtgacactcactgggaaggtctgcagcttcactcctgaagccagcgagatcacgaacccaccagaagaaagaaactcctaacacatccgaacatcagaaggaacaaactcaggacacgcggcctttaagaactataacactcactgcaagggtccttggcttcattctcgaagtcagtgagaccaagaacccaccaattccggacacaatttgactgcagaaaatggatgtccaaccctgtggtttccctgggccacattggaagaagaaaggagttgtcttgggccacacataaaatacacttactatagcagatgagctaaagaaaagaaaaaagtccatgcgtaatctttgtgatatgtgccaccaccaataagcaaaattgttctcttattcaaaaggttggacacagctgctctagatattttattattaaatatgcaggcaattactgtttaaatgaagatttcctcacagaatgagattaaaagtatatattagtggcttagcattcattttagacaaccattttagagattcaaatcacacacttgcttacagaaattttgttgtcttcaatgtccccattgtggtttctttaccaagcctctactgttcttcacatcaccaagttaaaaaaaaaaaaggggcgggggggcagaatgaaaattgcatggtaggccacaagttcagatcctcatcgacacaagaggtgcctgaagcagtggatgaggcttttctatggatcatgagcagccacataaatgcttaaaagggcctggcagggagcatcagtgggtgatgtggctgggaggctgaatggagagcatttgttcttcagttatctatagaaggcagctgtcactcagcaccagctaagggcttcccatgagggaactggggatcaggtttcccagatctttttatgtaacaggataagacagagatccagctttttttgggtaattatttcctattttaaaatacgggtagttgattaaataaaaacaaacgaatgaacaccatatgggcacaacaaaacacatctgtggcttggattcagcttgtgaatgattactgcagatatttattctagaggacacccctgggtatgtcctaatataaaacctaaatctaaactcaagtcccatgctaccttcagagaataaatgacccagaaaaagaaccacctctcctaaggaagtataaatttgtaaataactgagacccaaacttacaactgtacatttttcttattgttgggctgttgctaacctcaattaagaaggcttgatgatatttgtaaagtgtcatcactccaccatggtccagtaacatctgatcactccaccatggtccagtaacatctgaatggtcaagaaatatctaaacgtatgtaccaaaaatttgtgtatactactgtaccaataaaccatttgtttccatttgatctctgagtgtggtaatacatgttatttgccctgctgttgtaaataaacaaaccaaatggaggcttgatgcaagatgcagtgtagcatagtgccaactctggactccgactactcagggtgtaaattctaactctgttctattaacaccatgaaactgagcaagttagttaaaactcgctgggcccattttctcatttatacaatggagattttaatagtacagctacataggccattttgtggtttaaaatacatcatgattatgaaacacttaatgtagggcttgctacataatgagcaaggtttgttgctgttatcattaatatccttaattctcattattataaaacttgagatagtatgaggtgaacaagttcataacagcaatataatgaaaattttaataattccttttatactttaacaaaaatacgagattgggtaatttattatttttacatgagtaataaatattgcattaaaatatatttaaaatttaccacattaatgtctgccagtcatgccaaatgaccaacatgaatgtgaataaaactcagtctgtgcccatttaatcttaaccaaccctttataattgttaatgatttgaacctctgccttgaaagatcacattacttgattgtcttcaacttatctgaatgtggtagtgatttctgtaaatttataggacctttgtctcatgcagctccatggagttgaacttatgcacctttaaaatggtatatacttaattaattaagtgttgatctgcttcacatgtgtataatattattagctcactaaaccaagaaaacagtggtcctttagggaaagaaactaaattacaacagagaatataaataccatataaatatctattatttattgaactgtcacaattattgcaaaaaattaccttttagtggacaaaacaattgatattgcccttttctggaaaagaaataatgtaatatatgatgaatagttttggccagtatcctctagaccttgccagttaactggctctcaaaattttgaataataaaaacttggtgatagtagaaaaatagtaattttttaaaagtatgtgcacaattatacaactaaacaattcattcaccagtgttcacaattctattgccttctttgaatcaaaatttacatagtttttcttttagactaagctcctttatgataccagtgtgcccatttctcattaccattgaaatgtctcatgagcatgtcacattctggtacaactgctaatccaggatgacagtttagttcttttaaatccaattgagagccttctactcatgaccagagaacctaaagaaaggttaagatacatttattccttggtgtaagtgatttgtctatttttagttttcctaagggtcatatttcaatttagatttttttttataggttaggtaaaataggcttcccttttgcaatatgaaatatgtagtcttttaaaaaatttcttcaaagctattaaactgaaaaaaaattaatttggtctattcagtttgttagcacttaccattttggaaagagagtgactctacttttgtatttggtaacattttccctactacagggcagtatcttttgtaagttcttagatattagcaccaaataaataggcaaaaaaaatctattatgttaattcttagaacccctgcttggcagtgcatcattgactagatggagaagaaatgaaaataatacattaggaagcagtttcctggttcttttgaaaacaactagagagtcttgttgttgactggaatatctgaagatcctgtttaatgctttcattctatgattgttaagaatatgtcatagaactgctgtatcctgtttctttatgtcttcccttctgtttgttgattagaaatccctgagtggctttacattattagtacagtagatatgtagtatattcccataataccactgctgctattgactaatagtaataattttagggcagctttatgacagttggtttatgttttagggtgtcatttgacttgtgaagcattgaaatctgggtattaagcacactgttttctatgtggtatggaatgattcttaaagccctgagaaaatggaaaataaaaatatttttcctttttaccataatcacctatgactgtcactctatcataaactgcataaactttataacctcaaaacattttggaaatgaaatgacagaacttgcttactcaattgcttctatatacaccaaatatttttttaaagtattatgttaagtccttgaaaatattttgttctactcaatagaagcagtttaggttggtagttctatgtggaaaccgtgaggaaataattttatattatgatgactagaccagtctttgaacatcactttggttattgttccattagtaaatattataattatttctgagatttactcaccttcaaagaatgttggcaatgccagcattattaacactcctctagttagaacaaagaggaaatgtaataacaaaacataataatagccaaataaagagtgacttagaatgtacacccttatctaggatcctgagtaattcgattattcttaggaaatacacttttgtgctagaacaaagacttttgaaatagctaatttctgggtttcttttcattttgaattaacttgaatttcaaggaaacaagggtagtttttacagatacagtgcatagaagctctgtgtacaatgaagaaaagtaggaaagtgagaaaaatgccattagatttttcatcgttatactatctgatatgtgaatttaactaaaacttatatacctcattatagtacttcctaatgtaatttcttaatttaagtgttccccataaggtttttttttatataaacttaagtactgttaaatatttaaggcaaattcaggtataaaataagacttgttgatatcttattccaagcatatttgtttctctcctatttatttttattctgtgttcatttccaaaattgttttactcacaactgtttgttttttctgtttcattctgtggtaaaggtatcatttggctaattgtataatttcagtgtcatttctaatattccaattgtgatagtatcaacacaagattaaatttctctacatggtttatgagaatggaatgccaaattgaaatagaacagagcacagatgatctaaatataaaaagaactacaaaaatcacagttgtttaaaaaggttttttgtttgtttatatatggtgcagaacatttgttccttagccaaatgtttccaccttgagaaagctatagagattctatgtagtcctagtaccaataatatgttttaacctgaatgtaccttatctttattcataaactgtgactttttacactgctgaaacttttttttttaagacaatctcactctgtcgtccagtctggagtgcagcagtggtgtgatcttggctcactgcaacctctaccttctgtgttcaagcaattctggtgcctcggccacctgagtagttgggatcacaggtgtacaccaccaggcctggctaatagtttttgatatttctagtagagatgagttttgccacattggccaggctggcctgaaactcctggcctcaagtgatctgcctgccttggcctcccaaagtgttggtattacaagtgtgagccactgtgcctggcctgaaactcataattcatttccattaatattaatctcaccttttccaataattaattgatttcacaagtattagtcccctataatcattgaatggctaataaaattatttatagcaaacagattaattatctgccagcagtctgagattagtttctttaaaaaatgtttattatttaaaacattcagctgtgatcttggctttcttgtgaggttcaatagtttctattgagtaaaggagagaaatggcagagaatttacttcagtgaaatttgaattccattaacttaatgtggtctcatcacaaataatagtacttagaacacctagtacagctgctggacccaggaacacaaagcaaaggaagatgaaattgtgtgtaccttgatattggtacacacatcaaatggtgtgatgtgaatttagatgtgggcatgggaggaataggtgaagatgttagaaaaaaaatcaactgtgtcttgttccattccaggtggctgcttctttggttgtgctgtggctccttggaaagtgagtattccatgtcctattgtgtagattgtgttttatttctgttgattaaatattgtaatccactatgtttgtatgtattgtaatccactttgtttcatttctcccaagcattatggtagtggaaagataaggttttttgtttaaatgatgaccattagttgggtgaggtgacacattcctgtagtcctagctcctccacaggctgacgcaggaggatcacttgagcccaggagttcagggctgtagtgttgtatcattgtgagtagccaccgcactccagcctggacaatatagtgagatcctatatctaaaataaaataaaataaaatgaataaattgtgagcatgtgcagctcctgcagtttctaaagaatatagttctgttcagtttctgtgaaacacaataaaaatatttgaaataacattacatatttagggttttcttcaaattttttaatttaataaagaacaactcaatctctatcaatagtgagaaaacatatctattttcttgcaataatagtatgattttgaggttaagggtgcatgctcttctaatgcaaaatattgtatttatttagactcaagtttagttccatttacatgtattggaaattcagtaagtaactttggctgccaaataacgatttcctatttgctttacagcactcctcttcaagacaaagggaatagtactcatagtagaaataacagctatgcagtgattatcaccagcaccagttcgtattatgtgttttacatttacgtgggagtagccgacactttgcttgctatgggattcttcagaggtctaccactggtgcatactctaatcacagtgtcgaaaattttacaccacaaaatgttacattctgttcttcaagcacctatgtcaaccctcaacacgttgaaagcaggtactttactaggtctaagaaatgaaactgctgatccaccatcaatagggcctgtggttttgttggttttctaatggcagtgctggcttttgcacagaggcatgtgccctttgttgaacctccatttgactggcatgcacatgtctcagatattataggttatcatatattgttgctcctaatatttctgtgttagataattagagtagcttggtttgtaagaatgtgatgttggtgggactgtagcagaacaagaaggcccttatgggtcagtcatacctctcttttcaaatatttggtctagctctcttctgggcatcttgttgccaatatatagtattgctcaaaagggcaggagatttgaagtgatcaaggaaaatatattttttctattgattaagtcttttgatggggtagaataatctaatttcatgtaactgctcaaagttatatggtagggggatcccaaatgtattttaaaactatttttatatcatcatatttgaagtaatagaaagtcagagtagcagaataaaggtactaaaaattttaaaaactaataaggtactttgaaagaaatcaattatgttgattcctcattaaacaaatttgcacttaaagactgaggttaataaggatttccccaagttttttcatagcaacctgtgagcactttctctgttgaggcatttatggtatgaaaagatgagtaaggcacagttcttgccctggagaaggtcacaggtgagaggaggagttgacacagaaacatttgatataaagcaaggaataaattccaagactaaaattttcagaaatctaaaaaactcaagataagaaaaacccattatattttctgggtaacaaaatttcagtgttattaacatgtaggaagatcttgatatttattctgaagcccatgtgtgttgctgaaatattgccgcatttgcatatactcatcaccatcctctgttttggagctaagaattttagactcaagatgtctaattaagttgatccattgattttattttttatggaaatctgagacccacagaaggcaggggatttgcccacatttctagaagagtcagacatgagcgatgaggcacagtggaaagaacatgagcattgcctgagctctgagttggcgctataagagcagtgatcatgggcaagtgactcttctgagccttggcctcctcacctgttaagtgaagaaaagaatatttcagaagatctttgtgagaatgaaacaaggcaatttacttgcctgctacatagccaatgggaaatcaatataagttccccgtggttcccttctgtggggttttgttcccacagagggtgcactggccattccacttcttcttttccaagctcctcattccctttaacgctgttcatagttggttccaaaccatttgaaatataataagcaccaggatggttttttctttccaccaaagcaaatttcattttctaaacactgtttataaatatcaatggctattttttcaatttttgattatcatgaaaatatacaaatatgtttaattaaatatgctaaagaatgtattaataaatatgtattaaataattcctacatataaggcctttttgcttggggtatgggtgatacaaaataaatgtggcatgaacccactgacctctagcaatttataacctagaaaaagagttatgatatgtttataagttcctgtgatataagacatgcatatagtcattataacagaggtgcaaacaagatgtatcaagtatgtccagaggaggaagagattaatcccagctggaggaaacactgatgctttcttgcagcaggggcatttgagttgagaaagggaggaaacatagattttgacaatgagagctgaggggaaaggggtttcaggtggagggaaccgcatgtggaaagcagggaggtaggaaagtgtagagtgtgtttaaagaatagaccagtttggctgaaacaggatatttgagcagaggaagcttgtactaggtaggtgggttgaggccaaattatgcaaggcattaaatattaaactaggaattttggactttatcctgcagtttatggggggtaaatgataagattcaatatcactttatttgtacagtattatgttacattttatctaattgtttgtttaattcctgtctagacaatgaattcctcaagggcaaggagcatggcttattcacctcagtaatttcagtgcctagcattgtgcctggtacaaagtggacacttgtatataaccttttttaattgaagcaacaagttgtcaaccttacaaatgtgaatccgtgattcagatgacaggttgaaatgtagattgtctgcgaagagggcagaaagagagtatgacaaaggaggacaagacagtggggcaggcagggagagagagcagccagggtttcggtagaggtatgtcaaaaaggtatggaagtcagaggagaaggagacccctatgttatagaatacaaatggaagggaaatgatgacaacagtaagttgtcattaaatgcaaggttgcaaaagtaagattgtaaagcaggatgagtacccacctattcctgacataatttatagtaaaagctatttcagagaaattggtcgttacttgaatcttacaagaatctgaaacttttaaaaaggtttaaaagtaaaagacaataacttgaacacataattatttagaatgtttggaaagaaacaaaaatttctaagtctatctgattctatttgctaattcttatttgggttctgaatgcgtctactgtgatccaaacttagtattgaatatattgatatatctttaaaaaattagtgttttttgaggaatttgtcatcttgtatattataggtgggattcttaatagattctccaaagatatagcaattttggatgaccttctgcctcttaccatatttgacttcatccaggtatgtaaaaataagtaccgttaagtatgtctgtattattaaaaaaacaataacaaaagcaaatgtgattttgttttcattttttatttgattgagggttgaagtcctgtctattgcattaattttgtaattatccaaagccttcaaaatagacataagtttagtaaattcaataataagtcagaactgcttacctggcccaaacctgaggcaatcccacatttagatgtaatagctgtctacttgggagtgatttgagaggcacaaaggaccatctttcccaaaatcactggccacaaagtgtgacattttggcattggcatcactatttgatggaagccaacctccccccaaaaggcctgtattagaatgaagatggattccctgggtgggttacacttgaaactagcctcacccatgaacactttggcacagattagctagcccattcccccacagtaaggaccataaggaagggacagaagcaaagataagttttagaacaaaagagaggggaaagaaaaaatctagggttttatgagggctgtccctgagtgatagatgtgaataggcctccagggcaggctggctcagaggctgactctttgggttggggtgactgattggtggtgaggatggagaagaaaaggggagtggaggaggtgaaagtgaccttgggacattaggtctccataagtgacaggatttaaggagtgttgtaagctgtggttgttggaccaggtttaagcacagcttcctgagcttcctgactggtttaggtcaagctccagagagcaaatgccacagtctcagtgatctccttggagaaacagttggaataggatgttgcccatgttgggatgagtcattgtccgctcttgctctttccctacccctgcaaaataataatactgtatttgattgaacatataaaacaaaagaaggattatcacataagtatgtatatataaccaacattggcaggtgcagaaaaaccagactgtcagtttgcctcatctgaaatgattgacacaaacaaatatatttactgtcccaagtgaactttggcattttggatatccttcagttgttctgtttaaagatataacttagaagcagctgatggaatatttaaatccatgcgttgaattcatgcattcaaagaaacatgtcctgagtcactaaatgctgacatttgtttttcatgttaagagtgtaaataactggtcccaaatataatattattacatcagataaaaactggaatgtgaacctcttaacttgattgtgaaagtatttgccaatggtgcctcttgataattatttgaggctcacttcagaactcctctggaagggttaatttttaaatagtcattttataaattaacatttttgacatatgtgatggctctcaaattttttcttttatgccagtttgaatcatttctgctcaatttttttttttaattgggatggagtctcactctgttgcccaggctggagtgcagtgatgcaatcttggctgactgcaacctccacctcctcggttcaagcgattctctcgcatcagcctccagagtagctgggattacaggcgcgcaccaccatgcctggataatttttgtattattactagagatggggtttcaccacgttggccaggctggtcttgaactcctgaactcctgacctcaagtgatccacctgcctcagcctcttaaagagctggaattataggtgtgagccactgcaccaggccctgttcaacttttaatgctaagattcatttgttgttgtttcacaagtgattaggcagaggtcttttatattaatttacccattttatttgtaagagagtctcatattaaggaagcataatatatgacaatccaaatacagtacaaatttggttaattttgattttgttaaataattaatcacaggggtccttcaaattgtgagctcctctggttatacttatgttttacctctggttatacttaatttcaaacaaatgaaatttcattctattcatgatatttcagaagcagatctgttgcacaaaataaagcatacctataaattttctttttttaaaaaaaagtctctgttcactctattttctattatttttctctttttaaaatttgaattttattgtggcaagtccacttaacatgagatttaccctcttaacagatttttatgtgtaaaatacaatattgttcaccatgggtaaatgttgcacagcagatctctggaacttattcattttgcactactgaaattttatacctgttgattagtatctccccatttccctctctcccctgtcctgttacccatggttctgttctttgcttctttgagtttgagtattttgatacctcatgtaatcttcattctattttctaactttgacaatgttctgacaaatttgctttccggattggagcactgtatagtgaaaattgaaaatcttggttattttctacagattcccactattttaccttgagcagacacttatcttgaagggtctcagatttgtcacttgtagaatggggaatataaacctgataatggtccctttcagttctaaagttatatcagttgaaaatacatgtgtcacttatggtaacgggtagagaactggctcactgaacagcatatggatattataaagtggttttttttaatcctttctgcagacagttactttatactttattcaaatggattattgtgaagtacatgttagcggactttgtaccttttaaaaatgtatgtatttggtgtaatgtagaaatatagaaatttattaagtatgatttatttcaatgttaagcatgagaaaatatgctccgaaaggttagatagcttgcctaaatgacaagcttgtatttcaagcagaactttctgaatcaaaagactccaagacgaatgcccagctttcaaaaactgtctaaccaaaataaatcctaagattcaccttcatactaaaattatttaaaaatagtttattttaaattaatattcacttaaaatgtatttatcatgcaatactttaaagtgtctgggaaatgaaaatatccaaagatcaaagaacaccatgttttcaaacttcaaaaatgttatcagtgacctaaacaatttttaaaattttcatagagcctatgaaaaatgtacttgcaaatggctactttctgactaggaatagaatggggagagtatttagtccaacaatgatagactggattaagaaaatgtggcacatatacaccatggaacactatgcagccataaaaaatgatgagttcatgtcctttgtagggacatggatgaaattggaaaacatcattctcagtaaactatcgcaagaacaaaaaaccaaacaccgcatattctcactcataggtgggaattgaacaatgagatcacatggacacaggaaggggaatatcacactctggggactgttgtggggtggggggaggggggagggatagcactgggagatatacctaatgctagatgacgagttagtgggtgcagtgcaccagcatggcacatgtatacatatgtaactaacctgcacaatgtgcacatgtaccctaaaacttaaagtataataaaaaaaataaaaaaaagtttgaggtgtttaaagtatgcaaaaaaaaaaaaagaaataaatcactgacacactttgtccactttgcaatgtgaaaatgtttactcaccaacatgttttctttgatcttacagttgttattaattgtgattggagctatagcagttgtcgcagttttacaaccctacatctttgttgcaacagtgccagtgatagtggcttttattatgttgagagcatatttcctccaaacctcacagcaactcaaacaactggaatctgaaggtatgacagtgaatgtgcgatactcatcttgtaaaaaagctataagagctatttgagattctttattgttaatctacttaaaaaaaattctgcttttaaacttttacatcatataacaataatttttttctacatgcatgtgtatataaaaggaaactatattacaaagtacacatggattttttttcttaattaatgaccatgtgacttcattttggttttaaaataggtatatagaatcttaccacagttggtgtacaggacattcatttataataaacttatatcagtcaaattaaacaaggatagtgctgctattactaaaggtttctctgggttcccaaatgatacttgaccaaatttgtccctttggcttgttgtcttcagacaccctttcttcatgtgttggagctgccatttcgtgtgcccccaaactctacttgagctgttagggaatcacattttgcagtgacagccttagtgtgggtgcattttcaggcaatactttttcagtatatttctgctttgtagattattagctaaatcaagtcacataaacttccttaatttagatacttgaaaaaattgtcttaaaagaaaatttttttagtaagaattaatttagaattagccagaaaactcccagtggtagccaagaaagaggaataaatattggtggtaattttttaagttcccatctctggtagccaagtaaaaaaagagggtaactcattaataaaataacaaatcatatctattcaaagaatggcaccagtgtgaaaaaaagctttttaaccaatgacatttgtgatatgattattctaatttagtctttttcaggtacaagatattatgaaattacattttgtgtttatgttatttgcaatgttttctatggaaatatttcacaggcaggagtccaattttcactcatcttgttacaagcttaaaaggactatggacacttcgtgccttcggacggcagccttactttgaaactctgttccacaaagctctgaatttacatactgccaactggttcttgtacctgtcaacactgcgctggttccaaatgagaatagaaatgatttttgtcatcttcttcattgctgttaccttcatttccattttaacaacaggtactatgaactcattaactttagctaagcatttaagtaaaaaattttcaatgaataaaatgctgcattctataggttatcaatttttgatatctttagagtttagtaattaacaaatttgttggtttattattgaacaagtgatttctttgaatttccattgttttattgttaaacaaataatttccttgaaatcggatatatatatatatatgtatatatatatatatatatatatatatatacatatatatatatagtattatccctgttttcacagttttaaaaaccgatgcacacagattgtcagatagcaattctgtgattgaaggggaaatatgtcacctcttcatactcatattggtgaagggtcctagcttcaaaattaatagattcctaaagaggggaaatgaaacatccgcatttacacacacacacacacacacacacacagagttcctcttgtcggtaagttttgttttttttaaatctctactagataaaatttgttatctaattgtgagttttacacaaagaaaaactgtcacagaaaagaaagacagtgtcacatttttcaaaagaaaaagaagaaaagaaagtgccatgtttttcaaatacaaatgttctggattgattttaggatctttagtgaaaaacaaagtatttcataataagtaaaataaaaatctatgtaggtaaatttgtttctctaatttaagaatttgaatttctgagtatttatgataagtgttgaaataacttcttatatgtgacagtgaatactggcagagcaaatgccaaatcaatgccaaatctgtaggatcatttgattgtaggaacagaattctactcaaaccgaaagcaggcatttgctggagttacagaaaggcctcatggaacaccgagaaggtggtgccattcgactcttaaagaagctgcaacaggcacaagagagtcagctgcagctcttcttcttgagtctatatctgtcctgggtccattcctttttgtggttgcttcattcctttctctctctgaagactggtttttctggtctaccagggctatgccacattgactttatgtagtgtctccattctggcctcctgaatttacaggagagttcctctgtacaaactcaaagtcctggagagaacagaaaacagcttccttttggctcaggggtccaactgcagtctactctgctgctatgaggatagtgggttcaccacctttgttgttctctcagctagggcagtgggaaatgactctatgaaaggaatatacatgggcaggcaaatgtactaatcctcatcagtactgtaattttaagcaactttaaaaaattcttttaagttatttgaaaataagatcaaagaaggctgaattacataaatgaagatttgttaacaattaattcaaaccaatataacacatgctataacatggttgagtgtgattgagtcttgatttattaggggcaataatcaaaacatttaacaatcattatagtacagaacttaccaatcaaatcagatgctcagccggagtggatgttggccacccagctattattatccctggctcaattggtcttcagctgtgttaacttgcaaacattaattaactatctaagcccctcattttcctcaagtgtaaatagacacaataatattacctattccataggtgtggggtgaatagtaaatgtaataatttgtccaaaacacttagtatagtgcctggtccatggtaaatactaaataaatgttatctgacttattattaaaattttatcttctcagcttaaccttcagaacagtaatatattggggtctagataaatcttgcctatatgaaaataatttaatactacatgcagatatatgctgtgtatattatgccttctgttagaggaattgcagaaacaaaaatttcaattaataataagatgaattatttctcccaattgtagaatcttttgacaattttatcatgcattacagatgtaagaactcttgattgggacttgatagtctaactttataataatttaagaacattcctcttagagaatttctatggccataatactgaacacatgaattttaattagctgtcctctttagccctaaaaaaaaaattactgtaatttaacacttaagtgttgttcttcccaggtacagtaatctttttttttttttttttttttttttgcatagagggtaatcttttctctttccaaatggcagaactgttagttttctgactgtccggtgaaattctaagtccacttacttcccaatagcatgcaattagcaaaggtcctccttgcaaaggcacagaacacacctaaacatcttgcagatgctgtttggacactcttcccctgcttttggtctctttgtaaagcagctcatctggatacaggatctcttttccccattgcccattctaatatatgttaccgttattacttatagaataatagtagaagagacaaatatggtacctacccattaccaacaacacctccaataccagtaacattttttaaaaagggcaacactttcctaatattcaatcgctctttgatttaaaatcctggttgaatacttactatatgcagagcattattctattagtagatgctgtgatgaactgagatttaaaaattgttaaaattagcataaaattgaaatgtaaatttaatgtgatatgtgccctaggagaagtgtgaataaagtcgttcacagaagagagaaataacatgaggttcatttacgtcttttgtgcatctataggagaaggagaaggaagagttggtattatcctgactttagccatgaatatcatgagtacattgcagtgggctgtaaactccagcatagatgtggatagcttggtaagtcttatcatctttttaacttttatgaaaaaaattcagacaagtaacaaagtatgagtaatagcatgaggaagaactatataccgtatattgagcttaagaaataaaacattacagataaattgagggtcactgtgtatctgtcattaaatccttatctcttctttccttctcatagatagccactatgaagatctaatactgcagtgagcattctttcacctgtttccttattcaggattttctaggagaaatacctaggggttgtattgctgggtcataggattcacccatgcttaactgagtggtgccaaattgtcctcaagtctgttgtactgatatatatccccatcaagagagtacaagaattctcatagctatgtatcttcaacaacacttggtgtctggtagatgtgaagtgattactaaaaatatagggaagctgcatacataattattggcttttgctgttctcttacattaatttcttattcatgttgattactcatttgtcacctagttttttcttccttaattaaattgtaggaatttatgaattatggattgatcatcagctctatacatttcaaacataatccctcagtcagtggcttggcttatagagtcttttgatgaaaagaagcttttaagtttaataaagttcaatttattgtcttttcctttatgttttgtgcttttggtatcttgattaagaactccttccttatattgggttctcaaatttagcagcataacattttcatactattatttaaatttttttcacattatttagtgatagcacctttcttattcctaaagtgtttatcattgccttctgtctttctgcttgataaatattgccacacatttgtatactttattagtgtgtacaaagaccacattttagttgtgttatttctcttgttttggttttctagaatgcagagccattaatattatagtaatgcttatgtgctaataccatatcaggggcacaaatcccattgcagcgggactgagaaattaaaggaaatgatgcacatttactcatttttgtttaaaaaatcaaatgcatatttttcaatcagactatatggttggtctggatagcttcatcattgaatttttaaagtatttttgtactactgtatttaaaattattcattcaccactgcttttgtagatggtttagaaacccaagttaggaatgactgtgcaacactattattatactctttttaaaattatactttttgcttaagtttctttccttgttctctgagacagtgttcatgttcccaaaccacacacatttattcagctataaaatttgtatgatcaactcctgtcagaacaaacatcattataaaaaatatctccaggaaaaagaaaacccttttaatgctctcttctggttcatgtgtcttcttattttctttaagcattttcataacccattgagctgtaatttaattggaacatgatttatactaaagttggtttctttacctttaacttttttttttagtttgatcagctctctttagcttctgtagttcggtctttaattccattccagtatgcttttggagttgggtctcataaatgtatagaaatgtttctgttgggaaacagcaggagaatattaaataaatattgtgcttacatctatttaattctttgcccaactttctacaactttgactttacatttaagctcctcatgcacttacatgtttctttacctaaaaatatcttttcaccatgggtgtgtacaattcctttgtccttgctgtattaattttcttggtttacatagtagcctctacacattgatgtcaaaacctctgtttggtgcatttctactctgcgtgttcaatctccatgaaagtttctgtaaggtattttcattcctctagtttttcacatgtgcatcctggctttgtgacctgtgctttgatatcgtgcctttcatcttgtggcattgaaggatctttgcaaggacctattgtgttataatacagtctatgaaaaatatcaatatttgcatttgatcacatttaaaaaaatcacattcttttgtttgaatatcaaagctaatatgtgagtgatttccctgccaaatagcacaagtagcctttcctgggtgtttatgggcatttatctggttaatgattcccatcatagtgctgtcacccatgccattgctaaacttatacagtaacttttttgttttcacctcagcatatgttgagagtaggaaatagataggactatgccctcaaattttacgtttatatgatgttaatcctaaaggtccttgtgacttctgaagtaaaaactcagtgttgtcattttacttactgaattgttagctgagtttagagttgagtttacaatggagtaaacaaggtgtttagtttgatgtatgcttttagtctttcagaaaaaaatgtttatacttggaaagaatagtttatttacccatctggcctagtttagacaaaaacacagagtcaaatgtcaacagaattctgaagttataaaaatgacagtgtggctttttttttttttaaccttccacctggtgcttatgcccaagtgcctagctttctttagctctcaactaataaaggtaatgtttagataacatttaacgttaagttgcattgtgtttatgatcacatatctcaaatattggtacacgaaactgtacaacaaccttttttattagattttcctacgaaattccttattatattccctaagatagctttttcccaccttcttcttccttctcccttctcaggtgctccaataattccaacccctgcagccagtgactttattatatctttttttaaaaatctaaaaaaaaaaattgatgcaaccaggaagaattttctcatttctctccaccagttgtaccagcctactgcacctctcctcatgcaccaccttctgcctgtgttcttgctcctatattcaggagcaagtaatatgcaatacctccctctttgtgggatctttctcattagcataaaaatactttcccttgatctccagctactaccccatttctttgacctacatatagcaaaatatttgagaaaggaccactttccatcttttcctcaatctacttccatttttttctcaatccactttcatttcattgttctcctcaacccattctttccacaacctacttcattttatttccatcagccccataactcaggatcaacatcttgccagagccaatttccttgtctcccttaacagctccagcagtatttatgccatggacaaattattcttcttgtgatactttctctcttgcttccatgacactactcccacttcattttctttctacctctctggctcttccttggtcccttttcctggccccttctctctttcagatctctaaacatcagctatatctcagccctgttctactgacactctctagctgttattttctaaacccatgtttcagaaaccatatcttgatgaatcttggaaggccgaggcaggcgaattacttgaggtcgggagtttgagaccagcctggccaacgtggtgaaaccccatctctcctaaaaatacaaaaattacctggccgtggtggcatgcacccagctacttgagaggctgaggcacaagaatcgcttgaacctgggaggtggaggtttcagtgagccgagatcctgccactgcactccagcctgagcaatagaggagactccgtctcacacacacacacacacacacacacacaaagaaaataaaccatctcttgatgaatcataaatttgtgtctctagtttagacctctatcctgctctctaaatgatgtatccaactatcatcttgacaccatcatatgttcataaaacataattatagaatatctttcagtaggcttgacattttaaggcatgagtttccgttcagtatctccttaaaatatacccagggtctcaggagactattcaaacaggacaaagcttctattctacttactaatgtgtctggccctatttggcaggttggataaaaagtcatctgaacattgtcactttatgaataatatagtttaatagtttgtgaatcacccctgcaatttaaaaaatagtaaaattatcagaatctaatttaataattcctattggaacaccccatgttaggggatttccagttatttcaattgatatctcaatgttttaaagattgtttatttctattactaattcactctttattttaacataaattgtggctatctatctctattcatttcaattatatttctcataccattctatagatggggtgaaaagaaaagtgttaattttttaaaactccatacctcaaatactatatgaatttatagttgttattgctaaagcaattatcttacatcttttcctccaaaacaaagttatgtgctggtttattttctttgtactcataagatgccttccatttttagtaacataagtcttgtctttctcctattcttagctacttaagcattatgtagcttaaataagcactaaagattcctatctgtatgaaaaaataaagattaaataaataagatctagaaagggtgacaaggtgatgcttcaaaatgaaccataccaagccatctagcgattgataaattactcacactcataatcacattgttggaaagaagccattgacaattcagtttgtttcacaactgtctatcacatagtgagcacaactaaaagactactttttgtcttttactgcttgttttgttgatcaagtgactgattgtacaatgaccaacaagaagtctgatgtgtagagaaaaggggaacctggcttttctgccttactcctgatgcctaattctgagcatgtgaatattattctgtttctttaattctccaagtgaagcagcagataaaccatccttgtttccattagctgtctaccctgttcaactgtgtgtttctaataacataagaataagaaagccaccagggtgagcagggaaggcaatgagtctgcaaggcttgtggatagatttctgttagtgaggctctagaaagttcttccaagattgatgcaatctgagaagagttttctgtcaatacaaactccctgggtttctcctttgtccttttactgcctgtgtttgttttgggttccagtaaagatcaagtgactgattgtaccatgaccaacaagaagcctgatgtgtggagaaaaggggaacctggcttttctgcattactcctaatgcctaattttcttgtactgaaagtagtttttgctgtaagaatctgaggggaggagtcatttcttcaatttttttttttggtctccttttaatggtttcttgatcatgtctatccttatttttctgttttcacaaatttttgtggtatattttcctctcatgacctctgtctcaagacttctttccatccatctcttctcatttcatcctgtagagtgtctgtggtaagagccctgcattctactctggccttgccatgtgtggccttgggcaagtcctagcctccttgagggtcttatttttctcatttgtaaaatgaaacagtttgatgagaagttttctaaggttccttcaagctttgacaatctctctcttctggatctttttcccatgaaaaatttcaactcttgattagcatgtaggcagggattattccacatccttataggaatcacatttctgctactgtccctgaatgctagagtccattgattaagttattcactgctgcaattgtcagagctgatcaaagaactctgaaccagtgtgttactagaactaacaaagaaaatgccattatgatgttctagagtcttgaattagtagaagaggtttaataagaaccctaagggattgctagaatgttaaaaacaaacaaacaaaaaaaaaggttgaaaagtttagaaaattcactggtctttgtgcccatcattttacttccagggtttagataatctcatttttgcaatgaaggaatggattagatcacaagttctcatcctagtagcacatgcagaatctttataaaaacacagagtagccaggtgcggtggctcatgcctgtaatcccagcactttgagagcctggggcaggtggatcacttgagaataggagttgaagaccaagctggtcaacatggcaaaaccctgtatctactaaaaattcaaaaattagccaggcatgatggcacatgcctcccagctactggggaggctgaggcaggagaatcgattgaacccgggagatggaggttgcagggagctgagatagctccactgcactccagcctggtgacagggtgagactccatcacaaacaaaacaaaacaaaagaaagcaaaaacacagattactcagggtccactaagaccagtgaagtcagttctcttggtagggggcagggtgactgagcatgatgtttgtaattttaaaagtgctccaggtgattctagcgtgtatcaagcaagacttgtgaaccactgaactacatgctaagactcattttagctctgattttctgtgagtcatagcagagggctcagcaaactttttctataaatgctaagatagtaaatattttcagctttgtgggctgtatcgtctttatgacaactcaactcagtctttgtagagaaaagcagctgtacataatatgtaaactaatgggagtagctagatgtgtcctgtgggccatagttttgctgactcctggtctatgtcatagaatttccttttgaattgatggaccaccagcaaatgatttttgtcctgtatcaatcaatgatacatacataaatctctacaagacatgtaaaggatgaggcttaatgacagagtactttggggaagacataatattgcaaaattaagatgcttagagaaaaatcatattaaaatagtgaaaactgtgagaaggtattttgatttgttgttttggattcctctttttgcaaattcttttgaaatattttcagtggaagctacatagatccaattgtattcaccaagctagattgtaattaagctccagagtaagtaatagatttgatgagtgatgtccaaccttttacatggaagagtaagtttgagtcttcctttgcccattgacacacttagtaccatgtttaccaaagttcttagttattgaaatgggcaccagcatattttgaaacgttggtgttaacttgggatatgccttttgtcatgttgcaaatagattttgtttctgttttgtgaagatcaccatctctgtcacttctgatagaaaaagtgacactgacttctcaagtgatttgacacaggttaaaatatgtaaaccatttctgtagagagcaagctgtaataatatactaaagggctaggtttatagtataatataaataactcatttatgctgttaataatttatagcaacatggcatttgactgactttttatgtgctctagtcatgtaagtaatagatgtggaaacatagaccagagtttcaagaacatgttttgggcagagtctgttttcttgctattatctcttaagtttatgttcatggcctaaagattatgctaatggatctgccttggtcttgggtgtcaggtctgtgttagcgagtattgaaaagcatagtttttgcctactgggaaggatttatgatttaaaagccctaaatctccccttttatgtacttcatacttagaaaatttttcctgtaaactgtgtgacttttttacattgtgccagttttctagatgactctcgtcatatttatttcttgcaatccttctataactatcagttatgaagtctctttatagtgttgccagccaggtctcaggtgtgtgaaatgtattttctattatggattttggggtatgatggcacatagtttgggtgttaatgcctaatcttgatgtactggcttctgaacaaccaaaaggatgaaaggaaatagaacaaatatttttgtgagggagaggagtctggcttcttgacttactctagaaaaagcctgtaagcctcctcttccctccttgtcacacaaagtgacaaagaaaatcaagaattgttttcttcttggcttaaatgcatcccttataaagtaaggctgagatcaggctgtgaagctatctttttgtcaagactgtcataattccaaaacactttgttcttctaatgcttaggttagtaactttaaacatttttataaagatagtgaggtccagttttaaggattgaccccttctcaaggggctcagaagaggttttggagaataataaaattaaataatgaaaccaataatttaaaccagatcatgatccttaagaaaaaatcccatcaaatttgggctaaactctaatatacagaggtctgcacaacttatgtcaagtattcttccccacaaatgaagaatggggttcattgtgtcattggttgggtctcattttggcttcatcttctatttctcaaagtctaagaaaagtgctcctacggaagtgggtgttggctatcatgagactttgctgctggcaggccagcttgctgctctagacagagatatccctcgatcctccttggacaactgttttctgtgcacaggaagcagcaggctggggttaaggagtttgccaatccagtcattctgataattgctgaatatgaatttctatccagcacaatctaggtagctacaatggcacagtagtttttatgtatcaggtgaaaatgtttaataggcactctaaatgagagaaaaggttaagtgaggttaaaagctcaatgaaaacaaatagatgagactaaaaatagttcaataggttgtaacttccatctcatccaaacagcaatgaatattttgaggctgaggcgctgaggggtaaaattgcagcctggactacttgctaatgtagacctacagcactgtcattcttactgcacagacactgctttctgcataggaggtagaataatgaattcatttattattaacaaagatttattaagtgactgcatggtgctaaccactagatggggagggatgttttgaactgtccattgtttgactataacaaggaacgctttgaacgaggttactatcataggcagaatttgtttaacatgaagcctatgagacataagccacaggtcctctcacgtgcaggaactcctttgaaggccctatacttaattttatatgcatagtttggatttggattcttttttttttaagagttccccaaattacttaagcttcaggctccacaaaacctggatctacccctggtagcagctatgaatctttgactatgaaattaagtgtacaagaaatatgactttactttttctgtgattgagtttattttctatttgagcacgcattccactgagtgaaagaaataatatcattgaattcagagattttgctgggttctaagtggagtttacagaatgccatgatattaggaattaaggagtgtgttgccctacatcatcttttgtccgtgctcactgtctctgaggcactgatgttcctatgtgacctagaggggcatggtccaggtagatggagtctgtccttgttctcactgtgagctctcgcttgctgacccttcttcagtttcttccatgcccctgaggggtaaaaagattcaaatctgaagctatatcaagccatctgtgcatagacattccaagcaaccatgttcactctactgctcccatgtcatgcaaggcacaggaagcttcactatggcatgagtatttcctgggctttgccttggaattgaggcacgggcctcctttgttctaaaattccccaaatctacttgaggatagaaccaggatttggttgcaaggcagaacttttcttagaggacctggtatctaaaccctcttgttacccccatttatggaccccatttatggggtgaggagagtgactgcttctaatccatcataatttttgtctatggctactgtttttgcatagacactatgttttgagtccttaggctttggcttttggcgcttaatggccaatattcacatggctcaaaattttcaaatgatccatatctgacttgagtttcaaaagtcagtttttgaaacttaaatgatcagaattgatttgttctgctctggttctgatgtggcctctccttccagaggtactggaggtagaatatccaaggtggaaagcccacgactacaaggaattggttagtaattcataatgttagctgtccacatctattcagtaatggcatttcagtggctgcacaactgaccatggtgaaagtgtctgcacaagccactttttcttcctgtcagaaaatgttctcacccactgaattgaatgactgtctgctcatatgctgtgaatgagtgcccagtcttaagattaaatcacacgttcttggctatgcatatttgggcatgctgtggggagttataataggctgtcttagagtcacattaagcagctagacagacaatgagttggaaagttacattttctaaatttgattggtacattccatttgtcacatttgacattagaagttctggattcaccctctatggtgagcttcactaatggagaatgtaatttgcaatgctcaaacacaagtcctaaacagaaaacattgtatgttacattccagtgctaccaaaatagtggttttgaaagtccttattttctaatactactatgtgtaattttgagtcatttagatagcaacagttaaatgttttatagattgtttggaagtattaaaatgtgaaggatttttgttatatagtgtctttcctatcttgcttaataaaatataagtttagaattgtgtatagaattaacatgcaaaaatatcaagtctcaactttatacagttaatctacatttgtgtatacccttcaattatttcaagagagggatactattcttatgcaggataaatacaataagatattttaaatgaattttaactacatctctggcagtttcatctcaatagtagttgtaattttatctcccagaccttattatagactagcagctctctatgaaaattagtgacagtgtgagtgtattttaattcaaagttaatcaagaatgactgagtcaagagttagctacccctgaaagtaactcataattcagaatttaaaatattacatgtggaacaatcatgactatatgccttttactttctctatcattatttaggttgtgggctttgggtccttttcacatccgttaacagtgggcttgacttcaaaggattattttcttgaatcttgaataattgctgaagacaatttgaagatattttcaagatgaaggaaactgaagcacagaatcactagagtgaaaaaagaacttcacaaacagtgcaggcttgatcaatggcatgggaaaacaggcaatacagttagaattgctaagatggaattttaacgttcaattaaggatctatctctaaactcctctgctttatccaccaatcattccatattaaagatgaagaattgttcccatttcaccttttgataaggaaaaatagaaataacagaagcaaatacacttttgcccacatttttttccaaaaagaataatttttgaagtctaaacgtttggtgtaaataagatgatgtgttaatattgtaaaggaaagctagttaagtttttgactgaataaagccagcatcaataattactagtaagactaaaaataagagcagtaaaattgtgtctaatcagctactaatatctgggaaggattgagccacaggatcaaagatggtatcttttaaaaatagaagttgagtgaattcggtcttcaaattctttctttttattcatttatatttatttactcattagtatattcattcctttattcatgtattgttcaaatatatattgggtacttattatatgccaagttgtttttaaaatcacattccaaattcccgtaagtcataattattcagagatgtatgttttttttaaaaaaaattgaacacctttaaaaattatcaagtccttttatttctgtatgcattaaagataaactttactaaatgttacatgaatagatttataaagcagataaatatttaatttcaaatataacccttatatgcaattatattttccttagcactaaaaatgaatatttaagtaatttatattaaaagtgtaattatttaactgcagatgtatgccaatgacttaaattgtttaaagattatagcaaagttgtttaaaattgtctaatcatgaagagttcacttaaccacctggttgacacataaaattatagttagttactaaggtagttcgagagaaagagaagaatcttcagtagtggttttgaggtgtggtacattttattataatataccggttatacagcattgtgcagtgctgctcatagtagaaataaattttctctttgatgtcatctattcccttgtgtggcttacataactgagaattaggtgatcacaaaaataaacaggcctatacagagcccatttatataagtcctggttatttctcttcagttaaacttttaattatatccaattatttcctgttagttcattgaaaagcccgacaaataaccaagtgacaaatagcaagtgttgcattttacaagttattttttaggaagcatcaaactaattgtgaaattgtctgccattcttaaaaacaaaaatgttgttatttttatttcagatgcgatctgtgagccgagtctttaagttcattgacatgccaacagaaggtaaacctaccaagtcaaccaaaccatacaagaatggccaactctcgaaagttatgattattgagaattcacacgtgaagaaagatgacatctggccctcagggggccaaatgactgtcaaagatctcacagcaaaatacacagaaggtggaaatgccatattagagaacatttccttctcaataagtcctggccagagggtgagatttgaacactgcttgctttgttagactgtgttcagtaagtgaatcccagtagcctgaagcaatgtgttagcagaatctatttgtaacattattattgtacagtagaatcaatattaaacacacatgttttattatatggagtcattatttttaatatgaaatttaatttgcagagtcctgaacctatataatgggtttattttaaatgtgattgtacttgcagaatatctaattaattgctaggttaataactaaagaagccattaaataaatcaaaattgtaacatgttttagatttcccatcttgaaaatgtcttccaaaaatatcttattgctgactccatctattgtcttaaattttatctaagttccattctgccaaacaagtgatactttttttctagcttttttcagtttgtttgttttgtttttctttgaagttttaattcagacatagattattttttcccagttatttactatatttattaagcatgagtaattgacattattttgaaatccttcttatggatcccagcactgggctgaacacatagaaggaacttaatatatactgatttctggaattgattcttggagacagggatggtcattatccatatacttcaggctccataaacatatttcttaattgccttcaaatccctattctggactgctctataaatctagacaagagtattatatattttgattgatattttttagataaaataaaagggagctgaaaactgaattgcaaactgaattttaaaactttatctctctgtggttaattgcaaacacagatacaaaaatatagagagagatacagttagtaaagatgttaggtcaccgttactaacactgacatagaaacagttttgctcatgagtttcagaatatatgagtttgattttgcccatggattttagaatatttgataaacatttaatgcattgtacaaattctgtgaaaacatatatataggatgtgcgaaaagtccctgtgtatcatgtgaaatggcttaaaacagaacaccataggtattcatatcagtgaataccataggtagctgaaagtgttttttcctggggtcgccaagatgaatgccaaaagtgatatcattattataaacaatagccagaataggttggtataaacctggtagaaagccttgataaattgactttctctcctcctgacatcctgccacccctttgctttgctgatgctcatttgtccactaaattaaactcaagcaagccctagtaaagtaatagaatttgtggagtcctcattagtataggaagtttccctgatgtgagattagtaattagagatgtagcaaaatgagaaagaagtaatatgcttagatatttcattttctctgaacctgtatatacaaaataggccatgcgtgttcagtaactattcactgcaaggcactctctaggtactttgggggaattggaaattactcacataaggctatggattgtgccatttgtcaaaagacaaaatgacaacaaatttagtttaaagacctcagtcagctttattttctattctagatttggacagtccttcatttcacaaattggagtaagtgttccaataagttgagcaaaggagcttggctttatagacccaaaaaaagggccaaaggaagcagaaacaaagaacaataagagaattggtcatttcaaagttacttttcttgaaaggtggggacaaggagacagaataatagaaaagtcactgattggttaacattggattaagaattaaaacagaggaaactttaagattgaagtttgaaactgacttgtttgggaaatcaggctgtcttctttcttgatttcttagaaggccggataacaactgagttttgctttggtgaacatgggtgactccatttttacttttagtctggtctgttgaggcctcgtgagagagcttaatctaaaacaatgacttcctataatttttgtttgacacatccaaagagggactctaatatttattgagagcttatcatatcttaagtactgtttaaacacttttatttgctattacatttgatcttattataactctaaaggcagaaatgattgcttttattttccacaatggaggaaactgaggttcaattaagtgagtaaggaagcagggatcttaaacccagataccattgctcctctttaaaggtggaagaacagaaaacatggggcaggggaagagagaaagtttctgtcccaggacatgataatctaaaagggaaaacgtaagatccactgaaacctgaggcagatttattgtggcaataacaaagcttaagtttcacagaccttcatttgcctgagccaactttgaaggccatgtatctaattttgtttttataattctataatctttattcttgaaaagagccctccctccaaatttacaagctttgggcccccaaaatccttgaaatgcccttgaataagagatatccaggtaaatgctatgggaattcagaggaggaagcagttagtatcagttggcggagagttaggctattaagagaaggttttatataggaagtggcatttagaatgaagctttgagaactgagctgtgtatttgaacaagtaaaggtggtgttgcagaattttgctccttagttctattaaaaacccgggttcttgtcacatgatccggaaaatttaggcacacagatacattgaagcatgagtagagcaggattttattgggcaaaaaggaaaaaaagaaaactcagcaaatcgagatggagtcttgctcacagattgaatcccaggccaccacaaaggaactgaagagatcgggcttctcccctgcataaggtgcaaattccccatggctccacccacttccccttagtgtgcatgtggggctccagtccacggtgggcatgcccagacaagccttgggcaggttccctcatctgtgcaaaagcatctgatgtaaacacttgaggggtggttcggagattctctgggacccttttattttcttatctgcctaggcatttggctgtctcagtgggtgggaaagggtgctccaggcaaagggcataacatgaggcaaagggcatgcacagaaaacagtgactggttcagtcaggttgggggatgccaaaggaagtaatgggagacaagattggagcaagatagataagagattgtggattttttttcttttttatctatataaatacagagacagggtctcactatgttgcccaggctggtctcaaactcctggcctcaagtgatcctcccacctcatcctcccaaagtgctaggattacaggcatgaggcactgtgcccaacctccaattttggattttgagagctaaagcaatatagtcgaaaactcagataatccaggtagattttgctattaggtgctatttggttcctggtacagagctaaaacccttggaatttcctaagtgataagagctacaggagcatcttttgttatatgtttccccccctagttcctgaaatagctctagagaaatacaggtgaataacatcctttgttattcatatcaagcccctatcaaccataccccagtttctatttatgaagtggcttttgggaagtccctaaagacaggagtggggaaaggctggttgtcagggggatgggttgaaactttcatcttccccccttgacctccagggagggatgagtggctgaaaattgtgtaaaatcaacaatggccagtgatttaatcaaccatgcctatgtaatgaagccacccgataagccttaactggaactttttggagagcctccaggctggtgaagacattgaggtgctcagaaggtggtattccagagagagcacagaatctctgttccccttcccacattcattttgctatgcatctctcccatctggctgttcttgagaggtatccgtttataataaactggtaacctagtaagtaaactgttaccctgagttctgtgagccattctagcaaattatcaaacctaaagagttcatggatacgtgcaatttacagatgcacagtcagaagcacagatgacaatctgggcttgccattggcatttgaagtgtgttgggaggcagtcttacaggaatgagcccttatcctgtggggtctatgctaataacagacagttgtcagcattgcttggtgtcgaaaacccacattgttggtgtcagaagtattgtcagtaggatagggaaaacagtttgttttctttttttagtggtctttggtcatctttaagagcagggcttctcaaagtgtggtccttgaaccagcatcacctgtaccacgtaagaacttatgagaaatgttcattcttgggccccaacaaagaattaaaaattctgagggtgtgaacggggtctgagtttcagcacaacttcccgaccatgctgatgcattcttgcccaagcatgaaagccctcccttgtttaagaaggccattagggccgggtgtggtggctcatgcttgtaatcgagcactttgagaggacatagtgggaggatcacttgagccctggagttctagacaagcctgggcaacatggcaaaatgctgtctccacaaaaatcacaaaaattaggtgggcgtgtgttgtgtgcctataggcccagctacttaggagactgaggcaggaggatcgcttgagcccaggagattaaggctgcagcgagctgtgatggcaccactacagcctggatgacagagtgagacactgtctcaaaaaaaaaaaagaaaaagaaaaagaaaaaagaaaggaaaatgaaaaagaacgccattaggtataaaggagcaatggtaaaagaccagttgcaaaaggttagggaatgggtggttactgaaataagaagctatgtagaacactagtgttggtggcaggaagtagaaagcaagagcactgctctgtgggggatggtcatagcaaatgcaatatggaggcatttgcctctgcactgaggagaaaactatcttttccaagataggaggaaaggagataagtggaattaaagagaacctttgagcacagagttgggaaactgaaggtatttgtgttgtgctccctcaatcttttaattcaactataagctaaacccatgaaacttgagtagtttcagttatctgacttttttcttctcttttgatacagtgttggctattctgggtcttttgcctctctttatgtacttaagaatcagtttgccaatgtatgcaaaataactggctgggattttgattgtgattggcttgaatctatagatggagttgggaaggactgacatcttgacaatgttgaagcttcctattcatcattatgaaatatttctccatttgtttgattctttgatttcttttatcagaatttagttttcctcatatagtcttttaaaatattttgttatattttgttcaagtattttgtttttgaggaatgccaatgtaaatggtattgtgattttaatttcaaattccaatttttcattgctgttatataggaaaatgattttttttgcatgttagccttatatctttcaactttgctataatcaattattgatagtttcaaggattttttggtcaattattttgaatcttctacatagattatcatcatctgaacttagttttatttcttccttcccaatctgtatacctttatctccttttcttatttcattagctaggacttccagtatgatgttgaaagtagtggtgagaggggatatcttggtcttgttcttgatcttagtgggaaaacttcaagtttcttatcattaagtatgattttagctggagggtttttgtagaagttttttttttttaagttgaagaagtctccttctatttttagtttgctgatttttaaaaagaatcaggaatgggtgttaaattttgtgaaatgcttttctgcaactattgatttgagcactttatttttcttctttggcttgttgatgtgaagtacattaattgatttttgaatgctgaatcaaccttttgtacctgagattaatcccgtttggttgtggtatataattatttgtatacatgttgagttcgatttgctaatactttttgagaatttttgcattggtgttcatgaaaaaatattggtgtgtagttttttgtgacatctttatctgcttatggttttaaggtaatgctggcctcatagcatgagttagggagtatttcctctacttttacatttgagaagagattgcagagaattagtaaaattcctactttaaatattttgtggaattcaccagtgaacccatctggacctggtgctttctgttttggaaggtcattaattattttaaaatagatataggcctattcagattacctattttttctcatgcgagttttagcagattgtctttcaaggaattggtctatttcatttaggttatcaaatatgtcaacgtagagttattcatagtattcttttattatccttttaatgtgcaagggatctgtagtgatgtccccttttttgttttattgatattagcaatttgtgtcacatcttttattttgctttgttagccaggctagagatatctctatttttgatgtttttgatgaaccaactttttgttttattgattttctctgttgatttcgtgatttcaatttcatgatttttaaattatgcttacatttgatttaatttgatcttcttttgctagttatccaaggtggaagcttatattgttaagatccttttgcattcttatgcattcaatgatgtaaatttccctctaagcactgctttttctgcatctcacaaatattcatgagttgtattttcatgttcatttagtttgaaatatttttaaatttctcttgatatttctcttttgacccatgtgttacttagaagtgtgttgtttaatcaccatttttaaaaattttctagctatctttctgttattgatttctagtttaattccattgtggtctgagagcatatattgtataattttaatttttataaaatttgttaaggtgtgatttatggcccagaatgtggtctatcttggtgaatgttccatgtaagctttggaagactgtgtattctgctatatttgaatgaggtagtctatagacatcaattatgtccagttgattgatggtgctgttgaattcaactatgtccttactgattttccacctgctagatctgtccattctttgcagagggacactgaagtctccaactctagtagtgaatattctatttcttgttacagttttatcaacttctgcttcatgtcttttgatgctttgttgctagaaacatacacatgaagaattggtatgtcttttggagcatgacccatttatcctcatataatgcccctcattatttcctcgccctgatgtctgttctctctgaaagaaatatagcctctccaggtctcttttggttggtgttaaaatgacttaactttctttatcccccttacttttagtttatatgtggttttaaatttaaagtgggtttcttgtagacagcaaatagttcagagttgtttttcgatccactttgacaatctttgtcttttaattggtatatttggactattgatattttaagtgattattgatatagttagataaacatctactatatttattactgttttctgtctgttacactacttgttctttgtttatatttttattgtctactctttttctttccattgtggttttaatcgagcattttatatgtttccattttcttttcttagcatagtaattcttctttaaaaaaacattttttagtggttgcccctagagtttgcaatatacatttacaactaatctaagtccattttcaaataatactaaataatttcatgtgtagtgcaagtaccttttaataataaaacactcccagttccaccttccagtctcttgtattatagctataatttagttcacttacatatatgggtatacctaagtatatacattatcatatttatgattgaatatattgatgaaattattttgaaaaaactgttatcgttaaatcaattaagagtaagaaaaatagttctaattttattataaaatgaaataccttcatttattcattctctaatacactttctttctttatgtagatccaagtttctgacctgtataattttccttttctctcttcagcttctttgaacatttcttaccagccagacctactgacaacaattttccccaatttttgtttgtctgatagagactttatttcttcttgacttttgaagaataattccacagggcacagaactctagattggtgatttcttcccctcaaacccttaaatatttcattccactgccttcttgcttgcattgtttctgagaagttagatataattcttatctttgcctttctataggtaagatgttttttcctctggcttctatcaagattttttctttatgaacatgatatgcctttctttttgaacatgatatgcctttctttttgaacatgatatgcctttgtgtcggattttttttggcattattctgcttggttttctctgagtttcttggatatgtggtatggtatctgacactaatttggaaaaattctcagtcattattgcttcaaatatttcttctgttcttttttttcctttattctccttctggtattcccattacatgtatgttacagtttttgtagtcatcccgctgttttggatattctgtttttttcagtttttttttccttcgcatttcagtgttggaagtttctattgacatattctcaacctcagagattctttcttcagctgtgttcagtctaccaatgagtccatcaaaggcattttacatttttattacagaatttttgacctatagaatttcttttgattccatctttgaatctccatttctcttctgcttttcatctgttcttgcatgttgcctactttttccatgaaaacctttagctttttttttttttctttttgaggtggagtctcactgttgcccaggctggagtgcagtggtgtgatcttggctcactgcaacctctgcctcctgggttcaagtgattctcctcctcagcctcccaagtagctgggattacaggtgcctgccaccatgcctgagtaatttttgtatttttagtagagatggggttttatcatgttggccaggcgggtcttgaactcctaacctcaagtgatctgcccaccttagcctcccaaattgctgggattataggtgtgagccaccatgccctgcctttagcatgttaatcatagttgttttaaattcctgatctgttaattccaacatccctgtcatatctgactgtggttctgatgcttgctctgtgttttcaaatggtgtttttttttttttgccttttagtaagccttgtaattttttattgaaaggtggacatgatgtgctgggtaaaaggaactgtagtaaataggcctttagtaatgtactggtaggtgtagcagagggtgagggaagtattctgtagtcctatgattaggttttagtcttttagtgagcctgtgcgcctgcagcttggaagcacttgtgaagtgttttttcaccccttttggtgggacatagtgactagtgtgagcgggagttgagtatttcccttcccctaggtcagttaggctctgaaaaaaccctgataggttaggcatggtaaaatagtctcttttgagggcaggcattgttataagaatagaatgctctggggccaggtgcggtggctcacgcctgtaatccccgcactttgggaggctaaggcaggtggatcacctgaggtcaggagttcgagaccagcctggccaacatggtgaaaccccgtctctactaaaaatacaaaaatcagccaggtgtggtggcacacacctataatcccagctactcaggaggctgaggcaggagaactgcttgaacccagtaagtggaggttacagtgacccaagattgtgccactgcagtctagtctgggtgacagagcaagactccgtctcaaaaaaaaaagaatgctctggcatatttgaaaatggttacttttccctttttttctctgatcttcactgtgagaacctggtaagcatcctataggcaaaattcataaaagtatagaagtcggccagtgacttggacccacttggaattttcttgctctcacatcatgcacactgaatctccagcaatttttcacttacagtttaggttttcctaccctactactggttctctcagaggtttctgcttattggtttctgttttgtaagttgtgattctctgtacctaactgcctgtctcccattttggggggcagtggtttgccctgtgacctcacttctctgacagatctaagaaaagttgtttatttttcagtgtgctctgctttttacttgttacgatgaagccaaccactttcagaatttctacaaaccagatcagaatctggaagtcctgtttttttattttttttatccctttgtttagcatgttacctatcttaacacattttaaataagtgaatgcatagcttatatctacttctaggttatatgcttccttagaataggaattgattcttaaaatgtcgttctgctcacgcctgtaattccagcactttgggaggccaaggcaggcggatcacttggggtcaggagttcaagaccagcctggtcaacatggtaaaaccctgtgcctgcaaaaaatacaaaaattagctgggcatggtggtggccatctgtaatcccagctactagggaagctaaggcatgagaatcacttgaacctgggaggtggaggttgcagtgagctgagatcgcgccactgcactccagcctgggtgacaagagcaaaactccatctcataaataaataaataaataaataaataaataataaaaataaaaaaataaaataaaacaaaaattttattctgagcagtctctgaagaatataaattctactgccttgcctttagaacttataacagcatctcgcaaactatcacaagatgctccaaacatacttcttatgtgctgaattaagaagtcaactcaaatttagtatactagtaatatttttggatatcccaaaacactgccagctcagctttaggctgcccttcttgggggggaaaaaagcagttgaaatttaggacttaagtgggcatctcgtttaatttttaatggatttctatgttgttggttatggtgaagaggtgaaaagaataaatattctgtgcagaaaaattattcagtcttcatgtgaaaacactttgtccatagcaattactttatgaaaaagatgtggtattactttctttgctcttaactgagacctttaatttaaagaacctatactttacaagtttttattttcaatgcatgaaaaatgtagcagctatttcacaacctttacttttaaaatccatttttctttttaatctcaaatagttttttcttaaaaccttttgactttttatctaaattgtaatagccagagcaccttcccacaactagaatatctcatcctttttgtcttttctttttcctctcaaaatgcctactgggaacttaatttggagtcagattcttcatgataaatctggacttaatcaaaattcctcatatggtatattgtatatatcacagtactggatagtcctctgattaaatagatatttgatagtactttaaggtctatacttttggatgaacttaactgctttctccatttgtagtctcttgaaaatacagaaatttcagaaataatttataagaatatcaaggattcaaatcatatcagcacaaacacctaaatacttgtttgctttgttaaacacatatcccattttctatcttgataaacattggtgtaaagtagttgaatcattcagtgggtataagcagcatattctcaatactatgtttcattaataattaatagagatatatgaacacataaaagattcaattataatcaccttgtggatctaaatttcagttgacttgtcatcttgatttctggagaccacaaggtaatgaaaaataattacaagagtcttccatctgttgcagtattaaaatggcgagtaagacaccctgaaaggaaatgttctattcatggtacaatgcaattacagctagcaccaaattcaacactgtttaactttcaacatattattttgatttatcttgatccaacattctcagggaggaggtgcattgaagttattagaaaacactgacttagatttagggtatgtcttaaaagcttatttgcgggaagtactctagccttattcaacagatcactgagaagcctggaaaaacaaatcccggaaactaattattatgtgccagttatataaacaagaagactttgttgggtacaaaccagtgattccttgcctttgaaaaatgtgtcagatatcatgcattaccagcagttcaatgatataaggaaaccagagtaatagctaaaacctttaaagctaaaccaaagatttacaaattgcctcttcatccagtctttcccaacctaaaaactgagttctctaaaaattttagtatttttttctgaagaaaagggaacatggacatttatctaatcctcattagaaatctgactaatgataacaaggatttagacctcaagcacttcttaccaaaattcttgatatgaccttatagcaaattactttcacctgttgaactttcctttcttttattcccctgtacctcacctgcactgggcatattcaagttgcttatacaacactttactattgtgttagaaaaatcatgacacatgatgaatgtgtttgtgcaacatgagctgattcataaatgaaaatgtgcattgaaattccacaatattttaaaattaggagtttatctagcaattgaacaaaattgattaaatccattatttgttagatcagctaaattacataagttcattcatctgctcataaatccatccattcttccatctggctatcccttagtcaattcaaataaatatttatggggcactttgggtaagccaggtgctaagaattcaatgcaaaacaagatagactcccctgtccttgttgaacttatatttttggtacaaacaaaagcaataatcaagaaaaaataaaaaaagtactgattgtgattaataatatgaagaaattcaacagagtattgtacttaacatttgattgatctgattttctcagttgtctgagaacaaacatttgtgaaaatctcattgtagagttcttacgatggatagggggtcaactgtgtcattattgcttatcagcttatcccaaagacctagtttattaccagattgcaaatagtgttcaataaattattcttattaagggttgttatgtactctaaaacatttattgtggtcccttcactggttctggtttacaaacttacttttctatgatgacatagtatagaaattgagagtgaatatttagaagttcatttttattatatatttttgaagtattgatatgtagtgaattagaaatttaaaaagaaaacaaaactgtccttcactacagattgaaaagcattatactaaaagaccatttgctcagttatagtatataaaggccaaatgacttaaaaacaaattatgtaaggagaaggaaacaaccatttattcagtgccactaactgtcagccagttttttcagtggtcagttaatgactgcagtagtgttctaccttgctcaaagcaccctcctcaagttctggcatctaagctgacatcagaacacagagttggggctctctgtgggtcacctctagcacttgatctcctcatgcagtgcatggtgctctcacgtctatgctatgttcttatggtctttaggtaacaagaataattttctttcttttccttactatacattttgctttctgaaattcccttctcgccaatccaggtgaatgtcagaatgtgatttgacaactgtccaaagtactcattcactgaggagtggtaaggccttcgcccaacctgccttctctgggaatatactgctgcctgaacatatcattgtttattgccaggcttgaacttcaccaaattaatttattagggtcaacatctaaatattagaactatttcagattaatttttaagtcgtatccactttgggtactagatcaaattgcaggtctctgcttctggcttgagcctatgtttagagatgatgtgcatgaagacactctttgcttttcctttatgcaaaatgggcattttcaatctttttgtcattagtaaaggtcagtgataaaggaagtctgcatcaggggtccaattccttatggccagtttctctattctgttccaaggttgtttgtctccatatatcaacattggtcaggattgaaagtgtgcaacaaggtttgaatgaataagtgaaaatcttccactggtgacaggataaaatattccaatggtttttattgaagtacaatactgaattatgtttatggcatggtacctatatgtcacagaagtgatcccatcacttttaccttataggtgggcctcttgggaagaactggatcagggaagagtactttgttatcagcttttttgagactactgaacactgaaggagaaatccagatcgatggtgtgtcttgggattcaataactttgcaacagtggaggaaagcctttggagtgataccacaggtgagcaaaaggacttagccagaaaaaaggcaactaaattatattttttactgctatttgatacttgtactcaagaaattcatattactctgcaaaatatatttgttatgcattgctgtcttttttctccagtgcagttttctcataggcagaaaagatgtctctaaaagtttggaattctcaaattctggttattgaaatgttcatagctttgatagtgtttttcagaagaccaaatttacagtgggagccttgggcttttgttttttaacagctcttttttgttcctgcttcagtggcctgacctccaagttagcaatcgccaggttgagaaatgctttgcgagacataacagatgctcctgaaataacaaacacttggaatcatgaggtagtggaattgaaaatagaaagtgtagtgattgttttttgttatttggatgggatgaacaatgtcagattagtctgtaactatttttttttaatgtcactctgatttggtcacaaaggatctctagtctcattgccttagtatcattctacgaattagaatgtgttactgtgtaagagcacttcttgtatatgagagaaatagcaacagttccagtttaaagtgatataaatggaaaccaagaaatgtctttactgggaccaaatctggacagcatttactgtatttttgctggtattttctctagtctttccgggtatattcacatttaatgatcacttttctccctttgtgctaatggacactgaatccattccactaccatagttcttgctaatactactctactttttacacaaaattaaaatgccaggagcacctccaggtagactgactataaatctagactgaaaaaaaagcttgtatttcttaacagattaccttgtggaacatttgctcctttcaactaatgaggcactaaatattgtaactgctcaactggtgcttttaatttatttgtctagactttgtcatgttgccagaagctttatcctggttggagttttgaaaacagtattgtttcttcagaaagaaaaaagggattgtcagatgatctaaaaataaagaaacactggaaatacaagtatcccaaggtgatagcattaggcaagataaaaatgttgaaaagcgaaaaagaactggttgatagagaagtgttgttattcagtagaacctaagtcttgtggtcccatttttaatgaaaaatggtgaattttttggtttttattgttcttgttcacacaaatctgcccattagaataagccaagccctaaaaattaatttcagtttcactgggaatcctttagtttatctactatgtagtagagaggttttgttttattgcatgtttgacgtaggaacgtatatatgcaagacatggaggaaaaccaagtgggccagagttttgaaaattctttatcttttctttctgccaaagtgagtctcccaagtttgtcttttttttttcatttccactcttctatggtttctagcattatataaaccaaacaaaaaaaatacgttcagagattccttcagaaatgctggatgatcttgatatcgatgcttttcatatatgtgtttatgatgctggtttctggggctggctctcagtatcacaaagatgtctgtaaacagaatatgctatttcttctttgtgacaaattttgaacattatgtgaatgtccaagaaagagcaaaagagggcaaacttctcatacatttttgatgtcgaaaccaagagacgcttttattttcctaacttttctttgaaagttcaaattaagtaattttatcctgtcctaaagtttaaaaagaaaaaaaaaaggaagaaggaattaaaaatccaaagaaaattatgtttgtttgcttttctgtttttttcttccttccaactccgagactttgcaagggcatagttctgaagatctctgacactgagacattagagatctctgtatcaatggatcatttgttttcagacatatgaaacaggaactttgaacaagaaatttcccctctttttctcatagtgatcctgagacatcagctgtggaatcacaacacgtcattagttttggcaggtccttgcaggtgttttgttttgttttattaatgttcttccctcctgtagctagacagcaatcttggagaatctgccagcttggaagactattgtgtaaatttcaaggtggagcctcctttaatttgttctgtgttacctgtgagctgtgaggtcatgaagaggagacaatgaggctaatcatgagagccccattggtttaggcaattagaacaacaagatctaaaatggtttattagccttgaattgtgttaagcacataattcataaaaaacagaaaaaatatttttaaatgtatgtctaaatcttcagttacaagtttgaaaggtgacaaactattctgaggaaatgattaggcctattcttgcaacgagtctttatgatctgaaaagaatctatgtccacacataactcccacctcaaagatggggcatcttttgctctgggagatatcaaatgcgaccaaaacaagtgtttgtagatttgaatgatgattcagcagtgtagcagttctcactcattttataataattaacaacttaataattaattattaaactcctacatgcttaacattataagtatgataacttctgtggttacataaaagatatacatagcacttgtccttgatctgtcacagtgaggtcccaatccaacctatgagcttcaaatgaaaagttcaaaattacactcattgtcataagtcagagatcaaaggaagaaaggatttaaccaaaatgataaattaaatataggtgattaaatatagtcatggttcaaggcatgggccagttagggagtgtgatgtgggtaattatgaaaggccagctcccaagccctgttgttgctactcccccacatcagtcatccttcctttttttctacttctactgcagtgccttcctcatcttttcccttgcatccctccattatatgagtcatacaaattagacttttcaaagcaacattaacattgtgtgaatttggggtttttgactaatcccaacattccacccccacattccagtcccacatgggatttggagccttgtttataaacctggcacttctaatatatcttatcttagagtaatccttgtatttgtttaatttccacttagcattgtaaatacttgcaggtatcctagttaagaaagcaaggtttaaacacaaaatcatcaccaattaaagcaggctagataaagaatgtaatagaaatgctagataaaacagattttttcttactaagttttctgtcccttatagagtgcataacacaataacttgcttgataagaattcaatgtacattgttttgtgctgaatcactaaatgcttgatttctgtaacaagagattgtggttccatcagtatctggattttagtctgtgtaatcttaggcaagttatttgatttctctgtgcctctgttttcttgtctgtaaaatgagtataatggtagtaactaattcattgtgtttttgtgaggattaaatgagttaataactagtactcctccctggcacatagtaagtacaatatgctgtgctgtggtggttgttattattttttatagttccttgagcaaaagaaataatgtccccatcttagtataatattggaggtatataccatagaagtgaacaaaagaatatagtttcacaaagaaagtgataattaaggcggttcataaagggtcataaagcttgtagattttagaaatgtgggggcatgaggatgtggagagggtattccaggatgccagacagggagattatggatgagtactaagatgagaactagaaaaagctgaggggcaaaaggtcagaggaggccacaagttagggagtattaggaaaaagaagttaatacttgacaagtgccaacatggcttcacgaggaatgggttgggcctttttgagtgaggaagaggctggtgaaagggtggtggaggacactgctgctgctgatggcatggggtgtaggtggcaggagaggcagggacatgagctaggaaactctccagctatgaagtgatgagtctggagtaatataaggacagtaggggtggagtgctgaacttaagggaggagagaaaaataattggtatggaagtaggtacaatgcaattttattatttctgagcctaaaaatgtgaaatttttgattatttggtcagaccagggaagtattttcttttatgctatctctgaaaatgtatacactaaaaagttgtagtataaaaaggttgtaaagcattaagtaattttagaggaaacaataatttggatattttacatgcaatcatttatatgcaaatatatgtaaatattacaaaattattctctatttgttacaaaccttaaatatttttgactgaggaatattttattcatctaattatagctactttgttctaactaatagatattcttgaaaacaaagcaacacttttttggagacagagtcttgcactgtcacctagacttgagtgtgttaccttgaactccagggctccagtgatcctcccacctcagtctcttgggtaggtggattacaggcccacactaccatgcccagctgtattagtccatcctttcattgctataaagaaataccggaaactgggtaatttataaagaaaataaatgtaactggctcacggttcttcaggctgtacgggaagcatagcagcatctgcttctgaggaggcctcaggaagttttcaatcatggtggaaggcaaataagaagcaggcatgttacacgacgaatcaggagcaagacaaagtgagggaggaggtgccacacactttgaaatgagcagatctcatgagaacagcgccaagaggatggtgctataccgttcatgagaaatccacccccatgatccagttacctcccaccaggccccgcctccaacactgggaattacaattcaacatgagatttgggcagagacacagatccaaaccataccaccagctaataccaaaaaaaaaaaaaaattttttttttaagacatggtcttactatgttctacaggctggtcttaaactcctggcctcaagtgatcctcccaccttggcctcccaaagcactgggaattcagacatgagtaacagtgcctggccaatacttatttttaaacattctctaccataaacttaggatcttgatttgttcacattgaacagatttttattatacagattgaatttataagaaaatgttgcagacattgtcaaaaagggacgtccaaaccactgtgatatttataagcatttgggccacattttgatagaactatacacggagtgtgtgtgtgtgtgtgtgtgtatatatatatacacacacacattatttatatatatgtatatatgtatatatatatatgtatttatatatatatgtgtatatgtatgtacacattatttacctacctactgtgtgagtgtgtgcatatatacacgcacacacacacacacaaatatatatatttcccttctgagacaaagccaaacagcactgtatgcttaaagaaaaacagtcacacttcccacttatgtaatttatattacatccagtcaccacaccagccaaactgctttattgttttttgtttgacatccaatgctaaagcataatgcctgttgcagtgaaatatacatgagcaaccctgagaactcaatatagcctcacgtgttgccactgagttgagttgaggagtcaagctgtagcaaaaaggtttgtcaccgggtgagtaatggtgctcttatttttctctgggtctcaagaagtgctctttatgacatatatggcattaaataaatatcagatatttgcacatcctaactttcctattggtgaagtttcttaaaagagagataaagggccattgtgtgattgatagtttcaggtatatttttgctgcacagtcagtccgagtgtaccacgtagggcaaaccacgtaacttctcagggccttgactgtttcatttgtaaaccagagaaaaggacttgggtgacctccaaagacctttcaaatttggagatgagtttgtggaaagttcaaacagtttagaaaacagaactaagacacccactggcacccctggaagcaagagagtgccaggtactatttgtaatacaggaatgaaatacctaattgtatgaaattgaattctaactgaaccagtttgttcagttaaattttttttttcaattagagtgcttacttcagtatctaacactagacagtaaactgtagacaaaagacctacagaatttctgaatggtatcaaattcaccacacttaaaactttgggatgtctaatttcaaccaacagctttctttcttcataatgttgaatatatgtgtatctattttagctaaatttaatatatatcaatatactttgatagatattttatataaactattagactatagtattatgagtaaaagacccaccatttcccaagcaattataaagaacgatcaaaattttaatgggttgttagtattatttctttaaagattgtgatactgataaatatttggccacattttaatagaattatacatgggatgtgtgtgtgtgtgtgtgtgtgtgtatatgtgtgtgtgtatatatatatggcagtagagatatatatatctacacacatctagatatatatatacatgtatatctatatatacacacatatatctgtgtgtatatatacatatgtatatatacctacatacatatgtacatatacatacatgcatatatctgtacatatatatatagtgtgtgtgtgtgtatatatatatatatatatatattttttttttcctgagccaaaacaaaatactaggttgtaatagctgttctttcagaaggaagaaaaacaacatgtgctgaactctgagtttgatgtttttgtattttacttcctattttcatatcagtccatttatttattcaggaagaatttattgagcatatattatgaacacagcttttgctaaggacagggtatgcagcagttatggcctagtaggagatatggatgttaaaaacaaaatgctcacaaatgcacatataatcttaatactcattgtaagctatgaaagcagagtgtgagtattatgagaccatatgttgggagattttatttggtattgaggatcaggaaagatacccctgaggaagtgatatttaatttgaaacctaaagaaagcagttggccatgggaagaaggtagggaatgagattcccaagcaataggaatccaatgtgtgaagaagctgagggagtgaaagaaagctagtgtggtggcaggaagaaagagaagagaatggagaagggcactaaatgagtcagagaagtaggaggggctaaaccatgtagggtcgtgtaggccatcttaaaggcctgagtgtagtggaaaacctttgaaggtttgttaaaaggtcaatgaaatgttctaatttctgttgtagtgaattgctttgattgctgaatgcgaatggatgggtagagatgcaagagtgaaagggaagaaatcaattaggaggctcttgccctgctccagataggactgataattaattttatttgggaagatcagggagaaagataagtcatgaatgactcccaagtttctggattgaagaaatgaaggtaccatacactgagatgggaaagcctaggggtagagtagctttgagaagaaaggtagcatttccccatttcataaaacatggaagaacaaagaggctggattcctgtttgtagacataccttccaggccagaactgcattactacaacatctttgcaagccacattgcctttcataactctgtgtcagtgttgatgccgtaacatctttggccttccccctaccatcctcccgcagtcctccatgataatgccattattccgtttcaaattgtgtgcttccattggatgtgtgagtctccttgaaagttataatgaggctgtagcccatatgaaatgcttcaactcaggtcctgcataggaagaggaagctaatctctccaggaactgagcctgtggctagagggatggataattgtttaaataaagaatatgctgctgagtactgatgggctctttatgtacccatttggctgctgctgcccaacctttaatctttcctgagctttaaataggaaggaaaaaatggtccacaaaggatttgagccattttgctgtggtgatgaggagcacgggtttagagacaaacactcctgtgtttgaattccagctcctactatctcctagctaagtgaccttggacaagtcacttaccttctccaacctgctgtttcttcatgtacgtaataggatttacctcatgaggttgacatgaagattgaaagaggtaacatatagaatgagcctgtcccaggacatggttcatgataagtctgccataaatgggagctatgtgtcccacccttttggaggagataactgttctgtagcaggtaatatattgtttgatacttggttaacccttacaattatcatttcctgttcttctcaataatgctagaaaccttttatttaaagaaccacaatataaaatgaaaaatatataaaaaaagcaaatggaaaaattctattggcaaggctttttaactttatatactaaataaatccaattgcttaaataatgaactgactcaagttctcagcactgcttcttgtttaattctctttagtttttcagaattctccaataatgacctttgtctactctcttcagtttattcagaaattacttttatttacatagaagtttggaagtggatacacaaacatatccctcacatatcttatgatcctatgagtcatatactcatctcttatattccctctgtaaagcaatgtaggtacctttcaggaaggtgatttttatgtaggttgagaaatatcagcatggaggtcctagctgacctctctagagagtttctgagacatttgacaacaactttttctttaagtcatcagttatgccccggggtatgaaatttctaacatgatcctcagtaaacttggctgccttgctgaggatactctccatctgcctgagagacacagacaccattaattgggaattgacttgacttgtgtggttccttgtggaccagatggccactaaatattctcatttcaaggcaattggtaaaaactacacttcaagaaatttcattcttaattccccttagtggatgttattaaccaaaggcaaaagaaaaaaagggtaaaaaaaatattctaaatgttaatatcaaaaatattattttcaattcaccccaggcacagagaactaagtattattattgctattgcaccggcattccccaatgagacagtgattttcttttaagacatttttaaataatataggcagaattaagtagacggtgatctggtaagtagatgtttcagggtaacagctgtgcaatgctccatgcagggaattagattgtcattttattccttaccaggaacatacattcagttaaacaattatttgacttctgctcttccactgatttctaagttgaggctctctcttgtgcctgtctgatcagataagtagagttgtgccttggtttatagatgagataaatgtgtatttgaataagcataagttaaagaaattttaaaatcccttaggaagctaggcttatcagagaaatccaaggaaatacattaacaaactaggaatttgttctaacaggttaattataactcataaacttattgggtttttttaccttttaattttatattacatttgcttataataaggaatattgctaggaataaaattttttaatattctacaattaacaattatctcaatttctttattctaaagacattgggattagaaaaatgttcacaagggactccaaatattgctgtagtatttgtttcttaaaagaatgatacaaagcagacatgataaaatattaaaatttgagagaacttgatggtaagtacatgggtgtttcttattttaaaataatttttctacttgaaatattttacaatacaataagggaaaaataaaaagttatttaagttattcatactttcttcttcttttcttttttgctatagaaagtatttattttttctggaacatttagaaaaaacttggatccctatgaacagtggagtgatcaagaaatatggaaagttgcagatgaggtaaggctgctaactgaaatgattttgaaaggggtaactcataccaacacaaatggctgatatagctgacatcattctacacactttgtgtgcatgtatgtgtgtgcacaactttaaaatggagtaccctaacatacctggagcaacaggtacttttgactggacctacccctaactgaaatgattttgaaagaggtaactcataccaacacaaatggttgatatggctaagatcattctacacactttgtgtgcatgtatttctgtgcacaacttcaaaatggagtaccctaaaatacctggcgcgacaagtacttttgactgagcctacttctctcctcactggtatggctccaaccatcaggccctatcttggtccatttaggctgctaaaataaaataccaaagactgagctgcttataagcaatctttggaggctgagaagtcaaagatcaaggtgccagcaggtttgctgtctcgtgagagcatacttcctggttcattgatggtgctttcttgctgtgtcctcacataatggaaagggcaagacctctctggtgtctcttttacaatggcactaatcccatcatgagggctttgttctcatgacctaatcacctcccacatgtcctacattctaatactatcaccttgggggttaggattttaacatatgaatttgaggaggtggcgggggggacacaaatatttagaccatagcatttcactcctgacctccaaagttcatgtcttcttcacatgcaaaatacattcattccatcccaatagcccccaaagtcttaacttgttccagcatcaacttacaaggctaaagtccaaggtttcatctaaatatcagctaaatcagcacaaacagctaaatcaggtagagtgggacttaaggtgtgattcctctttaggcagattgctctccaactatgaaattgtgaaatcaaacctattatgtactttcaaaataaaatggtgaaacaggcacaggctagacagtcccatttcaaaaaagagaaatagaaaagaaaaaaggagtgacaggtctctataagtctaaaactttaaggcttgagaataatttgctttgctttgcctccaggctcactggggtggtgtcttacctctggacacactggggtggaggctctatcctcatggatttgagtgtctcattctttgtggcaggtctgtgctccaatcccacacctatggctccctgagtgtgcaattgcatgcctggtggttctactggtctgggattgcataggtggcccagccttcatagctccactgggcattgccctaatgtgggctctatgtggtgacctcacccctgggcctctacctgggccctgtgactccctgggttcttgaaatctaggtggaggcagccatccccctacagttgtgctgagtgtagtgcatgagtgctggggtctgctagagctatacctagggtggtggagatgtatggcaatggagtatggggagctgatatggtttgggtgtgtccccacccaaatcttgtcttgaattataatttccataatctccatgtgttgagggagggacctggtgagaggtgactggatcatgggcatggttttcccatgctgttcatgtgatagtgagtgagttctcacgagatccaatggtttcataaggcagttttccctgctcttgcaccctctttcttgcctgtcaccatgtaagacataactctttcccttccgccatgattgtaagtttcctgaggccttcccagccatgtggaactgtgagtcaattaaacctcttttctttataaattacccagtctctttacagcaatgtgaaaatgtgctaatacaggagcaaagactgcagtgtgaggtggcaatgtgaagtctgcaatgtgaggtggcacggggcagttgtagcccctcctttgaaatctttcttccctaccccaggcctctgcactctgaactatgatgggaaaggcagcttggaagatctccaaatggctttggagtcattcttccattgtcttggactataaattctggcttctgtttaggtggctgactaatatccccactgtctgaatgcatagcacctagtttctgttgagatggctagtccatagtaatttacttatcaaatttggccacaccctttgtattctctcctgagcaggctttctcatctttcacaatatggataggctgagaattttccaaattttgaagttctgcttcccttttgatcaataattccattttaaagtcatttctcatcttgaattttactatgagcagtcaagagtaactaagctgctccttcaactttgcttggatatttcctcagtcaaacattcaatttcattgctttcaagttctgccttccacaaaacactaggacacaaacagctcagccaagttctttgacattttataagaaggatagcttttcctccattgtccaataacatgttcctcatttccatctgaaaacccatcagattggcctttaccgtccatatttctgggaacattctgctcatgaccacttaggtattcggtaagaagatagtagctttctctatagctctcctcctctctggagccctcaccagaatggcctttaattgtccattcacagcaatgtaggctttttctagcatgtacctgaaaactcttccagcctctactcattaccttgttccaaagctgcttccacattgagtatttgttacagcagtacccagatcccagtaccaatattctgtcttagtccattggggctactacacgatgtcttataaacaacagtaaaatttatttttcacagttgtggaggctgggaagttcaaaatctggtgccagcagattttgtgtctggtgaaggccttcttcctcacagatggctgtgttctcactgtgttgttacatggcagaagagtgggcaggctagctctctgggatgtcttttataagggcagtaatccaaatcatgggtttagggtagagccctcatgacctaaatcacctcccaaaggccccacctcctaataccagcatctttgaagttaggatttcaacatatgactttggcagggggacagaagctttcagtttatagcaaaccctataggtagcactactttgtcctttcctaatcaatttgcgtcaatgaaacatgaattagaagagacctaggcgactccactatactgggattattcccagtataaattatcatctctccacaccttctcatctactccctatctgagttctgaagctctccactacaagaaggaggctttggtttgacttgatatacttctctgggaaacaggtttagcataaaacagtgatgctcattctagaacacctgcaaatgacaatagttttctttcgaagtcgccaggaatcgtctgcctttgggtatgtggctgtgagcactgccgggcaaaatgccatatgacctagatgaggcatatgccatcctttgaagccattaggacattatataggaaatatattaactaaaatggaataaaattttctaaataacaccttatgtttatccaacaggtggttcattatacttgagagcattatacagaggaatttgatggggaggagagctggagaaattctcgaaattctgggtttctttaacagaatactctagctataaacttataattttaaaaaataagcattatattaaagaaaagggaacataaattattttgttttattaaacttaagtccaaaggtctggattgtggcagaataggatcaggggacctaaaatgttgagcctcaaaggtcttcttagagaacaactgtattccactattagcgcttttggtccttttagcccaatttctgtttatcccaaatgttcttcccttttctgccttccttcacagtggaccctgccaggagctttgaaatgcctgtgagtgttaaacacttacccattgagtgcccaaccttaacatgcccctaataaaatgtacttagattaaccgttttcattatcaaagtttccttattacccaacaaacacaggcgctttaaagaaaacattaactaaattgcaagtgacacattttaagatctttgatatgacttcagagaatgcactataggaacacaatgcaatgggagggaaacttgggagggaagacattagcctttataaaatctgcaagtattgccaaatcaaaataaaatttacaggaaagcaggatcataaatataatctaaaatcttagaacctgtggttatgattttaaatactaatacaatgcaaaatttttacctgtttaggtttttatttcatcagttcatatttaggtatatacttttactgttctccttttttataatttaccattcacaaagatgatgatgttagtctaactttaatgtcatgagtgctttgagtagtagtgctaagtttttgttgagtagtagtgtgcttttttgattagtagtgataggtttttgatgagtaagcctgctagcagcatacaaacaaacaagcaagtatcagcctagagaagcagaaaaggcatttgggtttcaaagtcacaaggcctaggctttagtctaatacagctgataatacaatttgtccaaacaggacatttttgggtgtgtcaaacactaaactggacaggacattatgacaaaagtgcaaagcaggactttccggggcaaaccaggatgtatgtcatctcactgagtcctctctttgtccttgccatgactagtatctctagaggtaaatgaacagagtaatgacaaatagccagacacctgaatcttatcccaacagcacctcctacataattccccattatcccaaatggaaattaaaaatatatacagtgataattccaggccaagaaatgctttatttctagcttggacttggcttccatgtccagtgtagaatcttatccttgctgatctggactgtatctcatgaagccatgacttgtacctagttactagctggaaggcttagaacaaaagctggtccagagagcctcctttttccttatttcctgggtccacacctttaccatggcagtctgcctatcatttgatggaggaatttaaagcaagtccaagggaagggaagagagtttctaaaatctagaacttggatagtttaatttacctatcccaaaacagcttaggcccagacagcttctctccaagattggtgccaaactgaaattaccagctgtgtagaccaaagagaatttcaaaagaaactgaatcccaagagaaaaaaaaaagacttctggcattgtggcccaataaattggtaggattgttgtgacttttcaagtttacatgtaaaatgggcccagcgcagtgcctggcaaatatgggtactaagtaaaagtaactataatcatgtttttttaatctggacttcacttggtcatcctttaaatggtgtctgacagaatcctagttcttgtctcactttacttagtttccctgggaaatttcatgtgtccttttggctttaattaatatctctattttgatgacctccattatctgcctattcccagagctttccacctgatatctcagcacatgaaaagcaccttatgtcaataagtgagttccttccctgccccaccacatacctgtcctgtgttcctaattccactgaatggcatcccatcctccagtttcccaaggccaagacctgggactcatctttcactctcaagttcctccacgggtacccacatgtcacatcctgtcaatgctgtccctggggagtatctgaaatatattcacttttcttcatttccacctgacaccactattaacacttgcacaaatttctgaggttcctggctcatttccctcattgacccccaatagttcattctgctctttgcagctctggtgatctttccaaaccccacatctgatcacttgtttcttcccttcatatggctccttaatgccttctggactaagtccacactgcttaaggtggcttaccaggtccttcatgattttgtctttgtttggctttctacactcactgcccaacttccccttacttcccatgattcagttatactgaatttctttggttctctaaagcacatgtgctttctgttctgcagaggcttttttgttcacttgctattctctacctgggaaactcccccagcccttcactgcctccttctaccatctttcaggcctctccttacacatcacttctttccaaaaatctgccttgacactccaggtctcggtttcctaggtgtaccctataactccacccctttcatagcatttctcactctggctggagatttaccttttaacttgtccatgtcccccactggagtggaagttcctggaggtcagggattatatcctattaattgttgtatttccagtgcctagagtagtcttgcatacatggatggtattcaataaatattggttgaatgaataaggagttctttcatttcatatgtaatagatcatggaaatagccttgtgattgatacacagcaggtattaccatcctcactttagaatgaggactcagagccttgagatgtctgagggccttgactgggacagctggcagatgcaggagcagagctgcatcacccctgtgggctatctcagggttgtctgtaatctaagtacaatgtctgttgattttggactgaaggctttttgggtaattgtttgctttttcaatacttataaaatagtttccatccttactcattgatagtaaggttagttattttagaaaacaagctaaatagcagaaatagtggccttttaagttgaaaatttaccctgaaaaatctacagagtagcaaacagagtatcaaaaggagttgactgtatctatttttataactgccacttatggattattcagtaaaaccacaattcacttttatgattttttttcatgtttctctgtcacaagagcaaactcttgctccataataacattccagaatacagcaatagcaaaagtcaacattttgaatcctttacaaactcttagacatttttttttttttagtttaacatgttacaaaacaaaatttcttcttttttcacagcagtttgggaagtacatactatttattagctcatcagcatgaagctggaaaattctttttcctaaagttctttatatctacaaactgttgatgttttcatttatttatttttaatgctacgttgtaatgaaaatcattggaaaactttagattctagtaattttgaagtcttcttagtttggacaggactgagctaaagtttgtactttttttaatttattgaaaaatggtttctaatgatagtattaacaagattatattgggggcaggacgcagtggctcacacttgtaatcctagcactttgggaggccgaggcggttggatcacctgaggtcaggagttcaagaccagcctggccaacatgtagaaatcccctctccactaaaatacaaaaattagctgggcatggtggcaggcactgtaatcccagctacttgggaggctgaggcaggagaattgtttgaacctgggagtcggaggttgcagtgagcccagatcgcaccactgcactccagcctgggcaatagagcaagattctgtctcaaaaaggaagaaagaaagattatattggggatatatatgtgtgtgtgtgtgtgtgtgtgtatatacacacacatatatatatacatatatacatatatatacatatttaaaggataaaggattctgctgccacagatcactaaatcagatgatctctagcaatttcctgtttgtttgttttttgcccatagtgcttatctctttgaacagtaattttccacttactatttttctccccttttggaccataatttcctttaaggcagagcctcctgttactcatctttgaatctggggtctgtcagagtacctagaatttaataaactctcattaagagccagttgaaagaatatatgactaagcagtcatttacatccaaaagatccgtaggagaattcttatcagcacatgtgattggtaacaataactttgtacttttcaaaaacaattactaatctatcttgctttccattatctcaccaaaacctattagcatgtctggcagaaaatagatacttaataaatttcttaaatgtttactgacttcaattttaagttttattaactatgttgacttttctctaatgaagatgattctaaaaagctttttactatacttcacagtgaataaaacagtgagataggaatattgcaaaatgtcccctgtgttggtcagtcttagtgtcattcattttaaaaattctgttctctaaatattgacagttatatataaatttatgtaattgtttacttctaataaagaatttcatctggggaaaaacatactttgctcagctctttgccacaagtgcaaagtctaagacagtcaaatagctttcctagtacggccttaggaacttagtatatgactggtgtgaatctagagggagcatactgcattctgaccaaaatctccaccctgttactatggccatcactaacttcgcagtattgcagtacttcctgctagcttagttcccaaggcaacttgtgaaggaaaatttttacaaagctgttgtcacacaaaggtagtgtttcagttcctgagcccatgtccttggagttgcccaggctccaataatactaataattactgtacattaggtacttaccatgtgccatattctgtgggagccgctttccacaaattatctctggtaatccttgtaacaaccctttgacatcaatattattattttctccatttttttacatatgagataaatgagacttaaaataatgtgcctgatatcatcagcaaatgagctgaggagggcagattcaaagctgattgtgtttgactctagagctgcagtcttaagccagaccttttcttgctggttaattttactgaaaaaaaaaaaaaaaaaaaaaaaccctcaaatactgctgattgatctaaagtactaacatttctatcagtgttagggaaattttaattttataatttgattttgtgagaaatttatagcatcttgaatactcacatgcaaagtgatatgtcttagataacattttacaatggcagagcttaagccagtgctcagtcattcattcatcctcaagttttgattcatttatcattcatcaaaactctgttttgtttggccacccacattctaggagctcagtacatatttgataaatgaatgaattgttgaggttgacagttacccaggactggcattaggaacacagagctgaagagcacgtttttaccctcaagaagcttacagtctaacgagggaacttgcacaaatactactatcactaggtgcctggttgaatggcttaagagatgatcagggatattcagaaggatatgtcaggctcagcaatggcatcacttgagagcatcaaggtgtttagggaactacaagatgtttggttctgctgggaataagagtgaagggggctccatttggatgcctcatacaccaggtgagagatcttagattttattccaccaggaggagaactaccataggatttaaaacagaaatgatatggtcaaacctacatcttaggaagatccctggggtgtttgtatggtggacttgcaatttgactaattgagatttgtaggatgattcttaagagatgatgatgacccagactgggatcactataatagagttggtaaggaggagaatgatttaaaaagtagttggaagaattctagggatggagataaacatttgaaaattattaacttataggtggtcatcaataccctgaaaatgactgggatctcagaggagagtctggagagttggaaatgacaaagactaatattcaagggggcaggaagagggagagttgttcacacatgacaataggaagaaatggccatagagtgtgtggtttctctcaagccaaggaatagatgttttaagaaaggaaaattcttgtggtgggaagcagtagagatgacagatacacattaatttcttgagatttctagatgactaaatgggcagatgttgaatgatagctaaaggagaacccagaaacaagggagggattttgtttttgttttttaaaaaagatagaccatagcagcttcatagactgaaacaataaaaaagttgaaggcacaaagaaagacacaggtcctctaactccctgcccagtgccctttattcatattctcagcacttgtatttctaagttttatgtttgagtcttcggggatacatcagagtagtcccccttgtctaataaatgtgtttacatttcctgccataccagaaacccttctcaaactttaatgaatttctacaaggtgagattactttaatgagaaaccaaccaaggaaaggagtatcatctgcaatatactttcaaatgttttttgcttgtttgtttcttgtccagctaaaaaaaaaaaaaaaaaacaagccattggtcctaacacaactttcatattctaccccaatatcaaagaggcttaaaatctcctggtcgtgtgatgggcacacagttaattttttgtgaacaaacacagtgttatgggccatttctgaatttatctctgaaatcataagattctttctgagccattatctcattctatattacagtcaggtggagcccatcttacctcctcatactaaattctagacttctcaagggcaggagacaatcatctgtatatctctttggccttcatacactcaggagtacttgccaaaaataaacatttaatgcacatttatttgaataattgataagatccaatacttcaataactttgtcatatttttatagaatgggtttctatatctcatttgcattttcaaactttacttttactgtctagctttaaaaaaaaagcctttgactctaatacagccctcatattctaccccaatatctaagaggctttatatctcctagtgttgtaccactattttaactccagtattttttacttcatagttttacctatttgttacagttagtttttatgaattcaagagatgaatagcaattttccatatgtaatttaaaaaaccccacagttgactattttatgctatcttttgtcctcagtcatgacagagtagaagatgggaggtagcaccaaggatgatgtcatacctccatcctttatgctacattctatcttctgtctacataagatgtcatactagagggcatatctgcaatgtatacatattatcttttccagcatgcattcagttgtgttggaataatttatgtacacctttataaacgctgagcctcacaagagccatgtgccacgtattgttttcttactactttttgggatacctggcacgtaatagacactcattgaaagtttcctaatgaatgaagtacaaagataaaacaagttatagactgattcttttgagctgtcaaggttgtaaatagacttttgctcaatcaattcaaatggtggcaggtagtgggggtagagggattggtatgaaaaacataagctttcagaactcctgtgtttatttttagaatgtcaactgcttgagtgtttttaactctgtggtatctgaactatcttctctaactgcaggttgggctcagatctgtgatagaacagtttcctgggaagcttgactttgtccttgtggatgggggctgtgtcctaagccatggccacaagcagttgatgtgcttggctagatctgttctcagtaaggcgaagatcttgctgcttgatgaacccagtgctcatttggatccagtgtgagtttcagatgttctgttacttaatagcacagtgggaacagaatcattatgcctgcttcatggtgacacatatttctattaggctgtcatgtctgcgtgtgggggtctcccccaagatatgaaataattgcccagtggaaatgagcataaatgcatatttccttgctaagagtcttgtgttttcttccgaagatagtttttagtttcatacaaactcttcccccttgtcaacacatgatgaagcttttaaatacatgggcctaatctgatccttatgatttgcctttgtatcccatttataccataagcatgtttatagccccaaataaagaagtactggtgattctacataatgaaaaatgtactcatttattaaagtttctttgaaatatttgtcctgtttatttatggatacttagagtctaccccatggttgaaaagctgattgtggctaacgctatatcaacattatgtgaaaagaacttaaagaaataagtaatttaaagagataatagaacaatagacatattatcaaggtaaatacagatcattactgttctgtgatattatgtgtggtattttctttcttttctagaacataccaaataattagaagaactctaaaacaagcatttgctgattgcacagtaattctctgtgaacacaggatagaagcaatgctggaatgccaacaatttttggtgagtctttataactttacttaagatctcattgcccttgtaattcttgataacaatctcacatgtgatagttcctgcaaattgcaacaatgtacaagttcttttcaaaaatatgtatcatacagccatccagctttactcaaaatagctgcacaagtttttcactttgatctgagccatgtggtgaggttgaaatatagtaaatctaaaatggcagcatattactaagttatgtttataaataggatatatatactttttgagccctttatttggggaccaagtcatacaaaatactctactgtttaagattttaaaaaaggtccctgtgattctttcaataactaaatgtcccatggatgtggtctgggacaggcctagttgtcttacagtctgatttatggtattaatgacaaagttgagaggcacatttcatttttctagccatgatttgggttcaggtagtacctttctcaaccaccttctcactgttcttaaaaaaactgtcacatggccaggcacagtggcttacatctgtaatcccaatactttgggaggctgaggtggggggattacttgaggccaggaattcaagaccagcccaggcaacatagtgaggccccatctgtctttattaaaacaaaacaaaactgtcacagcttctttcaagtgatgtttacaaattccctatggtttagtcacaaggaagttctgaggatgatgtatcacgtcatttctgttcaggcttttgagcctcctggaggtaaatggtttccttactgaaggcttgttattaccatgattatcactaagcttgaagtaacaaattaggggggcagactcacaacctcttgccctgccatggacaagttcaagaatctaagtaaagtcctctattgtctgatcttggatttgctcaacctgaacaagccaaggaggtgtattaaactcaggcacatcctgaccaatttggaattcttaagcttcagatcactgtggaagaggctcaactctttatggtgctgtagacttacgctcattttctaggtaatttataagggacctaatattttgttttcaaagcaacttcagttctactaaacctccctgaagaatcttccagctgctgagtagaaaatcacaactaatttcacagatggtagaacctccttagagcaaaaggacacagcagttaaatgtgacatacctgattgttcaaaatgcaaggctctggacattgcattctttgacttttattttcctttgagcctgtgccagtttctgtccctgctctggtctgacctgccttctgtcccagatctcactaacagccatttccctaggtcatagaagagaacaaagtgcggcagtacgattccatccagaaactgctgaacgagaggagcctcttccggcaagccatcagcccctccgacagggtgaagctctttccccaccggaactcaagcaagtgcaagtctaagccccagattgctgctctgaaagaggagacagaagaagaggtgcaagatacaaggctttagagagcagcataaatgttgacatgggacatttgctcatggaattggagctcgtgggacagtcacctcatggaattggagctcgtggaacagttacctctgcctcagaaaacaaggatgaattaagtttttttttaaaaaagaaacatttggtaaggggaattgaggacactgatatgggtcttgataaatggcttcctggcaatagtcaaattgtgtgaaaggtacttcaaatccttgaagatttaccacttgtgttttgcaagccagattttcctgaaaacccttgccatgtgctagtaattggaaaggcagctctaaatgtcaatcagcctagttgatcagcttattgtctagtgaaactcgttaatttgtagtgttggagaagaactgaaatcatacttcttagggttatgattaagtaatgataactggaaacttcagcggtttatataagcttgtattcctttttctctcctctccccatgatgtttagaaacacaactatattgtttgctaagcattccaactatctcatttccaagcaagtattagaataccacaggaaccacaagactgcacatcaaaatatgccccattcaacatctagtgagcagtcaggaaagagaacttccagatcctggaaatcagggttagtattgtccaggtctaccaaaaatctcaatatttcagataatcacaatacatcccttacctgggaaagggctgttataatctttcacaggggacaggatggttcccttgatgaagaagttgatatgccttttcccaactccagaaagtgacaagctcacagacctttgaactagagtttagctggaaaagtatgttagtgcaaattgtcacaggacagcccttctttccacagaagctccaggtagagggtgtgtaagtagataggccatgggcactgtgggtagacacacatgaagtccaagcatttagatgtataggttgatggtggtatgttttcaggctagatgtatgtacttcatgctgtctacactaagagagaatgagagacacactgaagaagcaccaatcatgaattagttttatatgcttctgttttataattttgtgaagcaaaattttttctctaggaaatatttattttaataatgtttcaaacatatataacaatgctgtattttaaaagaatgattatgaattacatttgtataaaataatttttatatttgaaatattgactttttatggcactagtatttctatgaaatattatgttaaaactgggacaggggagaacctagggtgatattaaccaggggccatgaatcaccttttggtctggagggaagccttggggctgatgcagttgttgcccacagctgtatgattcccagccagcacagcctcttagatgcagttctgaagaagatggtaccaccagtctgactgtttccatcaagggtacactgccttctcaactccaaactgactcttaagaagactgcattatatttattactgtaagaaaatatcacttgtcaataaaatccatacatttgtgtgaaactttgttgttttcagatgcgttcacttgtcatgtttcatcagtctctcactccaatttctaagcttcatggaacatgaaacacgaatctgtcttttaga

(19) United States
(12) Patent Application Publication
(10) Pub. No.: US 2012/0215459 A1
(43) Pub. Date: Aug. 23, 2012

(54) HIGH THROUGHPUT DETECTION OF GENOMIC COPY NUMBER VARIATIONS

(76) Inventors: Marianne Stef, Bajo Aldapa (ES); Diego Tejedor, Derio (ES); Antonio Martinez, Derio (ES); Laureano Simon, Derio (ES)

(21) Appl. No.: 13/394,078

(22) PCT Filed: Sep. 2, 2010
(86) PCT No.: PCT/IB10/02353

§ 371 Date: May 14, 2012

Related U.S. Application Data
(60) Provisional application No. 61/239,872, filed on Sep. 4, 2009.
(60) Provisional application No. 61/266,582, filed on Dec. 4, 2009.

(51) Int. Cl. G06F 19/18; G06F 19/22; G06F 19/20

(52) U.S. Cl. 702/19

(57) ABSTRACT

The invention relates to methods and algorithms for detecting and analysis of copy number variances in a genetic segment. The invention also relates to a computer implemented sequential method of processing and interpreting experimental data generated by genotyping nucleic acid-chips or nucleic acid-beads based on detection of a hybridization signal.

### CROSS REFERENCE TO RELATED APPLICATION

This application claims benefit under 35 U.S.C. §119(e) of the U.S. provisional application No. 61/239,872 filed Sep. 4, 2009, and No. 61/266,582 filed Dec. 4, 2009, the contents of which are expressly incorporated herein by reference in their entirety.

### BACKGROUND OF INVENTION

So-called “DNA-chips”, also named “micro-arrays”, “DNA-arrays” or “DNA bio-chips”, and collections of beads with attached nucleic acids, are systems that functional genomics uses for large scale studies. One can also tailor these systems for specific mutation detection or detection of several mutations at the same time and thus for the use in functional genomics which studies the changes in the expression of genes due to environmental factors and to genetic characteristics of an individual.

Gene sequences present small inter-individual variations at one unique nucleotide called an SNP (“single nucleotide polymorphism”), which in a small percentage are involved in changes in the expression and/or function of genes that cause certain pathologies. The majority of studies which apply DNA-chips study gene expression, although chips are also used in the detection of SNPs. Other genetic variations such as differences in nucleotide repeat sequences are also involved in phenotypic variations. For example, aberrant numbers of trinucleotide repeats causes Huntington's disease, several ataxias, and fragile X syndrome. Large deletions and insertions are associated with multi-gene disorders, such as Down's syndrome.

The first DNA-chip was the “Southern blot” where labeled nucleic acid molecules were used to examine nucleic acid molecules attached to a solid support. The support was typically a nylon membrane.

Two breakthroughs marked the definitive beginning of DNA-chip. The use of a solid non-porous support, such as glass, enabled miniaturization of arrays thereby allowing a large number of individual probe features to be incorporated onto the surface of the support at a density of >1,000 probes per cm². The adaptation of semiconductor photolithographic techniques enabled the production of DNA-chips containing more than 400,000 different oligonucleotide probes in a region of approximately 20 μm², so-called high density DNA-chips.

For genetic expression studies, probes deposited on the solid surface, e.g. glass, are hybridized to cDNAs synthesized from mRNAs extracted from a given sample. In general the cDNA has been labeled with a fluorophore. The larger the number of cDNA molecules joined to their complementary sequence in the DNA-chip, the greater the intensity of the fluorescent signal detected, typically measured with a laser. This measure is therefore a reflection of the number of mRNA molecules in the analyzed sample and consequently, a reflection of the level of expression of each gene represented in the DNA-chip.

In the nucleic acid beads, a bead set is typically coats with a number of nucleic acid probes that are labeled such that different probes can be “seen” using visualization or capture of the beads after hybridization to a target nucleic acid.

Gene expression DNA-chips typically also contain probes for detection of expression of control genes, often referred to as “house-keeping genes”, which allow experimental results to be standardized and multiple experiments to be compared in a quantitive manner. With the DNA-chip, the levels of expression of hundreds or thousands of genes in one cell can be determined in one single experiment. The cDNA of a test sample and that of a control sample can be labeled with two different fluorophores so that the same DNA-chip can be used to study differences in gene expression. DNA-chips for detection of genetic polymorphisms, changes or mutations (in general, genetic variations) in the DNA sequence, comprise a solid surface, typically glass, on which a high number of genetic sequences are deposited (the probes), complementary to the genetic variations to be studied. Using standard robotic printers to apply probes to the array a high density of individual probe features can be obtained, for example, probe densities of 600 features per cm.sup.2 or more can be typically achieved. The positioning of probes on an array is precisely controlled by the printing device (robot, inkjet printer, photolithographic mask etc) and probes are aligned in a grid. The organization of probes on the array facilitates the subsequent identification of specific probe-target interactions. Additionally, it is common, but not necessary to divide the array features into smaller sectors, also grid-shaped, that are subsequently referred to as sub-arrays. Sub-arrays typically comprise 32 individual probe features although lower (e.g. 16) or higher (e.g. 64 or more) features can comprise each sub-array.

One strategy used to detect genetic variations involves hybridization to sequences which specifically recognize the normal and the mutant allele in a fragment of DNA derived from a test sample. Typically, the fragment has been amplified, e.g. by using the polymerase chain reaction (PCR), and labeled e.g. with a fluorescent molecule. A laser can be used to detect bound labeled fragments on the chip and thus an individual who is homozygous for the normal allele can be specifically distinguished from heterozygous individuals (in the case of autosomal dominant conditions then these individuals are referred to as carriers) or those who are homozygous for the mutant allele.

Another strategy to detect genetic variations comprises carrying out an amplification reaction or extension reaction on the DNA-chip itself.

For differential hybridization based methods there are a number of methods for analyzing hybridization data for genotyping. For example, one can analyze an increase in hybridization level, wherein the hybridization level of complementary probes to the normal and mutant alleles are compared. One can also analyze a decrease in hybridization level, wherein differences in the sequence between a control sample and a test sample can be identified by a fall in the hybridization level of the totally complementary oligonucleotides with a reference sequence. A complete loss is produced in mutant homozygous individuals while there is only 50% loss in heterozygotes. In DNA-chips for examining all the bases of a sequence of “n” nucleotides (“oligonucleotide”) of length in both strands, a minimum of “2n” oligonucleotides that overlap with the previous oligonucleotide in all the sequence except in the nucleotide are necessary. Typically the size of the oligonucleotides is about 25 nucleotides. The increased number of oligonucleotides used to reconstruct the sequence reduces errors derived from fluctuation of the hybridization level. However, the exact change in sequence cannot be identified with this method; sequencing is later necessary in order to identify the mutation.

Where amplification or extension is carried out on the DNA-chip itself, three methods are presented by way of example:

In the mini-sequencing strategy, a mutation specific primer is fixed on the slide and after an extension reaction with fluorescent dideoxynucleotides, the image of the DNA-chip is captured with a scanner.

In the primer extension strategy, two oligonucleotides are designed for detection of the wild type and mutant sequences respectively. The extension reaction is subsequently carried out with one fluorescently labeled nucleotide and the remaining nucleotides unlabelled. In either case the starting material can be either an RNA sample or a DNA product amplified by PCR.

In the Tag arrays strategy, an extension reaction is carried out in solution with specific primers, which carry a determined 5′ sequence or “tag”. The use of DNA-chips with oligonucleotides complementary to these sequences or “tags” allows the capture of the resultant products of the extension. Examples of this include the high density DNA-chip “Flex-flex” (Affymetrix).

For genetic diagnosis, simplicity as well as accuracy must be taken into account. The need for amplification and purification reactions presents disadvantages for the on-chip extension/amplification methods compared to the differential hybridization based methods.

Typically, DNA-chip analysis is carried out using differential hybridization techniques. However, differential hybridization does not produce as high specificity or sensitivity as methods associated with amplification on glass slides.

For this reason the development of mathematical algorithms, which increase specificity and sensitivity of the hybridization methodology, are needed (Cutler D J, et al., Genome Research, 11:1913-1925 (2001)).

The problems of existing DNA-chips and beads in simultaneously detecting the presence or absence of a high number of genetic variations in a sensitive, specific and reproducible manner has prevented the application of DNA-chips for routine use in clinical diagnosis, of human disease.

### SUMMARY OF THE INVENTION

The present method provides a computer implemented sequential method of processing and interpreting the experimental data generated by genotyping nucleic acid-chips or nucleic acid-beads based on detection of a hybridization signal. The method produces high levels of specificity, sensitivity and reproducibility, which allow the DNA-chips and beads developed on the basis of this method to be used, for example, for sensitive and reliable routine clinical genetic diagnosis.

### BRIEF DESCRIPTION OF THE DRAWINGS

FIG. 1 shows a schematic presentation of an embodiment of the principle of the analysis method on a flat solid support.

FIG. 2 shows a flow chart of one embodiment of the analysis method.

FIG. 3 shows is a block diagram showing an exemplary system for detecting genetic variation.

FIG. 4 shows an exemplary set of instructions on a computer readable storage medium for use with the systems described herein.

FIG. 5 shows a flow chart of one embodiment of the analysis method as shown in Example 1.

FIG. 6 shows a flow chart of one embodiment of the analysis method as shown in Example 2.

FIG. 7 shows a flow chart of one embodiment of the analysis method as shown in Example 3.

### DETAILED DESCRIPTION OF THE INVENTION

The present invention relates to an in vitro method of detecting genetic variations in an individual, specifically variations (e.g. duplications, multiple copies, deletion or loss of copies) in sequence segments in the genome. The inventors have developed a sensitive, specific and reproducible computer implemented method for simultaneously detecting and characterizing genetic variations in a genome. The inventors also developed methods for designing oligonucleotides used for carrying out the method of detecting genetic variations. Specifically, using the analysis methods described herein, one can analyze copy number variations (CNV) in a genome. The method is also useful for the development of products for genotyping these CNV. For example, in one embodiment, one can perform the method of genotyping according to the methods of the present invention to detect deletions of 1, 2 or 3 bases on AFFYMETRIX® re-sequencing chips.

The method is unique in that it is based on a combination of (1) use of a solid support based microarray, such as nucleic acid-chips/beads genotyping strategy with some distinct modifications in the probe selection and array design, and (2) a sequential computation system (algorithm) amendable for electronically processing and interpreting the data generated by the genotyping strategy (based on a selection of the probes to be included in the computation of the genotype). This combination of genotyping strategy and a sequential system guarantees high levels of specificity, sensitivity and reproducibility of results. This method is versatile because any solid support, such as, chips or beads that are coated with the unique probes can be used, for example, in clinical genetic diagnosis. The method is versatile for processing and interpreting of the data and it can be performed manually or by using a computer that is programmed to carry out the algorithm.

One of the key advantages of the present method is that it evaluates CNV in a single step, while previously used methods involve several steps: first, a comparison of intensities between the sample and numerous controls. Also, a comparison between samples of the same patient, such as normal tissue versus tissue suspected of having CNV, e.g., tumor tissue is found in previously used methods. The present method does not need such comparisons. As used herein, the terms “patient” and “subject” are used interchangeably.

An additional advantage of this method compared to the previously used methods use polymorphic SNPs, since they analyze loss of heterozygosity as well as the probability of a simple being homozygote for the polymorphic SNPs rare alleles, is that the present method does not use polymorphic SNPs. Furthermore, the present method permits the use of specific design probes for any region of interest and the method focuses on just that region of interest, rather than working on the whole genome.

A yet an additional advantage of the present method is that the method performs an intra-chip (or intra-assay) normalization using a non-variant genetic segment such as specific regions on the Chromosome 21, e.g., the DSCR1 gene.

As a consequence of the above, the present method's computation algorithm is much simpler and has fewer steps than any previously described analysis method. Therefore the method is also much faster.

### DEFINITIONS

For convenience, certain terms employed herein, in the specification, examples and appended claims are collected here. Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Unless otherwise defined, all technical and scientific terms used herein have the same meaning as commonly understood by one of ordinary skill in the art to which this invention belongs.

The term “nucleic acid (NA)” refers to deoxyribonucleotides (DNA) or ribonucleotides (RNA) and polymers thereof (“polynucleotides”) in either single- or double-stranded form. Unless specifically limited, the term encompasses nucleic acids containing known analogues of natural nucleotides that have similar binding properties as the reference nucleic acid and are metabolized in a manner similar to naturally occurring nucleotides.

As used herein, the term “peptide-nucleic acid” or “PNA” refers to any synthetic nucleic acid analog (deoxyribonucleic acid (DNA) mimics with a pseudopeptide backbone) which can hybridize to form double-stranded structures with DNA in a similar fashion as naturally occurring nucleic acids. PNA is an extremely good structural mimic of DNA (or of ribonucleic acid (RNA)), and PNA oligomers are able to form very stable duplex structures with Watson-Crick complementary DNA and RNA (or PNA) oligomers, and they can also bind to targets in duplex DNA by helix invasion. Other type of complementary base pairing, such as the Hoogsteen pairing is possible too. PNA may be an oligomer, linked polymer or chimeric oligomer. Methods for the chemical synthesis and assembly of PNAs are well known in the art and are described in U.S. Pat. Nos. 5,539,082, 5,527,675, 5,623,049, 5,714,331, 5,736,336, 5,773,571, and 5,786,571. Uses of the PNA technology are also well known in the art; see U.S. Pat. Nos. 6,265,166, 6,596,486, and 6,949,343. These references are hereby incorporated by reference in their entirety.

As used herein, the term “complementary base pair” refers to A:T and G:C in DNA and A:U in RNA. Most DNA consists of sequences of nucleotide only four nitrogenous bases: base or base adenine (A), thymine (T), guanine (G), and cytosine (C) or pseudocytosine (J). The pairing is based on the Watson-Crick pairing or the Hoogsteen pairing. Together these bases form the genetic alphabet, and long ordered sequences of them contain, in coded form, much of the information present in genes. Most RNA also consists of sequences of only four bases. However, in RNA, thymine is replaced by uridine (U).

As used herein, the phrase “genetic variant segment” refers to a segment or region of NA wherein there are commonly known sequence variations within a population of animal specie, such as any allelic variations, silent or causal, or disease or disease-risk causing mutations. The NA can be DNA or RNA. The NA is typically a genomic DNA, but in some embodiments, it can also be a primary transcript or fragments thereof or a messenger RNA or fragments thereof. In one embodiment, the sequence variation or genetic variant present in the “genetic variant segment” is a copy number of genetic variance (CNV).

As used herein, the phrase “genetic non-variant segment” or “non-variant segment” refers to a segment or region of NA wherein the sequence is constant within a population of animal species, meaning that there is no allelic variation in this region in the population. While the “genetic non-variant segments” or “non-variant segment” do not have allelic variations among individuals in a population, they can have known mutations that result in very obvious and distinct phenotypes. Two normal individuals who are of the same gender and do not exhibit any of the obvious and distinct phenotypes (e.g. Down syndrome) that are associated with known mutations at these “genetic non-variant segments” would have identical “genetic non-variant segments”. “Genetic non-variant segments” function as the reference/control segments in the present invention in the analysis of CNV. Mutations in non-variant segments can be selected from known disease-causing regions, such the DSCR1 locus on chromosome 21, or any other region, which results in an unmistakable phenotype, wherein an absence of a phenotype, such as a Down syndrome, indicates that this region does not have variations in the individual or animal whose nucleic acid is to be analyzed or in the control individual or control animal. A skilled artisan can easily select these regions based on these criteria and common knowledge of genetic diseases. The “genetic non-variant segments” or “non variant segment” can be DNA or RNA. The NA can be genomic DNA, a primary transcript or fragments thereof or a messenger RNA or fragments thereof.

In one embodiment, the non-variant segment selected is derived from the human chromosome 21. In another embodiment, the non-variant segment is derived from the Down syndrome critical region 1 (DSCR1) on chromosome 21. The gene DSCR1 is also called RCAN1 for Regulator of Calcineurin 1. DSCR1/RCAN1 is located at position on located 21q22.1-q22.2; chromosome 21: 34,810,654-34,909,252 (SEQ. ID. NO: 1) with respect to human genome assembly 18 Mar. 2006 (GENBANK™ accession number for its mRNA: NM_{—}004414.5, SEQ. ID. NO: 2). It is involved in the development of the phenotype of the Down syndrome. Indeed a deletion of one copy this gene is lethal whereas the presence of an extra copy of this gene, i.e. a duplication of this gene, is responsible of the Down syndrome phenotype which is easily recognizable. This gene, part of this gene or the region of the chromosome 21 wherein this gene is located can be used as the non-variant segment for the normalization in the present method.

As used herein, the term “known genotype” when in reference to control data of the genetic variant segment means that the copy number of genetic variance (CNV) in the genetic variant segment is known, for example, two copies of the genetic variant in the segment.

As used herein, the term “a test nucleic acid (tNA)” refers to a nucleic acid (NA) sequence wherein the copy number of genetic variance (CNV) within the sequence is unknown. In one embodiment, the term “a test nucleic acid (tNA)” refers to a NA sequence wherein the CNV within the sequence is of interest to the investigator and the tNA therefore is being studied, regardless of whether the CNV is known or not. For example, the investigator would like to verify that the indicated CNV in the tNA is accurate and valid. A “test nucleic acid (tNA)” sample refers to a NA sample comprising at least one tNA.

As used herein, the term “a control nucleic acid (cNA)” refers to a nucleic acid (NA) sequence wherein the copy number variance (CNV) within the sequence is known. The control NA can is used in parallel with a tNA in the methods described herein for the analysis and determination of the CNV in the tNA. A “control nucleic acid (cNA)” sample refers to a NA sample comprising at least one cNA.

As used herein, the term “target nucleic acids (target NAs)” refers to the nucleic acids that are to be hybridized to the probes immobilized on solid supports described herein. Target NAs can comprise both the control nucleic acid and the test nucleic acid. In some embodiments, target NAs can be detectably labeled or fragmented to smaller segments of nucleic acid sequences.

As used herein, the term “probe” refers to a short sequence of NA, typically consisting between 15-50 nucleotides (nt), including all of the whole integers between 15-50, wherein the short sequence is complementary to a small portion of a genetic variant segment or complementary to a small portion of a non-variant segment (the control) that is under interrogation such that the probe can hybridize to the segment by complementary base pairing. For example, one can use probes that are 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 nucleic acids long. In some embodiments shorter or longer probes can be used, but typically, one uses about 25 nucleic acids as a standard probe. The probe can be a DNA, RNA, peptide nucleic acid (PNA) or hybrids thereof. Modifications to the backbone of the NA are encompassed within the definition. In one embodiment, the probe is a DNA-probe. In another embodiment, the probe is an RNA-probe. In another embodiment, the probe is a PNA-probe. Probes are preferably single-stranded probes, but double-stranded or partially double-stranded probes can also be used.

As used herein, the term “a probe set” refers to the collection of all of the probes selected for interrogating a genetic variant segment or a non-variant segment. For example, a genetic variant segment where CNVs are known to occur encompassing 10 kilobases (kb) long is selected for interrogation. A control/reference non-variant segment of about 12 kb is also selected for interrogation. The investigator can select any number of probes covering these two regions. For example, one can decide to have 25 different probes covering the variant segment and another distinct 30 probes for covering the control non-variant segment. The 25 probes for the variant segment forms a probe set for the variant segment (variant probe set), and the 30 probes for the control non-variant segment forms the probe set (control probe set). A probe set comprises at least one probe to a segment under interrogation. The number of distinct probes in a probe set can range from one to about 10,000, typically one uses about 5-70 probes per probe set for a nucleic acid region covering 3 kb. The probes are all distinct probes, and they complement and interrogate a single genetic variant segment or non-variant segment. In one embodiment, the genetic variant segment where CNV is of interest is between about 100 base-pair (bp) to about 2000 bp. In one embodiment, the genetic variant segment where CNV is of interest is less than 2000 bp. In one embodiment, there is at least a duplicate of a probe. In one embodiment, one uses triplicate of a probe. In one embodiment, four or five replicates of each of the different probes making up a probe set can be used. In another embodiment, there are ten replicates of each of the different and distinct probes making up a probe set used. For example, a probe set comprising 12 different probes interrogates the genetic variant segment LDLR gene Exon 2, from position (68-121) in intron 1 to nucleotide in position (190+102) on chromosome 19:11060757-11105505 (SEQ. ID. NO: 3) with respect to human genome assembly 18 Mar. 2006. (GENBANK™ sequence of the LDLR mRNA is NM_{—}000527.3; SEQ. ID. NO: 4). Each of these 12 different probes is in triplicate. Therefore, there are a total of 12×3=48 probes in this probe set interrogating this specific genetic variant in the LDLR gene Exon 2.

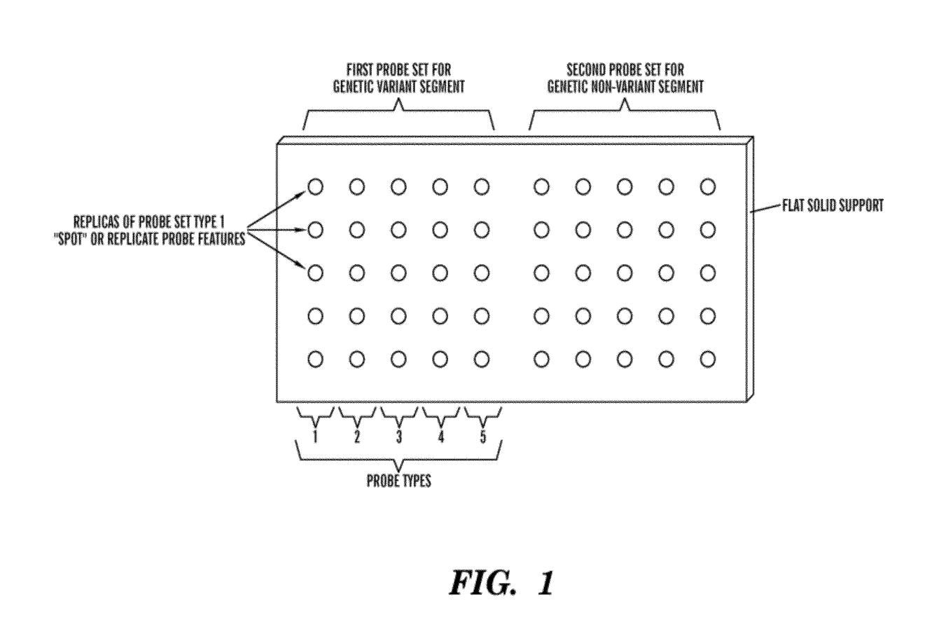

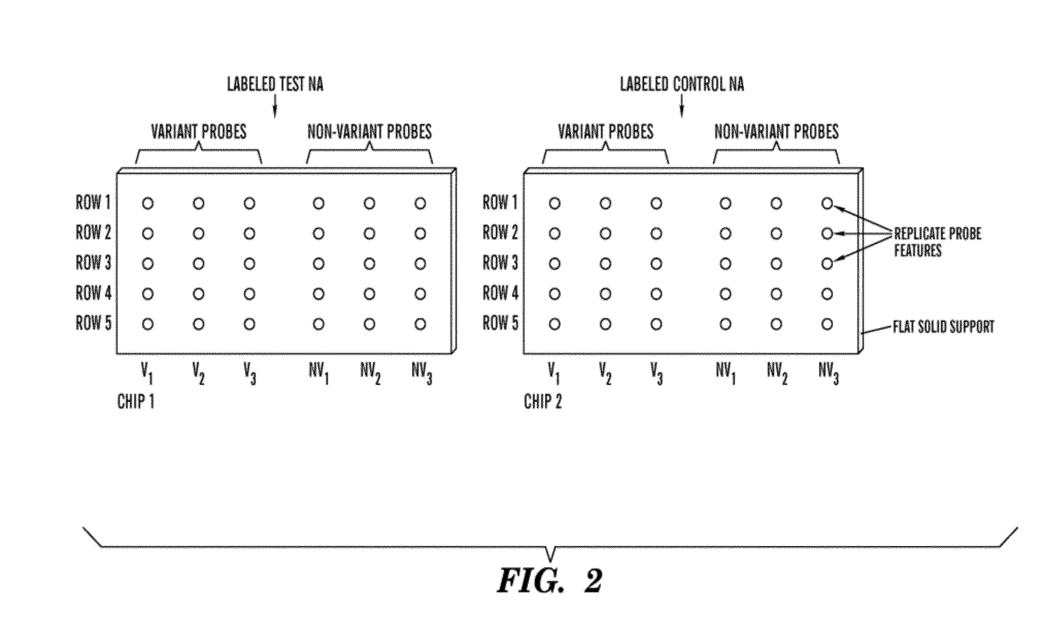

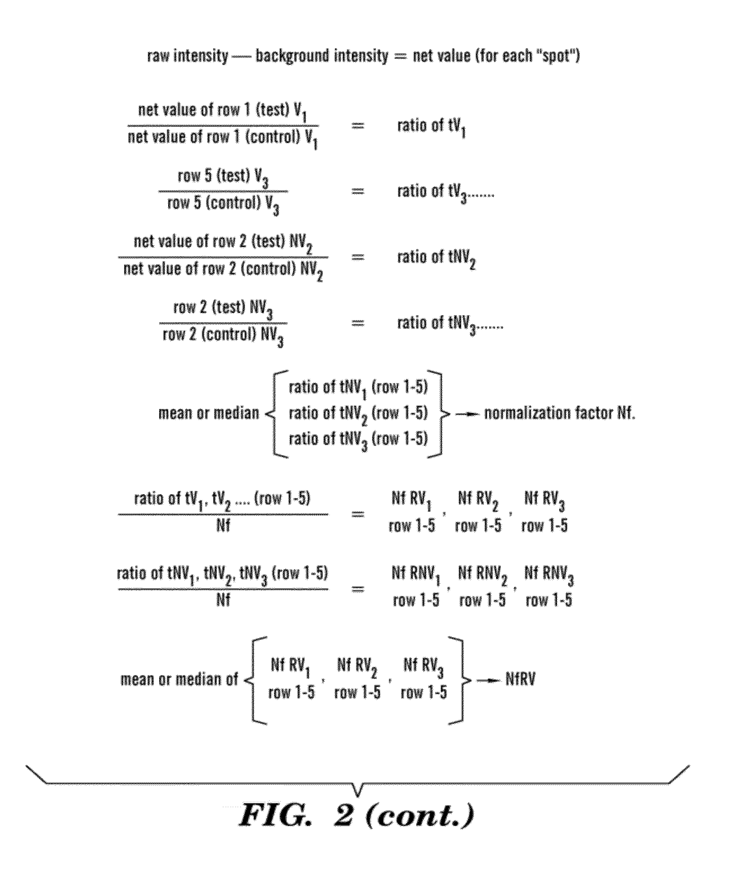

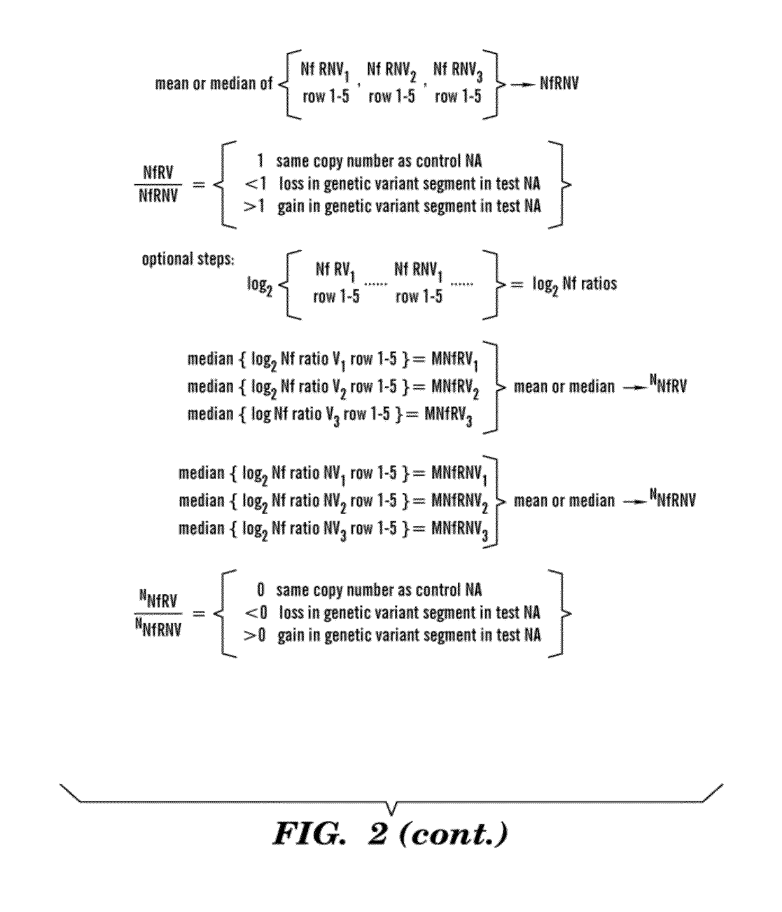

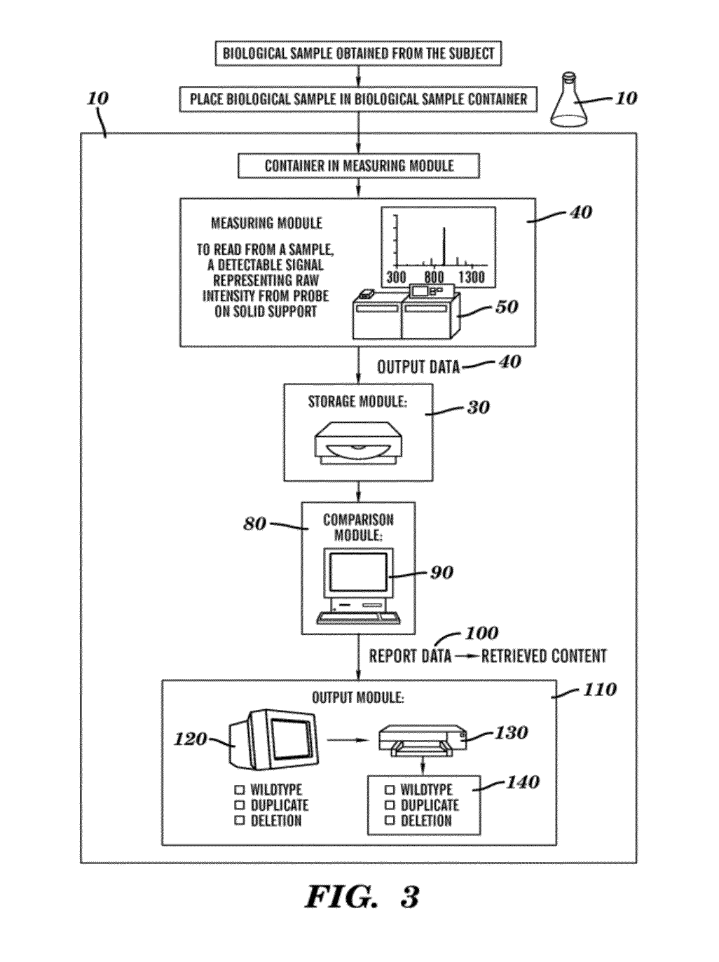

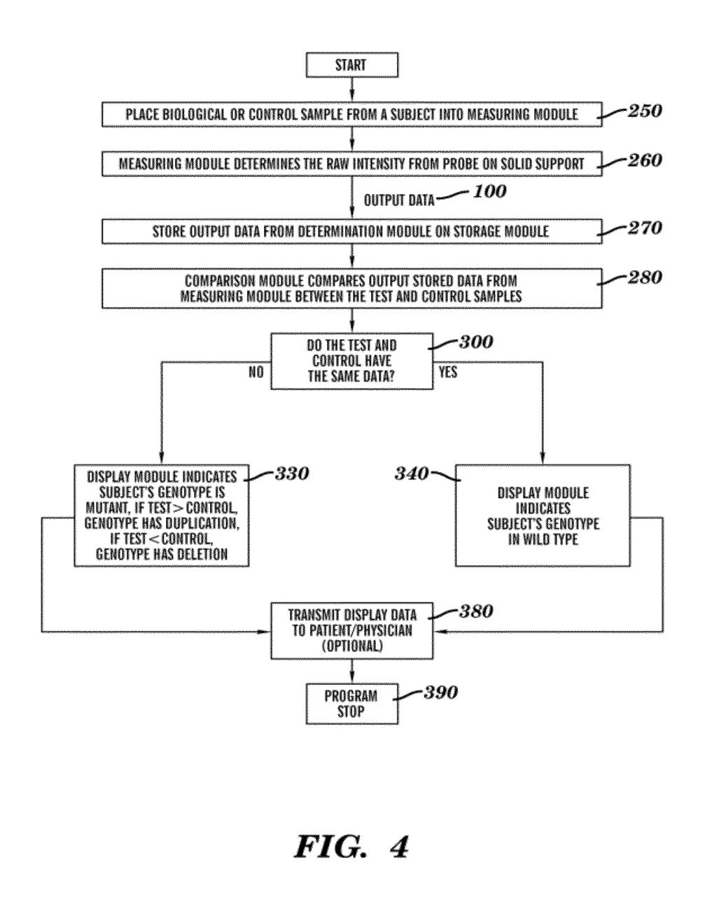

As used herein, the phrase “probe feature” refers to a localized and concentrated deposit of multiple copies of the same probe on a solid support surface (a defined “spot” on the glass surface or oligonucleotides on one bead). For example, for a flat solid support such as on the glass-chip surface, a probe feature is a spot or dot printed with multiple copies of the same probe. The multiple copies can range from tens to hundreds to thousands, e.g., about 10-10,000, or 100-10,000. All of the whole integers between 10 and 10,000 are included. Typically the concentration of the oligonucleotide probe solution and the droplet size will determine the approximate copies of oligonucleotide probes printed on a “probe feature spot” on a flat solid support. For a spherical surface such as a glass bead, “a probe feature” refers to a single bead coated with at least about 100 copies of the same oligonucleotides probe that complement and interrogate a single genetic variant segment or non-variant segment. In this case, typically the concentration of the oligonucleotide solution determines the approximate copies of oligonucleotides coating the bead. In one embodiment, the bead can have about 100-10,000 copies of the same probe. All of the whole integers between 100 to 10,000 are included. The raw value or signal intensity of the hybridization reaction in the methods herein is obtained from a probe feature, meaning from a “dot” or a single probe-coated bead. In other words, measuring the signal intensity after hybridization of the test sample or the control sample gives a raw signal value. On FIGS. 1, 2, 5-7, each circular spot on the flat solid support is a “probe feature”. In FIG. 1, there are five different distinct probes making up the first probe set for a genetic variant segment: probe type 1, 2, 3, 4, and 5. The five different distinct probes are also known as probe types or types of probes comprising the first probe set. As shown on FIG. 1, for each probe type 1-5, there are five replicas, otherwise known as replica probe features. In FIG. 2, three variant probe types: V1, V2, and V3 form the variant probe set for interrogating the genetic variant segment; and three non-variant probe types: NV1, NV2, and NV3 form the non-variant probe set for interrogating the genetic non-variant segment. There are five replica probe features for each probe or probe type, these replicas are arranged in the row 1, row 2, row 3, row 4 and row 5 as shown on FIG. 2.

As used herein, the phrases “replicate feature” or “replicate probe feature” refer to a replicate or multiples of a probe feature all having a single/same type of probe to genetic variant segment or non-variant segment (parallel dots or spots with same probe or oligonucleotide sequence on a solid surface or parallel numbers of beads coated with the same probe). For a flat solid support such as a glass-chip, all replicate features of one probe feature have one type of probe and the replicate features can be arranged, for example in a row but not close to each other on the glass-chip surface. For a spherical solid support such as a glass bead, “replicate feature” refers to number of probe-coated beads. For example, 100 probe-coated beads are 100 replicate features or replicate probe features. On a solid flat surface, for each probe, there are at least four replicate features, at least five, at least six, at least seven, at least eight, at least nine, and at least ten replicate features. However, one can also use 11, 12, 13, 14, 15 16, 17, 18, 19, 20, 20-25, or even 25-50 replicates. In a typical analysis, one uses 10 replicate features. For a spherical solid surface, there are at least 100 replicate features, typically between about 100-5000 probe-coated beads. All of the whole integers between 10 to 5,000 are included. In some embodiments, 10-15, 15-20, or 10-20 replicates are used.

As used herein, the term “interrogation” refers to the examination, investigation or study of the genotype of a NA.

As used herein, the term “comprising” means that other elements can also be present in addition to the defined elements presented. The use of “comprising” indicates inclusion rather than limitation. The term “consisting” is a closed term, indicating that nothing else is considered to be included. The phrase “consisting essentially of” is intended to cover situations, wherein the operational parts are included but one can also include non-essential or non-active ingredients or steps.

As used herein, the term “median” when used in the analysis of the data obtained from the probe feature replicas refers to general meaning when used in statistical analysis. Median is the ‘middle value’ in a list of values when arranged in increasing order. For example, for a list of the following numbers: 9, 3, 44, 17, 15 (odd amount of numbers), after lining up these numbers: 3, 9, 15, 17, 44 in increasing order (smallest to largest), the median is 15 which is the number in the middle of the ordered list. In the situation, wherein an even number of replicates are present, a median is found by finding the middle pair of numbers, and then find the value that would be half way between them. This is easily done by adding them together and dividing by two. In the present methods, the analysis of median is performed using computer-implemented software with the signal intensity values from the replicate features as an input and median as an output.

As used herein, the term “mean” when used in the analysis of the data obtained from the probe feature replicas refers to general meaning when used in statistical analysis. Median is the average of a list of values, calculated by the formula:

Average=(Sum of the list of number)/Number in list

For example, for a list of the following five numbers: 9, 3, 44, 17, 15, the

mean=(9+3+44+17+15)/5=17.6.

As used herein, the term “solid support”, on which the plurality of probes is deposited, can be any solid support to which oligonucleotides can be attached. Practically any support, to which an oligonucleotide can be joined or immobilized, and which may be used in the production of DNA probe arrays and particle suspensions, can be used in the invention. For example, the said support can be of a non-porous material, for example, glass, silicone, plastic, or a porous material such as a membrane or filter (for example, nylon, nitrocellulose) or a gel. In one embodiment, the said support is a glass support, such as a glass slide. In another embodiment, the support is a particle in suspension, as described above, such as a microparticle. Microparticles useful for the methods of the invention are commercially available for example from LUMINEX® Inc., INVITROGEN™ (Carlsbad, Calif.), and Polysciences Inc. (Warrington, Pa.). In one embodiment, the solid support is a non-porous solid support. In one embodiment the solid support is a porous solid support. Such supports are well known to one skilled in the art.

### Analysis Methods

Accordingly, in one embodiment, the present invention provides a method of analyzing at least one genetic variant segment in a nucleic acid sample comprising:
(a) providing a test nucleic acid (tNA) sample;
(b) providing at least one control nucleic acid (cNA) sample;
(c) amplifying the tNA and the cNA samples in parallel reactions;
(d) providing a first oligonucleotide probe set designed to hybridize to the at least one genetic variant segment and a second probe set designed to hybridize to at least one genetic non-variant segment, wherein the first and the second probe set are attached to a solid support to form at least a genetic variant probe feature and at least a genetic non-variant probe feature respectively;
(e) contacting, in parallel reactions, the tNA and the cNA with the solid support, thereby allowing NA hybridization between the tNA and the cNA to the genetic variant probe feature and non-variant probe feature thereby forming NA-probe complexes, wherein each complex is detectably labeled;
(f) measuring an intensity of the detectable label for NA-probe complex at each probe feature;
(g) applying an algorithm to the data from step (f), thereby determining the genotype with respect to each genetic variant present in the genetic variant segment of the tNA sample, wherein algorithm comprises the steps of:
   (i) computing a ratio of the net value of each probe feature after hybridization to the tNA over the net value of each probe feature hybridized to the cNA, for the probe set interrogating the at least one genetic non-variant segment;
   (ii) computing a ratio of the net value of each probe feature after hybridization to the tNA over the net value of each probe feature hybridized to the cNA, for the at least one probe set interrogating the at least one genetic variant segment;
   (iii) computing a median or mean of the ratios from step (i) for the probe features for the probe set interrogating the at least one non-variant segment, wherein the median or mean is used as a normalization factor for the ratios of step (i) obtained from the at least one non-variant segment and for the ratios of step (ii) obtained from the at least one genetic variant segment;
   (iv) applying the normalization factor of step (iii) to the ratios of step (i) and for the ratios of step (ii) to obtain a normalized ratio for the probe features of each probe set;
   (v) computing a median or mean of the ratios from step (iv) for the probe features for the probe set interrogating the at least one genetic variant segment and for the probe features for the probe set interrogating the at least one non-variant segment, wherein either the median is computed for both the variant and non-variant segment or the mean is computed for both the variant and non-variant segment;
   (vi) computing a ratio of median or mean from step (v) for a genetic variant segment over the median or mean from step (v) for a genetic non-variant segment, wherein if ratio is equal to about one, the genotype of the tNA sample, i.e. copy number variation, is the same as that of the cNA sample; if the ratio is greater than one, this indicates a gain in copies of the genetic variant segment in the tNA sample genotype; and if the ratio is less than one, the test genotype has a deletion, this indicates a loss in copies of the genetic variant segment in the tNA sample genotype.

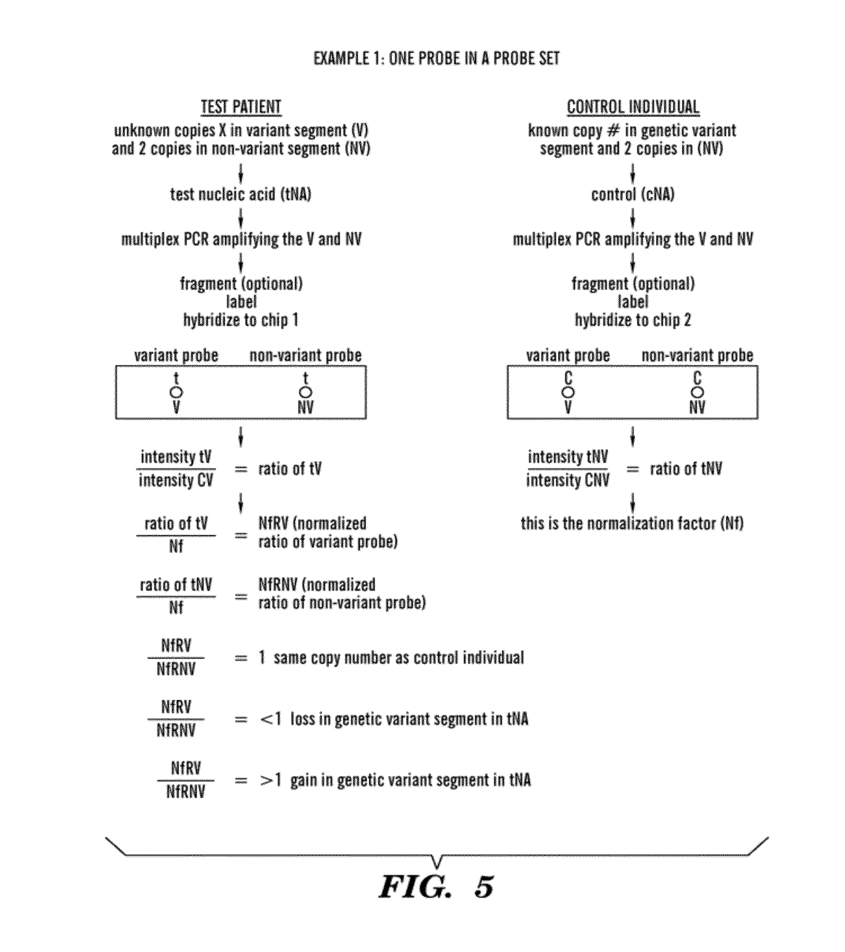

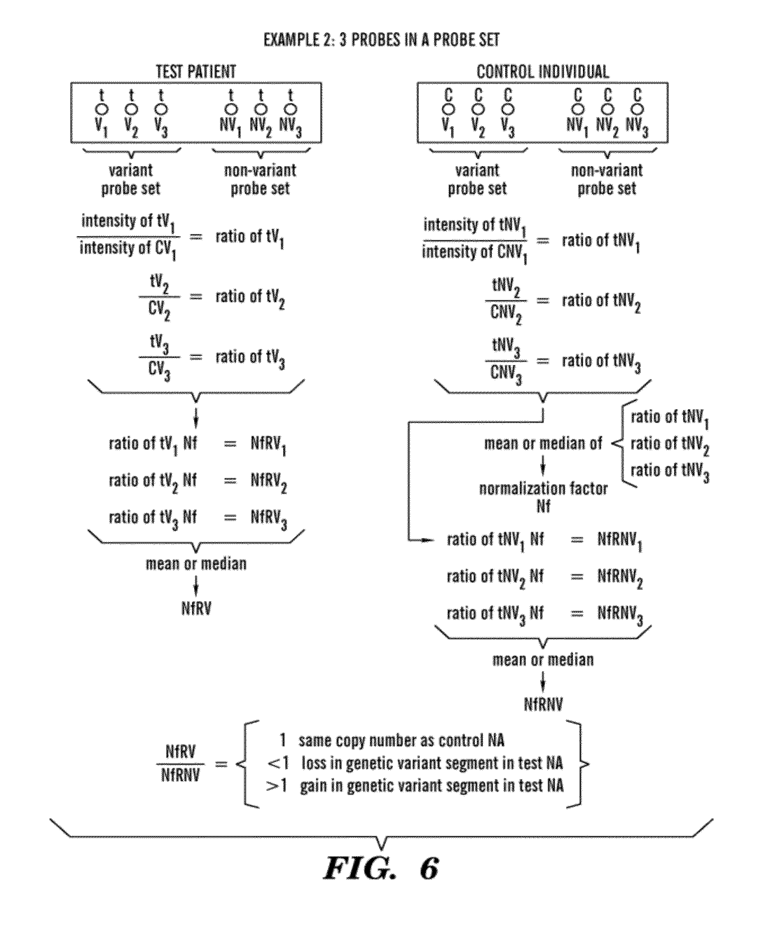

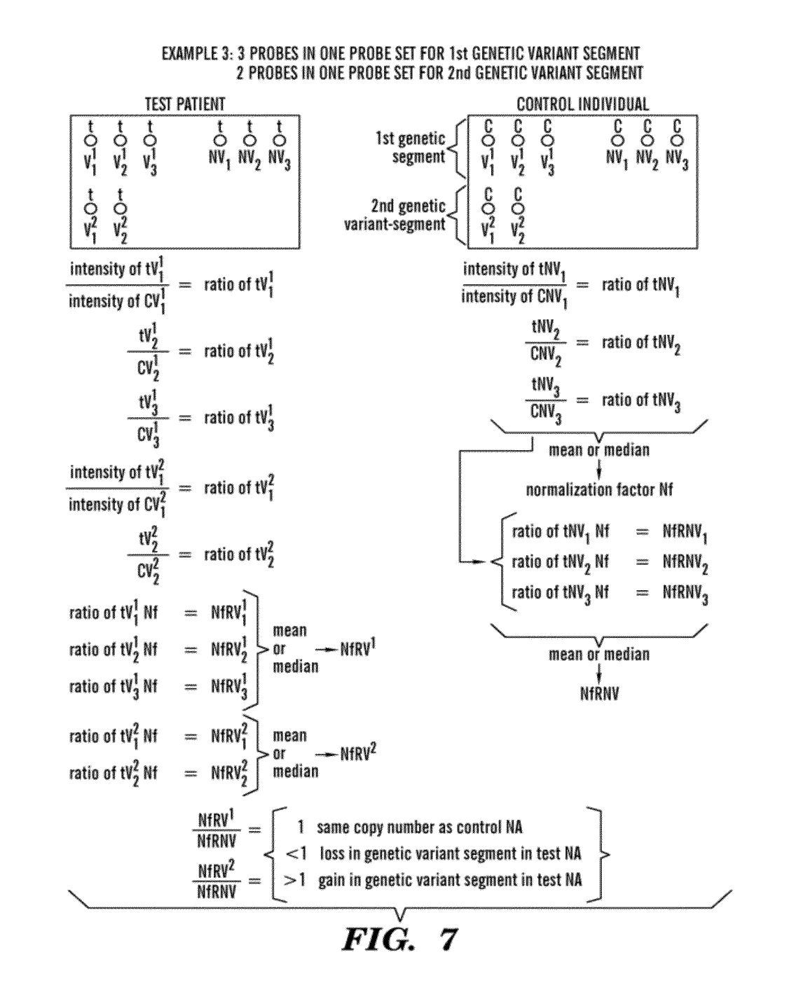

In one embodiment, the first oligonucleotide probe set that interrogates the at least one genetic variant segment comprise only one probe or in other words, one individual type of probe as exemplified in Example 1 (FIG. 5). In one embodiment, the second oligonucleotide probe set that interrogates the at least one genetic non-variant segment comprise only one probe or in other words, one individual type of probe as exemplified in Example 1 (FIG. 5). In some embodiments, each probe set comprises a number of (several) different probes as exemplified in Example 2 (FIGS. 6) and 3 (FIG. 7). In Example 2 (FIG. 6), there are three different probes for the genetic variant segment and another three different probes for the genetic non-variant segment. In Example 3 (FIG. 7), two different genetic variant segments are being interrogated simultaneously; there are three different probes for the genetic variant segment #1, two different probes for the genetic variant segment #2 and another three different probes for the genetic non-variant segment.

In one embodiment where there are multiple probe sets, each of the probes of multiple probe set is attached to a solid support to form probe features. In one embodiment where there are two probe sets, a first and a second probe set, replicates of each probe features of the first and second probe set are present on the solid support as exemplified in FIG. 1. In some embodiments, the number of replicates for each probe is between 0-50. In one embodiment, there are four replicate features for each probe.

In one embodiment, the method comprises measuring an intensity of the detectable label in non-probe positions of the solid support to obtain a background intensity value.

In one embodiment, the method comprises transforming the intensity of the detectable label obtained into a raw value for each probe or probe feature and the solid support background using a quantitation software.

One embodiment of the method comprises amending the raw value for each of the probe feature or replicate probe feature by deducting the background raw value, thereby obtaining a net value for the each probe feature or replicate probe feature for both the at least one genetic variant segment and the at least one genetic non-variant segment.

net intensity=raw intensity−background raw intensity

One embodiment of the method comprises selecting for subsequent analysis the probe features whose net values pass quality control thresholds or values signal to noise ratio of, typically, over three (SNR>3), in the probe feature positions wherein a signal is detected.

In one embodiment, the method comprises computing a Log₂ for each of the normalized ratios for the probe features of each probe set obtained from step (iv).

In one embodiment, the method comprises computing a median Log₂ for each replicate probe feature if each probe set comprise probe features that are replicated in the solid support.

In one embodiment, the method comprises eliminating from a subsequent analysis the replicate probe features whose Log₂ deviates more than 0.2 units from the median Log₂ for that probe.

In one embodiment, the method comprises eliminating from a subsequent analysis each probe for which less than four replicate probe features remaining after the previous elimination step of any replicates whose Log₂ deviates more than 0.2 units from the median Log₂ for that probe and computing a new median Log₂ for the probe feature when 4 or more replicate features remain for that probe after the elimination.

In one embodiment, the method comprises computing a median Log₂ of each genetic variant from the median Log₂ for each probe in the probe set interrogating the genetic variant segment. In another embodiment, the median Log₂ of each genetic variant segment is computed from the new median Log₂ for the probe feature when 4 or more replicate features remain for that probe after the elimination.

In one embodiment, the method comprises eliminating from a subsequent analysis the probes whose median Log₂ deviates more than 0.2 units from the median Log₂ of the probes for the probe set for the variant segment;

In one embodiment, the method comprises computing a median Log₂ each genetic non-variant from the median Log₂ for each probe in the probe set interrogating the genetic non-variant segment.

In one embodiment, the method comprises eliminating from a subsequent analysis the probes whose median Log₂ deviates more than 0.2 units from the median Log₂ of the probes for the probe set for the non-variant segment.

In one embodiment, the method comprises computing a new median Log₂ for a genetic non-variant segment from the Log₂ of probes that remain for that segment after the elimination of probes whose median Log₂ deviates more than 0.2 units from the median Log₂ of the probes for the probe set for the non-variant segment.

In another embodiment, the median Log₂ of each genetic non-variant segment is computed from the new median Log₂ for the probe feature when 4 or more replicate features remain for that probe after the elimination.

In one embodiment, the method comprises computing the ratio of new median Log₂ for the genetic variant segment over the new median Log₂ for the genetic non-variant segment, wherein if ratio is equal to about one or substantially one, the genotype of the tNA sample, i.e. copy number variation, is the same as that of the cNA sample; if the ratio is greater than about one or substantially one, this indicates a gain in copies of the genetic variant segment in the tNA sample genotype; and if the ratio is less than about one or substantially one, the test genotype has a deletion, this indicates a loss in copies of the genetic variant segment in the tNA sample genotype.

In one embodiment, the method comprises computing the ratio of new median Log₂ for the genetic variant segment over the new median Log₂ for the genetic non-variant segment, wherein if ratio is equal to about zero or substantially zero, the genotype of the tNA sample, i.e. copy number variation, is the same as that of the cNA sample; if the ratio is greater than about zero or substantially zero, this indicates a gain in copies of the genetic variant segment in the tNA sample genotype; and if the ratio is less than about zero or substantially zero, the test genotype has a deletion, this indicates a loss in copies of the genetic variant segment in the tNA sample genotype.

In one embodiment, one can use one or more control samples.

In one embodiment, the method is computer implemented.

According to the present methods, a test NA sample and at least one control NA sample are provided. Both the test and control NA samples comprise at least a genetic variant segment and at least a non-variant segment. The test NA sample is the NA from an individual whose genotype in at least one genetic variant segment is in query e.g. the genetic variation, in terms of copy number, in the LDLR gene Exon 2, from position 68−121, in intron 1, to nucleotide in position 190+102 (genomic sequence SEQ. ID. NO: 3 and mRNA reference sequence NM_{—}000527.3, SEQ. ID. NO: 4) is unknown.

The at least one non-variant segment in the test NA sample serves as an internal control for the test NA sample. The genotype at this non-variant segment in the tNA sample, in terms of copy number, is known and should theoretically be the same with that in the cNA sample. Example of such a non-variant segment is the DSCR1 locus on chromosome 21 and there are two copies for each of the tNA and cNA samples for a diploid individual. The cNA sample is NA from an individual whose genotypes in the same at least one genetic variant segment and also the same non-variant segment as the test individual are known.

For example, in a cNA sample, the genetic variation (copy number) in the LDLR gene Exon 2, from position 68−121, in intron 1, to nucleotide in position 190+102 is two and the genetic variation (copy number) in the non-variant segment DSCR1 locus is also two.

In one embodiment, the genotype of the cNA sample represents the normal genotype where the genetic variant segment under interrogation has no CNV. The tNA sample has unknown DNA variation at the genetic variant segment and normal genotype at the non-variant segment. The genetic variant and non variant segments under interrogation are the same in both test and control samples. For example, the LDLR gene Exon 2, from position 68−121, in intron 1, to nucleotide in position 190+102 as the genetic variant segment and the DSCR1 locus as the non-variant segment.

In one embodiment, control probes are provided in the solid support. Control probes hybridize to known non-variant segments on the X chromosomes and exhibit gender dimorphism, meaning the known copy number present depends on whether hybridization is performed on a male or female subject (one copy in males, two in females). Such control probes and their respective X chromosomes non-variant segments are used as controls to verify that a change in copy number can be detected in each hybridization, by comparing the test subject and a control subject of different gender.

For example, X chromosome non-variant segments can be selected from two genes: the PLP locus and F9 locus on the human chromosome X. These non-variant segments can use for the normalization. The first gene is PLP (for Proteolipid Protein1, located Xq22), a gene whose duplications and deletions are responsible of the Pelizaeus-Merzbacher disease (PMD). This disease is an X-linked recessive hypomyelinative leukodystrophy (HLD1) in which myelin is not formed properly in the central nervous system. PMD is characterized clinically by nystagmus, spastic quadriplegia, ataxia, and developmental delay. PLP1 is located at position chromosome X: 102,927,195-102,934,703 (SEQ. ID. NO: 5) with respect to human genome assembly 18 Mar. 2006 (GENBANK™ accession number for its mRNA: NM_{—}000533.3, SEQ. ID. NO: 6). The second gene is the F9 (for coagulation factor IX, located Xq22) which is responsible of Hemophilia B. Deletions of this gene cause Hemophilia B. These genes or part of these genes can be used as the non-genetic variant segments in test samples. F9 is located at position chromosome X:138,440,061-138,473,783 (SEQ. ID. NO: 7) with respect to human genome assembly 18 Mar. 2006 (GENBANK™ accession number for its mRNA: NM_{—}000133.3; SEQ. ID. NO: 8).

The NA samples can be obtained from any appropriate biological sample which contains NA. The sample may be taken from a fluid or tissue, secretion, cell or cell line derived from the human body.

For example, samples may be taken from blood, including serum, lymphocytes, lymphoblastoid cells, fibroblasts, platelets, mononuclear cells or other blood cells, from saliva, liver, kidney, pancreas or heart, urine or from any other tissue, fluid, cell or cell line derived from the human body. For example, a suitable sample may be a sample of cells from the buccal cavity. One can also use hair follicle samples.

In one embodiment, the NA is obtained from a blood sample.

In general, NA can be extracted and isolated from the biological sample using conventional techniques. The nucleic acid to be extracted from the biological sample can be DNA, or RNA, typically total RNA. Typically RNA is extracted if the genetic variation to be studied is situated in the coding sequence of a gene. Where RNA is extracted from the biological sample, the methods further comprise a step of obtaining cDNA from the RNA. This may be carried out using conventional methods, such as reverse transcription using suitable primers. Subsequent procedures are then carried out on the extracted DNA or the cDNA obtained from extracted RNA. The term DNA, as used herein, may include both DNA and cDNA.

One can also use lab-on-a-chip methods wherein the separate isolation step is not necessary because the raw sample, such as blood or urine sample, can be inserted into the microchannel and will be hybridized to the designed chip either within the microchannel or after exiting the microchannel. Such lab-on-a-chip systems are well known to one skilled in the art.

In general, any genetic variant can be analyzed using the computer-implemented algorithm as described. It is contemplated that the genetic variations to be tested are located within known nucleic acid sequences and are also well characterized.

In one aspect, the NA region which contains the segment or segments to be identified (e.g., a target DNA region) are subjected to an amplification reaction prior to analysis in order to obtain amplification products which contain the genetic variations to be identified. The amplified nucleic acid regions are typically the variant and non-variant segment to be interrogated. Any suitable technique or method can be used for amplification. In general, the technique allows the multiplex amplification of all the DNA sequences containing the genetic variations to be identified. In other words, where multiple genetic variations are to be analyzed, it is preferable to simultaneously amplify all of the corresponding target DNA regions in one reaction (comprising the variations). Carrying out the amplification in a single step (or as few steps as possible) simplifies the method. PCR amplification conditions are such that the final copy number after amplification reflects the initial copy number of the segments in the NA samples.

For example, multiplex PCR can be carried out, using appropriate pairs of oligonucleotide PCR primers which are capable of amplifying the target regions containing the genetic variations to be identified. Here each genetic variant segment is amplified together with a genetic non-variant segment in the multiplex PCR reaction using the test or control NA sample as the DNA template. The genetic variant and the genetic non-variant segments amplified together form an amplification group. Any suitable pair of primers which allow specific amplification of a target DNA region may be used.

In one aspect, the primers allow amplification in the least possible number of PCR reactions. Thus, by using appropriate pairs of oligonucleotide primers and appropriate conditions, all of the target DNA regions necessary for genotyping the genetic variations can be amplified for genotyping (e.g. DNA-array or particle suspension) analysis with the minimum number of reactions. One can use PCR primers for amplification of target DNA regions comprising genetic variations associated with any genetic variation, for example, erythrocyte antigens, IBD, adverse reaction to pharmaceuticals, are described in co-pending U.S. application Ser. No. 11/813,646. In particular, PCR primers for amplification of target DNA regions comprising the genetic variations associated with IBD, erythrocyte antigens, and adverse reaction to drugs are listed in co-pending U.S. application Ser. No. 11/813,646. Other examples may be found in co-pending U.S. Patent Application Ser. Nos. 61/210,124 (Multiple sclerosis), 61/185,187 (Hypercholesterolemia); 12/309,206 (Rheumatoid Arthritis); 12/309,162 (Osteoporosis); 12/309,208 (Prostate cancer); and International Patent Application number PCT/ES2004/070001 (Familial Hypercholesterolemia). The present method can comprise the use of one or more of these primers, or one or more of the listed primer pairs. Examples presented in the present application provide additional exemplary primers.

In one embodiment, several independent multiplex PCR amplification reactions are carried out for the test NA sample and the control sample. In one embodiment, at least four independent multiplex PCR amplification reactions are carried out for the test NA sample and the control sample. In one embodiment, about four independent multiplex PCR amplification reactions are carried out for the test NA sample and the control NA sample. The PCR products from the independent amplifications for the test NA sample are pooled together. Likewise, those of the control NA samples are pooled together. Examples of some PCR primers for multiplex PCR amplification of the genetic variant segments in the LDLR gene and in the non-variant segments of PLP and F9 genes are set forth in Table 1.

In one embodiment, the pooled PCR products are fragmented to smaller sizes and then detectably labeled prior to hybridization with probes on a solid support. In one embodiment, the PCR products are fragmented to between about 12-250 nt in size. In other embodiments, the PCR products are fragmented to between about 25-200 nt in size, between about 25-150 nt in size, between about 25-100 nt in size, between about 25-75 nt in size or between about 25-50 nt in size. One skilled in the art can easily determined the acceptable size range for the PCR product fragments for hybridization with probes on a solid support by any method known in the art.

On can also use the method as described in e.g., U.S. Ser. No. 12/499,076 in the analysis methods of the present application.

The genetic variant segment is encompassed within the tNA and cNA sample. In one embodiment, the genetic variant segment has one CNV.

In parallel with each genetic variant segment comprising the CNV provided, at least one genetic non-variant segment is selected. The genetic non-variant segment is encompassed within the tNA and cNA sample. For example, if neither the test nor the control exhibit Down syndrome, a test region from the Down syndrome region of chromosome 21 can be selected as a non-variant segment.

In one embodiment, the NAs in the tNA and cNA samples are detectably-labeled. The aim is to be able to later detect hybridization between the genetic variant or non-variant segments and probe features fixed on a solid support. The greater the extent of hybridization of labeled segment to a probe feature, the greater the intensity of detectable label at that probe position. Methods of labeling NA are well known to one skill in the art, e.g. U.S. Pat. No. 6,573,374 and U.S. Pat. No. 5,700,647 describe exemplary suitable labeling methods. The attached label is detected by various methods known in the art, e.g. optically, wherein a photonic signal is converted to an electronic signal and registered by a computer, which outputs a signal in, for example, a numeric value. For example, a labeled nucleotide can be incorporated during the amplification reaction or labeled primers can be used for amplification. In some embodiments, the labeled nucleotide is a biotinylated nucleotide. In other embodiments, the labeled primer is a biotinylated primer.

Labeling can be direct using for example, fluorescent or radioactive markers or any other marker known by persons skilled in the art. Examples of fluorophores, include for example, Cy3 or Cy5. Alternatively enzymes can be used for sample labeling, for example alkaline phosphatase or peroxidase. Examples of radioactive isotopes which can be used include for example ³³P, ¹²⁵I, or any other marker known by persons skilled in the art. In one instance, labeling of amplification products is carried out using a nucleotide which has been labeled directly or indirectly with one or more fluorophores. In another example, labeling of amplification products is carried out using primers labeled directly or indirectly with one or more fluorophores.

Labeling can also be indirect, using, for example, chemical or enzymatic methods. For example, an amplification product may incorporate one member of a specific binding pair, for example avidin or streptavidin, conjugated with a fluorescent marker and the probe to which it will hybridize may be joined to the other member of the specific binding pair, for example biotin (indicator), allowing the probe/target binding signal to be measured by fluorimetry. In another example, an amplification product can incorporate one member of a specific binding pair, for example, an anti-dioxigenin antibody combined with an enzyme (marker) and the probe to which it will hybridize may be joined to the other member of the specific binding pair, for example dioxigenin (indicator). On hybridization of amplification product to probe the enzyme substrate is converted into a luminous or fluorescent product and the signal can be read by, for example, chemi-luminescence or fluorometry.

The NA or the amplification products can further undergo a fragmentation reaction, thereby obtaining some fragmentation products which comprise or contain the genetic variations to be identified or analyzed. Typically fragmentation increases the efficiency of the hybridization reaction. Fragmentation can be carried out by any suitable method known in the art, for example, by contacting the nucleic acid, e.g. the amplification products with a suitable enzyme such as a DNase.

If the NA has not been previously labeled, e.g. during the amplification reaction, (and, typically, where no post-hybridization amplification or ligation is carried out on the solid support) then labeling with a detectable label can be carried out pre-hybridization by labeling the fragmentation products. Suitable labeling techniques are known in the art and can be direct or indirect, for example, biotin or one or various fluorophores, although other known markers can be used by those skilled in the art. Direct labeling can comprise the use of, for example, fluorophores, enzymes or radioactive isotopes. In one embodiment, the direct labeling comprises the use of biotin. Indirect labeling can comprise the use of, for example, specific binding pairs that incorporate e.g. fluorophores, enzymes, etc.

In one embodiment, at least one oligonucleotide probe is designed and synthesized for each of the variant and non-variant segment to be interrogated. In a preferred embodiment, at least two unique probes are designed and synthesize for each segment. In other embodiments, at least five, at least ten, at least 15, at least 20, at least 25, at least 30, at least 35, at least 40, at least 45, at least 50, at least 55, at least 60, at least 65, at least 70, at least 75, at least 80, at least 85, at least 90, at least 95, and at least 100, including all the whole integers between 2-100, unique probes are designed and synthesized for each segment. All of the probes are unique, although they can have overlapping sequences.

In one embodiment, the collection of unique probes designed and synthesized for each segment constitutes a probe set. In one embodiment, the probe set for a segment that is interrogated comprises at least two unique probes for that segment. In other embodiments, a probe set for a segment that is interrogated comprises at least five, at least ten, at least 15, at least 20, at least 25, at least 30, at least 35, at least 40, at least 45, at least 50, at least 55, at least 60, at least 65, at least70, at least 75, at least 80, at least 85, at least 90, at least 95, and at least 100, including all the whole integers between 2-100, unique probes. In one embodiment, for the practice of the method described, a first probe set is provided for a genetic variant segment (form the test NA sample) to be interrogated. In one embodiment, for the practice of the method, a second probe set is provided for a genetic non-variant segment (from the control NA sample) to be interrogated.

### DNA Chips or Microbeads

In some embodiments, the probes are attached to a solid support as probe features in a specific arrangement wherein the location of each probe feature is known. In one embodiment, a probe feature is provided on a solid support; the probe feature being a localized and concentrated sample having multiple copies of the same probe is deposited and attached on a solid surface. For example, for a flat solid support such as on the glass-chip surface, a probe feature is a minute spot or dot printed with multiple copies of the same probe. The multiple copies can range from hundreds to thousands, e.g. 100-10000. All of the whole integers between 100 to 10,000 are included. For a spherical surface such as a glass bead, “a probe feature” refers to a single probe-coated bead. All the beads are coated with the multiple copies of same probe that complements and interrogates a single genetic variant segment or non-variant segment. The range of numbers of probe-coated beads in “a probe feature” is between 100-1000, including all of the whole integers between 100 and 10,000.

In some embodiments for the practice of the method, a first probe feature is provided for a genetic variant segment to be interrogated. In some embodiments for the practice of the method, a second probe feature is provided for a genetic non-variant segment to be interrogated. The first and second probe features are attached on same solid support (see FIG. 1). In accordance with the method, two identical solid supports are used, each solid support having a first and a second probe feature. One solid support is used to hybridize with the tNA sample and the other solid support is used to hybridize with the cNA sample (FIG. 2).

In one embodiment, replicates of a probe feature are made on a solid support. For a flat solid support such as a glass-chip, all replicate features of one probe feature type have one type of probe and the replicates can be arranged in a row on the glass-chip surface. Multiple rows can be made and distributed in fix and known coordinates on the glass chip (see FIG. 1). For a spherical solid support such as a glass bead, replicate features of one probe are many probe-coated beads, e.g., about 100 probe-coated beads. These beads all have probes of a single type. For each probe on a flat solid support, there are at least four replicate features, at least five, at least six, at least seven, at least eight, at least nine, and at least ten replicate features, sometimes more. In some embodiments, the solid support has between 10-20 replicate features for each unique probe. All whole integers between 10 and 20 are considered. For each probe on a spherical solid support, there are at least about 100 replicate features or probe-coated beads.

In one embodiment for the practice of the method, replicates of probe features of a first probe set are provided for a genetic variant segment (form the tNA sample) to be interrogated. In one embodiment for the practice of the method, replicates of probe features of a second probe set are provided for a genetic non-variant segment (from the cNA sample) to be interrogated. The replicates of probe features of the first and second probe sets are attached on same solid support. In accordance with the method, two identical solid supports are used, each solid support having all the replicates of a first and a second probe set, wherein the first probe set interrogates a genetic variant segment and the second probe set interrogates a genetic non-variant segment. One solid support is used to hybridize with the tNA sample and the other solid support is used to hybridize with the cNA sample (see FIG. 2).

In one embodiment, each probe feature is provided in at least 10 replicates and the probe features are attached to the flat surface at positions according to a known uniform spatial distribution, i.e., a support or surface with an ordered array of binding (e.g. hybridization) sites or probes. Thus, the arrangement of replicate features on the support is predetermined. Each probe replicate is located at a known predetermined position on the solid support such that the identity (i.e. the sequence) of each probe can be determined from its position on the array. Typically, the probes are uniformly distributed in a predetermined pattern.

In one embodiment, the solid support is a flat surface. For example, for a flat solid support is a glass-chip surface.

In addition to DNA-arrays in the form of DNA-chips to detect genetic variations, the present inventions also contemplate the use of DNA particle or bead suspensions.

In one embodiment, the solid support is a micron-size particle. In one embodiment, the beads are uniquely identifiable. Examples of particle identifiers on a particle are a bar code and/or a fluorescent dye. In one embodiment, the beads are bar-coded. These beads such as polymer or magnetic beads have unique spectroscopic signatures. Beads can be synthesized by any method knows in the art, e.g., dispersion polymerization of a family of styrene monomers and methacrylic acid to generate a spectroscopically encoded bead library. Raman spectroscopy can be used to monitor complexing events on the barcoded beads. The genotyping assays from ILLUMINA®, Inc. uses the particles that are cylindrical beads encoded with a barcode, which are then read by a barcode scanner. Platforms such as the XMAP™ technology from LUMINEX® have the particles that are microspheres encoded with fluorescent dyes. The particles are read by a flow cytometer.

In one embodiment, the solid supports form particle suspensions. It has been found that these particle suspensions should comply with a number of requirements in order to be used in the present methods, for example in terms of the design of the probes, the number of probes provided for each genetic variation to be detected and the distribution of probes on the support. These are described in detail herein.

In one embodiment, wherein the solid support is a micron-size particle, each probe is attached to at least 10 units of each particle species, wherein each particle species is distinguishable by a unique code from all other particle species. This results in at least 10 probe features for each probe.

In one embodiment, wherein the solid support is a micron-size particle, each probe is attached to at least 1000 units of each particle species. This results in at least 1000 probe feature for each probe.

In practicing the method described, the labeled NA are contacted with a solid support having attached probes in a specified arrangement described as replicate features, allowing NA hybridization between the tNA and the cNA (collective hereby termed as target NA) with the probes in the replicate features and the formation of target-probe complexes. Under conditions which allow hybridization to occur between target NA and the corresponding probes, specific hybridization complexes are formed between target NA and corresponding probes. Since the NAs are labeled, the target-probe complexes formed can therefore be detected.

Typically, the hybridization conditions allow specific hybridization between probes and corresponding target NA to form specific probe/target hybridization complexes while minimizing hybridization between probes carrying one or more mismatches to the DNA. Such conditions may be determined empirically, for example by varying the time and/or temperature of hybridization and/or the number and stringency of the array washing steps that are performed following hybridization and are designed to eliminate all probe-DNA interactions that are non-specific. For example, the melting temperature of the probe/target complexes may occur at 75-85° C. In some embodiments, hybridizations can be for one hour, although higher and lower temperatures and longer or shorter hybridizations may also suffice. A skilled artisan can optimize these conditions using routine methods.

The hybridization can be carried out using conventional methods and devices known to a skilled artisan. In one instance, hybridization can be carried out using an automated hybridization station. For hybridization to occur, the segments are placed in contact with the probes under conditions which allow hybridization to take place. Using stable hybridization conditions allow the length and sequence of the probes to be optimized in order to maximize the discrimination between genetic variations A and B, e.g. between wild type and mutant sequences, as described.

In general a chip DNA array has from 300 to 40000 probe features, for example, from 400 to 30000 or 400 to 20000. The chip can have from 1000 to 20000 probes, such as 1000 to 15000 or 1000 to 10000, or 1000 to 5000. A suitable chip may have from 2000 to 20000, 2000 to 10000 or 2000 to 5000 probe features. For example, a chip may have 1000, 2000, 3000, 4000, 5000, 6000, 7000, 8000, 9000, 10000, 12000, 14000, 16000, 18000 or 20000 probes. Smaller chips 400 to 1000 probes, such as 400, 500, 600, 700, 800, 900 or 950 probes are also envisaged. The number of probes in a particle suspension will vary depending on the number of individually identifiable particles.

In general the chip DNA array of the invention comprises a support or surface with an ordered array of binding (e.g. hybridization) sites or probe features. Thus the arrangement of probes on the support is predetermined. Each probe (i.e. each replicate feature) is located at a known predetermined position on the solid support such that the identity (i.e. the sequence) of each probe can be determined from its position in the array. Typically the probes are uniformly distributed in a predetermined pattern.

Preferably, the probes deposited on the support, although they maintain a predetermined arrangement, are not grouped by genetic variation but have a random distribution. Typically they are also not grouped within the same genetic variation. If desired, this random distribution can be always the same. Therefore, typically the probes are deposited on the solid support (in an array) following a predetermined pattern so that they are uniformly distributed, for example, between the two areas that may constitute a DNA-chip, but not grouped according to the genetic variation to be characterized. Distributing probe replicates across the array in this way helps to reduce or eliminate any distortion of signal and data interpretation, e.g. arising from a non-uniform distribution of background noise across the array.

In some embodiments, probe features are arranged on the support in subarrays. Microarrays are in general prepared by selecting probes which comprise a given polynucleotide sequence, and then immobilizing such probes to a solid support or surface. Probes can be designed, tested and selected as described herein. In general, the probes can comprise DNA sequences. In some embodiments the probes can comprise RNA sequences, or copolymer sequences of DNA and RNA. The polynucleotide sequences of the probes can also comprise DNA and/or RNA analogues, or combinations thereof. For example, the polynucleotide sequences of the probes can be full or partial fragments of genomic DNA. The polynucleotide sequences of the probes can also be synthesized nucleotide sequences, such as synthetic oligonucleotide sequences. The probe sequences can be synthesized either enzymatically in vivo, enzymatically in vitro (e.g., by PCR), or non-enzymatically, such as chemically synthesized in vitro.

Microarrays or chips can be made in a number of ways. However produced, microarrays typically share certain characteristics. The arrays are reproducible, allowing multiple copies of a given array to be produced and easily compared with each other. Preferably, microarrays are made from materials that are stable under binding (e.g., nucleic acid hybridization) conditions. The microarrays are preferably small, e.g., between 0.25 to 25 or 0.5 to 20 cm², such 0.5 to 20 cm² or 0.5 to 15 cm², for example, 1 to 15 cm² or 1 to 10 cm², such as 2, 4, 6 or 9 cm².

Replicate features can be attached to the solid support using conventional techniques for immobilization of oligonucleotides on the surface of the supports. The techniques used depend, amongst other factors, on the nature of the support used—porous (membranes, micro-particles, etc.) or non-porous (glass, plastic, silicone, etc.) In general, the probes can be immobilized on the support either by using non-covalent immobilization techniques or by using immobilization techniques based on the covalent binding of the probes to the support by chemical processes.

Preparation of non-porous supports (e.g., glass, silicone, plastic) requires, in general, either pre-treatment with reactive groups (e.g., amino, aldehyde) or covering the surface of the support with a member of a specific binding pair (e.g. avidin, streptavidin). Likewise, in general, it is advisable to pre-activate the probes to be immobilized by means of corresponding groups such as thiol, amino or biotin, in order to achieve a specific immobilization of the probes on the support.

The immobilization of the probes on the support can be carried out by conventional methods, for example, by means of techniques based on the synthesis in situ of probes on the support (e.g., photolithography, direct chemical synthesis, etc.) or by techniques based on, for example, robotic arms which deposit the corresponding pre-synthesized probe (e.g. printing without contact, printing by contact) (See U.S. Pat. No. 7,281,419 for example).

In one embodiment, the support is a glass slide and in this case, the probes, in the number of established replicates (for example, 6, 8 or 10) are printed on pre-treated glass slides, for example coated with aminosilanes, using equipment for automated production of DNA-chips by deposition of the oligonucleotides on the glass slides (“micro-arrayer”). Deposition is carried out under appropriate conditions, for example, by means of crosslinking with ultraviolet radiation and heating (80° C.), maintaining the humidity and controlling the temperature during the process of deposition, typically at a relative humidity of between 40-50% and typically at a temperature of 20° C.

The replicate features are distributed uniformly amongst the areas or sectors (sub-arrays), which typically constitute a DNA-chip. The number of replicas and their uniform distribution across the DNA-chip minimizes the variability arising from the printing process that can affect experimental results.

To control the quality of the manufacturing process of the DNA-chip, in terms of hybridization signal, background noise, specificity, sensitivity and reproducibility of each replica as well as differences caused by variations in the morphology of the spotted probe features after printing, a commercially synthesize NA can be used.

In contrast to chip DNA array technology, in which the probes are attached to the solid support at known locations, particle suspension technology allows for the detection of probes in a single vessel, with individual probes attached to a particle with a distinguishable characteristic. In some embodiments the particles are encoded with one or more optically distinguishable dyes, a detectable label, or other identifying characteristic such as a bar code. Other labeling methods include, but are not limited to a combination of fluorescent and non-fluorescent dyes, or avidin coating for binding of biotinylated ligands. Such methods of encoding particles are known in the art.

Once hybridization has taken place, the intensity of detectable label at each probe position (including control probes) can be determined. The intensity of the signal (the raw intensity value) is a measure of hybridization at each replicate feature.

The intensity of detectable label at each probe position (each probe replica) can be determined using any suitable means. The means chosen will depend upon the nature of the label. In general an appropriate device, for example, a scanner, collects the image of the hybridized and developed DNA-chip. An image is captured and quantified.

In one instance, e.g. where fluorescent labeling is used, after hybridization, the hybridized and developed DNA-chip is placed in a scanner in order to quantify the intensity of labeling at the points where hybridization has taken place. Although practically any scanner can be used, in one embodiment a fluorescence confocal scanner is used. In this case, the DNA-chip is placed in the said apparatus and the signal emitted by the fluorophore due to excitation by a laser is scanned in order to quantify the signal intensity at the points where hybridization has taken place. Non-limiting examples of scanners which can be used according to the present invention, include scanners marketed by the following companies: Axon, Agilent, Perkin Elmer, etc.

In one aspect of the invention, the signal from the particles is detected by the use of a flow cytometer. In other embodiments, detection of fluorescent labels may also be carried out using a microscope or camera that will read the image on the particles. Flow cytometric software for detection and analysis of the signal is available for example from Luminex, Inc. (Austin, Tex.).

In one embodiment, wherein the measuring intensity of the detectable label for each probe is performed using scanning.

In one embodiment, wherein the measuring intensity of the detectable label for each probe is performed using flow measuring systems.

Typically, in determining the intensity of detectable label at each probe position (i.e. for each probe feature replica), account is taken of background noise, which is eliminated. Background noise arises because of non-specific binding to the probe array and can be determined by means of controls included in the array. Once the intensity of the background signal has been determined, this can be subtracted from the raw intensity value for each probe replica in order to obtain a clean intensity value. Typically the local background, based on the signal intensity detected in the vicinity of each individual feature is subtracted from the raw signal intensity value. This background is determined from the signal intensity in a predetermined area surrounding each feature (e.g. an area of X, Y or Z μm² centered on the position of the probe). The background signal is typically determined from the local signal of “blank” controls (solvent only). In many instances the device, e.g. scanner, which is used to determine signal intensities will provide means for determining background signal.

Thus, for example, where the label is a fluorescent label, absolute fluorescence values (raw intensity values) can be gathered for each probe replica and the background noise associated with each probe replica can also be assessed in order to produce “clean” values for signal intensity at each replicate feature position.

Once the tNA and cNA have hybridized to the chip and the intensity of detectable label have determined at the probe feature replica positions on the chip (the raw intensity values), it is necessary to provide a method (model) which can relate the intensity data from the chip to the genotype of the individual.

The inventors have found that this can be done by applying a specific algorithm to the intensity data. The algorithm and computer software developed by the inventors allows analysis of the genetic variations with sufficient sensitivity and reproducibility as to allow use in a clinical setting.

In general, for a given genetic variation in a tNA sample, the raw intensity values of the tNA and cNA sample (that was run in parallel with the test sample) are used in the analysis and interpretation of the genetic variation of the test sample. The analysis and interpretation using the raw intensity values obtained from the two chips (one hybridized with the tNA sample, the other hybridized with the cNA sample) comprises the following steps:

(i) providing the intensity of detectable label at each probe feature or probe feature replica for each unique probes in the first and second probe sets provided for the genetic variation segment and the non-variant segment (the raw intensity value);
(ii) (optionally) amending the raw value for each of the probe feature by deducting the background raw value, thereby obtaining a net value for the each probe feature for both the at least one genetic variant segment and the at least one genetic non-variant segment;
(iii) selecting for subsequent analysis the probe features whose net values pass quality control thresholds or values signal to noise ratio of over three (SNR>3), in the probe feature positions wherein a signal is detected;
(iv) computing a ratio of the net value of each probe feature after hybridization to the test NA sample over the net value of each corresponding probe feature hybridized to the control NA sample, for the probe set interrogating the genetic variant segment (See FIG. 2);
(v) computing a ratio of the net value of each probe feature after hybridization to the test NA sample over the net value of each probe feature hybridized to the control NA sample, for the probe set interrogating the at least one genetic non-variant segment (See FIG. 2);
(vi) computing a median or mean of the ratios from step (v) for all the probe features for the probe set interrogating the at least one non-variant segment, wherein the median or mean is used as a normalization factor for the ratio of intensity signals from each of the genetic variant segment (See FIG. 2);
(vii) applying the normalization factor to the ratio of each probe feature interrogating the variant segment and the non-variant segment to obtain a normalized ratio for each probe set;
(viii) computing a median or mean of the normalized ratios for the variant segment and the median or mean of the non-variant segment; and
(ix) computing the formula I:

$$\frac{\begin{matrix}median or mean of the normalized \\ ratios for the variant segment\end{matrix}}{\begin{matrix}median or mean of the normalized \\ ratios for the non \text{-} variant segment\end{matrix}}$$

wherein if ratio is equal to one, the genotype of the test NA sample, i.e. copy number variation, is the same as that of the control NA sample; if the ratio is greater than one, this indicates a gain in copies of the genetic variant segment in the test NA sample genotype; and if the ratio is less than one, the test genotype has a deletion, this indicates a loss in copies of the genetic variant segment in the test NA sample genotype.

Optionally, one or more, or all of the following additional algorithms are included before the final computation of the formula I wherein new median Log₂ of ratios are used instead of normalized ratios:
(i) computing a Log₂ for each of the normalized ratios;
(ii) computing a median Log₂ for each probe if there are replicates of probe features;
(iii) eliminating from a subsequent analysis the replicate features whose Log₂ deviates more than 0.2 units from the median Log₂ for that probe;
(iv) eliminating from a subsequent analysis each probe for which less than 4 replicate features remain after the previous elimination step and computing a new median Log₂ for the probe set when 4 or more replicate features remain for that probe set after the elimination;
(v) computing a median Log₂ for each genetic variant from the median Log₂ for each probe in the probe set interrogating that genetic variant segment;
(vi) eliminating from a subsequent analysis the probes whose median Log₂ deviates more than 0.2 units from the median Log₂ of the variant segment;
(vii) computing a new median Log₂ of ratios for a genetic variant segment from the Log₂ of probes that remain for that segment after the previous elimination steps (viii) computing a median Log₂ for the genetic non-variant from the median Log₂ for each probe in the probe set interrogating that genetic non-variant segment;
(ix) eliminating from a subsequent analysis the probes whose median Log₂ deviates more than 0.2 units from the median Log₂ of the non-variant segment; and
(x) computing a new median Log₂ of ratios for a genetic non-variant segment from the Log₂ of probes that remain for that segment after the previous elimination steps.

In one embodiment, the analysis of the ratio of the new mean or median Log₂ for genetic variant segment over the new mean or median Log₂ for genetic non-variant segment is compared to about one or substantially one, wherein substantially one means “the same as or very close to one”, such as 0.999, 1.01, 1.005, 0.9998, and 1.001, wherein when the ratio is less to about one or substantially one, this indicates that there is a loss of genetic variation in the test segment.

In another embodiment, the analysis of the ratio of the new mean or median Log₂ for genetic variant segment over the new mean or median Log₂ for genetic non-variant segment is compared to about zero or substantially zero, wherein substantially zero means “the same as or very close to zero”, such as 0.01, 0.03, 0.005, and 0.001, wherein when the ratio is less to about zero or substantially zero, this indicates that there is a loss of genetic variation in the test segment.

Typically, amending the raw intensity value to obtain the clean intensity value for each probe replica comprises subtracting background noise from the raw value. Background noise is typically determined using appropriate controls such as area of chip with no NA or probe.

The inventors have found that the use of replicas and median calculated from replicas is important for reliable working of the invention.

The algorithm as described herein is designed to be computer implemented, and thus in some embodiments, the methods described herein comprise the use of a computer system and a computer program.

### Systems for Analysis of CNV Genetic Variation

Embodiments of the invention can be described through functional modules, which are defined by computer executable instructions recorded on computer readable media and which cause a computer to perform method steps when executed. The modules are segregated by function for the sake of clarity. However, it should be understood that the modules/systems need not correspond to discreet blocks of code and the described functions can be carried out by the execution of various code portions stored on various media and executed at various times. Furthermore, it should be appreciated that the modules may perform other functions, thus the modules are not limited to having any particular functions or set of functions.

The computer readable storage media can be any available tangible media that can be accessed by a computer. Computer readable storage media includes volatile and nonvolatile, removable and non-removable tangible media implemented in any method or technology for storage of information such as computer readable instructions, data structures, program modules or other data. Computer readable storage media includes, but is not limited to, RAM (random access memory), ROM (read only memory), EPROM (eraseable programmable read only memory), EEPROM (electrically eraseable programmable read only memory), flash memory or other memory technology, CD-ROM (compact disc read only memory), DVDs (digital versatile disks) or other optical storage media, magnetic cassettes, magnetic tape, magnetic disk storage or other magnetic storage media, other types of volatile and non-volatile memory, and any other tangible medium which can be used to store the desired information and which can accessed by a computer including and any suitable combination of the foregoing.

Computer-readable data embodied on one or more computer-readable media may define instructions, for example, as part of one or more programs that, as a result of being executed by a computer, instruct the computer to perform one or more of the functions described herein, and/or various embodiments, variations and combinations thereof. Such instructions may be written in any of a plurality of programming languages, for example, Java, J#, Visual Basic, C, C#, C++, Fortran, Pascal, Eiffel, Basic, COBOL assembly language, and the like, or any of a variety of combinations thereof. The computer-readable media on which such instructions are embodied may reside on one or more of the components of either of a system, or a computer readable storage medium described herein, may be distributed across one or more of such components.

The computer-readable media can be transportable such that the instructions stored thereon can be loaded onto any computer resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a computer to implement aspects of the present invention. The computer executable instructions may be written in a suitable computer language or combination of several languages. Basic computational biology methods are known to those of ordinary skill in the art and are described in, for example, Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2nd ed., 2001).

The functional modules of certain embodiments of the invention include at minimum a measuring module #40, a storage module #30, a comparison module #80, and an output module #110. The functional modules can be executed on one, or multiple, computers, or by using one, or multiple, computer networks. The measuring module has computer executable instructions to provide e.g., expression information in computer readable form.

The measuring module #40, can comprise any system for detecting a signal representing the detectable label from a target NA-probe complex. Such systems can include DNA microarray readers, RNA expression array reader, flow cytometer or any other system which produces an electronic signal converted from the original label, such as a photonic signal or a radioactive signal. The original signal intensity or frequency determines the electronic signal intensity or frequency.

The information determined in the determination/measuring system can be read by the storage module #30. As used herein the “storage module” is intended to include any suitable computing or processing apparatus or other device configured or adapted for storing data or information. Examples of electronic apparatus suitable for use with the present invention include stand-alone computing apparatus, data telecommunications networks, including local area networks (LAN), wide area networks (WAN), Internet, Intranet, and Extranet, and local and distributed computer processing systems. Storage modules also include, but are not limited to: magnetic storage media, such as floppy discs, hard disc storage media, magnetic tape, optical storage media such as CD-ROM, DVD, electronic storage media such as RAM, ROM, EPROM, EEPROM and the like, general hard disks and hybrids of these categories such as magnetic/optical storage media. The storage module is adapted or configured for having recorded thereon genetic variation information. Such information may be provided in digital form that can be transmitted and read electronically, e.g., via the Internet, on diskette, via USB (universal serial bus) or via any other suitable mode of communication.

As used herein, “stored” refers to a process for encoding information on the storage module. Those skilled in the art can readily adopt any of the presently known methods for recording information on known media to generate manufactures comprising genetic variation information.

In one embodiment, the reference data stored in the storage module to be read by the comparison module is e.g., genetic variation data from normal subjects.

The “comparison module” #80 can use a variety of available software programs and formats for the comparison operative to compare genetic variation data determined in the measuring module for the variant and non-variant segment. In one embodiment, the comparison module is configured to use pattern recognition techniques to compare information from one or more entries to one or more reference data patterns. The comparison module may be configured using existing commercially-available or freely-available software for comparing patterns, and may be optimized for particular data comparisons that are conducted. The comparison module provides computer readable information related to normalized ratios of intensities, median log₂ of intensities etc in the analysis and interpretation of the genetic variation in an individual.

The comparison module, or any other module of the invention, may include an operating system (e.g., UNIX) on which runs a relational database management system, a World Wide Web application, and a World Wide Web server. World Wide Web application includes the executable code necessary for generation of database language statements (e.g., Structured Query Language (SQL) statements). Generally, the executables will include embedded SQL statements. In addition, the World Wide Web application may include a configuration file which contains pointers and addresses to the various software entities that comprise the server as well as the various external and internal databases which must be accessed to service user requests. The Configuration file also directs requests for server resources to the appropriate hardware—as may be necessary should the server be distributed over two or more separate computers. In one embodiment, the World Wide Web server supports a TCP/IP protocol. Local networks such as this are sometimes referred to as “Intranets.” An advantage of such Intranets is that they allow easy communication with public domain databases residing on the World Wide Web (e.g., the GENBANK™ or Swiss Pro World Wide Web site). Thus, in a particular preferred ebodiment of the present invention, users can directly access data (via Hypertext links for example) residing on Internet databases using a HTML interface provided by Web browsers and Web servers.

The comparison module provides a computer readable comparison result that can be processed in computer readable form by predefined criteria, or criteria defined by a user, to provide a content-based in part on the comparison result that may be stored and output as requested by a user using an output module #110.

The content based on the comparison result, can be an expression value compared to a reference showing the median Log₂ values of genetic variant and non-variant segments in normal individuals.

In one embodiment of the invention, the content based on the comparison result is displayed on a computer monitor #120. In one embodiment of the invention, the content based on the comparison result is displayed through printable media #130, #140. The display module can be any suitable device configured to receive from a computer and display computer readable information to a user. Non-limiting examples include, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) of Sunnyvale, Calif., or any other type of processor, visual display devices such as flat panel displays, cathode ray tubes and the like, as well as computer printers of various types.

In one embodiment, a World Wide Web browser is used for providing a user interface for display of the content based on the comparison result. It should be understood that other modules of the invention can be adapted to have a web browser interface. Through the Web browser, a user may construct requests for retrieving data from the comparison module. Thus, the user will typically point and click to user interface elements such as buttons, pull down menus, scroll bars and the like conventionally employed in graphical user interfaces.

The present invention therefore provides for systems (and computer readable media for causing computer systems) to perform methods for analyzing genetic variations in a test NA sample.

Systems and computer readable media described herein are merely illustrative embodiments of the invention for detecting CNV genetic variation in an individual, and are not intended to limit the scope of the invention. Variations of the systems and computer readable media described herein are possible and are intended to fall within the scope of the invention.

The modules of the machine, or those used in the computer readable medium, may assume numerous configurations. For example, function may be provided on a single machine or distributed over multiple machines.

In one embodiment, provided herein is a system to analyzing the genetic variation in NA sample, comprising:
a. a measuring module measuring the raw intensity comprising a detectable signal from a replicate feature indicating the presence or level of a NA-probe complex on a solid support comprising the replicate feature;
b. a storage module configured to store data output from the measuring module;
c. a comparison module adapted to compare the data stored on the storage module with reference and/or control data, and to provide a retrieved content, and
d. an output module for displaying the retrieved content for the user, wherein the retrieved content the median, mean, or median Log₂ intensities of genetic variant segments indicates that the presence of DNA variation in the test NA sample.

In one embodiment, provided herein is a computer readable storage medium comprising:
a. a storing data module containing a detectable signal from a replicate feature indicating the presence or level of a NA-probe complex on a solid support comprising the replicate feature
b. a comparison module that compares the data stored on the storing data module with a reference data and/or control data, and to provide a comparison content, and
c. an output module displaying the comparison content for the user, wherein the retrieved content the median, mean, or median log₂ intensities of genetic variant segments indicates that the presence of DNA variation in the test NA sample.

In one embodiment, the control data comprises data from an individual with normal genotype at the genetic variant segment under interrogation.

### Design and Selection of Probe Sets and Variant Segments for CNV Analysis and a CNV-Chip

In one embodiment, genes or genetic variant segments are selected on the basis of the pathogenicity of a CNV they may contain. The probes for detecting CNVs are oligonucleotide NA ranging from 15 to 50 nt are found in genes or genetic variant segments

As an exemplary, the gene having genetic variant segments that can be interrogated is the gene encoding LDLR (for Low Density Lipoprotein Receptor, located 19p13.2). It is involved in the phenotype of Hypercholesterolemia, Autosomic Dominant (HAD mainly called Familial Hypercholesterolemia, hereafter named FH), all the regions known to be possibly affected by CNVs are selected as genetic variant segments for interrogations.

These regions are listed below:

Genetic variant segment 1: Promoter and exon 1 of LDLR gene (SEQ. ID. NO: 10).

From position (−377), considering the first nucleotide of the initiating methionine in position 1 of the protein as the origin, until 67+106, localized in intron 1 (reference sequence LDLR mRNA is NM_{—}000527.3, SEQ. ID. NO: 4). This region includes transcription regulatory elements (2 TATA box and 3 imperfect repetitions of elements regulated by sterol (SER elements).

### Genetic Variant Segment 2: Exon 2 (SEQ. ID. NO: 11).

From position 68−121, in intron 1, until nucleotide in position 190+102. Genetic variant segment 3: Exon 3 (SEQ. ID. NO: 12).

From position 191−124, in intron 2, until nucleotide in position 313+121.

### Genetic Variant Segment 4: Exon 4 (SEQ. ID. NO: 13).

From position 314−77, in intron 3, until nucleotide in position 694+81.

### Genetic Variant Segment 5: Exon 5 (SEQ. ID. NO: 14).

From position 695−71, in intron 4, until nucleotide in position 817+78.

### Genetic Variant Segment 6: Exon 6 (SEQ. ID. NO: 15).

From position 818−71, in intron 5, until nucleotide in position 940+83.

### Genetic Variant Segment 7: Exon 7 (SEQ. ID. NO: 16).

From position 941−84, in intron 6, until nucleotide in position 1060+146.

### Genetic Variant Segment 8: Exon 8 (SEQ. ID. NO: 17).

From position 1061−94, in intron 7, until nucleotide in position 1186+106.

Genetic Variant Segment 9: Exon 9, intron 9 and exon 10 (SEQ. ID. NO: 18).

From position 1187−93, in intron 8, until nucleotide in position 1586+111. This region includes full intron 9.

### Genetic Variant Segment 10: Exon 11 (SEQ. ID. NO: 19).

From position 1587−96, in intron 10, until nucleotide in position 1705+107.

### Genetic Variant Segment 11: Exon 12 (SEQ. ID. NO: 20).

From position 1706−130, in intron 11, until nucleotide in position 1845+79.

### Genetic Variant Segment 12: Exon 13, Intron 13 and Exon 14 (SEQ. ID. NO: 21).

From position 1846−78, in intron 12, until nucleotide in position 2140+150. This region includes full intron 13.

### Genetic Variant Segment 13: Exon 15 (SEQ. ID. NO: 22).

From position 2141−71, in intron 14, until nucleotide in position 2311+84.

### Genetic Variant Segment 14: Exon 16 (SEQ. ID. NO: 23).

From position 2312−116, in intron 15, until nucleotide in position 2389+105.

### Genetic Variant Segment 15: Exon 17 (SEQ. ID. NO: 24).

From position 2390-105, in intron 16, until nucleotide in position 2547+80.

### Genetic Variant Segment 16: Exon 18 (SEQ. ID. NO: 25).

From position 2548−146, in intron 17, until nucleotide in position 2580+96.

Other genes having genetic variant segments that can be interrogated are the human apolipoprotein B (including Ag(x) antigen) (APOB) gene, the various exons in PCSK9 (Proprotein convertase subtilisin/kexin type 9) gene, in particular, exons 2, 4, 7 and 10, as provided in SEQ. ID. NOS: 27-30 respectively and the cystic fibrosis transmembrane conductance regulator (CFTR) gene that is responsible for the genetic disorder cystic fibrosis. This gene is located on chromosome 7:116907153-117096054 (approx. 188 kb) (SEQ. ID. NO: 31).

### Genetic Variant Segment 17: Exon 26 APOB (SEQ. ID. NO: 26).

From position 10453, exon 26, until nucleotide in position 10740 (reference sequence NM_{—}000384.2).

The nomenclature formula for the positions of the bases are as described in den Dunnen and Antonarakis, Human Mutation, 2000, 15:7-12. The first number within each position formula XXX−YYY or XXX+YYY, e.g. position 2141−71 or position 2547+80 refers to the position of the base on the mRNA human LDLR sequence (SEQ. ID. NO: 4) wherein the position number 1 is the “A” of the ATG of the signal peptide” in SEQ. ID. NO: 1. In SEQ. ID. NO: 4, the “A” of the ATG of the signal peptide” or base position number 1 is the 469th nucleotide in the genomic sequence of human LDLR sequence (SEQ. ID. NO: 4). In other words, the base position in the LDLR genomic sequence that correspond to the 1st base position in the LDLR mRNA is 469. The second number within each position formula refers to the number of the bases that is to be added or subtracted from the base position in the genomic where that base position corresponds to the first number of the position formula which is that in the mRNA.

The sequences of a number of oligonucleotides probes are selected from these are variant segments. These probes are synthesized and then spotted on a solid support in an array as probe feature replicas.

The patient's NA, such as DNA, to be genotyped, called test NA sample, is amplified to produce various genetic variant segments as listed herein and can be complementary of the entire size of the probes. Together with the patient's DNA, one or more control sample of known gender is amplified under the same conditions of the test target. Same conditions include the same PCR mix, the same amplification machine (usually called thermocycler) and the same hybridization conditions.

Once amplified, the targets (test and control) are fragmented and labeled and then hybridized onto the probes that are immobilized on solid supports. Solid supports such as flat glass chips or beads are scanned to obtain intensities of each single probe.

Additional embodiments of the invention provides a DNA chip comprising a plurality of probe features deposited on a solid support, the chip being suitable for use in a method of the invention described herein; a computational method for obtaining a genotype from DNA-chip hybridization intensity data wherein the method comprises using log₂ ratios for each segment to be genotyped; a computer system comprising a processor and means for controlling the processor to carry out a computational method of the invention; and a computer program comprising computer program code which when run on a computer or computer network causes the computer or computer network to carry out a computational method of the invention.

Unless otherwise explained, all technical and scientific terms used herein have the same meaning as commonly understood by one of ordinary skill in the art to which this disclosure belongs. Definitions of common terms in genomics and molecular biology can be found in The Encyclopedia of Molecular Biology, published by Blackwell Science Ltd., 1994 (ISBN 0-632-02182-9); Robert A. Meyers (ed.), Molecular Biology and Biotechnology: a Comprehensive Desk Reference, published by VCH Publishers, Inc., 1995 (ISBN 1-56081-569-8); and Discovering Genomics, Proteomics and Bioinformatics 2nd edition—by A. Malcolm Campbell and Laurie J. Heyer. (ISBN 0-8053-4722-4; published by Cold Spring Harbor Laboratory Press and Benjamin Cummings: 2006). Definitions of common terms in molecular biology may be found in Benjamin Lewin, Genes IX, published by Jones & Bartlett Publishing, 2007 (ISBN-13: 9780763740634); Kendrew et al. (eds.).

Unless otherwise stated, the present invention was performed using standard procedures, as described, for example in Microarrays Methods and Applications (Nuts & Bolts series) by Gary Hardiman (Ed.), DNA Press; 1st edition (2003; ISBN-13: 978-0966402766), Analytical Tools for DNA, Genes and Genomes: Nuts & Bolts (Nuts & Bolts series) by Arseni Markoff (Ed.), DNA Press, (2005, ISBN-13: 978-0974876511); and DNA Microarrays, Part B: Databases and Statistics, Volume 411 (Methods in Enzymology) by Alan R. Kimmel and Brian Oliver (Eds), Academic Press, 1^{st} edition (2006; ISBN-13: 978-0121828165) which are all incorporated by reference herein in their entireties.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

Other than in the operating examples, or where otherwise indicated, all numbers expressing quantities of ingredients or reaction conditions used herein should be understood as modified in all instances by the term “about.” The term “about” when used in connection with percentages may mean±1%.

The singular terms “a,” “an,” and the include plural referents unless context clearly indicates otherwise. Similarly, the word or is intended to include and unless the context clearly indicates otherwise. It is further to be understood that all base sizes or amino acid sizes, and all molecular weight or molecular mass values, given for nucleic acids or polypeptides are approximate, and are provided for description. Although methods and materials similar or equivalent to those described herein can be used in the practice or testing of this disclosure, suitable methods and materials are described below. The abbreviation, “e.g.” is derived from the Latin exempli gratia, and is used herein to indicate a non-limiting example. Thus, the abbreviation “e.g.” is synonymous with the term “for example.”

All patents and other publications identified in the specification are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The present invention can be defined in any of the following alphabetized paragraphs:
[A] A method of analyzing at least one genetic variant segment in a nucleic acid (NA) sample comprising:
   (a) providing a test nucleic acid (tNA) sample;
   (b) providing at least one control nucleic acid (cNA) sample;
   (c) amplifying the tNA and the cNA samples in parallel reactions;
   (d) providing a first oligonucleotide probe set designed to hybridize to at least one genetic variant segment and a second probe set designed to hybridize to at least one genetic non-variant segment, wherein the first and the second probe set are attached to a solid support to form at least a genetic variant probe feature and at least a genetic non-variant probe feature respectively;
   (e) contacting, in parallel reactions, the tNA and the cNA with the solid support, thereby allowing NA hybridization between the tNA and the cNA to the genetic variant probe feature and non-variant probe feature thereby forming NA-probe complexes, wherein each complex is detectably labeled;
   (f) measuring an intensity of the detectable label for NA-probe complex at each probe feature;
   (g) applying an algorithm to the data from step (f), thereby determining the genotype with respect to each genetic variant present in the genetic variant segment of the tNA sample, wherein algorithm comprises the steps of:
   (i) computing a ratio of the net value of each probe feature after hybridization to the test NA over the net value of each probe feature hybridized to the cNA, for the probe set interrogating the at least one genetic non-variant segment;
   (ii) computing a ratio of the net value of each probe feature after hybridization to the test NA over the net value of each probe feature hybridized to the control nucleic acid, for the at least one probe set interrogating the at least one genetic variant segment; (iii) computing a median or mean of the ratios from step (i) for the probe features for the probe set interrogating the at least one non-variant segment, wherein the median or mean is used as a normalization factor for the ratios of step (i) obtained from the at least one non-variant segment and for the ratios of step (ii) obtained from the at least one genetic variant segment;
   (iv) applying the normalization factor of step (iii) to the ratios of step (i) and for the ratios of step (ii) to obtain a normalized ratio for the probe features of each probe set;
   (v) computing a median or mean of the ratios from step (iv) for the probe features for the probe set interrogating the at least one genetic variant segment and for the probe features for the probe set interrogating the at least one non-variant segment, wherein either the median is computed for both the variant and non-variant segment or the mean is computed for both the variant and non-variant segment;
   (vi) computing a ratio of median or mean from step (v) for a genetic variant segment over the median or mean from step (v) for a genetic non-variant segment, wherein if ratio is equal to one, the genotype of the tNA sample, i.e. copy number variation, is the same as that of the cNA sample; if the ratio is greater than one, this indicates a gain in copies of the genetic variant segment in the tNA sample genotype; and if the ratio is less than one, the genotype of the tNA sample has a deletion, this indicates a loss in copies of the genetic variant segment in the tNA sample genotype.
[B] The method of paragraph [A], wherein the solid support is a flat surface.
[C] The method of paragraph [B], wherein each probe feature is provided in replicates and the probe features are attached to the flat surface at positions according to a known uniform spatial distribution.
[D] The method of paragraph [A], wherein the solid support is a micron-size particle.
[E] The method of paragraph [A], wherein each probe is attached to at least 10 units of particle species, wherein each particle species is distinguishable by a unique code from all other particle species.
[F] The method of paragraph [B] or [C], wherein the measuring intensity of the detectable label for each probe is performed using scanning
[G] The method of paragraph [D] or [E] wherein the measuring intensity of the detectable label for each probe is performed using flow measuring systems.
[H] The method of paragraph [A], wherein one computes a mean in step (iii).
[I] The method of claim [A], wherein one computes a median in step (iii).
[J] A system to analyzing a genetic variation in a test nucleic acid (tNA) sample, comprising:
   (a) a measuring module capable of measuring the raw intensity comprising a detectable signal from a replicate feature indicating the presence or level of a NA-probe complex on a solid support comprising the replicate feature;
   (b) a storage module configured to store data output from the measuring module;
   (c) a comparison module adapted to compare the data stored on the storage module with reference and/or control data, and to provide a retrieved content using an algorithm with the steps:
   (i) computing a ratio of the net value of each probe feature after hybridization to the test NA over the net value of each probe feature hybridized to the control NA (cNA), for the probe set interrogating the at least one genetic non-variant segment;
   (ii) computing a ratio of the net value of each probe feature after hybridization to the test NA over the net value of each probe feature hybridized to the control nucleic acid, for the at least one probe set interrogating the at least one genetic variant segment; (iii) computing a median or mean of the ratios from step (i) for the probe features for the probe set interrogating the at least one non-variant segment, wherein the median or mean is used as a normalization factor for the ratios of step (i) obtained from the at least one non-variant segment and for the ratios of step (ii) obtained from the at least one genetic variant segment;
   (iv) applying the normalization factor of step (iii) to the ratios of step (i) and for the ratios of step (ii) to obtain a normalized ratio for the probe features of each probe set;
   (v) computing a median or mean of the ratios from step (iv) for the probe features for the probe set interrogating the at least one genetic variant segment and for the probe features for the probe set interrogating the at least one non-variant segment, wherein either the median is computed for both the variant and non-variant segment or the mean is computed for both the variant and non-variant segment;
   (vi) computing a ratio of median or mean from step (v) for a genetic variant segment over the median or mean from step (v) for a genetic non-variant segment, wherein if ratio is equal to one, the genotype of the tNA sample, i.e. copy number variation, is the same as that of the control NA sample; if the ratio is greater than one, this indicates a gain in copies of the genetic variant segment in the tNA sample genotype; and if the ratio is less than one, the genotype of the tNA sample has a deletion, this indicates a loss in copies of the genetic variant segment in the tNA sample genotype; and
   (d) an output module for displaying the retrieved content for the user, wherein the retrieved content the ratio of median or mean for the genetic variant segment indicates the genetic variation in the tNA.
[K] A computer readable storage medium comprising:
   (a) a storing data module containing a detectable signal from a replicate feature indicating the presence or level of a test nucleic acid (tNA)-probe complex on a solid support comprising the replicate feature;
   (b) a comparison module that compares the data stored on the storing data module with a reference data and/or control data, and provides a comparison content, wherein the comparison module performs an algorithm with the steps:
   (i) computing a ratio of the net value of each probe feature after hybridization to the tNA over the net value of each probe feature hybridized to the control NA (cNA), for the probe set interrogating the at least one genetic non-variant segment;
   (ii) computing a ratio of the net value of each probe feature after hybridization to the test NA over the net value of each probe feature hybridized to the control nucleic acid, for the at least one probe set interrogating the at least one genetic variant segment; (iii) computing a median or mean of the ratios from step (i) for the probe features for the probe set interrogating the at least one non-variant segment, wherein the median or mean is used as a normalization factor for the ratios of step (i) obtained from the at least one non-variant segment and for the ratios of step (ii) obtained from the at least one genetic variant segment;
   (iv) applying the normalization factor of step (iii) to the ratios of step (i) and for the ratios of step (ii) to obtain a normalized ratio for the probe features of each probe set;
   (v) computing a median or mean of the ratios from step (iv) for the probe features for the probe set interrogating the at least one genetic variant segment and for the probe features for the probe set interrogating the at least one non-variant segment, wherein either the median is computed for both the variant and non-variant segment or the mean is computed for both the variant and non-variant segment;
   (vi) computing a ratio of median or mean from step (v) for a genetic variant segment over the median or mean from step (v) for a genetic non-variant segment, wherein if ratio is equal to one, the genotype of the tNA sample, i.e. copy number variation, is the same as that of the control NA sample; if the ratio is greater than one, this indicates a gain in copies of the genetic variant segment in the tNA sample genotype; and if the ratio is less than one, the genotype of the tNA sample has a deletion, this indicates a loss in copies of the genetic variant segment in the tNA sample genotype; and
   (c) an output module displaying the comparison content for the user, wherein the retrieved content the ratio of median or mean for the genetic variant segment indicates the genetic variation in the tNA.
[L] The system of paragraph [J], wherein the control data comprises data from an individual with known genotype at the genetic variant segment under interrogation.
[M] The storage medium of paragraph [K], wherein the control data comprises data from an individual with known genotype at the genetic variant segment under interrogation.

The contents of all references cited throughout this application, as well as the figures are expressively incorporated herein by reference in their entirety.

1. A method of analyzing at least one genetic variant segment in a nucleic acid (NA) sample comprising:
(a) providing a test nucleic acid (tNA) sample;
(b) providing at least one control nucleic acid (cNA) sample;
(c) amplifying the tNA and the cNA samples in parallel reactions;
(d) providing a first oligonucleotide probe set designed to hybridize to at least one genetic variant segment and a second probe set designed to hybridize to at least one genetic non-variant segment, wherein the first and the second probe set are attached to a solid support to form at least a genetic variant probe feature and at least a genetic non-variant probe feature respectively;
(e) contacting, in parallel reactions, the tNA and the cNA with the solid support, thereby allowing NA hybridization between the tNA and the cNA to the genetic variant probe feature and non-variant probe feature thereby forming NA-probe complexes, wherein each complex is detectably labeled;
(f) measuring an intensity of the detectable label for NA-probe complex at each probe feature;
(g) applying an algorithm to the data from step (f), thereby determining the genotype with respect to each genetic variant present in the genetic variant segment of the tNA sample, wherein algorithm comprises the steps of:
(i) computing a ratio of the net value of each probe feature after hybridization to the test NA over the net value of each probe feature hybridized to the cNA, for the probe set interrogating the at least one genetic non-variant segment;
(ii) computing a ratio of the net value of each probe feature after hybridization to the test NA over the net value of each probe feature hybridized to the control nucleic acid, for the at least one probe set interrogating the at least one genetic variant segment;
(iii) computing a median or mean of the ratios from step (i) for the probe features for the probe set interrogating the at least one non-variant segment, wherein the median or mean is used as a normalization factor for the ratios of step (i) obtained from the at least one non-variant segment and for the ratios of step (ii) obtained from the at least one genetic variant segment;
(iv) applying the normalization factor of step (iii) to the ratios of step (i) and for the ratios of step (ii) to obtain a normalized ratio for the probe features of each probe set;
(v) computing a median or mean of the ratios from step (iv) for the probe features for the probe set interrogating the at least one genetic variant segment and for the probe features for the probe set interrogating the at least one non-variant segment, wherein either the median is computed for both the variant and non-variant segment or the mean is computed for both the variant and non-variant segment;
(vi) computing a ratio of median or mean from step (v) for a genetic variant segment over the median or mean from step (v) for a genetic non-variant segment, wherein if ratio is equal to one, the genotype of the tNA sample, i.e. copy number variation, is the same as that of the cNA sample; if the ratio is greater than one, this indicates a gain in copies of the genetic variant segment in the tNA sample genotype; and if the ratio is less than one, the genotype of the tNA sample has a deletion, this indicates a loss in copies of the genetic variant segment in the tNA sample genotype.

2. The method of claim 1, wherein the solid support is a flat surface.

3. The method of claim 2, wherein each probe feature is provided in replicates and the probe features are attached to the flat surface at positions according to a known uniform spatial distribution.

4. The method of claim 1, wherein the solid support is a micron-size particle.

5. The method of claim 1, wherein each probe is attached to at least 10 units of particle species, wherein each particle species is distinguishable by a unique code from all other particle species.

6. The method of claim 2, wherein the measuring intensity of the detectable label for each probe is performed using scanning.

7. The method of claim 4 wherein the measuring intensity of the detectable label for each probe is performed using flow measuring systems.

8. The method of claim 1, wherein one computes a mean in step (iii).

9. The method of claim 1, wherein one computes a median in step (iii).

10. A system to analyzing a genetic variation in a test nucleic acid (tNA) sample, comprising:
(a) a measuring module capable of measuring the raw intensity comprising a detectable signal from a replicate feature indicating the presence or level of a NA-probe complex on a solid support comprising the replicate feature;
(b) a storage module configured to store data output from the measuring module;
(c) a comparison module adapted to compare the data stored on the storage module with reference and/or control data, and to provide a retrieved content using an algorithm with the steps:
(i) computing a ratio of the net value of each probe feature after hybridization to the test NA over the net value of each probe feature hybridized to the control NA (cNA), for the probe set interrogating the at least one genetic non-variant segment;
(ii) computing a ratio of the net value of each probe feature after hybridization to the test NA over the net value of each probe feature hybridized to the control nucleic acid, for the at least one probe set interrogating the at least one genetic variant segment;
(iii) computing a median or mean of the ratios from step (i) for the probe features for the probe set interrogating the at least one non-variant segment, wherein the median or mean is used as a normalization factor for the ratios of step (i) obtained from the at least one non-variant segment and for the ratios of step (ii) obtained from the at least one genetic variant segment;
(iv) applying the normalization factor of step (iii) to the ratios of step (i) and for the ratios of step (ii) to obtain a normalized ratio for the probe features of each probe set;
(v) computing a median or mean of the ratios from step (iv) for the probe features for the probe set interrogating the at least one genetic variant segment and for the probe features for the probe set interrogating the at least one non-variant segment, wherein either the median is computed for both the variant and non-variant segment or the mean is computed for both the variant and non-variant segment;
(vi) computing a ratio of median or mean from step (v) for a genetic variant segment over the median or mean from step (v) for a genetic non-variant segment, wherein if ratio is equal to one, the genotype of the tNA sample, i.e. copy number variation, is the same as that of the control NA sample; if the ratio is greater than one, this indicates a gain in copies of the genetic variant segment in the tNA sample genotype; and if the ratio is less than one, the genotype of the tNA sample has a deletion, this indicates a loss in copies of the genetic variant segment in the tNA sample genotype; and
(d) an output module for displaying the retrieved content for the user, wherein the retrieved content the ratio of median or mean for the genetic variant segment indicates the genetic variation in the tNA.

11. A computer readable storage medium comprising:
(a) a storing data module containing a detectable signal from a replicate feature indicating the presence or level of a test nucleic acid (tNA)-probe complex on a solid support comprising the replicate feature;
(b) a comparison module that compares the data stored on the storing data module with a reference data and/or control data, and provides a comparison content, wherein the comparison module performs an algorithm with the steps:
(i) computing a ratio of the net value of each probe feature after hybridization to the tNA over the net value of each probe feature hybridized to the control NA (cNA), for the probe set interrogating the at least one genetic non-variant segment;
(ii) computing a ratio of the net value of each probe feature after hybridization to the test NA over the net value of each probe feature hybridized to the control nucleic acid, for the at least one probe set interrogating the at least one genetic variant segment;
(iii) computing a median or mean of the ratios from step (i) for the probe features for the probe set interrogating the at least one non-variant segment, wherein the median or mean is used as a normalization factor for the ratios of step (i) obtained from the at least one non-variant segment and for the ratios of step (ii) obtained from the at least one genetic variant segment;
(iv) applying the normalization factor of step (iii) to the ratios of step (i) and for the ratios of step (ii) to obtain a normalized ratio for the probe features of each probe set;
(v) computing a median or mean of the ratios from step (iv) for the probe features for the probe set interrogating the at least one genetic variant segment and for the probe features for the probe set interrogating the at least one non-variant segment, wherein either the median is computed for both the variant and non-variant segment or the mean is computed for both the variant and non-variant segment;
(vi) computing a ratio of median or mean from step (v) for a genetic variant segment over the median or mean from step (v) for a genetic non-variant segment, wherein if ratio is equal to one, the genotype of the tNA sample, i.e. copy number variation, is the same as that of the control NA sample; if the ratio is greater than one, this indicates a gain in copies of the genetic variant segment in the tNA sample genotype; and if the ratio is less than one, the genotype of the tNA sample has a deletion, this indicates a loss in copies of the genetic variant segment in the tNA sample genotype; and
(c) an output module displaying the comparison content for the user, wherein the retrieved content the ratio of median or mean for the genetic variant segment indicates the genetic variation in the tNA.

12. The system of claim 10, wherein the control data comprises data from an individual with known genotype at the genetic variant segment under interrogation.

13. The storage medium of claim 11, wherein the control data comprises data from an individual with known genotype at the genetic variant segment under interrogation.
